(19) United States
(12) Patent Application Publication
(10) Pub. No.: US 2004/0033899 A1
(43) Pub. Date: Feb. 19, 2004

(54) 5[(pyrazol-4-yl)carbonyl]benzazolone as herbicide

(76) Inventors: Guido Mayer, Neustadt (DE); Ulf Miblitz, Neustadt (DE); Ernst Baumann, Dudenhofen (DE); Wolfgang von Deyn, Neustadt (DE); Steffen Kudis, Mannheim (DE); Michael Hofmann, Ludwigshafen (DE); Thorsten Volk, Mannheim (DE); Matthias Witschel, Durkheim (DE); Cyrill Zagar, Ludwigshafen (DE); Andreas Landes, Romerberg (DE); Klaus Langemann, Schauenburg (DE)

Correspondence Address: KEIL & WEINKAUF, 1350 CONNECTICUT AVENUE, N.W., WASHINGTON, DC, 20036, US

(21) Appl. No.: 10/433,033

(22) PCT Filed: Dec. 10, 2001
(86) PCT No.: PCT/EP01/14476

(30) Foreign Application Priority Data
Dec. 11, 2000 (DE) 100 61 657.7

(51) Int. Cl. A01N 43/56

(52) U.S. Cl. 504/280; 504/281

(57) ABSTRACT

Pyrazolylbenzazolones of the formula I

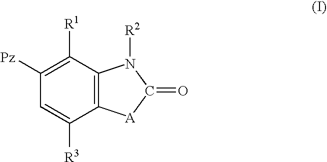

where the variables R¹, R², R³, A and Pz are as defined in claim 1, and their salts, and their use for controlling harmful plants, are described.

The present invention relates to 5-[(pyrazol-4-yl)carbonyl]-benzazolones (hereinbelow: benzazolones), to compositions comprising such compounds, and to the use of the benzazolones or of the compositions comprising them for controlling harmful plants.

WO 96/05197 discloses saccharin derivatives having herbicidal action which are substituted on the benzene ring of the saccharin skeleton by a (5-hydroxypyrazol-4-yl)carbonyl radical. WO 97/30993 and WO 97/09327 disclose dioxothiochromane derivatives and dihydrobenzothiophene derivatives having herbicidal action which likewise have a (5-hydroxypyrazol-4-yl)-carbonyl radical on the benzene ring of the sulfur heterocycle.

WO 97/08164 discloses, inter alia, benzo-fused derivatives of γ-butyrolactam having herbicidal action which likewise have a (5-hydroxypyrazol-4-yl)carbonyl radical.

JP 10130627 describes, inter alia, herbicides based on pyrazole derivatives of the formula (a)

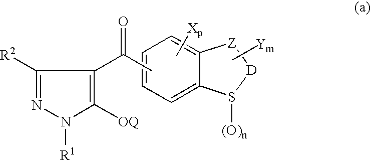

in which R¹ is C₁-C₄-alkyl or C₂-C₄-alkenyl, R² is preferably hydrogen or methyl, Q is preferably hydrogen, n-propylsulfonyl, tolylsulfonyl or cyclohexylsulfonyl. X is C₁-C₄-(halo)alkyl, C₂-C₄-alkoxyalkyl, halogen, C₁-C₄-(halo)alkoxy. Z is O, SOᵣ or NR³ where r=0 to 2, where R³ is hydrogen, C₁-C₄-(halo)alkyl, C₁-C₄-(halo)alkylsulfonyl or C₁-C₄-alkylcarbonyl. Y is oxygen or a substituent on the alkylene chain. D is a substituted or unsubstituted C₁-C₃-alkylene chain and p is an integer from 0 to 3. The variable m is an integer from zero to six, and n is an integer from zero to two.

However, the herbicidal properties of the compounds known from the publications mentioned and their compatibility with crop plants do not meet all of the criteria required from herbicides.

PCT/EP 00/04040 discloses 4-(3′,4′-heterocyclylbenzoyl)pyrazoles. Heterocyclic radicals mentioned are, inter alia, benzoxazolyl, benzimidazolyl, benzothiazolyl and benzotriazinyl. The compounds have herbicidal action.

It is an object of the present invention to provide novel compounds having herbicidal action which preferably have greater activity than the herbicidal substances of the prior art and/or better selectivity for harmful plants.

We have found that this object is achieved by 5-[(pyrazol-4-yl)-carbonyl]benzazolones of the formula I defined below.

Consequently, the present invention relates to pyrazolylcarbonyl-benzazolones of the formula I

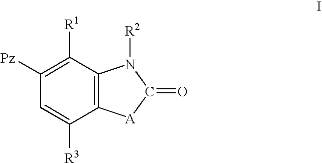

in which A, R¹, R², R³ and Pz are as defined below:

A is O, S, SO, SO₂ or NR⁶;

R¹ is halogen, C₁-C₄-alkyl, C₁-C₄-haloalkyl, C₁-C₄-hydroxyalkyl,

C₁-C₄-alkoxy-C₁-C₄-alkyl, C₁-C₄-haloalkoxy-C₁-C₄-alkyl,

C₁-C₄-haloalkylthio-C₁-C₄-alkyl, C₁-C₄-alkylthio-C₁-C₄-alkyl,

C₁-C₄-alkylsulfonyl-C₁-C₄-alkyl, C₁-C₄-haloalkylsulfonyl-C₁-C₄-alkyl, C₁-C₄-alkoxy, C₁-C₄-hydroxyalkoxy,

C₁-C₄-haloalkoxy, C₁-C₄-alkoxy-C₁-C₄-alkoxy, C₁-C₄-haloalkoxy-C₁-C₄-alkoxy, C₁-C₄-alkylthio, C₁-C₄-haloalkylthio,

C₁-C₄-alkylsulfonyl, C₁-C₄-haloalkylsulfonyl;

R² is hydrogen, hydroxyl, nitro, amino, C₁-C₆-alkylamino,

di(C₁-C₆-alkyl)amino, cyano, CHO, C₁-C₆-alkoxy, C₁-C₆-alkyl,

C₁-C₆-hydroxyalkyl, C₁-C₆-haloalkyl, C₁-C₆-alkoxy-C₁-C₆-alkyl,

C₁-C₆-haloalkoxy-C₁-C₆-alkyl, C₂-C₆-alkenyl, C₂-C₆-haloalkenyl,

C₁-C₆-haloalkoxy-C₂-C₆-alkenyl, C₁-C₆-alkoxy-C₂-C₆-alkenyl,

C₂-C₆-alkynyl, C₂-C₆-haloalkynyl, C₁-C₆-haloalkoxy-C₂-C₆-alkynyl, C₁-C₆-alkoxy-C₂-C₆-alkynyl, C₁-C₆-alkylsulfonyl,

C₁-C₆-haloalkylsulfonyl, (C₁-C₆-alkyl)carbonyl,

C₁-C₆-haloalkylcarbonyl, hydroxycarbonyl-C₁-C₄-alkyl,

C₁-C₆-alkoxycarbonyl-C₁-C₆-alkyl,

a radical of the formula C(O)OR⁴, CON(R⁵)₂ or C(═NOR^{4a})R^{4b},

aryl, aryl-C₁-C₄-alkyl, arylsulfonyl, arylcarbonyl,

C₃-C₆-cycloalkyl, C₃-C₆-cycloalkenyl,

3-, 4-, 5-, 6- or 7-membered heterocyclyl,

3-, 4-, 5-, 6- or 7-membered heterocyclyl-C₁-C₆-alkyl,

where each aryl, cycloalkyl, cycloalkenyl and each heterocyclyl radical may be unsubstituted or may carry one, two, three or four substituents, in each case selected from the group consisting of halogen, C₁-C₄-haloalkyl, C₁-C₄-alkoxy and C₁-C₄-haloalkoxy;

R³ is hydrogen, C₁-C₄-alkyl, C₁-C₄-haloalkyl, C₁-C₄-alkoxy-C₁-C₄-alkyl, C₁-C₄-haloalkoxy-C₁-C₄-alkyl or halogen;

in which

R⁴ is C₁-C₆-alkyl, C₁-C₆-haloalkyl, C₁-C₆-alkoxy-C₁-C₆-alkyl, C₁-C₆-haloalkoxy-C₁-C₆-alkyl,

C₂-C₆-alkenyl, C₂-C₆-haloalkenyl, C₁-C₆-haloalkoxy-C₂-C₆-alkenyl, C₁-C₆-alkoxy-C₂-C₆-alkenyl,

C₂-C₆-alkynyl, C₂-C₆-haloalkynyl, C₁-C₆-haloalkoxy-C₂-C₆-alkynyl, C₁-C₆-alkoxy-C₂-C₆-alkynyl;

R^{4a}, R^{4b} independently of one another may have the meanings mentioned for R⁴, and R^{4b} may be hydrogen;

R⁵ independently of one another are hydrogen,

C₁-C₆-alkyl, C₁-C₆-haloalkyl, C₁-C₆-alkoxy-C₁-C₆-alkyl, (C₁-C₆-haloalkoxy)-C₁-C₆-alkyl,

C₂-C₆-alkenyl, C₂-C₆-haloalkenyl, C₁-C₆-haloalkyl-C₂-C₆-alkenyl, C₁-C₆-haloalkoxy-C₂-C₆-alkenyl,

C₁-C₆-alkoxy-C₂-C₆-alkenyl, C₂-C₆-alkynyl,

C₂-C₆-haloalkynyl, C₁-C₆-haloalkyl-C₂-C₆-alkynyl,

C₁-C₆-haloalkoxy-C₂-C₆-alkynyl, C₁-C₆-alkoxy-C₂-C₆-alkynyl, or together form a 3- to 7-membered heterocycle which may be partially or fully halogenated and/or may carry one, two or three substituents selected from the group consisting of

C₁-C₆-alkyl, C₁-C₆-haloalkyl, C₁-C₆-alkoxy,

C₁-C₆-haloalkoxy;

R⁶ is hydrogen, C₁-C₄-alkyl, C₁-C₄-haloalkyl, C₁-C₄-halo-alkoxy-C₁-C₄-alkyl, C₁-C₄-alkoxy-C₁-C₄-alkyl; and

Pz is a radical of the formula IIa or IIb,

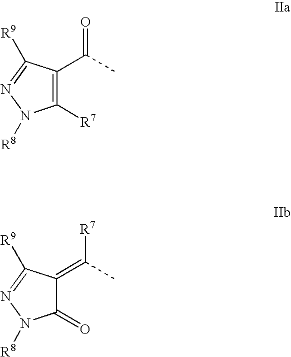

in which the variables R⁷, R⁸ and R⁹ are as defined below:

R⁷ is hydroxyl, mercapto, halogen, OR¹⁰, SR¹⁰, SOR¹¹, SO₂R¹¹,

OSO₂R¹¹, P(O)R¹²R¹³, OP(O)R¹²R¹³, P(S)R¹²R¹³, OP(S)R¹²R¹³,

NR¹⁴R¹⁵, ONR¹⁴R¹⁵ or N-bonded heterocyclyl which may be partially or fully halogenated and/or may carry one, two or three of the following radicals: nitro, cyano, C₁-C₄-alkyl,

C₁-C₄-haloalkyl, C₁-C₄-alkoxy or C₁-C₄-haloalkoxy;

R⁸ is hydrogen, C₁-C₆-alkyl, C₃-C₆-cycloalkyl, C₁-C₆-haloalkyl,

hydroxyl, C₁-C₆-alkoxy or C₁-C₆-haloalkoxy;

R⁹ is hydrogen, halogen, C₁-C₆-alkyl, C₃-C₆-cycloalkyl,

C₁-C₆-haloalkyl, hydroxyl, C₁-C₆-alkoxy, C₁-C₆-haloalkoxy,

C₁-C₆-alkylthio or C₁-C₆-haloalkylthio;

where

R¹⁰ is C₁-C₆-alkyl, C₃-C₆-alkenyl, C₃-C₆-haloalkenyl,

C₃-C₆-alkynyl, C₃-C₆-haloalkynyl, C₃-C₆-cycloalkyl,

C₁-C₆-alkylcarbonyl, C₂-C₆-alkenylcarbonyl,

C₂-C₆-alkynylcarbonyl, C₃-C₆-cycloalkylcarbonyl,

C₁-C₆-alkoxycarbonyl, C₃-C₆-alkenyloxycarbonyl,

C₃-C₆-alkynyloxycarbonyl, C₁-C₆-alkylthiocarbonyl,

C₁-C₆-alkylaminocarbonyl, C₃-C₆-alkenylaminocarbonyl,

C₃-C₆-alkynylaminocarbonyl, N,N-di(C₁-C₆-alkyl)amino-carbonyl, N—(C₃-C₆-alkenyl)-N—(C₁-C₆-alkyl)amino-carbonyl, N—(C₃-C₆-alkynyl)-N—(C₁-C₆-alkyl)amino-carbonyl, N—(C₁-C₆-alkoxy)-N—(C₁-C₆-alkyl)amino-carbonyl, N—(C₃-C₆-alkenyl)-N—(C₁-C₆-alkoxy)amino-carbonyl, N—(C₃-C₆-alkynyl)-N—(C₁-C₆-alkoxy)amino-carbonyl, di(C₁-C₆-alkyl)aminothiocarbonyl or

C₁-C₆-alkoxyimino-C₁-C₆-alkyl, where the alkyl, cycloalkyl and alkoxy radicals mentioned may be partially or fully halogenated and/or may carry one, two or three of the following groups: cyano,

C₁-C₄-alkoxy, C₁-C₄-alkylthio, di(C₁-C₄-alkyl)amino,

C₁-C₄-alkylcarbonyl, C₁-C₄-alkoxycarbonyl,

C₁-C₄-alkoxy-C₁-C₄-alkoxycarbonyl,

C₁-C₄-alkylaminocarbonyl, di(C₁-C₄-alkyl)-aminocarbonyl, aminocarbonyl, C₁-C₄-alkylcarbonyloxy or C₃-C₆-cycloalkyl;

is phenyl, phenyl-C₁-C₆-alkyl, phenylcarbonyl-C₁-C₆-alkyl, phenylcarbonyl, phenoxycarbonyl,

phenyloxythiocarbonyl, phenylaminocarbonyl,

N—(C₁-C₆-alkyl)-N-(phenyl)aminocarbonyl, phenyl-C₂-C₆-alkenylcarbonyl, heterocyclyl, heterocyclyl-C₁-C₆-alkyl, heterocyclylcarbonyl-C₁-C₆-alkyl,

heterocyclylcarbonyl, heterocyclyloxycarbonyl,

heterocyclyloxythiocarbonyl, heterocyclylaminocarbonyl, N—(C₁-C₆-alkyl)-N-(heterocyclyl)aminocarbonyl, or heterocyclyl-C₂-C₆-alkenylcarbonyl,

where the phenyl and the heterocyclyl radical of the 18 lastmentioned substituents may be partially or fully halogenated and/or may carry one, two or three of the following radicals: nitro, cyano, C₁-C₄-alkyl,

C₁-C₄-haloalkyl, C₁-C₄-alkoxy or C₁-C₄-haloalkoxy;

R¹¹ is C₁-C₆-alkyl, C₃-C₆-alkenyl, C₃-C₆-alkynyl or C₃-C₆-cycloalkyl, where the four radicals mentioned may be partially or fully halogenated and/or may carry one, two or three of the following groups:

cyano, C₁-C₄-alkoxy, C₁-C₄-haloalkoxy,

C₁-C₄-alkylthio, C₁-C₄-haloalkylthio,

C₁-C₄-alkylcarbonyl, C₁-C₄-alkoxycarbonyl or C₁-C₄-haloalkoxycarbonyl;

is phenyl, phenyl-C₁-C₆-alkyl, heterocyclyl or heterocyclyl-C₁-C₆-alkyl, where the phenyl and the heterocyclyl radical of the lastmentioned substituents may be partially or fully halogenated and/or may carry one, two or three of the following radicals: nitro, cyano, C₁-C₄-alkyl, C₁-C₄-haloalkyl,

C₁-C₄-alkoxy, C₁-C₄-haloalkoxy or

C₁-C₄-alkoxycarbonyl;

R¹², R¹³ independently of one another are hydrogen, hydroxyl,

C₁-C₆-alkyl, C₁-C₆-alkoxy, C₁-C₆-alkylthio, phenyl, phenyl-C₁-C₄-alkyl or phenoxy, where the three lastmentioned substituents may be partially or fully halogenated and/or may carry one, two or three of the following radicals: nitro, cyano, C₁-C₄-alkyl,

C₁-C₄-haloalkyl, C₁-C₄-alkoxy, C₁-C₄-haloalkoxy or

C₁-C₄-alkoxycarbonyl;

R¹⁴ is hydrogen, C₁-C₆-alkyl, C₃-C₆-alkenyl,

C₃-C₆-haloalkenyl, C₃-C₆-alkynyl, C₃-C₆-haloalkynyl,

C₃-C₆-cycloalkyl, C₁-C₆-alkylcarbonyl, hydroxyl,

C₁-C₆-alkoxy, C₃-C₆-alkenyloxy, C₃-C₆-alkynyloxy,

amino, C₁-C₆-alkylamino, di(C₁-C₆-alkyl)amino or C₁-C₆-alkylcarbonylamino, where the alkyl, cycloalkyl and alkoxy radicals mentioned may be partially or fully halogenated and/or may carry one, two or three of the following radicals: cyano, C₁-C₄-alkoxycarbonyl, C₁-C₄-alkylaminocarbonyl, di(C₁-C₄-alkyl)-aminocarbonyl or C₃-C₆-cycloalkyl;

is phenyl, phenyl-C₁-C₄-alkyl, phenylcarbonyl,

heterocyclyl, heterocyclyl-C₁-C₄-alkyl or

heterocyclylcarbonyl, where the phenyl or

heterocyclyl radical of the six lastmentioned substituents may be partially or fully halogenated and/or may carry one, two or three of the following radicals: nitro, cyano, C₁-C₄-alkyl, C₁-C₄-haloalkyl,

C₁-C₄-alkoxy or C₁-C₄-haloalkoxy; and

R¹⁵ is hydrogen, C₁-C₆-alkyl or C₃-C₆-alkenyl,

C₃-C₆-alkynyl;

and their agriculturally useful salts.

Furthermore we have found herbicidal compositions which comprise the pyrazolyl derivatives of the formula I and have very good herbicidal action. Moreover, we have found methods for controlling undesirable vegetation using the pyrazolyl derivatives of the formula I.

Depending on the substitution pattern, the compounds of the formula I may contain one or more chiral centers, in which case they are present as enantiomers or diasteromer mixtures. The invention provides both the pure enantiomers or diastereomers and their mixtures.

The compounds of the formula I may also be present in the form of their agriculturally useful salts, the type of salt generally being immaterial. In general, the salts of those cations and the acid addition salts of those acids are suitable whose cations and anions, respectively, do not negatively affect the herbicidal action of the compounds I.

Suitable cations are, in particular, ions of the alkali metals, preferably lithium, sodium and potassium, of the alkaline earth metals, preferably calcium and magnesium, and of the transition metals, preferably manganese, copper, zinc and iron, and also ammonium, where, if desired, one to four hydrogen atoms may be replaced by C₁-C₄-alkyl, hydroxy-C₁-C₄-alkyl, C₁-C₄-alkoxy-C₁-C₄-alkyl, hydroxy-C₁-C₄-alkoxy-C₁-C₄-alkyl, phenyl or benzyl, preferably ammonium, dimethylammonium, diisopropylammonium, tetramethylammonium, tetrabutylammonium, 2-(2-hydroxyeth-1-oxy)-eth-1-ylammonium, di(2-hydroxyeth-1-yl)ammonium, trimethylbenzylammonium, furthermore phosphonium ions, sulfonium ions, preferably tri(C₁-C₄-alkyl)sulfonium, and sulfoxonium ions, preferably tri(C₁-C₄-alkyl)sulfoxonium.

Anions of useful acid addition salts are primarily chloride, bromide, fluoride, hydrogen sulfate, sulfate, dihydrogen phosphate, hydrogen phosphate, nitrate, bicarbonate, carbonate, hexafluorosilicate, hexafluorophosphate, benzoate and the anions of C₁-C₄-alkanoic acids, preferably formate, acetate, propionate and butyrate.

For R⁷=hydroxyl or mercapto {Z=O,S}, IIa also represents the tautomeric forms IIa′ and IIa″

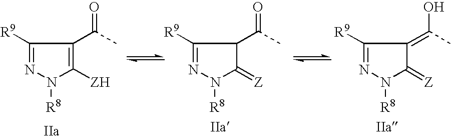

and IIb also represents the tautomeric forms IIb′ and IIb″

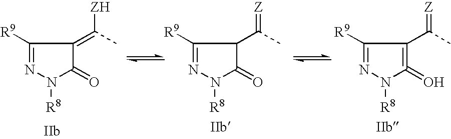

The organic molecular moieties mentioned for the substituents R¹ to R¹⁵ or as radicals on phenyl and heterocyclyl radicals are collective terms for individual enumerations of the particular group members. All hydrocarbon chains, i.e. all alkyl, haloalkyl, alkoxy, haloalkoxy, alkylthio, haloalkylthio, alkylsulfinyl, haloalkylsulfinyl, alkylsulfonyl, haloalkylsulfonyl, N-alkylamino, N,N-dialkylamino, N-haloalkylamino, N-alkoxyamino, N-alkoxy-N-alkylamino, N-alkylcarbonylamino, alkylcarbonyl, haloalkylcarbonyl, alkoxycarbonyl, haloalkoxycarbonyl, alkylthiocarbonyl, alkylcarbonyloxy, alkylaminocarbonyl, dialkylaminocarbonyl, dialkylaminothiocarbonyl, alkoxyalkyl, hydroxyalkoxyalkyl, alkoxyiminoalkyl, phenylalkylcarbonyl, heterocyclylalkylcarbonyl, phenylalkenylcarbonyl, heterocyclylalkenylcarbonyl, N-alkoxy-N-alkylaminocarbonyl, N-alkyl-N-phenylaminocarbonyl, N-alkyl-N-heterocyclylaminocarbonyl, phenylalkyl, heterocyclylalkyl, phenylcarbonylalkyl, heterocyclylcarbonyl-alkyl, alkoxyalkoxycarbonyl, alkenylcarbonyl, alkenyloxycarbonyl, alkenylaminocarbonyl, N-alkenyl-N-alkylaminocarbonyl, N-alkenyl-N-alkoxyaminocarbonyl, alkynylcarbonyl, alkynyloxycarbonyl, alkynylaminocarbonyl, N-alkynyl-N-alkylaminocarbonyl, N-alkynyl-N-alkoxyaminocarbonyl, alkenyl, alkynyl, haloalkenyl, haloalkynyl, alkenyloxy, alkynyloxy, alkanediyl, alkenediyl, alkadienediyl or alkynediyl moieties can be straight-chain or branched. Unless indicated otherwise, halogenated substituents preferably carry one to five identical or different halogen atoms. The expression halogen represents in each case fluorine, chlorine, bromine or iodine.

Examples of other meanings are:

C₁-C₄-alkyl: for example methyl, ethyl, propyl, 1-methylethyl,

butyl, 1-methylpropyl, 2-methylpropyl or 1,1-dimethylethyl;

C₁-C₄-haloalkyl: a C₁-C₄-alkyl radical as mentioned above which is partially or fully substituted by fluorine, chlorine, bromine and/or iodine, i.e., for example,

chloromethyl, dichloromethyl, trichloromethyl, fluoromethyl,

difluoromethyl, trifluoromethyl, chlorofluoromethyl,

dichlorofluoromethyl, chlorodifluoromethyl, 2-fluoroethyl,

2-chloroethyl, 2-bromoethyl, 2-iodoethyl, 2,2-difluoroethyl,

2,2,2-trifluoroethyl, 2-chloro-2-fluoroethyl,

2-chloro-2,2-difluoroethyl, 2,2-dichloro-2-fluoroethyl,

2,2,2-trichloroethyl, pentafluoroethyl, 2-fluoropropyl,

3-fluoropropyl, 2,2-difluoropropyl, 2,3-difluoropropyl,

2-chloropropyl, 3-chloropropyl, 2,3-dichloropropyl,

2-bromopropyl, 3-bromopropyl, 3,3,3-trifluoropropyl,

3,3,3-trichloropropyl, 2,2,3,3,3-pentafluoropropyl,

heptafluoropropyl, 1-(fluoromethyl)-2-fluoroethyl,

1-(chloromethyl)-2-chloroethyl, 1-(bromomethyl)-2-bromoethyl,

4-fluorobutyl, 4-chlorobutyl, 4-bromobutyl or

nonafluorobutyl;

C₁-C₆-alkyl, and the alkyl moieties of C₁-C₆-alkylamino,

di(C₁-C₆-alkyl)amino, N—(C₁-C₆-alkoxy)-N—(C₁-C₆-alkyl)aminocarbonyl, N—(C₃-C₆-alkenyl)-N—(C₁-C₆-alkyl)-aminocarbonyl,

(C₃-C₆-alkynyl)-N—(C₁-C₆-alkyl)aminocarbonyl, N—(C₁-C₆-alkyl)-N-phenylaminocarbonyl, and also N—(C₁-C₆-alkyl)-N-heterocyclylamino-carbonyl: C₁-C₄-alkyl as mentioned above,

and also, for example, n-pentyl, 1-methylbutyl,

2-methylbutyl, 3-methylbutyl, 2,2-dimethylpropyl,

1-ethylpropyl, hexyl, 1,1-dimethylpropyl, 1,2-dimethylpropyl,

1-methylpentyl, 2-methylpentyl, 3-methylpentyl,

4-methylpentyl, 1,1-dimethylbutyl, 1,2-dimethylbutyl,

1,3-dimethylbutyl, 2,2-dimethylbutyl, 2,3-dimethylbutyl,

3,3-dimethylbutyl, 1-ethylbutyl, 2-ethylbutyl,

1,1,2-trimethylpropyl, 1-ethyl-1-methylpropyl or

1-ethyl-3-methylpropyl;

C₁-C₆-haloalkyl, and the haloalkyl moieties of

N—C₁-C₆-haloalkylamino: C₁-C₄-haloalkyl, as mentioned above,

and also, for example, 5-fluoropentyl, 5-chloropentyl,

5-bromopentyl, 5-iodopentyl, undecafluoropentyl,

6-fluorohexyl, 6-chlorohexyl, 6-bromohexyl, 6-iodohexyl or

dodecafluorohexyl;

C₁-C₄-alkoxy and the alkoxy moieties of hydroxy-C₁-C₄-alkoxy-C₁-C₄-alkyl, C₁-C₄-alkoxy-C₁-C₄-alkoxycarbonyl: for example

methoxy, ethoxy, propoxy, 1-methylethoxy, butoxy,

1-methylpropoxy, 2-methylpropoxy or 1,1-dimethylethoxy;

C₁-C₆-alkoxy, and the alkoxy moieties of

C₁-C₆-alkoxy-C₃-C₆-alkenyl, C₁-C₆-alkoxy-C₃-C₆-alkynyl,

C₁-C₆-alkoxy-C₂-C₆-alkenyl, C₁-C₆-alkoxy-C₂-C₆-alkynyl,

N—C₁-C₆-alkoxyamino, N—(C₁-C₆-alkoxy)-N—(C₁-C₆-alkyl)amino,

C₁-C₆-alkoxyimino-C₁-C₆-alkyl, (C₁-C₆-alkoxy) (C₁-C₆-alkylthio)methyl, N—(C₁-C₆-alkoxy)-N—(C₁-C₆-alkyl)aminocarbonyl,

N—(C₃-C₆-alkenyl)-N—(C₁-C₆-alkoxy)aminocarbonyl and

N—(C₃-C₆-alkynyl)-N—(C₁-C₆-alkoxy)aminocarbonyl: C₁-C₄-alkoxy as mentioned above, and also, for example, pentoxy,

1-methylbutoxy, 2-methylbutoxy, 3-methylbutoxy, 1,1-dimethylpropoxy, 1,2-dimethylpropoxy, 2,2-dimethylpropoxy,

1-ethylpropoxy, hexoxy, 1-methylpentoxy, 2-methylpentoxy,

3-methylpentoxy, 4-methylpentoxy, 1,1-dimethylbutoxy,

1,2-dimethylbutoxy, 1,3-dimethylbutoxy, 2,2-dimethylbutoxy,

2,3-dimethylbutoxy, 3,3-dimethylbutoxy, 1-ethylbutoxy,

2-ethylbutoxy, 1,1,2-trimethylpropoxy,

1,2,2-trimethylpropoxy, 1-ethyl-1-methylpropoxy or

1-ethyl-2-methylpropoxy;

C₁-C₄-haloalkoxy and the haloalkoxy moieties of

C₁-C₄-haloalkoxy-C₁-C₄-alkyl, C₁-C₄-haloalkoxy-C₁-C₄-alkoxy,

C₁-C₄-haloalkoxy-C₁-C₆-alkyl, C₁-C₄-haloalkoxy-C₁-C₆-alkoxy,

C₁-C₄-haloalkoxy-C₃-C₆-alkenyl, C₁-C₄-haloalkoxy-C₃-C₆-alkynyl: a

C₁-C₄-alkoxy radical as mentioned above which is partially or fully substituted by fluorine, chlorine, bromine and/or iodine, i.e., for example, fluoromethoxy, difluoromethoxy,

trifluoromethoxy, chlorodifluoromethoxy, bromodifluoromethoxy, 2-fluoroethoxy, 2-chloroethoxy, 2-bromomethoxy,

2-iodoethoxy, 2,2-difluoroethoxy, 2,2,2-trifluoroethoxy,

2-chloro-2-fluoroethoxy, 2-chloro-2,2-difluoroethoxy,

2,2-dichloro-2-fluoroethoxy, 2,2,2-trichloroethoxy,

pentafluoroethoxy, 2-fluoropropoxy, 3-fluoropropoxy,

2-chloropropoxy, 3-chloropropoxy, 2-bromopropoxy,

3-bromopropoxy, 2,2-difluoropropoxy, 2,3-difluoropropoxy,

2,3-dichloropropoxy, 3,3,3-trifluoropropoxy, 3,3,3-trichloro-propoxy, 2,2,3,3,3-pentafluoropropoxy, heptafluoropropoxy,

1-(fluoromethyl)-2-fluoroethoxy, 1-(chloromethyl)-2-chloro-ethoxy, 1-(bromomethyl)-2-bromoethoxy, 4-fluorobutoxy,

4-chlorobutoxy, 4-bromobutoxy or nonafluorobutoxy;

C₁-C₆-haloalkoxy: C₁-C₄-haloalkoxy as mentioned above, and also, for example, 5-fluoropentoxy, 5-chloropentoxy,

5-bromopentoxy, 5-iodopentoxy, undecafluoropentoxy,

6-fluorohexoxy, 6-chlorohexoxy, 6-bromohexoxy, 6-iodohexoxy

or dodecafluorohexoxy;

C₁-C₄-alkylthio (C₁-C₄-alkylsulfanyl: C₁-C₄-alkyl-S—): for example methylthio, ethylthio, propylthio, 1-methylethylthio,

butylthio, 1-methylpropylthio, 2-methylpropylthio or

1,1-dimethylethylthio;

C₁-C₆-alkylthio, and the alkylthio moieties of

C₁-C₆-alkylthiocarbonyl: C₁-C₄-alkylthio as mentioned above, and also, for example, pentylthio, 1-methylbutylthio,

2-methylbutylthio, 3-methylbutylthio, 2,2-dimethylpropylthio,

1-ethylpropylthio, hexylthio, 1,1-dimethylpropylthio,

1,2-dimethylpropylthio, 1-methylpentylthio,

2-methylpentylthio, 3-methylpentylthio, 4-methylpentylthio,

1,1-dimethylbutylthio, 1,2-dimethylbutylthio,

1,3-dimethylbutylthio, 2,2-dimethylbutylthio,

2,3-dimethylbutylthio, 3,3-dimethylbutylthio,

1-ethylbutylthio, 2-ethylbutylthio, 1,1,2-trimethyl-propylthio, 1,2,2-trimethylpropylthio, 1-ethyl-1-methyl-propylthio or 1-ethyl-2-methylpropylthio;

C₁-C₄-haloalkylthio and the haloalkylthio moieties of

C₁-C₄-haloalkylthio-C₁-C₄-alkyl: a C₁-C₄-alkylthio radical as mentioned above which is partially or fully substituted by fluorine, chlorine, bromine and/or iodine, i.e., for example,

fluoromethylthio, difluoromethylthio, trifluoromethylthio,

chlorodifluoromethylthio, bromodifluoromethylthio,

2-fluoroethylthio, 2-chloroethylthio, 2-bromoethylthio,

2-iodoethylthio, 2,2-difluoroethylthio, 2,2,2-trifluoroethylthio, 2,2,2-trichloroethylthio, 2-chloro-2-fluoroethylthio, 2-chloro-2,2-difluoroethylthio, 2,2-dichloro2-fluoroethylthio, pentafluoroethylthio, 2-fluoropropylthio,

3-fluoropropylthio, 2-chloropropylthio, 3-chloropropylthio,

2-bromopropylthio, 3-bromopropylthio, 2,2-difluoropropylthio,

2,3-difluoropropylthio, 2,3-dichloropropylthio,

3,3,3-trifluoropropylthio, 3,3,3-trichloropropylthio,

2,2,3,3,3-pentafluoropropylthio, heptafluoropropylthio,

1-(fluoromethyl)-2-fluoroethylthio, 1-(chloromethyl)-2-chloroethylthio, 1-(bromomethyl)-2-bromoethylthio,

4-fluorobutylthio, 4-chlorobutylthio, 4-bromobutylthio or nonafluorobutylthio;

C₁-C₆-haloalkylthio: C₁-C₄-haloalkylthio as mentioned above,

and also 5-fluoropentylthio, 5-chloropentylthio,

5-bromopentylthio, 5-iodopentylthio, undecafluoropentylthio,

6-fluorohexylthio, 6-chlorohexylthio, 6-bromohexylthio,

6-iodohexylthio or dodecafluorohexylthio;

C₁-C₄-alkylsulfinyl (C₁-C₄-alkyl-S(═O)—): for example,

methylsulfinyl, ethylsulfinyl, propylsulfinyl,

1-methylethylsulfinyl, butylsulfinyl, 1-methylpropylsulfinyl,

2-methylpropylsulfinyl or 1,1-dimethylethylsulfinyl;

C₁-C₆-alkylsulfinyl: C₁-C₄-alkylsulfinyl as mentioned above,

and also pentylsulfinyl, 1-methylbutylsulfinyl,

2-methylbutylsulfinyl, 3-methylbutylsulfinyl,

2,2-dimethylpropylsulfinyl, 1-ethylpropylsulfinyl,

1,1-dimethylpropylsulfinyl, 1,2-dimethylpropylsulfinyl,

hexylsulfinyl, 1-methylpentylsulfinyl, 2-methylpentyl-sulfinyl, 3-methylpentylsulfinyl, 4-methylpentylsulfinyl,

1,1-dimethylbutylsulfinyl, 1,2-dimethylbutylsulfinyl,

1,3-dimethylbutylsulfinyl, 2,2-dimethylbutylsulfinyl,

2,3-dimethylbutylsulfinyl, 3,3-dimethylbutylsulfinyl,

1-ethylbutylsulfinyl, 2-ethylbutylsulfinyl,

1,1,2-trimethylpropylsulfinyl, 1,2,2-trimethylpropylsulfinyl,

1-ethyl-1-methylpropylsulfinyl or

1-ethyl-2-methylpropylsulfinyl;

C₁-C₄-haloalkylsulfinyl: a C₁-C₄-alkylsulfinyl radical as mentioned above which is partially or fully substituted by fluorine, chlorine, bromine and/or iodine, i.e., for example,

fluoromethylsulfinyl, difluoromethylsulfinyl,

trifluoromethylsulfinyl, chlorodifluoromethylsulfinyl,

bromodifluoromethylsulfinyl, 2-fluoroethylsulfinyl,

2-chloroethylsulfinyl, 2-bromoethylsulfinyl,

2-iodoethylsulfinyl, 2,2-difluoroethylsulfinyl,

2,2,2-trifluoroethylsulfinyl, 2,2,2-trichloroethylsulfinyl,

2-chloro-2-fluoroethylsulfinyl, 2-chloro-2,2-difluoro-ethylsulfinyl, 2,2-dichloro-2-fluoroethylsulfinyl,

pentafluoroethylsulfinyl, 2-fluoropropylsulfinyl,

3-fluoropropylsulfinyl, 2-chloropropylsulfinyl,

3-chloropropylsulfinyl, 2-bromopropylsulfinyl,

3-bromopropylsulfinyl, 2,2-difluoropropylsulfinyl,

2,3-difluoropropylsulfinyl, 2,3-dichloropropylsulfinyl,

3,3,3-trifluoropropylsulfinyl, 3,3,3-trichloropropylsulfinyl,

2,2,3,3,3-pentafluoropropylsulfinyl, heptafluoropropyl-sulfinyl, 1-(fluoromethyl)-2-fluoroethylsulfinyl,

1-(chloromethyl)-2-chloroethylsulfinyl, 1-(bromomethyl)-2-bromoethylsulfinyl, 4-fluorobutylsulfinyl,

4-chlorobutylsulfinyl, 4-bromobutylsulfinyl or

nonafluorobutylsulfinyl;

C₁-C₆-haloalkylsulfinyl: C₁-C₄-haloalkylsulfinyl as mentioned above, and also 5-fluoropentylsulfinyl,

5-chloropentylsulfinyl, 5-bromopentylsulfinyl,

5-iodopentylsulfinyl, undecafluoropentylsulfinyl,

6-fluorohexylsulfinyl, 6-chlorohexylsulfinyl,

6-bromohexylsulfinyl, 6-iodohexylsulfinyl or

dodecafluorohexylsulfinyl;

C₁-C₄-alkylsulfonyl (C₁-C₄-alkyl-S(═O)₂—) and the alkylsulfonyl moieties of C₁-C₄-alkylsulfonyl-C₁-C₄-alkyl: for example methylsulfonyl, ethylsulfonyl, propylsulfonyl,

1-methylethylsulfonyl, butylsulfonyl, 1-methylpropylsulfonyl,

2-methylpropylsulfonyl or 1,1-dimethylethylsulfonyl;

C₁-C₆-alkylsulfonyl: C₁-C₄-alkylsulfonyl, as mentioned above,

and also pentylsulfonyl, 1-methylbutylsulfonyl,

2-methylbutylsulfonyl, 3-methylbutylsulfonyl,

1,1-dimethylpropylsulfonyl, 1,2-dimethylpropylsulfonyl,

2,2-dimethylpropylsulfonyl, 1-ethylpropylsulfonyl,

hexylsulfonyl, 1-methylpentylsulfonyl,

2-methylpentylsulfonyl, 3-methylpentylsulfonyl,

4-methylpentylsulfonyl, 1,1-dimethylbutylsulfonyl,

1,2-dimethylbutylsulfonyl, 1,3-dimethylbutylsulfonyl,

2,2-dimethylbutylsulfonyl, 2,3-dimethylbutylsulfonyl,

3,3-dimethylbutylsulfonyl, 1-ethylbutylsulfonyl,

2-ethylbutylsulfonyl, 1,1,2-trimethylpropylsulfonyl,

1,2,2-trimethylpropylsulfonyl, 1-ethyl-1-methylpropylsulfonyl

or 1-ethyl-2-methylpropylsulfonyl;

C₁-C₄-haloalkylsulfonyl: a C₁-C₄-alkylsulfonyl radical as mentioned above which is partially or fully substituted by fluorine, chlorine, bromine and/or iodine, and also the haloalkylsulfonyl of C₁-C₄-haloalkylsulfonyl-C₁-C₄-alkyl: for example, fluoromethylsulfonyl, difluoromethylsulfonyl,

trifluoromethylsulfonyl, chlorodifluoromethylsulfonyl,

bromodifluoromethylsulfonyl, 2-fluoroethylsulfonyl,

2-chloroethylsulfonyl, 2-bromoethylsulfonyl,

2-iodoethylsulfonyl, 2,2-difluoroethylsulfonyl,

2,2,2-trifluoroethylsulfonyl, 2-chloro-2-fluoroethylsulfonyl,

2-chloro-2,2-difluoroethylsulfonyl, 2,2-dichloro-2-fluoroethylsulfonyl, 2,2,2-trichloroethylsulfonyl,

pentafluoroethylsulfonyl, 2-fluoropropylsulfonyl,

3-fluoropropylsulfonyl, 2-chloropropylsulfonyl,

3-chloropropylsulfonyl, 2-bromopropylsulfonyl,

3-bromopropylsulfonyl, 2,2-difluoropropylsulfonyl,

2,3-difluoropropylsulfonyl, 2,3-dichloropropylsulfonyl,

3,3,3-trifluoropropylsulfonyl, 3,3,3-trichloropropylsulfonyl,

2,2,3,3,3-pentafluoropropylsulfonyl, heptafluoropropylsulfonyl, 1-(fluoromethyl)-2-fluoroethylsulfonyl,

1-(chloromethyl)-2-chloroethylsulfonyl, 1-(bromomethyl)-2-bromoethylsulfonyl, 4-fluorobutylsulfonyl,

4-chlorobutylsulfonyl, 4-bromobutylsulfonyl or

nonafluorobutylsulfonyl;

C₁-C₆-haloalkylsulfonyl and the haloalkylsulfonyl moieties of C₁-C₆-haloalkylsulfonyl-C₁-C₆-alkyl: C₁-C₄-haloalkylsulfonyl as mentioned above, and also 5-fluoropentylsulfonyl,

5-chloropentylsulfonyl, 5-bromopentylsulfonyl,

5-iodopentylsulfonyl, 6-fluorohexylsulfonyl,

6-bromohexylsulfonyl, 6-iodohexylsulfonyl or

dodecafluorohexylsulfonyl;

C₁-C₆-alkylamino: methylamino, ethylamino, propylamino,

1-methylethylamino, butylamino, 1-methylpropylamino,

2-methylpropylamino, 1,1-dimethylethylamino, pentylamino,

1-methylbutylamino, 2-methylbutylamino, 3-methylbutylamino,

2,2-dimethylpropylamino, 1-ethylpropylamino, hexylamino,

1,1-dimethylpropylamino, 1,2-dimethylpropylamino,

1-methylpentylamino, 2-methylpentylamino,

3-methylpentylamino, 4-methylpentylamino,

1,1-dimethylbutylamino, 1,2-dimethylbutylamino,

1,3-dimethylbutylamino, 2,2-dimethylbutylamino,

2,3-dimethylbutylamino, 3,3-dimethylbutylamino,

1-ethylbutylamino, 2-ethylbutylamino,

1,1,2-trimethylpropylamino, 1,2,2-trimethylpropylamino,

1-ethyl-1-methylpropylamino or 1-ethyl-2-methylpropylamino;

di(C₁-C₄-alkyl)amino: for example N,N-dimethylamino,

N,N-diethylamino, N,N-dipropylamino, N,N-di(1-methylethyl)-amino, N,N-dibutylamino, N,N-di(1-methylpropyl)amino,

N,N-di(2-methylpropyl)amino, N,N-di(1,1-dimethylethyl)amino,

N-ethyl-N-methylamino, N-methyl-N-propylamino,

N-methyl-N-(1-methylethyl)amino, N-butyl-N-methylamino,

N-methyl-N-(1-methylpropyl)amino, N-methyl-N-(2-methylpropyl)amino, N-(1,1-dimethylethyl)-N-methylamino,

N-ethyl-N-propylamino, N-ethyl-N-(1-methylethyl)amino,

N-butyl-N-ethylamino, N-ethyl-N-(1-methylpropyl)amino,

N-ethyl-N-(2-methylpropyl)amino, N-ethyl-N-(1,1-dimethyl-ethyl)amino, N-(1-methylethyl)-N-propylamino,

N-butyl-N-propylamino, N-(1-methylpropyl)-N-propylamino,

N-(2-methylpropyl)-N-propylamino, N-(1,1-dimethylethyl)-N-propylamino, N-butyl-N-(1-methylethyl)amino,

N-(1-methylethyl)-N-(1-methylpropyl)amino, N-(1-methylethyl)-N-(2-methylpropyl)amino, N-(1,1-dimethylethyl)-N-(1-methylethyl)amino, N-butyl-N-(1-methylpropyl)amino,

N-butyl-N-(2-methylpropyl)amino, N-butyl-N-(1,1-dimethyl-ethyl)amino, N-(1-methylpropyl)-N-(2-methylpropyl)amino,

N-(1,1-dimethylethyl)-N-(1-methylpropyl)amino or

N-(1,1-dimethylethyl)-N-(2-methylpropyl)amino;

di(C₁-C₆-alkyl)amino: di(C₁-C₄-alkyl)amino as mentioned above,

and also N,N-dipentylamino, N,N-dihexylamino,

N-methyl-N-pentylamino, N-ethyl-N-pentylamino,

N-methyl-N-hexylamino or N-ethyl-N-hexylamino;

C₁-C₄-alkylcarbonyl: for example methylcarbonyl,

ethylcarbonyl, propylcarbonyl, 1-methylethylcarbonyl,

butylcarbonyl, 1-methylpropylcarbonyl, 2-methylpropylcarbonyl

or 1,1-dimethylethylcarbonyl;

C₁-C₆-alkylcarbonyl, and the alkylcarbonyl radicals of C₁-C₆-alkylcarbonylamino: C₁-C₄-alkylcarbonyl as mentioned above, and also, for example, pentylcarbonyl,

1-methylbutylcarbonyl, 2-methylbutylcarbonyl,

3-methylbutylcarbonyl, 2,2-dimethylpropylcarbonyl,

1-ethylpropylcarbonyl, hexylcarbonyl, 1,1-dimethylpropyl-carbonyl, 1,2-dimethylpropylcarbonyl, 1-methylpentylcarbonyl,

2-methylpentylcarbonyl, 3-methylpentylcarbonyl,

4-methylpentylcarbonyl, 1,1-dimethylbutylcarbonyl,

1,2-dimethylbutylcarbonyl, 1,3-dimethylbutylcarbonyl,

2,2-dimethylbutylcarbonyl, 2,3-dimethylbutylcarbonyl,

3,3-dimethylbutylcarbonyl, 1-ethylbutylcarbonyl,

2-ethylbutylcarbonyl, 1,1,2-trimethylpropylcarbonyl,

1,2,2-trimethylpropylcarbonyl, 1-ethyl-1-methylpropylcarbonyl

or 1-ethyl-2-methylpropylcarbonyl;

C₁-C₄-haloalkylcarbonyl: a C₁-C₄-alkylcarbonyl radical as mentioned above which is partially or fully substituted by fluorine, chlorine, bromine and/or iodine, i.e. for example,

chloroacetyl, dichloroacetyl, trichloroacetyl, fluoroacetyl,

difluoroacetyl, trifluoroacetyl, chlorofluoroacetyl,

dichlorofluoroacetyl, chlorodifluoroacetyl, 2-fluoroethyl-carbonyl, 2-chloroethylcarbonyl, 2-bromoethylcarbonyl,

2-iodoethylcarbonyl, 2,2-difluoroethylcarbonyl,

2,2,2-trifluoroethylcarbonyl, 2-chloro-2-fluoroethylcarbonyl,

2-chloro-2,2-difluoroethylcarbonyl, 2,2-dichloro-2-fluoroethylcarbonyl, 2,2,2-trichloroethylcarbonyl,

pentafluoroethylcarbonyl, 2-fluoropropylcarbonyl,

3-fluoropropylcarbonyl, 2,2-difluoropropylcarbonyl,

2,3-difluoropropylcarbonyl, 2-chloropropylcarbonyl,

3-chloropropylcarbonyl, 2,3-dichloropropylcarbonyl,

2-bromopropylcarbonyl, 3-bromopropylcarbonyl,

3,3,3-trifluoropropylcarbonyl, 3,3,3-trichloropropylcarbonyl,

2,2,3,3,3-pentafluoropropylcarbonyl, heptafluoropropyl-carbonyl, 1-(fluoromethyl)-2-fluoroethylcarbonyl,

1-(chloromethyl)-2-chloroethylcarbonyl, 1-(bromomethyl)-2-bromoethylcarbonyl, 4-fluorobutylcarbonyl,

4-chlorobutylcarbonyl, 4-bromobutylcarbonyl or

nonafluorobutylcarbonyl;

C₁-C₆-haloalkylcarbonyl: a C₁-C₄-haloalkylcarbonyl radical as mentioned above, and also 5-fluoropentylcarbonyl,

5-chloropentylcarbonyl, 5-bromopentylcarbonyl,

perfluoropentylcarbonyl, 6-fluorohexylcarbonyl,

6-chlorohexylcarbonyl, 6-bromohexylcarbonyl or

perfluorohexylcarbonyl;

C₁-C₄-alkoxycarbonyl: for example methoxycarbonyl,

ethoxycarbonyl, propoxycarbonyl, 1-methylethoxycarbonyl,

butoxycarbonyl, 1-methylpropoxycarbonyl,

2-methylpropoxycarbonyl or 1,1-dimethylethoxycarbonyl;

C₁-C₆-alkoxycarbonyl and also the alkoxycarbonyl moieties of C₁-C₆-alkoxycarbonyl-C₁-C₆-alkyl: C₁-C₄-alkoxycarbonyl as mentioned above, and also, for example, pentoxycarbonyl,

1-methylbutoxy-carbonyl, 2-methylbutoxycarbonyl, 3-methylbutoxycarbonyl,

2,2-dimethylpropoxycarbonyl, 1-ethylpropoxycarbonyl,

hexoxycarbonyl, 1,1-dimethylpropoxycarbonyl,

1,2-dimethylpropoxycarbonyl, 1-methylpentoxycarbonyl,

2-methylpentoxycarbonyl, 3-methylpentoxycarbonyl,

4-methylpentoxycarbonyl, 1,1-dimethylbutoxycarbonyl,

1,2-dimethylbutoxycarbonyl, 1,3-dimethylbutoxycarbonyl,

2,2-dimethylbutoxycarbonyl, 2,3-dimethylbutoxycarbonyl,

3,3-dimethylbutoxycarbonyl, 1-ethylbutoxycarbonyl,

2-ethylbutoxycarbonyl, 1,1,2-trimethylpropoxycarbonyl,

1,2,2-trimethylpropoxycarbonyl, 1-ethyl-1-methylpropoxy-carbonyl or 1-ethyl-2-methylpropoxycarbonyl;

C₁-C₄-haloalkoxycarbonyl: a C₁-C₄-alkoxycarbonyl radical as mentioned above which is partially or fully substituted by fluorine, chlorine, bromine and/or iodine, i.e., for example

fluoromethoxycarbonyl, difluoromethoxycarbonyl,

trifluoromethoxycarbonyl, chlorodifluoromethoxycarbonyl,

bromodifluoromethoxycarbonyl, 2-fluoroethoxycarbonyl,

2-chloroethoxycarbonyl, 2-bromoethoxycarbonyl,

2-iodoethoxycarbonyl, 2,2-difluoroethoxycarbonyl,

2,2,2-trifluoroethoxycarbonyl, 2-chloro-2-fluoroethoxy-carbonyl, 2-chloro-2,2-difluoroethoxycarbonyl,

2,2-dichloro-2-fluoroethoxycarbonyl, 2,2,2-trichloroethoxycarbonyl, pentafluoroethoxycarbonyl, 2-fluoropropoxycarbonyl,

3-fluoropropoxycarbonyl, 2-chloropropoxycarbonyl,

3-chloropropoxycarbonyl, 2-bromopropoxycarbonyl,

3-bromopropoxycarbonyl, 2,2-difluoropropoxycarbonyl,

2,3-difluoropropoxycarbonyl, 2,3-dichloropropoxycarbonyl,

3,3,3-trifluoropropoxycarbonyl, 3,3,3-trichloropropoxycarbonyl, 2,2,3,3,3-pentafluoropropoxycarbonyl,

heptafluoropropoxycarbonyl, 1-(fluoromethyl)-2-fluoroethoxycarbonyl, 1-(chloromethyl)-2-chloroethoxycarbonyl,

1-(bromomethyl)-2-bromoethoxycarbonyl,

4-fluorobutoxycarbonyl, 4-chlorobutoxycarbonyl,

4-bromobutoxycarbonyl or 4-iodobutoxycarbonyl;

C₁-C₆-haloalkoxycarbonyl: a C₁-C₄-haloalkoxycarbonyl radical as mentioned above, and also 5-fluoropentoxycarbonyl,

5-chloropentoxycarbonyl, 5-bromopentoxycarbonyl,

6-fluorohexoxycarbonyl, 6-chlorohexoxycarbonyl or

6-bromohexoxycarbonyl;

(C₁-C₄-alkyl)carbonyloxy: acetyloxy, ethylcarbonyloxy,

propylcarbonyloxy, 1-methylethylcarbonyloxy,

butylcarbonyloxy, 1-methylpropylcarbonyloxy,

2-methylpropylcarbonyloxy or 1,1-dimethylethylcarbonyloxy;

(C₁-C₄-alkylamino)carbonyl: for example methylaminocarbonyl,

ethylaminocarbonyl, propylaminocarbonyl,

1-methylethylaminocarbonyl, butylaminocarbonyl,

1-methylpropylaminocarbonyl, 2-methylpropylaminocarbonyl or

1,1-dimethylethylaminocarbonyl;

(C₁-C₆-alkylamino)carbonyl: (C₁-C₄-alkylamino)carbonyl as mentioned above, and also, for example, pentylaminocarbonyl,

1-methylbutylaminocarbonyl, 2-methylbutylaminocarbonyl,

3-methylbutylaminocarbonyl, 2,2-dimethylpropylaminocarbonyl,

1-ethylpropylaminocarbonyl, hexylaminocarbonyl,

1,1-dimethylpropylaminocarbonyl, 1,2-dimethylpropylamino-carbonyl, 1-methylpentylaminocarbonyl, 2-methylpentylamino-carbonyl, 3-methylpentylaminocarbonyl, 4-methylpentylamino-carbonyl, 1,1-dimethylbutylaminocarbonyl, 1,2-dimethylbutylamino-carbonyl, 1,3-dimethylbutylaminocarbonyl, 2,2-dimethyl-butylaminocarbonyl, 2,3-dimethylbutylaminocarbonyl,

3,3-dimethylbutylaminocarbonyl, 1-ethylbutylaminocarbonyl,

2-ethylbutylaminocarbonyl, 1,1,2-trimethylpropylamino-carbonyl, 1,2,2-trimethylpropylaminocarbonyl,

1-ethyl-1-methylpropylaminocarbonyl or

1-ethyl-2-methylpropylaminocarbonyl;

di(C₁-C₄-alkyl)aminocarbonyl: for example

N,N-dimethylaminocarbonyl, N,N-diethylaminocarbonyl,

N,N-di(1-methylethyl)aminocarbonyl, N,N-dipropylamino-carbonyl, N,N-dibutylaminocarbonyl, N,N-di(1-methylpropyl)-aminocarbonyl, N,N-di(2-methylpropyl)aminocarbonyl,

N,N-di(1,1-dimethylethyl)aminocarbonyl, N-ethyl-N-methyl-aminocarbonyl, N-methyl-N-propylaminocarbonyl,

N-methyl-N-(1-methylethyl)aminocarbonyl, N-butyl-N-methyl-aminocarbonyl, N-methyl-N-(1-methylpropyl)aminocarbonyl,

N-methyl-N-(2-methylpropyl)aminocarbonyl,

N-(1,1-dimethylethyl)-N-methylaminocarbonyl,

N-ethyl-N-propylaminocarbonyl, N-ethyl-N-(1-methylethyl)-aminocarbonyl, N-butyl-N-ethylaminocarbonyl,

N-ethyl-N-(1-methylpropyl)aminocarbonyl, N-ethyl-N-(2-methyl-propyl)aminocarbonyl, N-ethyl-N-(1,1-dimethylethyl)amino-carbonyl, N-(1-methylethyl)-N-propylaminocarbonyl,

N-butyl-N-propylaminocarbonyl, N-(1-methylpropyl)-N-propyl-aminocarbonyl, N-(2-methylpropyl)-N-propylaminocarbonyl,

N-(1,1-dimethylethyl)-N-propylaminocarbonyl,

N-butyl-N-(1-methylethyl)aminocarbonyl, N-(1-methylethyl)-N-(1-methylpropyl)aminocarbonyl, N-(1-methylethyl)-N-(2-methylpropyl)aminocarbonyl, N-(1,1-dimethylethyl)-N-(1-methylethyl)aminocarbonyl, N-butyl-N-(1-methylpropyl)aminocarbonyl,

N-butyl-N-(2-methylpropyl)aminocarbonyl,

N-butyl-N-(1,1-dimethylethyl)aminocarbonyl,

N-(1-methylpropyl)-N-(2-methylpropyl)aminocarbonyl,

N-(1,1-dimethylethyl)-N-(1-methylpropyl)aminocarbonyl or N-(1,1-dimethylethyl)-N-(2-methylpropyl)aminocarbonyl;

di(C₁-C₆-alkyl)aminocarbonyl: di(C₁-C₄-alkyl)aminocarbonyl as mentioned above, and also, for example, N-methyl-N-pentyl-aminocarbonyl,

N-methyl-N-(1-methylbutyl)aminocarbonyl, N-methyl-N-(2-methylbutyl)aminocarbonyl, N-methyl-N-(3-methylbutyl)aminocarbonyl, N-methyl-N-(2,2-dimethyl-propyl)aminocarbonyl, N-methyl-N-(1-ethylpropyl)-aminocarbonyl, N-methyl-N-hexylaminocarbonyl,

N-methyl-N-(1,1-dimethylpropyl)aminocarbonyl,

N-methyl-N-(1,2-dimethylpropyl)aminocarbonyl,

N-methyl-N-(1-methylpentyl)aminocarbonyl,

N-methyl-N-(2-methylpentyl)aminocarbonyl,

N-methyl-N-(3-methylpentyl)aminocarbonyl,

N-methyl-N-(4-methylpentyl)aminocarbonyl,

N-methyl-N-(1,1-dimethylbutyl)aminocarbonyl,

N-methyl-N-(1,2-dimethylbutyl)aminocarbonyl,

N-methyl-N-(1,3-dimethylbutyl)aminocarbonyl,

N-methyl-N-(2,2-dimethylbutyl)aminocarbonyl,

N-methyl-N-(2,3-dimethylbutyl)aminocarbonyl,

N-methyl-N-(3,3-dimethylbutyl)aminocarbonyl,

N-methyl-N-(1-ethylbutyl)aminocarbonyl,

N-methyl-N-(2-ethylbutyl)aminocarbonyl,

N-methyl-N-(1,1,2-trimethylpropyl)aminocarbonyl,

N-methyl-N-(1,2,2-trimethylpropyl)aminocarbonyl,

N-methyl-N-(1-ethyl-1-methylpropyl)aminocarbonyl,

N-methyl-N-(1-ethyl-2-methylpropyl)aminocarbonyl,

N-ethyl-N-pentylaminocarbonyl,

N-ethyl-N-(1-methylbutyl)aminocarbonyl,

N-ethyl-N-(2-methylbutyl)aminocarbonyl,

N-ethyl-N-(3-methylbutyl)aminocarbonyl,

N-ethyl-N-(2,2-dimethylpropyl)aminocarbonyl,

N-ethyl-N-(1-ethylpropyl)aminocarbonyl,

N-ethyl-N-hexylaminocarbonyl,

N-ethyl-N-(1,1-dimethylpropyl)aminocarbonyl,

N-ethyl-N-(1,2-dimethylpropyl)aminocarbonyl,

N-ethyl-N-(1-methylpentyl)aminocarbonyl,

N-ethyl-N-(2-methylpentyl)aminocarbonyl,

N-ethyl-N-(3-methylpentyl)aminocarbonyl,

N-ethyl-N-(4-methylpentyl)aminocarbonyl,

N-ethyl-N-(1,1-dimethylbutyl)aminocarbonyl,

N-ethyl-N-(1,2-dimethylbutyl)aminocarbonyl,

N-ethyl-N-(1,3-dimethylbutyl)aminocarbonyl,

N-ethyl-N-(2,2-dimethylbutyl)aminocarbonyl,

N-ethyl-N-(2,3-dimethylbutyl)aminocarbonyl,

N-ethyl-N-(3,3-dimethylbutyl)aminocarbonyl,

N-ethyl-N-(1-ethylbutyl)aminocarbonyl,

N-ethyl-N-(2-ethylbutyl)aminocarbonyl,

N-ethyl-N-(1,1,2-trimethylpropyl)aminocarbonyl,

N-ethyl-N-(1,2,2-trimethylpropyl)aminocarbonyl,

N-ethyl-N-(1-ethyl-1-methylpropyl)aminocarbonyl,

N-ethyl-N-(1-ethyl-2-methylpropyl)aminocarbonyl,

N-propyl-N-pentylaminocarbonyl,

N-butyl-N-pentylaminocarbonyl, N,N-dipentylaminocarbonyl,

N-propyl-N-hexylaminocarbonyl, N-butyl-N-hexylaminocarbonyl,

N-pentyl-N-hexylaminocarbonyl or N,N-dihexylaminocarbonyl;

di(C₁-C₆-alkyl)aminothiocarbonyl: for example

N,N-dimethylaminothiocarbonyl, N,N-diethylaminothiocarbonyl,

N,N-di(1-methylethyl)aminothiocarbonyl,

N,N-dipropylaminothiocarbonyl, N,N-dibutylaminothiocarbonyl,

N,N-di(1-methylpropyl)aminothiocarbonyl,

N,N-di(2-methylpropyl)aminothiocarbonyl,

N,N-di(1,1-dimethylethyl)aminothiocarbonyl,

N-ethyl-N-methylaminothiocarbonyl,

N-methyl-N-propylaminothiocarbonyl,

N-methyl-N-(1-methylethyl)aminothiocarbonyl,

N-butyl-N-methylaminothiocarbonyl,

N-methyl-N-(1-methylpropyl)aminothiocarbonyl,

N-methyl-N-(2-methylpropyl)aminothiocarbonyl,

N-(1,1-dimethylethyl)-N-methylaminothiocarbonyl,

N-ethyl-N-propylaminothiocarbonyl,

N-ethyl-N-(1-methylethyl)aminothiocarbonyl,

N-butyl-N-ethylaminothiocarbonyl,

N-ethyl-N-(1-methylpropyl)aminothiocarbonyl,

N-ethyl-N-(2-methylpropyl)aminothiocarbonyl,

N-ethyl-N-(1,1-dimethylethyl)aminothiocarbonyl,

N-(1-methylethyl)-N-propylaminothiocarbonyl,

N-butyl-N-propylaminothiocarbonyl,

N-(1-methylpropyl)-N-propylaminothiocarbonyl,

N-(2-methylpropyl)-N-propylaminothiocarbonyl,

N-(1,1-dimethylethyl)-N-propylaminothiocarbonyl,

N-butyl-N-(1-methylethyl)aminothiocarbonyl,

N-(1-methylethyl)-N-(1-methylpropyl)aminothiocarbonyl,

N-(1-methylethyl)-N-(2-methylpropyl)aminothiocarbonyl,

N-(1,1-dimethylethyl)-N-(1-methylethyl)aminothiocarbonyl,

N-butyl-N-(1-methylpropyl)aminothiocarbonyl,

N-butyl-N-(2-methylpropyl)aminothiocarbonyl,

N-butyl-N-(1,1-dimethylethyl)aminothiocarbonyl,

N-(1-methylpropyl)-N-(2-methylpropyl)aminothiocarbonyl,

N-(1,1-dimethylethyl)-N-(1-methylpropyl)aminothiocarbonyl,

N-(1,1-dimethylethyl)-N-(2-methylpropyl)aminothiocarbonyl,

N-methyl-N-pentylaminothiocarbonyl,

N-methyl-N-(1-methylbutyl)aminothiocarbonyl,

N-methyl-N-(2-methylbutyl)aminothiocarbonyl,

N-methyl-N-(3-methylbutyl)aminothiocarbonyl,

N-methyl-N-(2,2-dimethylpropyl)aminothiocarbonyl,

N-methyl-N-(1-ethylpropyl)aminothiocarbonyl,

N-methyl-N-hexylaminothiocarbonyl,

N-methyl-N-(1,1-dimethylpropyl)aminothiocarbonyl,

N-methyl-N-(1,2-dimethylpropyl)aminothiocarbonyl,

N-methyl-N-(1-methylpentyl)aminothiocarbonyl,

N-methyl-N-(2-methylpentyl)aminothiocarbonyl,

N-methyl-N-(3-methylpentyl)aminothiocarbonyl,

N-methyl-N-(4-methylpentyl)aminothiocarbonyl,

N-methyl-N-(1,1-dimethylbutyl)aminothiocarbonyl,

N-methyl-N-(1,2-dimethylbutyl)aminothiocarbonyl,

N-methyl-N-(1,3-dimethylbutyl)aminothiocarbonyl,

N-methyl-N-(2,2-dimethylbutyl)aminothiocarbonyl,

N-methyl-N-(2,3-dimethylbutyl)aminothiocarbonyl,

N-methyl-N-(3,3-dimethylbutyl)aminothiocarbonyl,

N-methyl-N-(1-ethylbutyl)aminothiocarbonyl,

N-methyl-N-(2-ethylbutyl)aminothiocarbonyl,

N-methyl-N-ethyl-N-(1,1,2-trimethylpropyl)aminothiocarbonyl,

N-methyl-N-(1,2,2-trimethylpropyl)aminothiocarbonyl,

N-methyl-N-(1-ethyl-1-methylpropyl)aminothiocarbonyl,

N-methyl-N-(1-ethyl-2-methylpropyl)aminothiocarbonyl,

N-ethyl-N-pentylaminothiocarbonyl,

N-ethyl-N-(1-methylbutyl)aminothiocarbonyl,

N-ethyl-N-(2-methylbutyl)aminothiocarbonyl,

N-ethyl-N-(3-methylbutyl)aminothiocarbonyl,

N-ethyl-N-(2,2-dimethylpropyl)aminothiocarbonyl,

N-ethyl-N-(1-ethylpropyl)aminothiocarbonyl,

N-ethyl-N-hexylaminothiocarbonyl,

N-ethyl-N-(1,1-dimethylpropyl)aminothiocarbonyl,

N-ethyl-N-(1,2-dimethylpropyl)aminothiocarbonyl,

N-ethyl-N-(1-methylpentyl)aminothiocarbonyl,

N-ethyl-N-(2-methylpentyl)aminothiocarbonyl,

N-ethyl-N-(3-methylpentyl)aminothiocarbonyl,

N-ethyl-N-(4-methylpentyl)aminothiocarbonyl,

N-ethyl-N-(1,1-dimethylbutyl)aminothiocarbonyl,

N-ethyl-N-(1,2-dimethylbutyl)aminothiocarbonyl,

N-ethyl-N-(1,3-dimethylbutyl)aminothiocarbonyl,

N-ethyl-N-(2,2-dimethylbutyl)aminothiocarbonyl,

N-ethyl-N-(2,3-dimethylbutyl)aminothiocarbonyl,

N-ethyl-N-(3,3-dimethylbutyl)aminothiocarbonyl,

N-ethyl-N-(1-ethylbutyl)aminothiocarbonyl,

N-ethyl-N-(2-ethylbutyl)aminothiocarbonyl,

N-ethyl-N-(1,1,2-trimethylpropyl)aminothiocarbonyl,

N-ethyl-N-(1,2,2-trimethylpropyl)aminothiocarbonyl,

N-ethyl-N-(1-ethyl-1-methylpropyl)aminothiocarbonyl,

N-ethyl-N-(1-ethyl-2-methylpropyl)aminothiocarbonyl,

N-propyl-N-pentylaminothiocarbonyl,

N-butyl-N-pentylaminothiocarbonyl,

N,N-dipentylaminothiocarbonyl,

N-propyl-N-hexylaminothiocarbonyl,

N-butyl-N-hexylaminothiocarbonyl,

N-pentyl-N-hexylaminothiocarbonyl or

N,N-dihexylaminothiocarbonyl;

C₁-C₆-hydroxyalkyl: C₁-C₆-alkyl which is substituted by one to three OH groups, for example hydroxymethyl, 1-hydroxyethyl,

2-hydroxyethyl, 1,2-bishydroxyethyl, 1-hydroxypropyl,

2-hydroxypropyl, 3-hydroxypropyl, 4-hydroxybutyl,

2,2-dimethyl-3-hydroxypropyl;

phenyl-C₁-C₆-alkyl: C₁-C₆-alkyl which is substituted by a phenyl radical, for example benzyl, 1-phenylethyl and 2-phenylethyl, where the phenyl radical may, in the manner mentioned, be partially or fully halogenated or may carry one to three of the substituents mentioned above for phenyl; correspondingly, heterocyclyl-C₁-C₆-alkyl is a C₁-C₆-alkyl which is substituted by a heterocyclyl radical;

C₁-C₆-alkoxy-C₁-C₆-alkyl: C₁-C₆-alkyl which is substituted by C₁-C₆-alkoxy as mentioned above, i.e., for example,

methoxymethyl, ethoxymethyl, propoxymethyl, (1-methylethoxy)-methyl, butoxymethyl, (1-methylpropoxy)methyl,

(2-methylpropoxy)methyl, (1,1-dimethylethoxy)methyl,

2-(methoxy)ethyl, 2-(ethoxy)ethyl, 2-(propoxy)ethyl,

2-(1-methylethoxy)ethyl, 2-(butoxy)ethyl,

2-(1-methylpropoxy)ethyl, 2-(2-methylpropoxy)ethyl,

2-(1,1-dimethylethoxy)ethyl, 2-(methoxy)propyl,

2-(ethoxy)propyl, 2-(propoxy)propyl, 2-(1-methylethoxy)-propyl, 2-(butoxy)propyl, 2-(1-methylpropoxy)propyl,

2-(2-methylpropoxy)propyl, 2-(1,1-dimethylethoxy)propyl,

3-(methoxy)propyl, 3-(ethoxy)propyl, 3-(propoxy)propyl,

3-(1-methylethoxy)propyl, 3-(butoxy)propyl,

3-(1-methylpropoxy)propyl, 3-(2-methylpropoxy)propyl,

3-(1,1-dimethylethoxy)propyl, 2-(methoxy)butyl,

2-(ethoxy)butyl, 2-(propoxy)butyl, 2-(1-methylethoxy)butyl,

2-(butoxy)butyl, 2-(1-methylpropoxy)butyl,

2-(2-methylpropoxy)butyl, 2-(1,1-dimethylethoxy)butyl,

3-(methoxy)butyl, 3-(ethoxy)butyl, 3-(propoxy)butyl,

3-(1-methylethoxy)butyl, 3-(butoxy)butyl,

3-(1-methylpropoxy)butyl, 3-(2-methylpropoxy)butyl,

3-(1,1-dimethylethoxy)butyl, 4-(methoxy)butyl,

4-(ethoxy)butyl, 4-(propoxy)butyl, 4-(1-methylethoxy)butyl,

4-(butoxy)butyl, 4-(1-methylpropoxy)butyl,

4-(2-methylpropoxy)butyl or 4-(1,1-dimethylethoxy)butyl;

C₁-C₆-alkoxy-C₁-C₆-alkoxy, and the alkoxyalkoxy moieties of C₁-C₆-alkoxy-C₁-C₆-alkoxycarbonyl: C₁-C₆-alkoxy which is substituted by C₁-C₆-alkoxy as mentioned above, i.e, for example, methoxymethoxy, ethoxymethoxy, propoxymethoxy,

(1-methylethoxy)methoxy, butoxymethoxy, (1-methylpropoxy)-methoxy, (2-methylpropoxy)methoxy, (1,1-dimethylethoxy)-methoxy, 2-(methoxy)ethoxy, 2-(ethoxy)ethoxy,

2-(propoxy)ethoxy, 2-(1-methylethoxy)ethoxy,

2-(butoxy)ethoxy, 2-(1-methylpropoxy)ethoxy,

2-(2-methylpropoxy)ethoxy, 2-(1,1-dimethylethoxy)ethoxy,

2-(methoxy)propoxy, 2-(ethoxy)propoxy, 2-(propoxy)propoxy,

2-(1-methylethoxy)propoxy, 2-(butoxy)propoxy,

2-(1-methylpropoxy)propoxy, 2-(2-methylpropoxy)propoxy,

2-(1,1-dimethylethoxy)propoxy, 3-(methoxy)propoxy,

3-(ethoxy)propoxy, 3-(propoxy)propoxy, 3-(1-methylethoxy)-propoxy, 3-(butoxy)propoxy, 3-(1-methylpropoxy)propoxy,

3-(2-methylpropoxy)propoxy, 3-(1,1-dimethylethoxy)propoxy,

2-(methoxy)butoxy, 2-(ethoxy)butoxy, 2-(propoxy)-butoxy,

2-(1-methylethoxy)butoxy, 2-(butoxy)butoxy,

2-(1-methylpropoxy)butoxy, 2-(2-methylpropoxy)butoxy,

2-(1,1-dimethylethoxy)butoxy, 3-(methoxy)butoxy,

3-(ethoxy)butoxy, 3-(propoxy)butoxy, 3-(1-methylethoxy)butoxy, 3-(butoxy)butoxy, 3-(1-methylpropoxy)butoxy,

3-(2-methylpropoxy)butoxy, 3-(1,1-dimethylethoxy)butoxy,

4-(methoxy)butoxy, 4-(ethoxy)butoxy, 4-(propoxy)butoxy,

4-(1-methylethoxy)butoxy, 4-(butoxy)butoxy,

4-(1-methylpropoxy)butoxy, 4-(2-methylpropoxy)butoxy or

4-(1,1-dimethylethoxy)butoxy;

C₃-C₆-alkenyl, and the alkenyl moieties of

C₃-C₆-alkenylcarbonyl, C₃-C₆-alkenyloxy,

C₃-C₆-alkenyloxycarbonyl, C₃-C₆-alkenylaminocarbonyl,

N—(C₃-C₆-alkenyl)-N—(C₁-C₆-alkyl)aminocarbonyl,

N—(C₃-C₆-alkenyl)-N—(C₁-C₆-alkoxy)aminocarbonyl: for example

prop-1-en-3-yl, but-1-en-4-yl, 1-methylprop-2-en-1-yl,

2-methylprop-2-en-1-yl, 2-buten-1-yl, 1-penten-3-yl,

1-penten-4-yl, 2-penten-4-yl, 1-methylbut-2-en-1-yl,

2-methylbut-2-en-1-yl, 3-methylbut-2-en-1-yl,

1-methylbut-3-en-1-yl, 2-methylbut-3-en-1-yl,

3-methyl-but-3-en-1-yl, 1,1-dimethylprop-2-en-1-yl,

1,2-dimethylprop-2-en-1-yl, 1-ethylprop-2-en-1-yl,

hex-3-en-1-yl, hex-4-en-1-yl, hex-5-en-1-yl,

1-methylpent-3-en-1-yl, 2-methylpent-3-en-1-yl,

3-methylpent-3-en-1-yl, 4-methylpent-3-en-1-yl,

1-methylpent-4-en-1-yl, 2-methylpent-4-en-1-yl,

3-methylpent-4-en-1-yl, 4-methylpent-4-en-1-yl,

1,1-dimethylbut-2-en-1-yl, 1,1-dimethylbut-3-en-1-yl,

1,2-dimethylbut-2-en-1-yl, 1,2-dimethylbut-3-en-1-yl,

1,3-dimethylbut-2-en-1-yl, 1,3-dimethylbut-3-en-1-yl,

2,2-dimethylbut-3-en-1-yl, 2,3-dimethylbut-2-en-1-yl,

2,3-dimethylbut-3-en-1-yl, 3,3-dimethylbut-2-en-1-yl,

1-ethylbut-2-en-1-yl, 1-ethylbut-3-en-1-yl,

2-ethylbut-2-en-1-yl, 2-ethylbut-3-en-1-yl,

1,1,2-trimethylprop-2-en-1-yl, 1-ethyl-1-methylprop-2-en-1-yl

or 1-ethyl-2-methylprop-2-en-1-yl;

C₂-C₆-alkenyl, and the alkenyl moieties of C₂-C₆-alkenylcarbonyl, phenyl-C₂-C₆-alkenylcarbonyl and heterocyclyl-C₂-C₆-alkenylcarbonyl: C₃-C₆-alkenyl as mentioned above, and also ethenyl;

C₃-C₆-haloalkenyl: a C₃-C₆-alkenyl radical as mentioned above which is partially or fully substituted by fluorine, chlorine, bromine and/or iodine, i.e., for example,

2-chloroallyl, 3-chloroallyl, 2,3-dichloroallyl,

3,3-dichloroallyl, 2,3,3-trichloroallyl,

2,3-dichlorobut-2-enyl, 2-bromoallyl, 3-bromoallyl,

2,3-dibromoallyl, 3,3-dibromoallyl, 2,3,3-tribromoallyl or

2,3-dibromobut-2-enyl;

C₃-C₆-alkynyl, and the alkynyl moieties of

C₃-C₆-alkynylcarbonyl, C₃-C₆-alkynyloxy,

C₃-C₆-alkynyloxycarbonyl, C₃-C₆-alkynylaminocarbonyl,

N—(C₃-C₆-alkynyl)-N—(C₁-C₆-alkyl)aminocarbonyl,

N—(C₃-C₆-alkynyl)-N—(C₁-C₆-alkoxy)aminocarbonyl: for example

propargyl, but-1-yn-3-yl, but-1-yn-4-yl, but-2-yn-1-yl,

pent-1-yn-3-yl, pent-1-yn-4-yl, pent-1-yn-5-yl,

pent-2-yn-1-yl, pent-2-yn-4-yl, pent-2-yn-5-yl,

3-methylbut-1-yn-3-yl, 3-methylbut-1-yn-4-yl, hex-1-yn-3-yl,

hex-1-yn-4-yl, hex-1-yn-5-yl, hex-1-yn-6-yl, hex-2-yn-1-yl,

hex-2-yn-4-yl, hex-2-yn-5-yl, hex-2-yn-6-yl, hex-3-yn-1-yl,

hex-3-yn-2-yl, 3-methylpent-1-yn-3-yl,

3-methylpent-1-yn-4-yl, 3-methylpent-1-yn-5-yl,

4-methylpent-2-yn-4-yl or 4-methylpent-2-yn-5-yl;

C₂-C₆-alkynyl, and the alkynyl moieties of C₂-C₆-alkynylcarbonyl: C₃-C₆-alkynyl as mentioned above, and also ethynyl;

C₃-C₆-haloalkynyl: a C₃-C₆-alkynyl radical as mentioned above which is partially or fully substituted by fluorine, chlorine, bromine and/or iodine, i.e., for example,

1,1-difluoroprop-2-yn-1-yl, 3-iodoprop-2-yn-1-yl,

4-fluorobut-2-yn-1-yl, 4-chlorobut-2-yn-1-yl,

1,1-difluorobut-2-yn-1-yl, 4-iodobut-3-yn-1-yl,

5-fluoropent-3-yn-1-yl, 5-iodopent-4-yn-1-yl,

6-fluorohex-4-yn-1-yl or 6-iodohex-5-yn-1-yl;

C₁-C₆-alkanediyl: methanediyl, ethane-1,1-diyl,

ethane-1,2-diyl, propane-1,1-diyl, propane-1,2-diyl,

propane-1,3-diyl, propane-2,2-diyl, butane-1,1-diyl,

butane-1,2-diyl, butane-1,3-diyl, butane-1,4-diyl,

2-methylpropane-1,3-diyl, 2-methylpropane-1,2-diyl,

2-methylpropane-1,1-diyl, 1-methylpropane-1,2-diyl,

1-methylpropane-2,2-diyl, 1-methylpropane-1,1-diyl,

pentane-1,1-diyl, pentane-1,2-diyl, pentane-1,3-diyl,

pentane-1,5-diyl, pentane-2,3-diyl, pentane-2,2-diyl,

1-methylbutane-1,1-diyl, 1-methylbutane-1,2-diyl,

1-methylbutane-1,3-diyl, 1-methylbutane-1,4-diyl,

2-methylbutane-1,1-diyl, 2-methylbutane-1,2-diyl,

2-methylbutane-1,3-diyl, 2-methylbutane-1,4-diyl,

2,2-dimethylpropane-1,1-diyl, 2,2-dimethylpropane-1,3-diyl,

1,1-dimethylpropane-1,3-diyl, 1,1-dimethylpropane-1,2-diyl,

2,3-dimethylpropane-1,3-diyl, 2,3-dimethylpropane-1,2-diyl,

1,3-dimethylpropane-1,3-diyl, hexane-1,1-diyl,

hexane-1,2-diyl, hexane-1,3-diyl, hexane-1,4-diyl,

hexane-1,5-diyl, hexane-1,6-diyl, hexane-2,5-diyl,

2-methylpentane-1,1-diyl, 1-methylpentane-1,2-diyl,

1-methylpentane-1,3-diyl, 1-methylpentane-1,4-diyl,

1-methylpentane-1,5-diyl, 2-methylpentane-1,1-diyl,

2-methylpentane-1,2-diyl, 2-methylpentane-1,3-diyl,

2-methylpentane-1,4-diyl, 2-methylpentane-1,5-diyl,

3-methylpentane-1,1-diyl, 3-methylpentane-1,2-diyl,

3-methylpentane-1,3-diyl, 3-methylpentane-1,4-diyl,

3-methylpentane-1,5-diyl, 1,1-dimethylbutane-1,2-diyl,

1,1-dimethylbutane-1,3-diyl, 1,1-dimethylbutane-1,4-diyl,

1,2-dimethylbutane-1,1-diyl, 1,2-dimethylbutane-1,2-diyl,

1,2-dimethylbutane-1,3-diyl, 1,2-dimethylbutane-1,4-diyl,

1,3-dimethylbutane-1,1-diyl, 1,3-dimethylbutane-1,2-diyl,

1,3-dimethylbutane-1,3-diyl, 1,3-dimethylbutane-1,4-diyl,

1-ethylbutane-1,1-diyl, 1-ethylbutane-1,2-diyl,

1-ethylbutane-1,3-diyl, 1-ethylbutane-1,4-diyl,

2-ethylbutane-1,1-diyl, 2-ethylbutane-1,2-diyl,

2-ethylbutane-1,3-diyl, 2-ethylbutane-1,4-diyl,

2-ethylbutane-2,3-diyl, 2,2-dimethylbutane-1,1-diyl,

2,2-dimethylbutane-1,3-diyl, 2,2-dimethylbutane-1,4-diyl,

1-isopropylpropane-1,1-diyl, 1-isopropylpropane-1,2-diyl,

1-isopropylpropane-1,3-diyl, 2-isopropylpropane-1,1-diyl,

2-isopropylpropane-1,2-diyl, 2-isopropylpropane-1,3-diyl,

1,2,3-trimethylpropane-1,1-diyl, 1,2,3-trimethylpropane1,2-diyl or 1,2,3-trimethylpropane-1,3-diyl;

C₂-C₆-alkenediyl: ethene-1,1-diyl, ethene-1,2-diyl,

1-propene-1,1-diyl, 1-propene-1,2-diyl, 1-propene-1,3-diyl,

2-propene-1,1-diyl, 2-propene-1,2-diyl, 2-propene-1,3-diyl,

1-butene-1,1-diyl, 1-butene-1,2-diyl, 1-butene-1,3-diyl,

1-butene-1,4-diyl, 2-butene-1,1-diyl, 2-butene-1,2-diyl,

2-butene-1,3-diyl, 2-butene-1,4-diyl, 3-butene-1,1-diyl,

3-butene-1,2-diyl, 3-butene-1,3-diyl, 3-butene-1,4-diyl,

1-methyl-1-propene-1,2-diyl, 1-methyl-1-propene-1,3-diyl,

1-methyl-2-propene-1,1-diyl, 1-methyl-2-propene-1,2-diyl,

1-methyl-2-propene-1,3-diyl, 2-methyl-1,1-propene-1,1-diyl,

2-methyl-1-propene-1,3-diyl, 3-butene-1,1-diyl,

3-butene-1,2-diyl, 3-butene-1,3-diyl, 3-butene-1,4-diyl,

1-pentene-1,1-diyl, 1-pentene-1,2-diyl, 1-pentene-1,3-diyl,

1-pentene-1,4-diyl, 1-pentene-1,5-diyl, 1-hexene-1,1-diyl,

1-hexene-1,2-diyl, 1-hexene-1,3-diyl, 1-hexene-1,4-diyl,

1-hexene-1,5-diyl or 1-hexene-1,6-diyl;

C₂-C₆-alkadienediyl: 1,3-butadiene-1,1-diyl,

1,3-butadiene-1,2-diyl, 1,3-butadiene-1,3-diyl,

1,3-butadiene-1,4-diyl, 1,3-pentadiene-1,1-diyl,

1,3-pentadiene-1,2-diyl, 1,3-pentadiene-1,3-diyl,

1,3-pentadiene-1,4-diyl, 1,3-pentadiene-1,5-diyl,

2,4-pentadiene-1,1-diyl, 2,4-pentadiene-1,2-diyl,

2,4-pentadiene-1,3-diyl, 2,4-pentadiene-1,4-diyl,

2,4-pentadiene-1,5-diyl, 1-methyl-1,3-butadiene-1,4-diyl,

1,3-hexadiene-1,1-diyl, 1,3-hexadiene-1,2-diyl,

1,3-hexadiene-1,3-diyl, 1,3-hexadiene-1,4-diyl,

1,3-hexadiene-1,5-diyl, 1,3-hexadiene-1,6-diyl,

1-methyl-1,3-pentadiene-1,2-diyl, 1-methyl-1,3-pentadiene-1,3-diyl, 1-methyl-1,3-pentadiene-1,4-diyl or

1-methyl-1,3-pentadiene-1,5-diyl;

C₂-C₆-alkynediyl: ethyne-1,2-diyl, 1-propyne-1,3-diyl,

2-propyne-1,1-diyl, 2-propyne-1,3-diyl, 1-butyne-1,3-diyl,

1-butyne-1,4-diyl, 2-butyne-1,1-diyl, 2-butyne-1,4-diyl,

1-methyl-2-propyne-1,1-diyl, 1-methyl-2-propyne-1,3-diyl,

1-pentyne-1,3-diyl, 1-pentyne-1,4-diyl, 1-pentyne-1,5-diyl,

2-pentyne-1,1-diyl, 2-pentyne-1,4-diyl, 2-pentyne-1,5-diyl,

3-pentyne-1,1-diyl, 3-pentyne-1,2-diyl, 3-pentyne-1,5-diyl,

4-pentyne-1,1-diyl, 4-pentyne-1,2-diyl, 4-pentyne-1,3-diyl,

4-pentyne-1,5-diyl, 1-hexyne-1,3-diyl, 1-hexyne-1,4-diyl,

1-hexyne-1,5-diyl, 1-hexyne-1,6-diyl, 2-hexyne-1,1-diyl,

2-hexyne-1,4-diyl, 2-hexyne-1,5-diyl, 2-hexyne-1,6-diyl,

3-hexyne-1,1-diyl, 3-hexyne-1,2-diyl, 3-hexyne-1,5-diyl,

3-hexyne-1,6-diyl, 4-hexyne-1,1-diyl, 4-hexyne-1,2-diyl,

4-hexyne-1,3-diyl, 4-hexyne-1,6-diyl, 5-hexyne-1,1-diyl,

5-hexyne-1,2-diyl, 5-hexyne-1,3-diyl, 5-hexyne-1,4-diyl or

5-hexyne-1,6-diyl;

C₃-C₆-cycloalkyl, and the cycloalkyl moieties of C₃-C₆-cycloalkylamino and C₃-C₆-cycloalkylcarbonyl: for example cyclopropyl, cyclobutyl, cyclopentyl or cyclohexyl;

aryl is understood as meaning carbocyclic aromatic compounds such as phenyl or naphthyl;

a 3- to 7-membered heterocycle is understood as meaning a saturated, partially saturated or unsaturated 3-, 4-, 5-, 6- or 7-membered heterocyclic ring which contains one, two, three or four identical or different heteroatoms selected from the following group: oxygen, sulfur or nitrogen, i.e., for example,

C-bonded 5-membered rings such as:

tetrahydrofuran-2-yl, tetrahydrofuran-3-yl,

tetrahydrothien-2-yl, tetrahydrothien-3-yl,

tetrahydropyrrol-2-yl, tetrahydropyrrol-3-yl,

2,3-dihydrofuran-2-yl, 2,3-dihydrofuran-3-yl,

2,5-dihydrofuran-2-yl, 2,5-dihydrofuran-3-yl,

4,5-dihydrofuran-2-yl, 4,5-dihydrofuran-3-yl,

2,3-dihydrothien-2-yl, 2,3-dihydrothien-3-yl,

2,5-dihydrothien-2-yl, 2,5-dihydrothien-3-yl,

4,5-dihydrothien-2-yl, 4,5-dihydrothien-3-yl,

2,3-dihydro-1H-pyrrol-2-yl, 2,3-dihydro-1H-pyrrol-3-yl,

2,5-dihydro-1H-pyrrol-2-yl, 2,5-dihydro-1H-pyrrol-3-yl,

4,5-dihydro-1H-pyrrol-2-yl, 4,5-dihydro-1H-pyrrol-3-yl,

3,4-dihydro-2H-pyrrol-2-yl, 3,4-dihydro-2H-pyrrol-3-yl,

3,4-dihydro-5H-pyrrol-2-yl, 3,4-dihydro-5H-pyrrol-3-yl,

2-furyl, 3-furyl, 2-thienyl, 3-thienyl, pyrrol-2-yl,

pyrrol-3-yl, tetrahydropyrazol-3-yl, tetrahydropyrazol-4-yl,

tetrahydroisoxazol-3-yl, tetrahydroisoxazol-4-yl,

tetrahydroisoxazol-5-yl, 1,2-oxathiolan-3-yl,

1,2-oxathiolan-4-yl, 1,2-oxathiolan-5-yl,

tetrahydroisothiazol-3-yl, tetrahydroisothiazol-4-yl,

tetrahydroisothiazol-5-yl, 1,2-dithiolan-3-yl,

1,2-dithiolan-4-yl, tetrahydroimidazol-2-yl,

tetrahydroimidazol-4-yl, tetrahydrooxazol-2-yl,

tetrahydrooxazol-4-yl, tetrahydrooxazol-5-yl,

tetrahydrothiazol-2-yl, tetrahydrothiazol-4-yl,

tetrahydrothiazol-5-yl, 1,3-dioxolan-2-yl,

1,3-dioxolan-4-yl, 1,3-oxathiolan-2-yl, 1,3-oxathiolan-4-yl,

1,3-oxathiolan-5-yl, 1,3-dithiolan-2-yl, 1,3-dithiolan-4-yl,

4,5-dihydro-1H-pyrazol-3-yl, 4,5-dihydro-1H-pyrazol-4-yl,

4,5-dihydro-1H-pyrazol-5-yl, 2,5-dihydro-1H-pyrazol-3-yl,

2,5-dihydro-1H-pyrazol-4-yl, 2,5-dihydro-1H-pyrazol-5-yl,

4,5-dihydroisoxazol-3-yl, 4,5-dihydroisoxazol-4-yl,

4,5-dihydroisoxazol-5-yl, 2,5-dihydroisoxazol-3-yl,

2,5-dihydroisoxazol-4-yl, 2,5-dihydroisoxazol-5-yl,

2,3-dihydroisoxazol-3-yl, 2,3-dihydroisoxazol-4-yl,

2,3-dihydroisoxazol-5-yl, 4,5-dihydroisothiazol-3-yl,

4,5-dihydroisothiazol-4-yl, 4,5-dihydroisothiazol-5-yl,

2,5-dihydroisothiazol-3-yl, 2,5-dihydroisothiazol-4-yl,

2,5-dihydroisothiazol-5-yl, 2,3-dihydroisothiazol-3-yl,

2,3-dihydroisothiazol-4-yl, 2,3-dihydroisothiazol-5-yl,

Δ³-1,2-dithiol-3-yl, Δ³-1,2-dithiol-4-yl,

Δ³-1,2-dithiol-5-yl, 4,5-dihydro-1H-imidazol-2-yl,

4,5-dihydro-1H-imidazol-4-yl, 4,5-dihydro-1H-imidazol-5-yl,

2,5-dihydro-1H-imidazol-2-yl, 2,5-dihydro-1H-imidazol-4-yl,

2,5-dihydro-1H-imidazol-5-yl, 2,3-dihydro-1H-imidazol-2-yl,

2,3-dihydro-1H-imidazol-4-yl, 4,5-dihydrooxazol-2-yl,

4,5-dihydrooxazol-4-yl, 4,5-dihydrooxazol-5-yl,

2,5-dihydrooxazol-2-yl, 2,5-dihydrooxazol-4-yl,

2,5-dihydrooxazol-5-yl, 2,3-dihydrooxazol-2-yl,

2,3-dihydrooxazol-4-yl, 2,3-dihydrooxazol-5-yl,

4,5-dihydrothiazol-2-yl, 4,5-dihydrothiazol-4-yl,

4,5-dihydrothiazol-5-yl, 2,5-dihydrothiazol-2-yl,

2,5-dihydrothiazol-4-yl, 2,5-dihydrothiazol-5-yl,

2,3-dihydrothiazol-2-yl, 2,3-dihydrothiazol-4-yl,

2,3-dihydrothiazol-5-yl, 1,3-dioxol-2-yl, 1,3-dioxol-4-yl,

1,3-dithiol-2-yl, 1,3-dithiol-4-yl, 1,3-oxathiol-2-yl,

1,3-oxathiol-4-yl, 1,3-oxathiol-5-yl, pyrazol-3-yl,

pyrazol-4-yl, isoxazol-3-yl, isoxazol-4-yl, isoxazol-5-yl,

isothiazol-3-yl, isothiazol-4-yl, isothiazol-5-yl,

imidazol-2-yl, imidazol-4-yl, oxazol-2-yl, oxazol-4-yl,

oxazol-5-yl, thiazol-2-yl, thiazol-4-yl, thiazol-5-yl,

1,2,3-Δ²-oxadiazolin-4-yl, 1,2,3-Δ²-oxadiazolin-5-yl,

1,2,4-Δ⁴-oxadiazolin-3-yl, 1,2,4-Δ⁴-oxadiazolin-5-yl,

1,2,4-Δ²-oxadiazolin-3-yl, 1,2,4-Δ²-oxadiazolin-5-yl,

1,2,4-Δ³-oxadiazolin-3-yl, 1,2,4-Δ³-oxadiazolin-5-yl,

1,3,4-Δ²-oxadiazolin-2-yl, 1,3,4-Δ²-oxadiazolin-5-yl,

1,3,4-Δ³-oxadiazolin-2-yl, 1,3,4-oxadiazolin-2-yl,

1,2,4-Δ⁴-thiadiazolin-3-yl, 1,2,4-Δ⁴-thiadiazolin-5-yl,

1,2,4-Δ³-thiadiazolin-3-yl, 1,2,4-Δ³-thiadiazolin-5-yl,

1,2,4-Δ²-thiadiazolin-3-yl, 1,2,4-Δ²-thiadiazolin-5-yl,

1,3,4-Δ²-thiadiazolin-2-yl, 1,3,4-Δ²-thiadiazolin-5-yl,

1,3,4-Δ³-thiadiazolin-2-yl, 1,3,4-thiadiazolin-2-yl,

1,3,2-dioxathiolan-4-yl, 1,2,3-Δ²-triazolin-4-yl,

1,2,3-Δ²-triazolin-5-yl, 1,2,4-Δ²-triazolin-3-yl,

1,2,4-Δ²-triazolin-5-yl, 1,2,4-Δ³-triazolin-3-yl,

1,2,4-Δ³-triazolin-5-yl, 1,2,4-Δ¹-triazolin-2-yl,

1,2,4-triazolin-3-yl, 3H-1,2,4-dithiazol-5-yl,

2H-1,3,4-dithiazol-5-yl, 2H-1,3,4-oxathiazol-5-yl,

1,2,3-oxadiazol-4-yl, 1,2,3-oxadiazol-5-yl,

1,2,4-oxadiazol-3-yl, 1,2,4-oxadiazol-5-yl,

1,3,4-oxadiazol-2-yl, 1,2,3-thiadiazol-4-yl,

1,2,3-thiadiazol-5-yl, 1,2,4-thiadiazol-3-yl,

1,2,4-thiadiazol-5-yl, 1,3,4-thiadiazol-2-yl,

1,2,3-triazol-4-yl, 1,2,4-triazol-3-yl, tetrazol-5-yl;

C-bonded 6-membered rings such as:

tetrahydropyran-2-yl, tetrahydropyran-3-yl,

tetrahydropyran-4-yl, piperidin-2-yl, piperidin-3-yl,

piperidin-4-yl, tetrahydrothiopyran-2-yl,

tetrahydrothiopyran-3-yl, tetrahydrothiopyran-4-yl,

2H-3,4-dihydropyran-6-yl, 2H-3,4-dihydropyran-5-yl,

2H-3,4-dihydropyran-4-yl, 2H-3,4-dihydropyran-3-yl,

2H-3,4-dihydropyran-2-yl, 2H-3,4-dihydropyran-6-yl,

2H-3,4-dihydrothiopyran-5-yl, 2H-3,4-dihydrothiopyran-4-yl,

2H-3,4-dihydropyran-3-yl, 2H-3,4-dihydropyran-2-yl,

1,2,3,4-tetrahydropyridin-6-yl,

1,2,3,4-tetrahydropyridin-5-yl,

1,2,3,4-tetrahydropyridin-4-yl,

1,2,3,4-tetrahydropyridin-3-yl,

1,2,3,4-tetrahydropyridin-2-yl, 2H-5,6-dihydropyran-2-yl,

2H-5,6-dihydropyran-3-yl, 2H-5,6-dihydropyran-4-yl,

2H-5,6-dihydropyran-5-yl, 2H-5,6-dihydropyran-6-yl,

2H-5,6-dihydrothiopyran-2-yl, 2H-5,6-dihydrothiopyran-3-yl,

2H-5,6-dihydrothiopyran-4-yl, 2H-5,6-dihydrothiopyran-5-yl,

2H-5,6-dihydrothiopyran-6-yl, 1,2,5,6-tetrahydropyridin-2-yl,

1,2,5,6-tetrahydropyridin-3-yl,

1,2,5,6-tetrahydropyridin-4-yl,

1,2,5,6-tetrahydropyridin-5-yl,

1,2,5,6-tetrahydropyridin-6-yl,

2,3,4,5-tetrahydropyridin-2-yl,

2,3,4,5-tetrahydropyridin-3-yl,

2,3,4,5-tetrahydropyridin-4-yl,

2,3,4,5-tetrahydropyridin-5-yl,

2,3,4,5-tetrahydropyridin-6-yl, 4H-pyran-2-yl, 4H-pyran-3-yl,

4H-pyran-4-yl, 4H-thiopyran-2-yl, 4H-thiopyran-3-yl,

4H-thiopyran-4-yl, 1,4-dihydropyridin-2-yl,

1,4-dihydropyridin-3-yl, 1,4-dihydropyridin-4-yl,

2H-pyran-2-yl, 2H-pyran-3-yl, 2H-pyran-4-yl, 2H-pyran-5-yl,

2H-pyran-6-yl, 2H-thiopyran-2-yl, 2H-thiopyran-3-yl,

2H-thiopyran-4-yl, 2H-thiopyran-5-yl, 2H-thiopyran-6-yl,

1,2-dihydropyridin-2-yl, 1,2-dihydropyridin-3-yl,

1,2-dihydropyridin-4-yl, 1,2-dihydropyridin-5-yl,

1,2-dihydropyridin-6-yl, 3,4-dihydropyridin-2-yl,

3,4-dihydropyridin-3-yl, 3,4-dihydropyridin-4-yl,

3,4-dihydropyridin-5-yl, 3,4-dihydropyridin-6-yl,

2,5-dihydropyridin-2-yl, 2,5-dihydropyridin-3-yl,

2,5-dihydropyridin-4-yl, 2,5-dihydropyridin-5-yl,

2,5-dihydropyridin-6-yl, 2,3-dihydropyridin-2-yl,

2,3-dihydropyridin-3-yl, 2,3-dihydropyridin-4-yl,

2,3-dihydropyridin-5-yl, 2,3-dihydropyridin-6-yl,

pyridin-2-yl, pyridin-3-yl, pyridin-4-yl, 1,3-dioxan-2-yl,

1,3-dioxan-4-yl, 1,3-dioxan-5-yl, 1,4-dioxan-2-yl,

1,3-dithian-2-yl, 1,3-dithian-4-yl, 1,3-dithian-5-yl,

1,4-dithian-2-yl, 1,3-oxathian-2-yl, 1,3-oxathian-4-yl,

1,3-oxathian-5-yl, 1,3-oxathian-6-yl, 1,4-oxathian-2-yl,

1,4-oxathian-3-yl, 1,2-dithian-3-yl, 1,2-dithian-4-yl,

hexahydropyrimidin-2-yl, hexahydropyrimidin-4-yl,

hexahydropyrimidin-5-yl, hexahydropyrazin-2-yl,

hexahydropyridazin-3-yl, hexahydropyridazin-4-yl,

tetrahydro-1,3-oxazin-2-yl, tetrahydro-1,3-oxazin-4-yl,

tetrahydro-1,3-oxazin-5-yl, tetrahydro-1,3-oxazin-6-yl,

tetrahydro-1,3-thiazin-2-yl, tetrahydro-1,3-thiazin-4-yl,

tetrahydro-1,3-thiazin-5-yl, tetrahydro-1,3-thiazin-6-yl,

tetrahydro-1,4-thiazin-2-yl, tetrahydro-1,4-thiazin-3-yl,

tetrahydro-1,4-oxazin-2-yl, tetrahydro-1,4-oxazin-3-yl,

tetrahydro-1,2-oxazin-3-yl, tetrahydro-1,2-oxazin-4-yl,

tetrahydro-1,2-oxazin-5-yl, tetrahydro-1,2-oxazin-6-yl,

2H-5,6-dihydro-1,2-oxazin-3-yl,

2H-5,6-dihydro-1,2-oxazin-4-yl,

2H-5,6-dihydro-1,2-oxazin-5-yl,

2H-5,6-dihydro-1,2-oxazin-6-yl,

2H-5,6-dihydro-1,2-thiazin-3-yl,

2H-5,6-dihydro-1,2-thiazin-4-yl,

2H-5,6-dihydro-1,2-thiazin-5-yl,

2H-5,6-dihydro-1,2-thiazin-6-yl,

4H-5,6-dihydro-1,2-oxazin-3-yl,

4H-5,6-dihydro-1,2-oxazin-4-yl,

4H-5,6-dihydro-1,2-oxazin-5-yl,

4H-5,6-dihydro-1,2-oxazin-6-yl,

4H-5,6-dihydro-1,2-thiazin-3-yl,

4H-5,6-dihydro-1,2-thiazin-4-yl,

4H-5,6-dihydro-1,2-thiazin-5-yl,

4H-5,6-dihydro-1,2-thiazin-6-yl,

2H-3,6-dihydro-1,2-oxazin-3-yl,

2H-3,6-dihydro-1,2-oxazin-4-yl,

2H-3,6-dihydro-1,2-oxazin-5-yl,

2H-3,6-dihydro-1,2-oxazin-6-yl,

2H-3,6-dihydro-1,2-thiazin-3-yl,

2H-3,6-dihydro-1,2-thiazin-4-yl,

2H-3,6-dihydro-1,2-thiazin-5-yl,

2H-3,6-dihydro-1,2-thiazin-6-yl,

2H-3,4-dihydro-1,2-oxazin-3-yl,

2H-3,4-dihydro-1,2-oxazin-4-yl,

2H-3,4-dihydro-1,2-oxazin-5-yl,

2H-3,4-dihydro-1,2-oxazin-6-yl,

2H-3,4-dihydro-1,2-thiazin-3-yl,

2H-3,4-dihydro-1,2-thiazin-4-yl,

2H-3,4-dihydro-1,2-thiazin-5-yl,

2H-3,4-dihydro-1,2-thiazin-6-yl,

2,3,4,5-tetrahydropyridazin-3-yl,

2,3,4,5-tetrahydropyridazin-4-yl,

2,3,4,5-tetrahydropyridazin-5-yl,

2,3,4,5-tetrahydropyridazin-6-yl,

3,4,5,6-tetrahydropyridazin-3-yl,

3,4,5,6-tetrahydropyridazin-4-yl,

1,2,5,6-tetrahydropyridazin-3-yl,

1,2,5,6-tetrahydropyridazin-4-yl,

1,2,5,6-tetrahydropyridazin-5-yl,

1,2,5,6-tetrahydropyridazin-6-yl,

1,2,3,6-tetrahydropyridazin-3-yl,

1,2,3,6-tetrahydropyridazin-4-yl,

4H-5,6-dihydro-1,3-oxazin-2-yl,

4H-5,6-dihydro-1,3-oxazin-4-yl,

4H-5,6-dihydro-1,3-oxazin-5-yl,

4H-5,6-dihydro-1,3-oxazin-6-yl,

4H-5,6-dihydro-1,3-thiazin-2-yl,

4H-5,6-dihydro-1,3-thiazin-4-yl,

4H-5,6-dihydro-1,3-thiazin-5-yl,

4H-5,6-dihydro-1,3-thiazin-6-yl,

3,4,5,6-tetrahydropyrimidin-2-yl,

3,4,5,6-tetrahydropyrimidin-4-yl,

3,4,5,6-tetrahydropyrimidin-5-yl,

3,4,5,6-tetrahydropyrimidin-6-yl,

1,2,3,4-tetrahydropyrazin-2-yl,

1,2,3,4-tetrahydropyrazin-5-yl,

1,2,3,4-tetrahydropyrimidin-2-yl,

1,2,3,4-tetrahydropyrimidin-4-yl,

1,2,3,4-tetrahydropyrimidin-5-yl,

1,2,3,4-tetrahydropyrimidin-6-yl,

2,3-dihydro-1,4-thiazin-2-yl, 2,3-dihydro-1,4-thiazin-3-yl,

2,3-dihydro-1,4-thiazin-5-yl, 2,3-dihydro-1,4-thiazin-6-yl,

2H-1,2-oxazin-3-yl, 2H-1,2-oxazin-4-yl, 2H-1,2-oxazin-5-yl,

2H-1,2-oxazin-6-yl, 2H-1,2-thiazin-3-yl, 2H-1,2-thiazin-4-yl,

2H-1,2-thiazin-5-yl, 2H-1,2-thiazin-6-yl, 4H-1,2-oxazin-3-yl,

4H-1,2-oxazin-4-yl, 4H-1,2-oxazin-5-yl, 4H-1,2-oxazin-6-yl,

4H-1,2-thiazin-3-yl, 4H-1,2-thiazin-4-yl,

4H-1,2-thiazin-5-yl, 4H-1,2-thiazin-6-yl, 6H-1,2-oxazin-3-yl,

6H-1,2-oxazin-4-yl, 6H-1,2-oxazin-5-yl, 6H-1,2-oxazin-6-yl,

6H-1,2-thiazin-3-yl, 6H-1,2-thiazin-4-yl,

6H-1,2-thiazin-5-yl, 6H-1,2-thiazin-6-yl, 2H-1,3-oxazin-2-yl,

2H-1,3-oxazin-4-yl, 2H-1,3-oxazin-5-yl, 2H-1,3-oxazin-6-yl,

2H-1,3-thiazin-2-yl, 2H-1,3-thiazin-4-yl,

2H-1,3-thiazin-5-yl, 2H-1,3-thiazin-6-yl, 4H-1,3-oxazin-2-yl,

4H-1,3-oxazin-4-yl, 4H-1,3-oxazin-5-yl, 4H-1,3-oxazin-6-yl,

4H-1,3-thiazin-2-yl, 4H-1,3-thiazin-4-yl,

4H-1,3-thiazin-5-yl, 4H-1,3-thiazin-6-yl, 6H-1,3-oxazin-2-yl,

6H-1,3-oxazin-4-yl, 6H-1,3-oxazin-5-yl, 6H-1,3-oxazin-6-yl,

6H-1,3-thiazin-2-yl, 6H-1,3-oxazin-4-yl, 6H-1,3-oxazin-5-yl,

6H-1,3-thiazin-6-yl, 2H-1,4-oxazin-2-yl, 2H-1,4-oxazin-3-yl,

2H-1,4-oxazin-5-yl, 2H-1,4-oxazin-6-yl, 2H-1,4-thiazin-2-yl,

2H-1,4-thiazin-3-yl, 2H-1,4-thiazin-5-yl,

2H-1,4-thiazin-6-yl, 4H-1,4-oxazin-2-yl, 4H-1,4-oxazin-3-yl,

4H-1,4-thiazin-2-yl, 4H-1,4-thiazin-3-yl,

1,4-dihydropyridazin-3-yl, 1,4-dihydropyridazin-4-yl,

1,4-dihydropyridazin-5-yl, 1,4-dihydropyridazin-6-yl,

1,4-dihydropyrazin-2-yl, 1,2-dihydropyrazin-2-yl,

1,2-dihydropyrazin-3-yl, 1,2-dihydropyrazin-5-yl,

1,2-dihydropyrazin-6-yl, 1,4-dihydropyrimidin-2-yl,

1,4-dihydropyrimidin-4-yl, 1,4-dihydropyrimidin-5-yl,

1,4-dihydropyrimidin-6-yl, 3,4-dihydropyrimidin-2-yl,

3,4-dihydropyrimidin-4-yl, 3,4-dihydropyrimidin-5-yl,

3,4-dihydropyrimidin-6-yl, pyridazin-3-yl, pyridazin-4-yl,

pyrimidin-2-yl, pyrimidin-4-yl, pyrimidin-5-yl, pyrazin-2-yl,

1,3,5-triazin-2-yl, 1,2,4-triazin-3-yl, 1,2,4-triazin-5-yl,

1,2,4-triazin-6-yl or 1,2,4,5-tetrazin-3-yl;

+P2

N-bonded 5-membered rings such as:

tetrahydropyrrol-1-yl, 2,3-dihydro-1H-pyrrol-1-yl,

2,5-dihydro-1H-pyrrol-1-yl, pyrrol-1-yl,

tetrahydropyrazol-1-yl, tetrahydroisoxazol-2-yl,

tetrahydroisothiazol-2-yl, tetrahydroimidazol-1-yl,

tetrahydrooxazol-3-yl, tetrahydrothiazol-3-yl,

4,5-dihydro-1H-pyrazol-1-yl, 2,5-dihydro-1H-pyrazol-1-yl,

2,3-dihydro-1H-pyrazol-1-yl, 2,5-dihydroisoxazol-2-yl,

2,3-dihydroisoxazol-2-yl, 2,5-dihydroisothiazol-2-yl,

2,3-dihydroisoxazol-2-yl, 4,5-dihydro-1H-imidazol-1-yl,

2,5-dihydro-1H-imidazol-1-yl, 2,3-dihydro-1H-imidazol-1-yl,

2,3-dihydrooxazol-3-yl, 2,3-dihydrothiazol-3-yl,

pyrazol-1-yl, imidazol-1-yl, 1,2,4-Δ⁴-oxadiazolin-2-yl,

1,2,4-Δ²-oxadiazolin-4-yl, 1,2,4-Δ³-oxadiazolin-2-yl,

1,3,4-Δ²-oxadiazolin-4-yl, 1,2,4-Δ⁵-thiadiazolin-2-yl,

1,2,4-Δ³-thiadiazolin-2-yl, 1,2,4-Δ²-thiadiazolin-4-yl,

1,3,4-Δ²-thiadiazolin-4-yl, 1,2,3-Δ²-triazolin-1-yl,

1,2,4-Δ²-triazolin-1-yl, 1,2,4-Δ²-triazolin-4-yl,

1,2,4-Δ³-triazolin-1-yl, 1,2,4-Δ¹-triazolin-4-yl,

1,2,3-triazol-1-yl, 1,2,4-triazol-1-yl, tetrazol-1-yl;

N-bonded 6-membered rings such as:

piperidin-1-yl, 1,2,3,4-tetrahydropyridin-1-yl,

1,2,5,6-tetrahydropyridin-1-yl, 1,4-dihydropyridin-1-yl,

1,2-dihydropyridin-1-yl, hexahydropyrimidin-1-yl,

hexahydropyrazin-1-yl, hexahydropyridazin-1-yl,

tetrahydro-1,3-oxazin-3-yl, tetrahydro-1,3-thiazin-3-yl,

tetrahydro-1,4-thiazin-4-yl, tetrahydro-1,4-oxazin-4-yl

(morpholinyl), tetrahydro-1,2-oxazin-2-yl,

2H-5,6-dihydro-1,2-oxazin-2-yl,

2H-5,6-dihydro-1,2-thiazin-2-yl,

2H-3,6-dihydro-1,2-oxazin-2-yl,

2H-3,6-dihydro-1,2-thiazin-2-yl,

2H-3,4-dihydro-1,2-thiazin-2-yl,

2,3,4,5-tetrahydropyridazin-2-yl,

1,2,5,6-tetrahydropyridazin-1-yl,

1,2,5,6-tetrahydropyridazin-2-yl,

1,2,3,6-tetrahydropyridazin-1-yl,

3,4,5,6-tetrahydropyrimidin-3-yl,

1,2,3,4-tetrahydropyrazin-1-yl,

1,2,3,4-tetrahydropyrimidin-1-yl,

1,2,3,4-tetrahydropyrimidin-3-yl,

2,3-dihydro-1,4-thiazin-4-yl, 2H-1,2-oxazin-2-yl,

2H-1,2-thiazin-2-yl, 4H-1,4-oxazin-4-yl, 4H-1,4-thiazin-4-yl,

1,4-dihydropyridazin-1-yl, 1,4-dihydropyrazin-1-yl,

1,2-dihydropyrazin-1-yl, 1,4-dihydropyrimidin-1-yl or

3,4-dihydropyrimidin-3-yl;

and also N-bonded cyclic imides such as:

phthalimide, tetrahydrophthalimide, succinimide, maleimide,

glutarimide, 5-oxotriazolin-1-yl,

5-oxo-1,3,4-oxadiazolin-4-yl or

2,4-dioxo(1H,3H)pyrimidin-3-yl;

where, if appropriate, the sulfur of the heterocycles mentioned may be oxidized to S═O or S(═O)₂

and where a bicyclic ring system may be formed with a fused-on phenyl ring or with a C₃-C₆-carbocycle or with a further 5- to 6-membered heterocycle.

All phenyl rings or heterocyclyl radicals and all phenyl components in phenoxy, phenylalkyl, phenylcarbonylalkyl, phenylcarbonyl, phenylalkenylcarbonyl, phenoxycarbonyl, phenyloxythiocarbonyl, phenylaminocarbonyl and N-alkyl-N-phenylaminocarbonyl, phenylsulfonyl or phenoxysulfonyl or heterocyclyl components in heterocyclyloxy, heterocyclylalkyl, heterocyclylcarbonylalkyl, heterocyclylcarbonyl, heterocyclyloxythiocarbonyl, heterocyclylalkenylcarbonyl, heterocyclyloxycarbonyl, heterocyclylaminocarbonyl, N-alkyl-N-heterocyclylaminocarbonyl, heterocyclylsulfonyl or heterocyclyloxysulfonyl are, unless stated otherwise, preferably unsubstituted, or they carry one, two or three halogen atoms and/or a nitro group, a cyano radical and/or one or two methyl, trifluoromethyl, methoxy or trifluoromethoxy substituents.

With respect to the use of the compounds of the formula I according to the invention as herbicides, the variables A, R¹ to R¹⁵ preferably have the following meanings, in each case on their own or in combination:

A is S, SO₂, O or NR⁶, where R⁶ is as defined above. R⁶ is preferably not hydrogen. R⁶ is in particular C₁-C₄-alkyl and very particularly preferably methyl. In a first group of particularly preferred compounds I, A is O or NR⁶, where R⁶ is as defined above. In another group of particularly preferred compounds, A is S or SO₂.

R¹ is halogen, C₁-C₄-alkyl, C₁-C₄-alkoxy, in particular methyl, methoxy or chlorine.

R² has the abovementioned meanings other than hydrogen, and is in particular

C₁-C₄-alkyl, C₁-C₄-haloalkyl, hydroxyl, C₁-C₄-alkoxy,

C₁-C₄-alkylsulfonyl, C₁-C₄-haloalkylsulfonyl, hydroxycarbonyl-C₁-C₄-alkyl, C(═N—O(—C₁-C₄-alkyl) )-(C₁-C₄-alkyl), NH₂,

C₁-C₄-alkylamino, di(C₁-C₄-alkyl)amino, phenyl, phenylcarbonyl or benzyl, where the phenyl rings of the three lastmentioned substituents may be substituted by one or two halogen atoms, methoxy groups or methyl groups, cyano, C₁-C₄-alkylcarbonyl,

C₁-C₄-haloalkylcarbonyl, C₁-C₄-alkoxycarbonyl,

C₁-C₄-alkoxycarbonyl-C₁-C₄-alkyl, C₃-C₆-alkenyl, C₃-C₆-alkynyl,

1,3-dioxolan-2-yl, 1,3-dithiolan-2-yl, 1,3-dioxan-2-yl,

1,3-dithian-2-yl, oxazolin-2-yl, oxazolidin-2-yl,

4,5-dihydroisoxazol-3-yl, 4,5-dihydroisoxazol-4-yl,

isoxazol-3-yl, isoxazol-4-yl, methyl or ethyl substituted by one of the heterocycles mentioned above, such as in

(1,3-dioxolan-2-yl)methyl, (1,3-dithiolan-2-yl)methyl,

(1,3-dioxan-2-yl)methyl, (1,3-dithian-2-yl)methyl,

(oxazolin-2-yl)methyl, (oxazolidin-2-yl)methyl,

(4,5-dihydroisoxazol-3-yl)methyl,

(4,5-dihydroisoxazol-4-yl)methyl, (isoxazol-3-yl)methyl,

(isoxazol-4-yl)methyl, 2-(1,3-dioxolan-2-yl)ethyl,

2-(1,3-dithiolan-2-yl)ethyl, 2-(1,3-dioxan-2-yl)ethyl,

2-(1,3-dithian-2-yl)ethyl, 2-(oxazolin-2-yl)ethyl,

2-(oxazolidin-2-yl)ethyl, 2-(4,5-dihydroisoxazol-3-yl)ethyl,

(4,5-dihydroisoxazol-4-yl)ethyl, 2-(isoxazol-3-yl)ethyl,

2-(isoxazol-4-yl)ethyl, where the abovementioned heterocycles may be mono-, di- or trisubstituted by C₁-C₄-alkyl, in particular methyl;

and is especially C₁-C₄-alkyl, C₃-C₆-alkenyl, methoxymethyl, CF₃, CHF₂, CN, OH, OCH₃, NH₂, NHCH₃, N(CH₃)₂, C₁-C₄-alkoxycarbonyl, acetyl, trifluoroacetyl, C(═NOCH₃)CH₃, SO₂CH₃, SO₂CF₃, CH₂CO₂H, C₁-C₄-alkoxycarbonyl-C₁-C₄-alkyl, cyclopropyl, cyclopentyl, cyclohexyl, 4,5-dihydroisoxazol-3-yl, 4,5-dihydroisoxazol-4-yl, isoxazol-3-yl, isoxazol-4-yl, where the abovementioned heterocycles may be monosubstituted by methyl, is phenyl, benzyl, benzoyl, 2-pyridyl.

R² is particularly preferably C₁-C₄-alkyl or C₃-C₆-alkenyl. Particular preference is also given to those compounds I in which R² is C₃-C₆-alkynyl, (1,3-dioxolan-2-yl)methyl, 2-(1,3-dioxolan-2-yl)ethyl or benzyl where the phenyl ring may be unsubstituted or carry 1 or 2 substituents, selected from the group consisting of halogen, methyl and methoxy.

R³ is C₁-C₄-alkyl, halogen and in particular hydrogen.

In especially prefered compounds I, A is O or S, R¹ is methyl, R³ is hydrogen and R³ is a substituent different from hydrogen, in particular one of the substituents mentioned above as being preferred and specifically C₁-C₆-alkyl, C₃-C₆-alkynyl, C₃-C₆-alkenyl, (1,3-dioxolan-2-yl)methyl, 2-(1,3-dioxolan-2-yl)ethyl or benzyl where the phenyl ring may be unsubstituted or may carry 1 or 2 substituents selected from the group consisting of halogen, methyl and methoxy.

R⁷ is hydroxyl, halogen, OR¹⁰, SR¹⁰, SO₂R¹¹, OSO₂R¹¹, NR¹⁴R¹⁵, ONR¹⁴R¹⁵ or N-bonded heterocyclyl which may be partially or fully halogenated and/or may carry one, two or three of the following radicals: nitro, cyano, C₁-C₄-alkyl,

C₁-C₄-haloalkyl, C₁-C₄-alkoxy or C₁-C₄-haloalkoxy; in particular hydroxyl, OR¹⁰ and OSO₂R¹¹, especially hydroxyl,

C₁-C₄-alkyloxy, O—CH₂-phenyl, phenylcarbonyloxy, 2-, 3- or

4-fluorophenylcarbonyloxy, cyclopropylcarbonyloxy,

C₁-C₄-sulfonyloxy, phenylsulfonyloxy and 2-, 3- or

4-methylphenylsulfonyloxy;

R⁸ is C₁-C₆-alkyl, C₃-C₆-cycloalkyl, in particular C₁-C₄-alkyl and cyclopropyl; and

R⁹ is hydrogen or C₁-C₄-alkyl, in particular hydrogen or C₁-C₄-alkyl.

An important group of compounds are those compounds in which R⁸ is a C₃-C₆-cycloalkyl group, in particular if A is S, SO or SO₂.

Among the pyrazolyl derivatives of the formula I mentioned as being preferred, preference is in turn given to those compounds in which Pz in formula I is a group of the formula IIa. Amongst these, in turn, particular preference is given to compounds of the formula I in which the variables R⁷, R⁸ and R⁹ in formula IIa on their own and particularly preferably in combination with one another have the following meanings:

R⁷ is hydroxyl, halogen, OR¹⁰, SR¹⁰, SO₂R¹¹, OSO₂R¹¹, NR¹⁴R¹⁵, ONR¹⁴R¹⁵ or N-bonded heterocyclyl which may be partially or fully halogenated and/or may carry one, two or three of the following radicals: nitro, cyano, C₁-C₄-alkyl,

C₁-C₄-haloalkyl, C₁-C₄-alkoxy or C₁-C₄-haloalkoxy, in particular hydroxyl, OR¹⁰ and OSO₂R¹¹;

R⁸ is C₁-C₄-alkyl, C₃-C₆-cycloalkyl; in particular cyclopropyl;

R⁹ is hydrogen or C₁-C₄-alkyl.

Among the compounds of the formula I in which Pz is a pyrazolyl radical of the formula IIa, very particular preference is given to those compounds in which the variables R⁷, R⁸ and R⁹ together have the following meanings:

R⁷ is hydroxyl, C₁-C₄-alkyloxy, acetoxy, O—CH₂-phenyl,

phenylcarbonyloxy, 2-, 3- or 4-fluorophenylcarbonyloxy,

cyclopropylcarbonyloxy, C₁-C₄-sulfonyloxy, phenylsulfonyloxy

and 2-, 3- or 4-methylphenylsulfonyloxy;

R⁸ is C₁-C₄-alkyl or cyclopropyl and

R⁹ is hydrogen or C₁-C₄-alkyl.

Examples of particularly preferred radicals of the formula IIa are the radicals IIa1 to IIa90 listed in Table 1.

TABLE 1

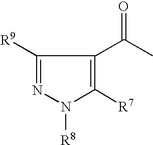

| IIa | R⁷ | R⁸ | R⁹ |
|---|---|---|---|
| IIa1 | OH | CH₃ | H |
| IIa2 | OCH₃ | CH₃ | H |
| IIa3 | OCH₂—C₆H₅ | CH₃ | H |
| IIa4 | OC(O)CH₃ | CH₃ | H |
| IIa5 | OC(O)C₆H₅ | CH₃ | H |
| IIa6 | OC(O)-(3-C₆H₄F) | CH₃ | H |
| IIa7 | OS(O)₂CH₃ | CH₃ | H |
| IIa8 | OS(O)₂-(4-C₆H₄CH₃) | CH₃ | H |
| IIa9 | OH | C₂H₅ | H |
| IIa10 | OCH₃ | C₂H₅ | H |
| IIa11 | OCH₂—C₆H₅ | C₂H₅ | H |
| IIa12 | OC(O)CH₃ | C₂H₅ | H |
| IIa13 | OC(O)C₆H₅ | C₂H₅ | H |
| IIa14 | OC(O)-(3-C₆H₄F) | C₂H₅ | H |
| IIa15 | OS(O)₂CH₃ | C₂H₅ | H |
| IIa16 | OS(O)₂-(4-C₆H₄CH₃) | C₂H₅ | H |
| IIa17 | OH | i-C₃H₇ | H |
| IIa18 | OCH₃ | i-C₃H₇ | H |
| IIa19 | OCH₂—C₆H₅ | i-C₃H₇ | H |
| IIa20 | OC(O)CH₃ | i-C₃H₇ | H |
| IIa21 | OC(O)C₆H₅ | i-C₃H₇ | H |
| IIa22 | OC(O)-(3-C₆H₄F) | i-C₃H₇ | H |
| IIa23 | OS(O)₂CH₃ | i-C₃H₇ | H |
| IIa24 | OS(O)₂-(4-C₆H₄CH₃) | i-C₃H₇ | H |
| IIa25 | OH | t-C₄H₉ | H |
| IIa26 | OCH₃ | t-C₄H₉ | H |
| IIa27 | OCH₂—C₆H₅ | t-C₄H₉ | H |
| IIa28 | OC(O)CH₃ | t-C₄H₉ | H |
| IIa29 | OC(O)C₆H₅ | t-C₄H₉ | H |
| IIa30 | OC(O)-(3-C₆H₄F) | t-C₄H₉ | H |
| IIa31 | OS(O)₂CH₃ | t-C₄H₉ | H |
| IIa32 | OS(O)₂-(4-C₆H₄CH₃) | t-C₄H₉ | H |
| IIa33 | OH | CH₃ | CH₃ |
| IIa34 | OCH₃ | CH₃ | CH₃ |
| IIa35 | OCH₂—C₆H₅ | CH₃ | CH₃ |
| IIa36 | OC(O)CH₃ | CH₃ | CH₃ |
| IIa37 | OC(O)C₆H₅ | CH₃ | CH₃ |
| IIa38 | OC(O)-(3-C₆H₄F) | CH₃ | CH₃ |
| IIa39 | OS(O)₂CH₃ | CH₃ | CH₃ |
| IIa40 | OS(O)₂-(4-C₆H₄CH₃) | CH₃ | CH₃ |
| IIa41 | OH | C₂H₅ | CH₃ |
| IIa42 | OCH₃ | C₂H₅ | CH₃ |
| IIa43 | OCH₂—C₆H₅ | C₂H₅ | CH₃ |
| IIa44 | OC(O)CH₃ | C₂H₅ | CH₃ |
| IIa45 | OC(O)C₆H₅ | C₂H₅ | CH₃ |
| IIa46 | OC(O)-(3-C₆H₄F) | C₂H₅ | CH₃ |
| IIa47 | OS(O)₂CH₃ | C₂H₅ | CH₃ |
| IIa48 | OS(O)₂-(4-C₆H₄CH₃) | C₂H₅ | CH₃ |
| IIa49 | OH | i-C₃H₇ | CH₃ |
| IIa50 | OCH₃ | i-C₃H₇ | CH₃ |
| IIa51 | OCH₂—C₆H₅ | i-C₃H₇ | CH₃ |
| IIa52 | OC(O)CH₃ | i-C₃H₇ | CH₃ |
| IIa53 | OC(O)C₆H₅ | i-C₃H₇ | CH₃ |
| IIa54 | OC(O)-(3-C₆H₄F) | i-C₃H₇ | CH₃ |
| IIa55 | OS(O)₂CH₃ | i-C₃H₇ | CH₃ |
| IIa56 | OS(O)₂(4-C₆H₄CH₃) | i-C₃H₇ | CH₃ |
| IIa57 | OH | t-C₄H₉ | CH₃ |
| IIa58 | OCH₃ | t-C₄H₉ | CH₃ |
| IIa59 | OCH₂—C₆H₅ | t-C₄H₉ | CH₃ |
| IIa60 | OC(O)CH₃ | t-C₄H₉ | CH₃ |
| IIa61 | OC(O)C₆H₅ | t-C₄H₉ | CH₃ |
| IIa62 | OC(O)-(3-C₆H₄F) | t-C₄H₉ | CH₃ |
| IIa63 | OS(O)₂CH₃ | t-C₄H₉ | CH₃ |
| IIa64 | OS(O)₂-(4-C₆H₄CH₃) | t-C₄H₉ | CH₃ |
| IIa65 | OH | c-C₃H₅ | CH₃ |
| IIa66 | OCH₃ | c-C₃H₅ | CH₃ |
| IIa67 | OCH₂—C₆H₅ | c-C₃H₅ | CH₃ |
| IIa68 | OC(O)CH₃ | c-C₃H₅ | CH₃ |
| IIa69 | OC(O)C₆H₅ | c-C₃H₅ | CH₃ |
| IIa70 | OC(O)-(3-C₆H₄F) | c-C₃H₅ | CH₃ |
| IIa71 | OS(O)₂CH₃ | c-C₃H₅ | CH₃ |
| IIa72 | OS(O)₂-(4-C₆H₄CH₃) | c-C₃H₅ | CH₃ |
| IIa73 | OH | c-C₃H₅ | H |
| IIa74 | OCH₃ | c-C₃H₅ | H |
| IIa75 | OCH₂—C₆H₅ | c-C₃H₅ | H |
| IIa76 | OC(O)CH₃ | c-C₃H₅ | H |
| IIa77 | OC(O)C₆H₅ | c-C₃H₅ | H |
| IIa78 | OC(O)-(3-C₆H₄F) | c-C₃H₅ | H |
| IIa79 | OS(O)₂CH₃ | c-C₃H₅ | H |
| IIa80 | OS(O)₂-(4-C₆H₄CH₃) | c-C₃H₅ | H |
| IIa81 | OC(O)c-C₃H₅ | CH₃ | H |
| IIa82 | OC(O)-c-C₃H₅ | C₂H₅ | H |
| IIa83 | OC(O)-c-C₃H₅ | i-C₃H₇ | H |
| IIa84 | OC(O)-c-C₃H₅ | t-C₄H₉ | H |
| IIa85 | OC(O)-c-C₃H₅ | c-C₃H₅ | H |
| IIa86 | OC(O)-c-C₃H₅ | CH₃ | CH₃ |
| IIa87 | OC(O)-c-C₃H₅ | C₂H₅ | CH₃ |
| IIa88 | OC(O)-c-C₃H₅ | i-C₃H₇ | CH₃ |
| IIa89 | OC(O)-c-C₃H₅ | t-C₄H₉ | CH₃ |
| IIa90 | OC(O)-c-C₃H₅ | c-C₃H₅ | CH₃ |

i-C₃H₇: isopropyl
c-C₃H₅: cyclopropyl
t-C₄H₉: tertiary butyl
C₆H₅: phenyl
3-C₆H₄F: 3-fluorophenyl
4-C₆H₄CH₃: 4-methylphenyl

Examples of compounds of the formula I which are particularly preferred according to the invention are the benzazolonylcarbonylpyrazoles I listed in Tables 2 to 25 below, where R¹, R², R³ and A in each case have the meanings given in one row of Table A.

TABLE 2
Compounds I-1a.1 to I-1a.3960

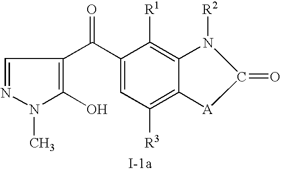

TABLE 3
Compounds I-1b.1 to I-1b.3960

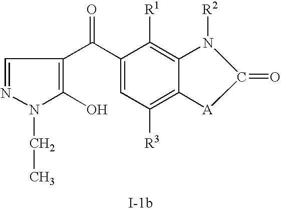

TABLE 4
Compounds I-1c.1 to I-1c.3960

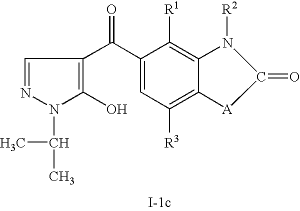

TABLE 5
Compounds I-1d.1 to I-1d.3960

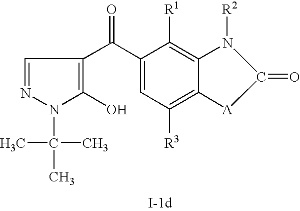

TABLE 6
Compounds I-1e.1 to I-1e.3960

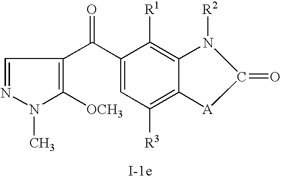

TABLE 7
Compounds I-1f.1 to I-1f.3960

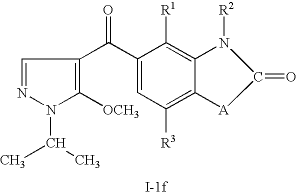

TABLE 8
Compounds I-1g.1 to I-1g.3960

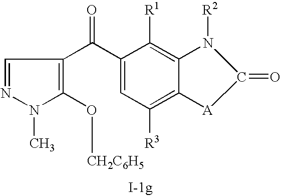

TABLE 9
Compounds I-1h.1 to I-1h.3960

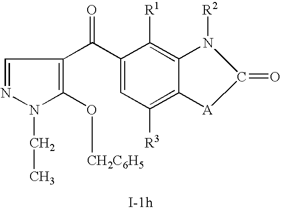

TABLE 10
Compounds I-1i.1 to I-1i.3960

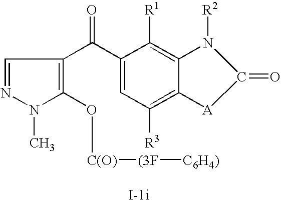

TABLE 11
Compounds I-1k.1 to I-1k.3960

| | |
|---|---|
| | I-1k |
| 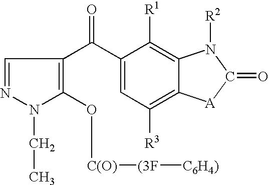 | |

TABLE 12
Compounds I-1l.1 to I-1l.3960

| | |
|---|---|
| | I-1l |
| 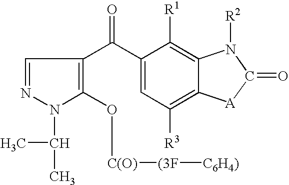 | |

TABLE 13
Compounds I-1m.1 to I-1m.3960

| | |
|---|---|
| | I-1m |
| 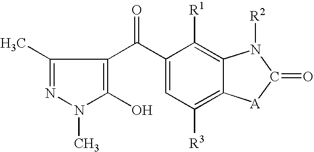 | |

TABLE 14
Compounds I-1n.1 to I-1n.3960

| | |
|---|---|
| | I-1n |
| 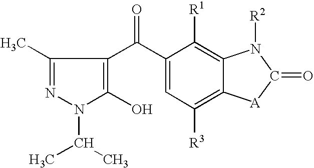 | |

TABLE 15
Compounds I-1o.1 to I-1o.3960

| | |
|---|---|
| | I-1o |
| 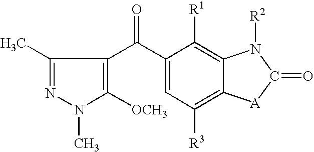 | |

TABLE 16
Compounds I-1p.1 to I-1p.3960

| | |
|---|---|
| | I-1p |
| 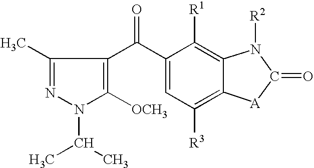 | |

TABLE 17
Compounds I-1q.1 to I-1q.3960

| | |
|---|---|
| | I-1q |
| 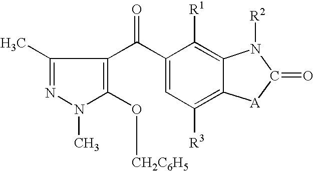 | |

TABLE 18
Compounds I-1r.1 to I-1r.3960

| | |
|---|---|
| | I-1r |
| 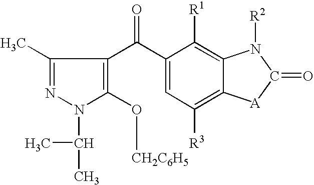 | |

TABLE 19
Compounds I-1s.1 to I-1s.3960

| | |
|---|---|
| | I-1s |
| 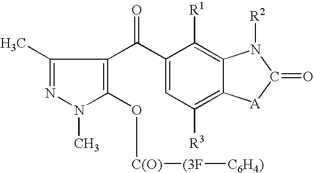 | |

TABLE 20
Compounds I-1t.1 to I-1t.3960

| | |
|---|---|
| | I-1t |
| 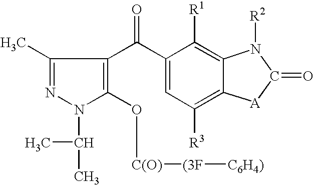 | |

TABLE 21
Compounds I-1u.1 to I-1u.3960

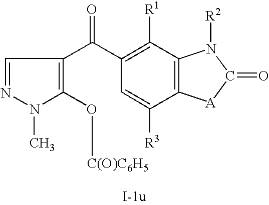

TABLE 22
Compounds I-1v.1 to I-1v.3960

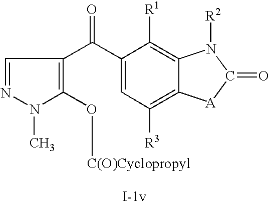

Table 23
Compounds I-1w.1 to I-1w.3960

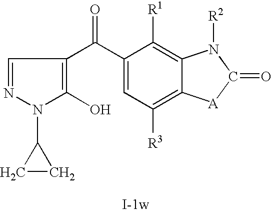

TABLE 24
Compounds I-1x.1 to I-1x.3960

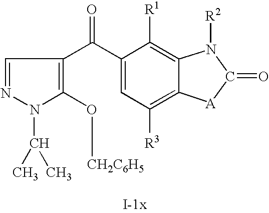

TABLE 25
Compounds I-1y.1 to I-1y.3960

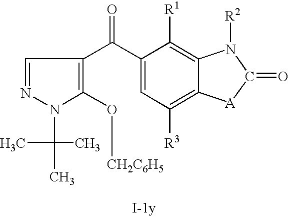

TABLE A
Particularly preferred combinations of R¹, R², R³ and A

| No. | R¹ | R² | R³ | A |
|---|---|---|---|---|
| 1 | CH₃ | H | H | O |
| 2 | CH₃ | CH₃ | H | O |
| 3 | CH₃ | C₂H₅ | H | O |
| 4 | CH₃ | n-C₃H₇ | H | O |
| 5 | CH₃ | i-C₃H₇ | H | O |
| 6 | CH₃ | n-C₄H₉ | H | O |
| 7 | CH₃ | i-C₄H₉ | H | O |
| 8 | CH₃ | s-C₄H₉ | H | O |
| 9 | CH₃ | t-C₄H₉ | H | O |
| 10 | CH₃ | CH₂OCH₃ | H | O |
| 11 | CH₃ | CF₃ | H | O |
| 12 | CH₃ | CF₂H | H | O |
| 13 | CH₃ | CN | H | O |
| 14 | CH₃ | OH | H | O |
| 15 | CH₃ | OCH₃ | H | O |
| 16 | CH₃ | NH₂ | H | O |
| 17 | CH₃ | NHCH₃ | H | O |
| 18 | CH₃ | N(CH₃)₂ | H | O |
| 19 | CH₃ | CO₂CH₃ | H | O |
| 20 | CH₃ | CO₂C₂H₅ | H | O |
| 21 | CH₃ | C(O)CH₃ | H | O |
| 22 | CH₃ | C(O)CF₃ | H | O |
| 23 | CH₃ | C(═NOCH₃)CH₃ | H | O |
| 24 | CH₃ | SO₂CH₃ | H | O |
| 25 | CH₃ | SO₂CF₃ | H | O |
| 26 | CH₃ | CH₂CO₂H | H | O |
| 27 | CH₃ | CH₂COOCH₃ | H | O |
| 28 | CH₃ | CH₂COOC₂H₅ | H | O |
| 29 | CH₃ | prop-1-en-3-yl | H | O |
| 30 | CH₃ | trans-but-2-en-1-yl | H | O |
| 31 | CH₃ | cis-but-2-en-1-yl | H | O |
| 32 | CH₃ | cis-3-methyl- | H | O |
| | | but-2-en-1-yl | | |
| 33 | CH₃ | cyclopropyl | H | O |
| 34 | CH₃ | cyclopentyl | H | O |
| 35 | CH₃ | cyclohexyl | H | O |
| 36 | CH₃ | 4,5-dihydroisoxazol- | H | O |
| | | 3-yl | | |
| 37 | CH₃ | 4-methyl-4,5-dihydroisoxazol- | H | O |
| | | 3-yl | | |
| 38 | CH₃ | isoxazol-3-yl | H | O |
| 39 | CH₃ | 4-methylisoxazol-3-yl | H | O |
| 40 | CH₃ | 4,5-dihydroisoxazol- | H | O |
| | | 4-yl | | |
| 41 | CH₃ | 3-methyl-4,5-dihydroisoxazol- | H | O |
| | | 4-yl | | |
| 42 | CH₃ | isoxazol-4-yl | H | O |
| 43 | CH₃ | 3-methylisoxazol-4-yl | H | O |
| 44 | CH₃ | phenyl | H | O |
| 45 | CH₃ | benzyl | H | O |
| 46 | CH₃ | benzoyl | H | O |
| 47 | CH₃ | 2-pyridyl | H | O |
| 48 | CH₃ | H | CH₃ | O |
| 49 | CH₃ | CH₃ | CH₃ | O |
| 50 | CH₃ | C₂H₅ | CH₃ | O |
| 51 | CH₃ | n-C₃H₇ | CH₃ | O |
| 52 | CH₃ | i-C₃H₇ | CH₃ | O |
| 53 | CH₃ | n-C₄H₉ | CH₃ | O |
| 54 | CH₃ | i-C₄H₉ | CH₃ | O |
| 55 | CH₃ | s-C₄H₉ | CH₃ | O |
| 56 | CH₃ | t-C₄H₉ | CH₃ | O |
| 57 | CH₃ | CH₂OCH₃ | CH₃ | O |
| 58 | CH₃ | CF₃ | CH₃ | O |
| 59 | CH₃ | CF₂H | CH₃ | O |
| 60 | CH₃ | CN | CH₃ | O |
| 61 | CH₃ | OH | CH₃ | O |
| 62 | CH₃ | OCH₃ | CH₃ | O |
| 63 | CH₃ | NH₂ | CH₃ | O |
| 64 | CH₃ | NHCH₃ | CH₃ | O |
| 65 | CH₃ | N(CH₃)₂ | CH₃ | O |
| 66 | CH₃ | CO₂CH₃ | CH₃ | O |
| 67 | CH₃ | CO₂C₂H₅ | CH₃ | O |
| 68 | CH₃ | C(O)CH₃ | CH₃ | O |
| 69 | CH₃ | C(O)CF₃ | CH₃ | O |
| 70 | CH₃ | C(═NOCH₃)CH₃ | CH₃ | O |
| 71 | CH₃ | SO₂CH₃ | CH₃ | O |
| 72 | CH₃ | SO₂CF₃ | CH₃ | O |
| 73 | CH₃ | CH₂CO₂H | CH₃ | O |
| 74 | CH₃ | CH₂COOCH₃ | CH₃ | O |
| 75 | CH₃ | CH₂COOC₂H₅ | CH₃ | O |
| 76 | CH₃ | prop-1-en-3-yl | CH₃ | O |
| 77 | CH₃ | trans-but-2-en-1-yl | CH₃ | O |
| 78 | CH₃ | cis-but-2-en-1-yl | CH₃ | O |
| 79 | CH₃ | cis-3-methyl- | CH₃ | O |
| | | but-2-en-1-yl | | |
| 80 | CH₃ | cyclopropyl | CH₃ | O |
| 81 | CH₃ | cyclopentyl | CH₃ | O |
| 82 | CH₃ | cyclohexyl | CH₃ | O |
| 83 | CH₃ | 4,5-dihydroisoxazol- | CH₃ | O |
| | | 3-yl | | |
| 84 | CH₃ | 4-methyl-4,5-dihydroisoxazol- | CH₃ | O |
| | | 3-yl | | |
| 85 | CH₃ | isoxazol-3-yl | CH₃ | O |
| 86 | CH₃ | 4-methylisoxazol-3-yl | CH₃ | O |
| 87 | CH₃ | 4,5-dihydroisoxazol- | CH₃ | O |
| | | 4-yl | | |
| 88 | CH₃ | 3-methyl-4,5-dihydroisoxazol- | CH₃ | O |
| | | 4-yl | | |
| 89 | CH₃ | isoxazol-4-yl | CH₃ | O |
| 90 | CH₃ | 3-methylisoxazol-4-yl | CH₃ | O |
| 91 | CH₃ | phenyl | CH₃ | O |
| 92 | CH₃ | benzyl | CH₃ | O |
| 93 | CH₃ | benzoyl | CH₃ | O |
| 94 | CH₃ | 2-pyridyl | CH₃ | O |
| 95 | CH₃ | H | Cl | O |
| 96 | CH₃ | CH₃ | Cl | O |
| 97 | CH₃ | C₂H₅ | Cl | O |
| 98 | CH₃ | n-C₃H₇ | Cl | O |
| 99 | CH₃ | i-C₃H₇ | Cl | O |
| 100 | CH₃ | n-C₄H₉ | Cl | O |
| 101 | CH₃ | i-C₄H₉ | Cl | O |
| 102 | CH₃ | s-C₄H₉ | Cl | O |
| 103 | CH₃ | t-C₄H₉ | Cl | O |
| 104 | CH₃ | CH₂OCH₃ | Cl | O |
| 105 | CH₃ | CF₃ | Cl | O |
| 106 | CH₃ | CF₂H | Cl | O |
| 107 | CH₃ | CN | Cl | O |
| 108 | CH₃ | OH | Cl | O |
| 109 | CH₃ | OCH₃ | Cl | O |
| 110 | CH₃ | NH₂ | Cl | O |
| 111 | CH₃ | NHCH₃ | Cl | O |
| 112 | CH₃ | N(CH₃)₂ | Cl | O |
| 113 | CH₃ | CO₂CH₃ | Cl | O |
| 114 | CH₃ | CO₂C₂H₅ | Cl | O |
| 115 | CH₃ | C(O)CH₃ | Cl | O |
| 116 | CH₃ | C(O)CF₃ | Cl | O |
| 117 | CH₃ | C(═NOCH₃)CH₃ | Cl | O |
| 118 | CH₃ | SO₂CH₃ | Cl | O |
| 119 | CH₃ | SO₂CF₃ | Cl | O |
| 120 | CH₃ | CH₂CO₂H | Cl | O |
| 121 | CH₃ | CH₂COOCH₃ | Cl | O |
| 122 | CH₃ | CH₂COOC₂H₅ | Cl | O |
| 123 | CH₃ | prop-1-en-3-yl | Cl | O |
| 124 | CH₃ | trans-but-2-en-1-yl | Cl | O |
| 125 | CH₃ | cis-but-2-en-1-yl | Cl | O |
| 126 | CH₃ | cis-3-methyl- | Cl | O |
| | | but-2-en-1-yl | | |
| 127 | CH₃ | cyclopropyl | Cl | O |
| 128 | CH₃ | cyclopentyl | Cl | O |
| 129 | CH₃ | cyclohexyl | Cl | O |
| 130 | CH₃ | 4,5-dihydroisoxazol- | Cl | O |
| | | 3-yl | | |
| 131 | CH₃ | 4-methyl-4,5-dihydroisoxazol- | Cl | O |
| | | 3-yl | | |
| 132 | CH₃ | isoxazol-3-yl | Cl | O |
| 133 | CH₃ | 4-methylisoxazol-3-yl | Cl | O |
| 134 | CH₃ | 4,5-dihydroisoxazol- | Cl | O |
| | | 4-yl | | |
| 135 | CH₃ | 3-methyl-4,5-dihydroisoxazol- | Cl | O |
| | | 4-yl | | |
| 136 | CH₃ | isoxazol-4-yl | Cl | O |
| 137 | CH₃ | 3-methylisoxazol-4-yl | Cl | O |
| 138 | CH₃ | phenyl | Cl | O |
| 139 | CH₃ | benzyl | Cl | O |
| 140 | CH₃ | benzoyl | Cl | O |
| 141 | CH₃ | 2-pyridyl | Cl | O |
| 142 | Cl | H | H | O |
| 143 | Cl | CH₃ | H | O |
| 144 | Cl | C₂H₅ | H | O |
| 145 | Cl | n-C₃H₇ | H | O |
| 146 | Cl | i-C₃H₇ | H | O |
| 147 | Cl | n-C₄H₉ | H | O |
| 148 | Cl | i-C₄H₉ | H | O |
| 149 | Cl | s-C₄H₉ | H | O |
| 150 | Cl | t-C₄H₉ | H | O |
| 151 | Cl | CH₂OCH₃ | H | O |
| 152 | Cl | CF₃ | H | O |
| 153 | Cl | CF₂H | H | O |
| 154 | Cl | CN | H | O |
| 155 | Cl | OH | H | O |
| 156 | Cl | OCH₃ | H | O |
| 157 | Cl | NH₂ | H | O |
| 158 | Cl | NHCH₃ | H | O |
| 159 | Cl | N(CH₃)₂ | H | O |
| 160 | Cl | CO₂CH₃ | H | O |
| 161 | Cl | CO₂C₂H₅ | H | O |
| 162 | Cl | C(O)CH₃ | H | O |
| 163 | Cl | C(O)CF₃ | H | O |
| 164 | Cl | C(═NOCH₃)CH₃ | H | O |
| 165 | Cl | SO₂CH₃ | H | O |
| 166 | Cl | SO₂CF₃ | H | O |
| 167 | Cl | CH₂CO₂H | H | O |
| 168 | Cl | CH₂COOCH₃ | H | O |
| 169 | Cl | CH₂COOC₂H₅ | H | O |
| 170 | Cl | prop-1-en-3-yl | H | O |
| 171 | Cl | trans-but-2-en-1-yl | H | O |
| 172 | Cl | cis-but-2-en-1-yl | H | O |
| 173 | Cl | cis-3-methyl- | H | O |
| | | but-2-en-1-yl | | |
| 174 | Cl | cyclopropyl | H | O |
| 175 | Cl | cyclopentyl | H | O |
| 176 | Cl | cyclohexyl | H | O |
| 177 | Cl | 4,5-dihydroisoxazol- | H | O |
| | | 3-yl | | |
| 178 | Cl | 4-methyl-4,5-dihydroisoxazol- | H | O |
| | | 3-yl | | |
| 179 | Cl | isoxazol-3-yl | H | O |
| 180 | Cl | 4-methylisoxazol-3-yl | H | O |
| 181 | Cl | 4,5-dihydroisoxazol- | H | O |
| | | 4-yl | | |
| 182 | Cl | 3-methyl-4,5-dihydroisoxazol- | H | O |
| | | 4-yl | | |
| 183 | Cl | isoxazol-4-yl | H | O |
| 184 | Cl | 3-methylisoxazol-4-yl | H | O |
| 185 | Cl | phenyl | H | O |
| 186 | Cl | benzyl | H | O |
| 187 | Cl | benzoyl | H | O |
| 188 | Cl | 2-pyridyl | H | O |
| 189 | Cl | H | CH₃ | O |
| 190 | Cl | CH₃ | CH₃ | O |
| 191 | Cl | C₂H₅ | CH₃ | O |
| 192 | Cl | n-C₃H₇ | CH₃ | O |
| 193 | Cl | i-C₃H₇ | CH₃ | O |
| 194 | Cl | n-C₄H₉ | CH₃ | O |
| 195 | Cl | i-C₄H₉ | CH₃ | O |
| 196 | Cl | s-C₄H₉ | CH₃ | O |
| 197 | Cl | t-C₄H₉ | CH₃ | O |
| 198 | Cl | CH₂OCH₃ | CH₃ | O |
| 199 | Cl | CF₃ | CH₃ | O |
| 200 | Cl | CF₂H | CH₃ | O |
| 201 | Cl | CN | CH₃ | O |
| 202 | Cl | OH | CH₃ | O |
| 203 | Cl | OCH₃ | CH₃ | O |
| 204 | Cl | NH₂ | CH₃ | O |
| 205 | Cl | NHCH₃ | CH₃ | O |
| 206 | Cl | N(CH₃)₂ | CH₃ | O |
| 207 | Cl | CO₂CH₃ | CH₃ | O |
| 208 | Cl | CO₂C₂H₅ | CH₃ | O |
| 209 | Cl | C(O)CH₃ | CH₃ | O |
| 210 | Cl | C(O)CF₃ | CH₃ | O |
| 211 | Cl | C(═NOCH₃)CH₃ | CH₃ | O |
| 212 | Cl | SO₂CH₃ | CH₃ | O |
| 213 | Cl | SO₂CF₃ | CH₃ | O |
| 214 | Cl | CH₂CO₂H | CH₃ | O |
| 215 | Cl | CH₂COOCH₃ | CH₃ | O |
| 216 | Cl | CH₂COOC₂H₅ | CH₃ | O |
| 217 | Cl | prop-1-en-3-yl | CH₃ | O |
| 218 | Cl | trans-but-2-en-1-yl | CH₃ | O |
| 219 | Cl | cis-but-2-en-1-yl | CH₃ | O |
| 220 | Cl | cis-3-methyl- | CH₃ | O |
| | | but-2-en-1-yl | | |
| 221 | Cl | cyclopropyl | CH₃ | O |
| 222 | Cl | cyclopentyl | CH₃ | O |
| 223 | Cl | cyclohexyl | CH₃ | O |
| 224 | Cl | 4,5-dihydroisoxazol- | CH₃ | O |
| | | 3-yl | | |
| 225 | Cl | 4-methyl-4,5-dihydroisoxazol- | CH₃ | O |
| | | 3-yl | | |
| 226 | Cl | isoxazol-3-yl | CH₃ | O |
| 227 | Cl | 4-methylisoxazol-3-yl | CH₃ | O |
| 228 | Cl | 4,5-dihydroisoxazol- | CH₃ | O |
| | | 4-yl | | |
| 229 | Cl | 3-methyl-4,5-dihydroisoxazol- | CH₃ | O |
| | | 4-yl | | |
| 230 | Cl | isoxazol-4-yl | CH₃ | O |
| 231 | Cl | 3-methylisoxazol-4-yl | CH₃ | O |
| 232 | Cl | phenyl | CH₃ | O |
| 233 | Cl | benzyl | CH₃ | O |
| 234 | Cl | benzoyl | CH₃ | O |
| 235 | Cl | 2-pyridyl | CH₃ | O |
| 236 | Cl | H | Cl | O |
| 237 | Cl | CH₃ | Cl | O |
| 238 | Cl | C₂H₅ | Cl | O |
| 239 | Cl | n-C₃H₇ | Cl | O |
| 240 | Cl | i-C₃H₇ | Cl | O |
| 241 | Cl | n-C₄H₉ | Cl | O |
| 242 | Cl | i-C₄H₉ | Cl | O |
| 243 | Cl | s-C₄H₉ | Cl | O |
| 244 | Cl | t-C₄H₉ | Cl | O |
| 245 | Cl | CH₂OCH₃ | Cl | O |
| 246 | Cl | CF₃ | Cl | O |
| 247 | Cl | CF₂H | Cl | O |
| 248 | Cl | CN | Cl | O |
| 249 | Cl | OH | Cl | O |
| 250 | Cl | OCH₃ | Cl | O |
| 251 | Cl | NH₂ | Cl | O |
| 252 | Cl | NHCH₃ | Cl | O |
| 253 | Cl | N(CH₃)₂ | Cl | O |
| 254 | Cl | CO₂CH₃ | Cl | O |
| 255 | Cl | CO₂C₂H₅ | Cl | O |
| 256 | Cl | C(O)CH₃ | Cl | O |
| 257 | Cl | C(O)CF₃ | Cl | O |
| 258 | Cl | C(═NOCH₃)CH₃ | Cl | O |
| 259 | Cl | SO₂CH₃ | Cl | O |
| 260 | Cl | SO₂CF₃ | Cl | O |
| 261 | Cl | CH₂CO₂H | Cl | O |
| 262 | Cl | CH₂COOCH₃ | Cl | O |
| 263 | Cl | CH₂COOC₂H₅ | Cl | O |
| 264 | Cl | prop-1-en-3-yl | Cl | O |
| 265 | Cl | trans-but-2-en-1-yl | Cl | O |
| 266 | Cl | cis-but-2-en-1-yl | Cl | O |
| 267 | Cl | cis-3-methyl- | Cl | O |
| | | but-2-en-1-yl | | |
| 268 | Cl | cyclopropyl | Cl | O |
| 269 | Cl | cyclopentyl | Cl | O |
| 270 | Cl | cyclohexyl | Cl | O |
| 271 | Cl | 4,5-dihydroisoxazol- | Cl | O |
| | | 3-yl | | |
| 272 | Cl | 4-methyl-4,5-dihydroisoxazol- | Cl | O |
| | | 3-yl | | |
| 273 | Cl | isoxazol-3-yl | Cl | O |
| 274 | Cl | 4-methylisoxazol-3-yl | Cl | O |
| 275 | Cl | 4,5-dihydroisoxazol- | Cl | O |
| | | 4-yl | | |
| 276 | Cl | 3-methyl-4,5-dihydroisoxazol- | Cl | O |
| | | 4-yl | | |
| 277 | Cl | isoxazol-4-yl | Cl | O |
| 278 | Cl | 3-methylisoxazol-4-yl | Cl | O |
| 279 | Cl | phenyl | Cl | O |
| 280 | Cl | benzyl | Cl | O |
| 281 | Cl | benzoyl | Cl | O |
| 282 | Cl | 2-pyridyl | Cl | O |
| 283 | OCH₃ | H | H | O |
| 284 | OCH₃ | CH₃ | H | O |
| 285 | OCH₃ | C₂H₅ | H | O |
| 286 | OCH₃ | n-C₃H₇ | H | O |
| 287 | OCH₃ | i-C₃H₇ | H | O |
| 288 | OCH₃ | n-C₄H₉ | H | O |
| 289 | OCH₃ | i-C₄H₉ | H | O |
| 290 | OCH₃ | s-C₄H₉ | H | O |
| 291 | OCH₃ | t-C₄H₉ | H | O |
| 292 | OCH₃ | CH₂OCH₃ | H | O |
| 293 | OCH₃ | CF₃ | H | O |
| 294 | OCH₃ | CF₂H | H | O |
| 295 | OCH₃ | CN | H | O |
| 296 | OCH₃ | OH | H | O |
| 297 | OCH₃ | OCH₃ | H | O |
| 298 | OCH₃ | NH₂ | H | O |
| 299 | OCH₃ | NHCH₃ | H | O |
| 300 | OCH₃ | N(CH₃)₂ | H | O |
| 301 | OCH₃ | CO₂CH₃ | H | O |
| 302 | OCH₃ | CO₂C₂H₅ | H | O |
| 303 | OCH₃ | C(O)CH₃ | H | O |
| 304 | OCH₃ | C(O)CF₃ | H | O |
| 305 | OCH₃ | C(═NOCH₃)CH₃ | H | O |
| 306 | OCH₃ | SO₂CH₃ | H | O |
| 307 | OCH₃ | SO₂CF₃ | H | O |
| 308 | OCH₃ | CH₂CO₂H | H | O |
| 309 | OCH₃ | CH₂COOCH₃ | H | O |
| 310 | OCH₃ | CH₂COOC₂H₅ | H | O |
| 311 | OCH₃ | prop-1-en-3-yl | H | O |
| 312 | OCH₃ | trans-but-2-en-1-yl | H | O |
| 313 | OCH₃ | cis-but-2-en-1-yl | H | O |
| 314 | OCH₃ | cis-3-methyl- | H | O |
| | | but-2-en-1-yl | | |
| 315 | OCH₃ | cyclopropyl | H | O |
| 316 | OCH₃ | cyclopentyl | H | O |
| 317 | OCH₃ | cyclohexyl | H | O |
| 318 | OCH₃ | 4,5-dihydroisoxazol- | H | O |
| | | 3-yl | | |
| 319 | OCH₃ | 4-methyl-4,5-dihydroisoxazol- | H | O |
| | | 3-yl | | |
| 320 | OCH₃ | isoxazol-3-yl | H | O |
| 321 | OCH₃ | 4-methylisoxazol-3-yl | H | O |
| 322 | OCH₃ | 4,5-dihydroisoxazol- | H | O |
| | | 4-yl | | |
| 323 | OCH₃ | 3-methyl-4,5-dihydroisoxazol- | H | O |
| | | 4-yl | | |
| 324 | OCH₃ | isoxazol-4-yl | H | O |
| 325 | OCH₃ | 3-methylisoxazol-4-yl | H | O |
| 326 | OCH₃ | phenyl | H | O |
| 327 | OCH₃ | benzyl | H | O |
| 328 | OCH₃ | benzoyl | H | O |
| 329 | OCH₃ | 2-pyridyl | H | O |
| 330 | OCH₃ | H | CH₃ | O |
| 331 | OCH₃ | CH₃ | CH₃ | O |
| 332 | OCH₃ | C₂H₅ | CH₃ | O |
| 333 | OCH₃ | n-C₃H₇ | CH₃ | O |
| 334 | OCH₃ | i-C₃H₇ | CH₃ | O |
| 335 | OCH₃ | n-C₄H₉ | CH₃ | O |
| 336 | OCH₃ | i-C₄H₉ | CH₃ | O |
| 337 | OCH₃ | s-C₄H₉ | CH₃ | O |
| 338 | OCH₃ | t-C₄H₉ | CH₃ | O |
| 339 | OCH₃ | CH₂OCH₃ | CH₃ | O |
| 340 | OCH₃ | CF₃ | CH₃ | O |
| 341 | OCH₃ | CF₂H | CH₃ | O |
| 342 | OCH₃ | CN | CH₃ | O |
| 343 | OCH₃ | OH | CH₃ | O |
| 344 | OCH₃ | OCH₃ | CH₃ | O |
| 345 | OCH₃ | NH₂ | CH₃ | O |
| 346 | OCH₃ | NHCH₃ | CH₃ | O |
| 347 | OCH₃ | N(CH₃)₂ | CH₃ | O |
| 348 | OCH₃ | CO₂CH₃ | CH₃ | O |
| 349 | OCH₃ | CO₂C₂H₅ | CH₃ | O |
| 350 | OCH₃ | C(O)CH₃ | CH₃ | O |
| 351 | OCH₃ | C(O)CF₃ | CH₃ | O |
| 352 | OCH₃ | C(═NOCH₃)CH₃ | CH₃ | O |
| 353 | OCH₃ | SO₂CH₃ | CH₃ | O |
| 354 | OCH₃ | SO₂CF₃ | CH₃ | O |
| 355 | OCH₃ | CH₂CO₂H | CH₃ | O |
| 356 | OCH₃ | CH₂COOCH₃ | CH₃ | O |
| 357 | OCH₃ | CH₂COOC₂H₅ | CH₃ | O |
| 358 | OCH₃ | prop-1-en-3-yl | CH₃ | O |
| 359 | OCH₃ | trans-but-2-en-1-yl | CH₃ | O |
| 360 | OCH₃ | cis-but-2-en-1-yl | CH₃ | O |
| 361 | OCH₃ | cis-3-methyl- | CH₃ | O |
| | | but-2-en-1-yl | | |
| 362 | OCH₃ | cyclopropyl | CH₃ | O |
| 363 | OCH₃ | cyclopentyl | CH₃ | O |
| 364 | OCH₃ | cyclohexyl | CH₃ | O |
| 365 | OCH₃ | 4,5-dihydroisoxazol- | CH₃ | O |
| | | 3-yl | | |
| 366 | OCH₃ | 4-methyl-4,5-dihydroisoxazol- | CH₃ | O |
| | | 3-yl | | |
| 367 | OCH₃ | isoxazol-3-yl | CH₃ | O |
| 368 | OCH₃ | 4-methylisoxazol-3-yl | CH₃ | O |
| 369 | OCH₃ | 4,5-dihydroisoxazol- | CH₃ | O |
| | | 4-yl | | |
| 370 | OCH₃ | 3-methyl-4,5-dihydroisoxazol- | CH₃ | O |
| | | 4-yl | | |
| 371 | OCH₃ | isoxazol-4-yl | CH₃ | O |
| 372 | OCH₃ | 3-methylisoxazol-4-yl | CH₃ | O |
| 373 | OCH₃ | phenyl | CH₃ | O |
| 374 | OCH₃ | benzyl | CH₃ | O |
| 375 | OCH₃ | benzoyl | CH₃ | O |
| 376 | OCH₃ | 2-pyridyl | CH₃ | O |
| 377 | OCH₃ | H | Cl | O |
| 378 | OCH₃ | CH₃ | Cl | O |
| 379 | OCH₃ | C₂H₅ | Cl | O |
| 380 | OCH₃ | n-C₃H₇ | Cl | O |
| 381 | OCH₃ | i-C₃H₇ | Cl | O |
| 382 | OCH₃ | n-C₄H₉ | Cl | O |
| 383 | OCH₃ | i-C₄H₉ | Cl | O |
| 384 | OCH₃ | s-C₄H₉ | Cl | O |
| 385 | OCH₃ | t-C₄H₉ | Cl | O |
| 386 | OCH₃ | CH₂OCH₃ | Cl | O |
| 387 | OCH₃ | CF₃ | Cl | O |
| 388 | OCH₃ | CF₂H | Cl | O |
| 389 | OCH₃ | CN | Cl | O |
| 390 | OCH₃ | OH | Cl | O |
| 391 | OCH₃ | OCH₃ | Cl | O |
| 392 | OCH₃ | NH₂ | Cl | O |
| 393 | OCH₃ | NHCH₃ | Cl | O |
| 394 | OCH₃ | N(CH₃)₂ | Cl | O |
| 395 | OCH₃ | CO₂CH₃ | Cl | O |
| 396 | OCH₃ | CO₂C₂H₅ | Cl | O |
| 397 | OCH₃ | C(O)CH₃ | Cl | O |
| 398 | OCH₃ | C(O)CF₃ | Cl | O |
| 399 | OCH₃ | C(═NOCH₃)CH₃ | Cl | O |
| 400 | OCH₃ | SO₂CH₃ | Cl | O |
| 401 | OCH₃ | SO₂CF₃ | Cl | O |
| 402 | OCH₃ | CH₂CO₂H | Cl | O |
| 403 | OCH₃ | CH₂COOCH₃ | Cl | O |
| 404 | OCH₃ | CH₂COOC₂H₅ | Cl | O |
| 405 | OCH₃ | prop-1-en-3-yl | Cl | O |
| 406 | OCH₃ | trans-but-2-en-1-yl | Cl | O |
| 407 | OCH₃ | cis-but-2-en-1-yl | Cl | O |
| 408 | OCH₃ | cis-3-methyl- | Cl | O |
| | | but-2-en-1-yl | | |
| 409 | OCH₃ | cyclopropyl | Cl | O |
| 410 | OCH₃ | cyclopentyl | Cl | O |
| 411 | OCH₃ | cyclohexyl | Cl | O |
| 412 | OCH₃ | 4,5-dihydroisoxazol- | Cl | O |
| | | 3-yl | | |
| 413 | OCH₃ | 4-methyl-4,5-dihydroisoxazol- | Cl | O |
| | | 3-yl | | |
| 414 | OCH₃ | isoxazol-3-yl | Cl | O |
| 415 | OCH₃ | 4-methylisoxazol-3-yl | Cl | O |
| 416 | OCH₃ | 4,5-dihydroisoxazol- | Cl | O |
| | | 4-yl | | |
| 417 | OCH₃ | 3-methyl-4,5-dihydroisoxazol- | Cl | O |
| | | 4-yl | | |
| 418 | OCH₃ | isoxazol-4-yl | Cl | O |
| 419 | OCH₃ | 3-methylisoxazol-4-yl | Cl | O |
| 420 | OCH₃ | phenyl | Cl | O |
| 421 | OCH₃ | benzyl | Cl | O |
| 422 | OCH₃ | benzoyl | Cl | O |
| 423 | OCH₃ | 2-pyridyl | Cl | O |
| 424 | OCF₃ | H | H | O |
| 425 | OCF₃ | CH₃ | H | O |
| 426 | OCF₃ | C₂H₅ | H | O |
| 427 | OCF₃ | n-C₃H₇ | H | O |
| 428 | OCF₃ | i-C₃H₇ | H | O |
| 429 | OCF₃ | n-C₄H₉ | H | O |
| 430 | OCF₃ | i-C₄H₉ | H | O |
| 431 | OCF₃ | s-C₄H₉ | H | O |
| 432 | OCF₃ | t-C₄H₉ | H | O |
| 433 | OCF₃ | CH₂OCH₃ | H | O |
| 434 | OCF₃ | CF₃ | H | O |
| 435 | OCF₃ | CF₂H | H | O |
| 436 | OCF₃ | CN | H | O |
| 437 | OCF₃ | OH | H | O |
| 438 | OCF₃ | OCH₃ | H | O |
| 439 | OCF₃ | NH₂ | H | O |
| 440 | OCF₃ | NHCH₃ | H | O |
| 441 | OCF₃ | N(CH₃)₂ | H | O |
| 442 | OCF₃ | CO₂CH₃ | H | O |
| 443 | OCF₃ | CO₂C₂H₅ | H | O |
| 444 | OCF₃ | C(O)CH₃ | H | O |
| 445 | OCF₃ | C(O)CF₃ | H | O |
| 446 | OCF₃ | C(═NOCH₃)CH₃ | H | O |
| 447 | OCF₃ | SO₂CH₃ | H | O |
| 448 | OCF₃ | SO₂CF₃ | H | O |
| 449 | OCF₃ | CH₂CO₂H | H | O |
| 450 | OCF₃ | CH₂COOCH₃ | H | O |
| 451 | OCF₃ | CH₂COOC₂H₅ | H | O |
| 452 | OCF₃ | prop-1-en-3-yl | H | O |
| 453 | OCF₃ | trans-but-2-en-1-yl | H | O |
| 454 | OCF₃ | cis-but-2-en-1-yl | H | O |
| 455 | OCF₃ | cis-3-methyl- | H | O |
| | | but-2-en-1-yl | | |
| 456 | OCF₃ | cyclopropyl | H | O |
| 457 | OCF₃ | cyclopentyl | H | O |
| 458 | OCF₃ | cyclohexyl | H | O |
| 459 | OCF₃ | 4,5-dihydroisoxazol- | H | O |
| | | 3-yl | | |
| 460 | OCF₃ | 4-methyl-4,5-dihydroisoxazol- | H | O |
| | | 3-yl | | |
| 461 | OCF₃ | isoxazol-3-yl | H | O |
| 462 | OCF₃ | 4-methylisoxazol-3-yl | H | O |
| 463 | OCF₃ | 4,5-dihydroisoxazol- | H | O |
| | | 4-yl | | |
| 464 | OCF₃ | 3-methyl-4,5-dihydroisoxazol- | H | O |
| | | 4-yl | | |
| 465 | OCF₃ | isoxazol-4-yl | H | O |
| 466 | OCF₃ | 3-methylisoxazol-4-yl | H | O |
| 467 | OCF₃ | phenyl | H | O |
| 468 | OCF₃ | benzyl | H | O |
| 469 | OCF₃ | benzoyl | H | O |
| 470 | OCF₃ | 2-pyridyl | H | O |
| 471 | OCF₃ | H | CH₃ | O |
| 472 | OCF₃ | CH₃ | CH₃ | O |
| 473 | OCF₃ | C₂H₅ | CH₃ | O |
| 474 | OCF₃ | n-C₃H₇ | CH₃ | O |
| 475 | OCF₃ | i-C₃H₇ | CH₃ | O |
| 476 | OCF₃ | n-C₄H₉ | CH₃ | O |
| 477 | OCF₃ | i-C₄H₉ | CH₃ | O |
| 478 | OCF₃ | s-C₄H₉ | CH₃ | O |
| 479 | OCF₃ | t-C₄H₉ | CH₃ | O |
| 480 | OCF₃ | CH₂OCH₃ | CH₃ | O |
| 481 | OCF₃ | CF₃ | CH₃ | O |
| 482 | OCF₃ | CF₂H | CH₃ | O |
| 483 | OCF₃ | CN | CH₃ | O |
| 484 | OCF₃ | OH | CH₃ | O |
| 485 | OCF₃ | OCH₃ | CH₃ | O |
| 486 | OCF₃ | NH₂ | CH₃ | O |
| 487 | OCF₃ | NHCH₃ | CH₃ | O |
| 488 | OCF₃ | N(CH₃)₂ | CH₃ | O |
| 489 | OCF₃ | CO₂CH₃ | CH₃ | O |
| 490 | OCF₃ | CO₂C₂H₅ | CH₃ | O |
| 491 | OCF₃ | C(O)CH₃ | CH₃ | O |
| 492 | OCF₃ | C(O)CF₃ | CH₃ | O |
| 493 | OCF₃ | C(═NOCH₃)CH₃ | CH₃ | O |
| 494 | OCF₃ | SO₂CH₃ | CH₃ | O |
| 495 | OCF₃ | SO₂CF₃ | CH₃ | O |
| 496 | OCF₃ | CH₂CO₂H | CH₃ | O |
| 497 | OCF₃ | CH₂COOCH₃ | CH₃ | O |
| 498 | OCF₃ | CH₂COOC₂H₅ | CH₃ | O |
| 499 | OCF₃ | prop-1-en-3-yl | CH₃ | O |
| 500 | OCF₃ | trans-but-2-en-1-yl | CH₃ | O |
| 501 | OCF₃ | cis-but-2-en-1-yl | CH₃ | O |
| 502 | OCF₃ | cis-3-methyl- | CH₃ | O |
| | | but-2-en-1-yl | | |
| 503 | OCF₃ | cyclopropyl | CH₃ | O |
| 504 | OCF₃ | cyclopentyl | CH₃ | O |
| 505 | OCF₃ | cyclohexyl | CH₃ | O |
| 506 | OCF₃ | 4,5-dihydroisoxazol- | CH₃ | O |
| | | 3-yl | | |
| 507 | OCF₃ | 4-methyl-4,5-dihydroisoxazol- | CH₃ | O |
| | | 3-yl | | |
| 508 | OCF₃ | isoxazol-3-yl | CH₃ | O |
| 509 | OCF₃ | 4-methylisoxazol-3-yl | CH₃ | O |
| 510 | OCF₃ | 4,5-dihydroisoxazol- | CH₃ | O |
| | | 4-yl | | |
| 511 | OCF₃ | 3-methyl-4,5-dihydroisoxazol- | CH₃ | O |
| | | 4-yl | | |
| 512 | OCF₃ | isoxazol-4-yl | CH₃ | O |
| 513 | OCF₃ | 3-methylisoxazol-4-yl | CH₃ | O |
| 514 | OCF₃ | phenyl | CH₃ | O |
| 515 | OCF₃ | benzyl | CH₃ | O |
| 516 | OCF₃ | benzoyl | CH₃ | O |
| 517 | OCF₃ | 2-pyridyl | CH₃ | O |
| 518 | OCF₃ | H | Cl | O |
| 519 | OCF₃ | CH₃ | Cl | O |
| 520 | OCF₃ | C₂H₅ | Cl | O |
| 521 | OCF₃ | n-C₃H₇ | Cl | O |
| 522 | OCF₃ | i-C₃H₇ | Cl | O |
| 523 | OCF₃ | n-C₄H₉ | Cl | O |
| 524 | OCF₃ | i-C₄H₉ | Cl | O |
| 525 | OCF₃ | s-C₄H₉ | Cl | O |
| 526 | OCF₃ | t-C₄H₉ | Cl | O |
| 527 | OCF₃ | CH₂OCH₃ | Cl | O |
| 528 | OCF₃ | CF₃ | Cl | O |
| 529 | OCF₃ | CF₂H | Cl | O |
| 530 | OCF₃ | CN | Cl | O |
| 531 | OCF₃ | OH | Cl | O |
| 532 | OCF₃ | OCH₃ | Cl | O |
| 533 | OCF₃ | NH₂ | Cl | O |
| 534 | OCF₃ | NHCH₃ | Cl | O |
| 535 | OCF₃ | N(CH₃)₂ | Cl | O |
| 536 | OCF₃ | CO₂CH₃ | Cl | O |
| 537 | OCF₃ | CO₂C₂H₅ | Cl | O |
| 538 | OCF₃ | C(O)CH₃ | Cl | O |
| 539 | OCF₃ | C(O)CF₃ | Cl | O |
| 540 | OCF₃ | C(═NOCH₃)CH₃ | Cl | O |
| 541 | OCF₃ | SO₂CH₃ | Cl | O |
| 542 | OCF₃ | SO₂CF₃ | Cl | O |
| 543 | OCF₃ | CH₂CO₂H | Cl | O |
| 544 | OCF₃ | CH₂COOCH₃ | Cl | O |
| 545 | OCF₃ | CH₂COOC₂H₅ | Cl | O |
| 546 | OCF₃ | prop-1-en-3-yl | Cl | O |
| 547 | OCF₃ | trans-but-2-en-1-yl | Cl | O |
| 548 | OCF₃ | cis-but-2-en-1-yl | Cl | O |
| 549 | OCF₃ | cis-3-methyl- | Cl | O |
| | | but-2-en-1-yl | | |
| 550 | OCF₃ | cyclopropyl | Cl | O |
| 551 | OCF₃ | cyclopentyl | Cl | O |
| 552 | OCF₃ | cyclohexyl | Cl | O |
| 553 | OCF₃ | 4,5-dihydroisoxazol- | Cl | O |
| | | 3-yl | | |
| 554 | OCF₃ | 4-methyl-4,5-dihydroisoxazol- | Cl | O |
| | | 3-yl | | |
| 555 | OCF₃ | isoxazol-3-yl | Cl | O |
| 556 | OCF₃ | 4-methylisoxazol-3-yl | Cl | O |
| 557 | OCF₃ | 4,5-dihydroisoxazol- | Cl | O |
| | | 4-yl | | |
| 558 | OCF₃ | 3-methyl-4,5-dihydroisoxazol- | Cl | O |
| | | 4-yl | | |
| 559 | OCF₃ | isoxazol-4-yl | Cl | O |
| 560 | OCF₃ | 3-methylisoxazol-4-yl | Cl | O |
| 561 | OCF₃ | phenyl | Cl | O |
| 562 | OCF₃ | benzyl | Cl | O |
| 563 | OCF₃ | benzoyl | Cl | O |
| 564 | OCF₃ | 2-pyridyl | Cl | O |
| 565 | SCH₃ | H | H | O |
| 566 | SCH₃ | CH₃ | H | O |
| 567 | SCH₃ | C₂H₅ | H | O |
| 568 | SCH₃ | n-C₃H₇ | H | O |
| 569 | SCH₃ | i-C₃H₇ | H | O |
| 570 | SCH₃ | n-C₄H₉ | H | O |
| 571 | SCH₃ | i-C₄H₉ | H | O |
| 572 | SCH₃ | s-C₄H₉ | H | O |
| 573 | SCH₃ | t-C₄H₉ | H | O |
| 574 | SCH₃ | CH₂OCH₃ | H | O |
| 575 | SCH₃ | CF₃ | H | O |
| 576 | SCH₃ | CF₂H | H | O |
| 577 | SCH₃ | CN | H | O |
| 578 | SCH₃ | OH | H | O |
| 579 | SCH₃ | OCH₃ | H | O |
| 580 | SCH₃ | NH₂ | H | O |
| 581 | SCH₃ | NHCH₃ | H | O |
| 582 | SCH₃ | N(CH₃)₂ | H | O |
| 583 | SCH₃ | CO₂CH₃ | H | O |
| 584 | SCH₃ | CO₂C₂H₅ | H | O |
| 585 | SCH₃ | C(O)CH₃ | H | O |
| 586 | SCH₃ | C(O)CF₃ | H | O |
| 587 | SCH₃ | C(═NOCH₃)CH₃ | H | O |
| 588 | SCH₃ | SO₂CH₃ | H | O |
| 589 | SCH₃ | SO₂CF₃ | H | O |
| 590 | SCH₃ | CH₂CO₂H | H | O |
| 591 | SCH₃ | CH₂COOCH₃ | H | O |
| 592 | SCH₃ | CH₂COOC₂H₅ | H | O |
| 593 | SCH₃ | prop-1-en-3-yl | H | O |
| 594 | SCH₃ | trans-but-2-en-1-yl | H | O |
| 595 | SCH₃ | cis-but-2-en-1-yl | H | O |
| 596 | SCH₃ | cis-3-methyl- | H | O |
| | | but-2-en-1-yl | | |
| 597 | SCH₃ | cyclopropyl | H | O |
| 598 | SCH₃ | cyclopentyl | H | O |
| 599 | SCH₃ | cyclohexyl | H | O |
| 600 | SCH₃ | 4,5-dihydroisoxazol- | H | O |
| | | 3-yl | | |
| 601 | SCH₃ | 4-methyl-4,5-dihydroisoxazol- | H | O |
| | | 3-yl | | |
| 602 | SCH₃ | isoxazol-3-yl | H | O |
| 603 | SCH₃ | 4-methylisoxazol-3-yl | H | O |
| 604 | SCH₃ | 4,5-dihydroisoxazol- | H | O |
| | | 4-y1 | | |
| 605 | SCH₃ | 3-methyl-4,5-dihydroisoxazol- | H | O |
| | | 4-yl | | |
| 606 | SCH₃ | isoxazol-4-yl | H | O |
| 607 | SCH₃ | 3-methylisoxazol-4-yl | H | O |
| 608 | SCH₃ | phenyl | H | O |
| 609 | SCH₃ | benzyl | H | O |
| 610 | SCH₃ | benzoyl | H | O |
| 611 | SCH₃ | 2-pyridyl | H | O |
| 612 | SCH₃ | H | CH₃ | O |
| 613 | SCH₃ | CH₃ | CH₃ | O |
| 614 | SCH₃ | C₂H₅ | CH₃ | O |
| 615 | SCH₃ | n-C₃H₇ | CH₃ | O |
| 616 | SCH₃ | i-C₃H₇ | CH₃ | O |
| 617 | SCH₃ | n-C₄H₉ | CH₃ | O |
| 618 | SCH₃ | i-C₄H₉ | CH₃ | O |
| 619 | SCH₃ | s-C₄H₉ | CH₃ | O |
| 620 | SCH₃ | t-C₄H₉ | CH₃ | O |
| 621 | SCH₃ | CH₂OCH₃ | CH₃ | O |
| 622 | SCH₃ | CF₃ | CH₃ | O |
| 623 | SCH₃ | CF₂H | CH₃ | O |
| 624 | SCH₃ | CN | CH₃ | O |
| 625 | SCH₃ | OH | CH₃ | O |
| 626 | SCH₃ | OCH₃ | CH₃ | O |
| 627 | SCH₃ | NH₂ | CH₃ | O |
| 628 | SCH₃ | NHCH₃ | CH₃ | O |
| 629 | SCH₃ | N(CH₃)₂ | CH₃ | O |
| 630 | SCH₃ | CO₂CH₃ | CH₃ | O |
| 631 | SCH₃ | CO₂C₂H₅ | CH₃ | O |
| 632 | SCH₃ | C(O)CH₃ | CH₃ | O |
| 633 | SCH₃ | C(O)CF₃ | CH₃ | O |
| 634 | SCH₃ | C(═NOCH₃)CH₃ | CH₃ | O |
| 635 | SCH₃ | SO₂CH₃ | CH₃ | O |
| 636 | SCH₃ | SO₂CF₃ | CH₃ | O |
| 637 | SCH₃ | CH₂CO₂H | CH₃ | O |
| 638 | SCH₃ | CH₂COOCH₃ | CH₃ | O |
| 639 | SCH₃ | CH₂COOC₂H₅ | CH₃ | O |
| 640 | SCH₃ | prop-1-en-3-yl | CH₃ | O |
| 641 | SCH₃ | trans-but-2-en-1-yl | CH₃ | O |
| 642 | SCH₃ | cis-but-2-en-1-yl | CH₃ | O |
| 643 | SCH₃ | cis-3-methyl- | CH₃ | O |
| | | but-2-en-1-yl | | |
| 644 | SCH₃ | cyclopropyl | CH₃ | O |
| 645 | SCH₃ | cyclopentyl | CH₃ | O |
| 646 | SCH₃ | cyclohexyl | CH₃ | O |
| 647 | SCH₃ | 4,5-dihydroisoxazol- | CH₃ | O |
| | | 3-yl | | |
| 648 | SCH₃ | 4-methyl-4,5-dihydroisoxazol- | CH₃ | O |
| | | 3-yl | | |
| 649 | SCH₃ | isoxazol-3-yl | CH₃ | O |
| 650 | SCH₃ | 4-methylisoxazol-3-yl | CH₃ | O |
| 651 | SCH₃ | 4,5-dihydroisoxazol- | CH₃ | O |
| | | 4-yl | | |
| 652 | SCH₃ | 3-methyl-4,5-dihydroisoxazol- | CH₃ | O |
| | | 4-yl | | |
| 653 | SCH₃ | isoxazol-4-yl | CH₃ | O |
| 654 | SCH₃ | 3-methylisoxazol-4-yl | CH₃ | O |
| 655 | SCH₃ | phenyl | CH₃ | O |
| 656 | SCH₃ | benzyl | CH₃ | O |
| 657 | SCH₃ | benzoyl | CH₃ | O |
| 658 | SCH₃ | 2-pyridyl | CH₃ | O |
| 659 | SCH₃ | H | Cl | O |
| 660 | SCH₃ | CH₃ | Cl | O |
| 661 | SCH₃ | C₂H₅ | Cl | O |
| 662 | SCH₃ | n-C₃H₇ | Cl | O |
| 663 | SCH₃ | i-C₃H₇ | Cl | O |
| 664 | SCH₃ | n-C₄H₉ | Cl | O |
| 665 | SCH₃ | i-C₄H₉ | Cl | O |
| 666 | SCH₃ | s-C₄H₉ | Cl | O |
| 667 | SCH₃ | t-C₄H₉ | Cl | O |
| 668 | SCH₃ | CH₂OCH₃ | Cl | O |
| 669 | SCH₃ | CF₃ | Cl | O |
| 670 | SCH₃ | CF₂H | Cl | O |
| 671 | SCH₃ | CN | Cl | O |
| 672 | SCH₃ | OH | Cl | O |
| 673 | SCH₃ | OCH₃ | Cl | O |
| 674 | SCH₃ | NH₂ | Cl | O |
| 675 | SCH₃ | NHCH₃ | Cl | O |
| 676 | SCH₃ | N(CH₃)₂ | Cl | O |
| 677 | SCH₃ | CO₂CH₃ | Cl | O |
| 678 | SCH₃ | CO₂C₂H₅ | Cl | O |
| 679 | SCH₃ | C(O)CH₃ | Cl | O |
| 680 | SCH₃ | C(O)CF₃ | Cl | O |
| 681 | SCH₃ | C(═NOCH₃)CH₃ | Cl | O |
| 682 | SCH₃ | SO₂CH₃ | Cl | O |
| 683 | SCH₃ | SO₂CF₃ | Cl | O |
| 684 | SCH₃ | CH₂CO₂H | Cl | O |
| 685 | SCH₃ | CH₂COOCH₃ | Cl | O |
| 686 | SCH₃ | CH₂COOC₂H₅ | Cl | O |
| 687 | SCH₃ | prop-1-en-3-yl | Cl | O |
| 688 | SCH₃ | trans-but-2-en-1-yl | Cl | O |
| 689 | SCH₃ | cis-but-2-en-1-yl | Cl | O |
| 690 | SCH₃ | cis-3-methyl- | Cl | O |
| | | but-2-en-1-yl | | |
| 691 | SCH₃ | cyclopropyl | Cl | O |
| 692 | SCH₃ | cyclopentyl | Cl | O |
| 693 | SCH₃ | cyclohexyl | Cl | O |
| 694 | SCH₃ | 4,5-dihydroisoxazol- | Cl | O |
| | | 3-yl | | |
| 695 | SCH₃ | 4-methyl-4,5-dihydroisoxazol- | Cl | O |
| | | 3-yl | | |
| 696 | SCH₃ | isoxazol-3-yl | Cl | O |
| 697 | SCH₃ | 4-methylisoxazol-3-yl | Cl | O |
| 698 | SCH₃ | 4,5-dihydroisoxazol- | Cl | O |
| | | 4-yl | | |
| 699 | SCH₃ | 3-methyl-4,5-dihydroisoxazol- | Cl | O |
| | | 4-yl | | |
| 700 | SCH₃ | isoxazol-4-yl | Cl | O |
| 701 | SCH₃ | 3-methylisoxazol-4-yl | Cl | O |
| 702 | SCH₃ | phenyl | Cl | O |
| 703 | SCH₃ | benzyl | Cl | O |
| 704 | SCH₃ | benzoyl | Cl | O |
| 705 | SCH₃ | 2-pyridyl | Cl | O |
| 706 | SO₂CH₃ | H | H | O |
| 707 | SO₂CH₃ | CH₃ | H | O |
| 708 | SO₂CH₃ | C₂H₅ | H | O |
| 709 | SO₂CH₃ | n-C₃H₇ | H | O |
| 710 | SO₂CH₃ | i-C₃H₇ | H | O |
| 711 | SO₂CH₃ | n-C₄H₉ | H | O |
| 712 | SO₂CH₃ | i-C₄H₉ | H | O |
| 713 | SO₂CH₃ | s-C₄H₉ | H | O |
| 714 | SO₂CH₃ | t-C₄H₉ | H | O |
| 715 | SO₂CH₃ | CH₂OCH₃ | H | O |
| 716 | SO₂CH₃ | CF₃ | H | O |
| 717 | SO₂CH₃ | CF₂H | H | O |
| 718 | SO₂CH₃ | CN | H | O |
| 719 | SO₂CH₃ | OH | H | O |
| 720 | SO₂CH₃ | OCH₃ | H | O |
| 721 | SO₂CH₃ | NH₂ | H | O |
| 722 | SO₂CH₃ | NHCH₃ | H | O |
| 723 | SO₂CH₃ | N(CH₃)₂ | H | O |
| 724 | SO₂CH₃ | CO₂CH₃ | H | O |
| 725 | SO₂CH₃ | CO₂C₂H₅ | H | O |
| 726 | SO₂CH₃ | C(O)CH₃ | H | O |
| 727 | SO₂CH₃ | C(O)CF₃ | H | O |
| 728 | SO₂CH₃ | C(═NOCH₃)CH₃ | H | O |
| 729 | SO₂CH₃ | SO₂CH₃ | H | O |
| 730 | SO₂CH₃ | SO₂CF₃ | H | O |
| 731 | SO₂CH₃ | CH₂CO₂H | H | O |
| 732 | SO₂CH₃ | CH₂COOCH₃ | H | O |
| 733 | SO₂CH₃ | CH₂COOC₂H₅ | H | O |
| 734 | SO₂CH₃ | prop-1-en-3-yl | H | O |
| 735 | SO₂CH₃ | trans-but-2-en-1-yl | H | O |
| 736 | SO₂CH₃ | cis-but-2-en-1-yl | H | O |
| 737 | SO₂CH₃ | cis-3-methyl- | H | O |
| | | but-2-en-1-yl | | |
| 738 | SO₂CH₃ | cyclopropyl | H | O |
| 739 | SO₂CH₃ | cyclopentyl | H | O |
| 740 | SO₂CH₃ | cyclohexyl | H | O |
| 741 | SO₂CH₃ | 4,5-dihydroisoxazol- | H | O |
| | | 3-yl | | |
| 742 | SO₂CH₃ | 4-methyl-4,5-dihydroisoxazol- | H | O |
| | | 3-yl | | |
| 743 | SO₂CH₃ | isoxazol-3-yl | H | O |
| 744 | SO₂CH₃ | 4-methylisoxazol-3-yl | H | O |
| 745 | SO₂CH₃ | 4,5-dihydroisoxazol- | H | O |
| | | 4-yl | | |
| 746 | SO₂CH₃ | 3-methyl-4,5-dihydroisoxazol- | H | O |
| | | 4-yl | | |
| 747 | SO₂CH₃ | isoxazol-4-yl | H | O |
| 748 | SO₂CH₃ | 3-methylisoxazol-4-yl | H | O |
| 749 | SO₂CH₃ | phenyl | H | O |
| 750 | SO₂CH₃ | benzyl | H | O |
| 751 | SO₂CH₃ | benzoyl | H | O |
| 752 | SO₂CH₃ | 2-pyridyl | H | O |
| 753 | SO₂CH₃ | H | CH₃ | O |
| 754 | SO₂CH₃ | CH₃ | CH₃ | O |
| 755 | SO₂CH₃ | C₂H₅ | CH₃ | O |
| 756 | SO₂CH₃ | n-C₃H₇ | CH₃ | O |
| 757 | SO₂CH₃ | i-C₃H₇ | CH₃ | O |
| 758 | SO₂CH₃ | n-C₄H₉ | CH₃ | O |
| 759 | SO₂CH₃ | i-C₄H₉ | CH₃ | O |
| 760 | SO₂CH₃ | s-C₄H₉ | CH₃ | O |
| 761 | SO₂CH₃ | t-C₄H₉ | CH₃ | O |
| 762 | SO₂CH₃ | CH₂OCH₃ | CH₃ | O |
| 763 | SO₂CH₃ | CF₃ | CH₃ | O |
| 764 | SO₂CH₃ | CF₂H | CH₃ | O |
| 765 | SO₂CH₃ | CN | CH₃ | O |
| 766 | SO₂CH₃ | OH | CH₃ | O |
| 767 | SO₂CH₃ | OCH₃ | CH₃ | O |
| 768 | SO₂CH₃ | NH₂ | CH₃ | O |
| 769 | SO₂CH₃ | NHCH₃ | CH₃ | O |
| 770 | SO₂CH₃ | N(CH₃)₂ | CH₃ | O |
| 771 | SO₂CH₃ | CO₂CH₃ | CH₃ | O |
| 772 | SO₂CH₃ | CO₂C₂H₅ | CH₃ | O |
| 773 | SO₂CH₃ | C(O)CH₃ | CH₃ | O |
| 774 | SO₂CH₃ | C(O)CF₃ | CH₃ | O |
| 775 | SO₂CH₃ | C(═NOCH₃)CH₃ | CH₃ | O |
| 776 | SO₂CH₃ | SO₂CH₃ | CH₃ | O |
| 777 | SO₂CH₃ | SO₂CF₃ | CH₃ | O |
| 778 | SO₂CH₃ | CH₂CO₂H | CH₃ | O |
| 779 | SO₂CH₃ | CH₂COOCH₃ | CH₃ | O |
| 780 | SO₂CH₃ | CH₂COOC₂H₅ | CH₃ | O |
| 781 | SO₂CH₃ | prop-1-en-3-yl | CH₃ | O |
| 782 | SO₂CH₃ | trans-but-2-en-1-yl | CH₃ | O |
| 783 | SO₂CH₃ | cis-but-2-en-1-yl | CH₃ | O |
| 784 | SO₂CH₃ | cis-3-methyl- | CH₃ | O |
| | | but-2-en-1-yl | | |
| 785 | SO₂CH₃ | cyclopropyl | CH₃ | O |
| 786 | SO₂CH₃ | cyclopentyl | CH₃ | O |
| 787 | SO₂CH₃ | cyclohexyl | CH₃ | O |
| 788 | SO₂CH₃ | 4,5-dihydroisoxazol- | CH₃ | O |
| | | 3-yl | | |
| 789 | SO₂CH₃ | 4-methyl-4,5-dihydroisoxazol- | CH₃ | O |
| | | 3-yl | | |
| 790 | SO₂CH₃ | isoxazol-3-yl | CH₃ | O |
| 791 | SO₂CH₃ | 4-methylisoxazol-3-yl | CH₃ | O |
| 792 | SO₂CH₃ | 4,5-dihydroisoxazol- | CH₃ | O |
| | | 4-yl | | |
| 793 | SO₂CH₃ | 3-methyl-4,5-dihydroisoxazol- | CH₃ | O |
| | | 4-yl | | |
| 794 | SO₂CH₃ | isoxazol-4-yl | CH₃ | O |
| 795 | SO₂CH₃ | 3-methylisoxazol-4-yl | CH₃ | O |
| 796 | SO₂CH₃ | phenyl | CH₃ | O |
| 797 | SO₂CH₃ | benzyl | CH₃ | O |
| 798 | SO₂CH₃ | benzoyl | CH₃ | O |
| 799 | SO₂CH₃ | 2-pyridyl | CH₃ | O |
| 800 | SO₂CH₃ | H | Cl | O |
| 801 | SO₂CH₃ | CH₃ | Cl | O |
| 802 | SO₂CH₃ | C₂H₅ | Cl | O |
| 803 | SO₂CH₃ | n-C₃H₇ | Cl | O |
| 804 | SO₂CH₃ | i-C₃H₇ | Cl | O |
| 805 | SO₂CH₃ | n-C₄H₉ | Cl | O |
| 806 | SO₂CH₃ | i-C₄H₉ | Cl | O |
| 807 | SO₂CH₃ | s-C₄H₉ | Cl | O |
| 808 | SO₂CH₃ | t-C₄H₉ | Cl | O |
| 809 | SO₂CH₃ | CH₂OCH₃ | Cl | O |
| 810 | SO₂CH₃ | CF₃ | Cl | O |
| 811 | SO₂CH₃ | CF₂H | Cl | O |
| 812 | SO₂CH₃ | CN | Cl | O |
| 813 | SO₂CH₃ | OH | Cl | O |
| 814 | SO₂CH₃ | OCH₃ | Cl | O |
| 815 | SO₂CH₃ | NH₂ | Cl | O |
| 816 | SO₂CH₃ | NHCH₃ | Cl | O |
| 817 | SO₂CH₃ | N(CH₃)₂ | Cl | O |
| 818 | SO₂CH₃ | CO₂CH₃ | Cl | O |
| 819 | SO₂CH₃ | CO₂C₂H₅ | Cl | O |
| 820 | SO₂CH₃ | C(O)CH₃ | Cl | O |
| 821 | SO₂CH₃ | C(O)CF₃ | Cl | O |
| 822 | SO₂CH₃ | C(═NOCH₃)CH₃ | Cl | O |
| 823 | SO₂CH₃ | SO₂CH₃ | Cl | O |
| 824 | SO₂CH₃ | SO₂CF₃ | Cl | O |
| 825 | SO₂CH₃ | CH₂CO₂H | Cl | O |
| 826 | SO₂CH₃ | CH₂COOCH₃ | Cl | O |
| 827 | SO₂CH₃ | CH₂COOC₂H₅ | Cl | O |
| 828 | SO₂CH₃ | prop-1-en-3-yl | Cl | O |
| 829 | SO₂CH₃ | trans-but-2-en-1-yl | Cl | O |
| 830 | SO₂CH₃ | cis-but-2-en-1-yl | Cl | O |
| 831 | SO₂CH₃ | cis-3-methyl- | Cl | O |
| | | but-2-en-1-yl | | |
| 832 | SO₂CH₃ | cyclopropyl | Cl | O |
| 833 | SO₂CH₃ | cyclopentyl | Cl | O |
| 834 | SO₂CH₃ | cyclohexyl | Cl | O |
| 835 | SO₂CH₃ | 4,5-dihydroisoxazol- | Cl | O |
| | | 3-yl | | |
| 836 | SO₂CH₃ | 4-methyl-4,5-dihydroisoxazol- | Cl | O |
| | | 3-yl | | |
| 837 | SO₂CH₃ | isoxazol-3-yl | Cl | O |
| 838 | SO₂CH₃ | 4-methylisoxazol-3-yl | Cl | O |
| 839 | SO₂CH₃ | 4,5-dihydroisoxazol- | Cl | O |
| | | 4-yl | | |
| 840 | SO₂CH₃ | 3-methyl-4,5-dihydroisoxazol- | Cl | O |
| | | 4-yl | | |
| 841 | SO₂CH₃ | isoxazol-4-yl | Cl | O |
| 842 | SO₂CH₃ | 3-methylisoxazol-4-yl | Cl | O |
| 843 | SO₂CH₃ | phenyl | Cl | O |
| 844 | SO₂CH₃ | benzyl | Cl | O |
| 845 | SO₂CH₃ | benzoyl | Cl | O |
| 846 | SO₂CH₃ | 2-pyridyl | Cl | O |
| 847 | CF₃ | H | H | O |
| 848 | CF₃ | CH₃ | H | O |
| 849 | CF₃ | C₂H₅ | H | O |
| 850 | CF₃ | n-C₃H₇ | H | O |
| 851 | CF₃ | i-C₃H₇ | H | O |
| 852 | CF₃ | n-C₄H₉ | H | O |
| 853 | CF₃ | i-C₄H₉ | H | O |
| 854 | CF₃ | s-C₄H₉ | H | O |
| 855 | CF₃ | t-C₄H₉ | H | O |
| 856 | CF₃ | CH₂OCH₃ | H | O |
| 857 | CF₃ | CF₃ | H | O |
| 858 | CF₃ | CF₂H | H | O |
| 859 | CF₃ | CN | H | O |
| 860 | CF₃ | OH | H | O |
| 861 | CF₃ | OCH₃ | H | O |
| 862 | CF₃ | NH₂ | H | O |
| 863 | CF₃ | NHCH₃ | H | O |
| 864 | CF₃ | N(CH₃)₂ | H | O |
| 865 | CF₃ | CO₂CH₃ | H | O |
| 866 | CF₃ | CO₂C₂H₅ | H | O |
| 867 | CF₃ | C(O)CH₃ | H | O |
| 868 | CF₃ | C(O)CF₃ | H | O |
| 869 | CF₃ | C(═NOCH₃)CH₃ | H | O |
| 870 | CF₃ | SO₂CH₃ | H | O |
| 871 | CF₃ | SO₂CF₃ | H | O |
| 872 | CF₃ | CH₂CO₂H | H | O |
| 873 | CF₃ | CH₂COOCH₃ | H | O |
| 874 | CF₃ | CH₂COOC₂H₅ | H | O |
| 875 | CF₃ | prop-1-en-3-yl | H | O |
| 876 | CF₃ | trans-but-2-en-1-yl | H | O |
| 877 | CF₃ | cis-but-2-en-1-yl | H | O |
| 878 | CF₃ | cis-3-methyl- | H | O |
| | | but-2-en-1-yl | | |
| 879 | CF₃ | cyclopropyl | H | O |
| 880 | CF₃ | cyclopentyl | H | O |
| 881 | CF₃ | cyclohexyl | H | O |
| 882 | CF₃ | 4,5-dihydroisoxazol- | H | O |
| | | 3-yl | | |
| 883 | CF₃ | 4-methyl-4,5-dihydroisoxazol- | H | O |
| | | 3-yl | | |
| 884 | CF₃ | isoxazol-3-yl | H | O |
| 885 | CF₃ | 4-methylisoxazol-3-yl | H | O |
| 886 | CF₃ | 4,5-dihydroisoxazol- | H | O |
| | | 4-yl | | |
| 887 | CF₃ | 3-methyl-4,5-dihydroisoxazol- | H | O |
| | | 4-yl | | |
| 888 | CF₃ | isoxazol-4-yl | H | O |
| 889 | CF₃ | 3-methylisoxazol-4-yl | H | O |
| 890 | CF₃ | phenyl | H | O |
| 891 | CF₃ | benzyl | H | O |
| 892 | CF₃ | benzoyl | H | O |
| 893 | CF₃ | 2-pyridyl | H | O |
| 894 | CF₃ | H | CH₃ | O |
| 895 | CF₃ | CH₃ | CH₃ | O |
| 896 | CF₃ | C₂H₅ | CH₃ | O |
| 897 | CF₃ | n-C₃H₇ | CH₃ | O |
| 898 | CF₃ | i-C₃H₇ | CH₃ | O |
| 899 | CF₃ | n-C₄H₉ | CH₃ | O |
| 900 | CF₃ | i-C₄H₉ | CH₃ | O |
| 901 | CF₃ | s-C₄H₉ | CH₃ | O |
| 902 | CF₃ | t-C₄H₉ | CH₃ | O |
| 903 | CF₃ | CH₂OCH₃ | CH₃ | O |
| 904 | CF₃ | CF₃ | CH₃ | O |
| 905 | CF₃ | CF₂H | CH₃ | O |
| 906 | CF₃ | CN | CH₃ | O |
| 907 | CF₃ | OH | CH₃ | O |
| 908 | CF₃ | OCH₃ | CH₃ | O |
| 909 | CF₃ | NH₂ | CH₃ | O |
| 910 | CF₃ | NHCH₃ | CH₃ | O |
| 911 | CF₃ | N(CH₃)₂ | CH₃ | O |
| 912 | CF₃ | CO₂CH₃ | CH₃ | O |
| 913 | CF₃ | CO₂C₂H₅ | CH₃ | O |
| 914 | CF₃ | C(O)CH₃ | CH₃ | O |
| 915 | CF₃ | C(O)CF₃ | CH₃ | O |
| 916 | CF₃ | C(═NOCH₃)CH₃ | CH₃ | O |
| 917 | CF₃ | SO₂CH₃ | CH₃ | O |
| 918 | CF₃ | SO₂CF₃ | CH₃ | O |
| 919 | CF₃ | CH₂CO₂H | CH₃ | O |
| 920 | CF₃ | CH₂COOCH₃ | CH₃ | O |
| 921 | CF₃ | CH₂COOC₂H₅ | CH₃ | O |
| 922 | CF₃ | prop-1-en-3-yl | CH₃ | O |
| 923 | CF₃ | trans-but-2-en-1-yl | CH₃ | O |
| 924 | CF₃ | cis-but-2-en-1-yl | CH₃ | O |
| 925 | CF₃ | cis-3-methyl- | CH₃ | O |
| | | but-2-en-1-yl | | |
| 926 | CF₃ | cyclopropyl | CH₃ | O |
| 927 | CF₃ | cyclopentyl | CH₃ | O |
| 928 | CF₃ | cyclohexyl | CH₃ | O |
| 929 | CF₃ | 4,5-dihydroisoxazol- | CH₃ | O |
| | | 3-yl | | |
| 930 | CF₃ | 4-methyl-4,5-dihydroisoxazol- | CH₃ | O |
| | | 3-yl | | |
| 931 | CF₃ | isoxazol-3-yl | CH₃ | O |
| 932 | CF₃ | 4-methylisoxazol-3-yl | CH₃ | O |
| 933 | CF₃ | 4,5-dihydroisoxazol- | CH₃ | O |
| | | 4-yl | | |
| 934 | CF₃ | 3-methyl-4,5-dihydroisoxazol- | CH₃ | O |
| | | 4-yl | | |
| 935 | CF₃ | isoxazol-4-yl | CH₃ | O |
| 936 | CF₃ | 3-methylisoxazol-4-yl | CH₃ | O |
| 937 | CF₃ | phenyl | CH₃ | O |
| 938 | CF₃ | benzyl | CH₃ | O |
| 939 | CF₃ | benzoyl | CH₃ | O |
| 940 | CF₃ | 2-pyridyl | CH₃ | O |
| 941 | CF₃ | H | Cl | O |
| 942 | CF₃ | CH₃ | Cl | O |
| 943 | CF₃ | C₂H₅ | Cl | O |
| 944 | CF₃ | n-C₃H₇ | Cl | O |
| 945 | CF₃ | i-C₃H₇ | Cl | O |
| 946 | CF₃ | n-C₄H₉ | Cl | O |
| 947 | CF₃ | i-C₄H₉ | Cl | O |
| 948 | CF₃ | s-C₄H₉ | Cl | O |
| 949 | CF₃ | t-C₄H₉ | Cl | O |
| 950 | CF₃ | CH₂OCH₃ | Cl | O |
| 951 | CF₃ | CF₃ | Cl | O |
| 952 | CF₃ | CF₂H | Cl | O |
| 953 | CF₃ | CN | Cl | O |
| 954 | CF₃ | OH | Cl | O |
| 955 | CF₃ | OCH₃ | Cl | O |
| 956 | CF₃ | NH₂ | Cl | O |
| 957 | CF₃ | NHCH₃ | Cl | O |
| 958 | CF₃ | N(CH₃)₂ | Cl | O |
| 959 | CF₃ | CO₂CH₃ | Cl | O |
| 960 | CF₃ | CO₂C₂H₅ | Cl | O |
| 961 | CF₃ | C(O)CH₃ | Cl | O |
| 962 | CF₃ | C(O)CF₃ | Cl | O |
| 963 | CF₃ | C(═NOCH₃)CH₃ | Cl | O |
| 964 | CF₃ | SO₂CH₃ | Cl | O |
| 965 | CF₃ | SO₂CF₃ | Cl | O |
| 966 | CF₃ | CH₂CO₂H | Cl | O |
| 967 | CF₃ | CH₂COOCH₃ | Cl | O |
| 968 | CF₃ | CH₂COOC₂H₅ | Cl | O |
| 969 | CF₃ | prop-1-en-3-yl | Cl | O |
| 970 | CF₃ | trans-but-2-en-1-yl | Cl | O |
| 971 | CF₃ | cis-but-2-en-1-yl | Cl | O |
| 972 | CF₃ | cis-3-methyl- | Cl | O |
| | | but-2-en-1-yl | | |
| 973 | CF₃ | cyclopropyl | Cl | O |
| 974 | CF₃ | cyclopentyl | Cl | O |
| 975 | CF₃ | cyclohexyl | Cl | O |
| 976 | CF₃ | 4,5-dihydroisoxazol- | Cl | O |
| | | 3-yl | | |
| 977 | CF₃ | 4-methyl-4,5-dihydroisoxazol- | Cl | O |
| | | 3-yl | | |
| 978 | CF₃ | isoxazol-3-yl | Cl | O |
| 979 | CF₃ | 4-methylisoxazol-3-yl | Cl | O |
| 980 | CF₃ | 4,5-dihydroisoxazol- | Cl | O |
| | | 4-yl | | |
| 981 | CF₃ | 3-methyl-4,5-dihydroisoxazol- | Cl | O |
| | | 4-yl | | |
| 982 | CF₃ | isoxazol-4-yl | Cl | O |
| 983 | CF₃ | 3-methylisoxazol-4-yl | Cl | O |
| 984 | CF₃ | phenyl | Cl | O |
| 985 | CF₃ | benzyl | Cl | O |
| 986 | CF₃ | benzoyl | Cl | O |
| 987 | CF₃ | 2-pyridyl | Cl | O |
| 988 | C₂H₅ | H | H | O |
| 989 | C₂H₅ | CH₃ | H | O |
| 990 | C₂H₅ | C₂H₅ | H | O |
| 991 | C₂H₅ | n-C₃H₇ | H | O |
| 992 | C₂H₅ | i-C₃H₇ | H | O |
| 993 | C₂H₅ | n-C₄H₉ | H | O |
| 994 | C₂H₅ | i-C₄H₉ | H | O |
| 995 | C₂H₅ | s-C₄H₉ | H | O |
| 996 | C₂H₅ | t-C₄H₉ | H | O |
| 997 | C₂H₅ | CH₂OCH₃ | H | O |
| 998 | C₂H₅ | CF₃ | H | O |
| 999 | C₂H₅ | CF₂H | H | O |
| 1000 | C₂H₅ | CN | H | O |
| 1001 | C₂H₅ | OH | H | O |
| 1002 | C₂H₅ | OCH₃ | H | O |
| 1003 | C₂H₅ | NH₂ | H | O |
| 1004 | C₂H₅ | NHCH₃ | H | O |
| 1005 | C₂H₅ | N(CH₃)₂ | H | O |
| 1006 | C₂H₅ | CO₂CH₃ | H | O |
| 1007 | C₂H₅ | CO₂C₂H₅ | H | O |
| 1008 | C₂H₅ | C(O)CH₃ | H | O |
| 1009 | C₂H₅ | C(O)CF₃ | H | O |
| 1010 | C₂H₅ | C(═NOCH₃)CH₃ | H | O |
| 1011 | C₂H₅ | SO₂CH₃ | H | O |
| 1012 | C₂H₅ | SO₂CF₃ | H | O |
| 1013 | C₂H₅ | CH₂CO₂H | H | O |
| 1014 | C₂H₅ | CH₂COOCH₃ | H | O |
| 1015 | C₂H₅ | CH₂COOC₂H₅ | H | O |
| 1016 | C₂H₅ | prop-1-en-3-yl | H | O |
| 1017 | C₂H₅ | trans-but-2-en-1-yl | H | O |
| 1018 | C₂H₅ | cis-but-2-en-1-yl | H | O |
| 1019 | C₂H₅ | cis-3-methyl- | H | O |
| | | but-2-en-1-yl | | |
| 1020 | C₂H₅ | cyclopropyl | H | O |
| 1021 | C₂H₅ | cyclopentyl | H | O |
| 1022 | C₂H₅ | cyclohexyl | H | O |
| 1023 | C₂H₅ | 4,5-dihydroisoxazol- | H | O |
| | | 3-yl | | |
| 1024 | C₂H₅ | 4-methyl-4,5-dihydroisoxazol- | H | O |
| | | 3-yl | | |
| 1025 | C₂H₅ | isoxazol-3-yl | H | O |
| 1026 | C₂H₅ | 4-methylisoxazol-3-yl | H | O |
| 1027 | C₂H₅ | 4,5-dihydroisoxazol- | H | O |
| | | 4-yl | | |
| 1028 | C₂H₅ | 3-methyl-4,5-dihydroisoxazol- | H | O |
| | | 4-yl | | |
| 1029 | C₂H₅ | isoxazol-4-yl | H | O |
| 1030 | C₂H₅ | 3-methylisoxazol-4-yl | H | O |
| 1031 | C₂H₅ | phenyl | H | O |
| 1032 | C₂H₅ | benzyl | H | O |
| 1033 | C₂H₅ | benzoyl | H | O |
| 1034 | C₂H₅ | 2-pyridyl | H | O |
| 1035 | C₂H₅ | H | CH₃ | O |
| 1036 | C₂H₅ | CH₃ | CH₃ | O |
| 1037 | C₂H₅ | C₂H₅ | CH₃ | O |
| 1038 | C₂H₅ | n-C₃H₇ | CH₃ | O |
| 1039 | C₂H₅ | i-C₃H₇ | CH₃ | O |
| 1040 | C₂H₅ | n-C₄H₉ | CH₃ | O |
| 1041 | C₂H₅ | i-C₄H₉ | CH₃ | O |
| 1042 | C₂H₅ | s-C₄H₉ | CH₃ | O |
| 1043 | C₂H₅ | t-C₄H₉ | CH₃ | O |
| 1044 | C₂H₅ | CH₂OCH₃ | CH₃ | O |
| 1045 | C₂H₅ | CF₃ | CH₃ | O |
| 1046 | C₂H₅ | CF₂H | CH₃ | O |
| 1047 | C₂H₅ | CN | CH₃ | O |
| 1048 | C₂H₅ | OH | CH₃ | O |
| 1049 | C₂H₅ | OCH₃ | CH₃ | O |
| 1050 | C₂H₅ | NH₂ | CH₃ | O |
| 1051 | C₂H₅ | NHCH₃ | CH₃ | O |
| 1052 | C₂H₅ | N(CH₃)₂ | CH₃ | O |
| 1053 | C₂H₅ | CO₂CH₃ | CH₃ | O |
| 1054 | C₂H₅ | CO₂C₂H₅ | CH₃ | O |
| 1055 | C₂H₅ | C(O)CH₃ | CH₃ | O |
| 1056 | C₂H₅ | C(O)CF₃ | CH₃ | O |
| 1057 | C₂H₅ | C(═NOCH₃)CH₃ | CH₃ | O |
| 1058 | C₂H₅ | SO₂CH₃ | CH₃ | O |
| 1059 | C₂H₅ | SO₂CF₃ | CH₃ | O |
| 1060 | C₂H₅ | CH₂CO₂H | CH₃ | O |
| 1061 | C₂H₅ | CH₂COOCH₃ | CH₃ | O |
| 1062 | C₂H₅ | CH₂COOC₂H₅ | CH₃ | O |
| 1063 | C₂H₅ | prop-1-en-3-yl | CH₃ | O |
| 1064 | C₂H₅ | trans-but-2-en-1-yl | CH₃ | O |
| 1065 | C₂H₅ | cis-but-2-en-1-yl | CH₃ | O |
| 1066 | C₂H₅ | cis-3-methyl- | CH₃ | O |
| | | but-2-en-1-yl | | |
| 1067 | C₂H₅ | cyclopropyl | CH₃ | O |
| 1068 | C₂H₅ | cyclopentyl | CH₃ | O |
| 1069 | C₂H₅ | cyclohexyl | CH₃ | O |
| 1070 | C₂H₅ | 4,5-dihydroisoxazol- | CH₃ | O |
| | | 3-yl | | |
| 1071 | C₂H₅ | 4-nethyl-4,5-dihydroisoxazol- | CH₃ | O |
| | | 3-yl | | |
| 1072 | C₂H₅ | isoxazol-3-yl | CH₃ | O |
| 1073 | C₂H₅ | 4-methylisoxazol-3-yl | CH₃ | O |
| 1074 | C₂H₅ | 4,5-dihydroisoxazol- | CH₃ | O |
| | | 4-yl | | |
| 1075 | C₂H₅ | 3-methyl-4,5-dihydroisoxazol- | CH₃ | O |
| | | 4-yl | | |
| 1076 | C₂H₅ | isoxazol-4-yl | CH₃ | O |
| 1077 | C₂H₅ | 3-methylisoxazol-4-yl | CH₃ | O |
| 1078 | C₂H₅ | phenyl | CH₃ | O |
| 1079 | C₂H₅ | benzyl | CH₃ | O |
| 1080 | C₂H₅ | benzoyl | CH₃ | O |
| 1081 | C₂H₅ | 2-pyridyl | CH₃ | O |
| 1082 | C₂H₅ | H | Cl | O |
| 1083 | C₂H₅ | CH₃ | Cl | O |
| 1084 | C₂H₅ | C₂H₅ | Cl | O |
| 1085 | C₂H₅ | n-C₃H₇ | Cl | O |
| 1086 | C₂H₅ | i-C₃H₇ | Cl | O |
| 1087 | C₂H₅ | n-C₄H₉ | Cl | O |
| 1088 | C₂H₅ | i-C₄H₉ | Cl | O |
| 1089 | C₂H₅ | s-C₄H₉ | Cl | O |
| 1090 | C₂H₅ | t-C₄H₉ | Cl | O |
| 1091 | C₂H₅ | CH₂OCH₃ | Cl | O |
| 1092 | C₂H₅ | CF₃ | Cl | O |
| 1093 | C₂H₅ | CF₂H | Cl | O |
| 1094 | C₂H₅ | CN | Cl | O |
| 1095 | C₂H₅ | OH | Cl | O |
| 1096 | C₂H₅ | OCH₃ | Cl | O |
| 1097 | C₂H₅ | NH₂ | Cl | O |
| 1098 | C₂H₅ | NHCH₃ | Cl | O |
| 1099 | C₂H₅ | N(CH₃)₂ | Cl | O |
| 1100 | C₂H₅ | CO₂CH₃ | Cl | O |
| 1101 | C₂H₅ | CO₂C₂H₅ | Cl | O |
| 1102 | C₂H₅ | C(O)CH₃ | Cl | O |
| 1103 | C₂H₅ | C(O)CF₃ | Cl | O |
| 1104 | C₂H₅ | C(═NOCH₃)CH₃ | Cl | O |
| 1105 | C₂H₅ | SO₂CH₃ | Cl | O |
| 1106 | C₂H₅ | SO₂CF₃ | Cl | O |
| 1107 | C₂H₅ | CH₂CO₂H | Cl | O |
| 1108 | C₂H₅ | CH₂COOCH₃ | Cl | O |
| 1109 | C₂H₅ | CH₂COOC₂H₅ | Cl | O |
| 1110 | C₂H₅ | prop-1-en-3-yl | Cl | O |
| 1111 | C₂H₅ | trans-but-2-en-1-yl | Cl | O |
| 1112 | C₂H₅ | cis-but-2-en-1-yl | Cl | O |
| 1113 | C₂H₅ | cis-3-methyl- | Cl | O |
| | | but-2-en-1-yl | | |
| 1114 | C₂H₅ | cyclopropyl | Cl | O |
| 1115 | C₂H₅ | cyclopentyl | Cl | O |
| 1116 | C₂H₅ | cyclohexyl | Cl | O |
| 1117 | C₂H₅ | 4,5-dihydroisoxazol- | Cl | O |
| | | 3-yl | | |
| 1118 | C₂H₅ | 4-methyl-4,5-dihydroisoxazol- | Cl | O |
| | | 3-yl | | |
| 1119 | C₂H₅ | isoxazol-3-yl | Cl | O |
| 1120 | C₂H₅ | 4-methylisoxazol-3-yl | Cl | O |
| 1121 | C₂H₅ | 4,5-dihydroisoxazol- | Cl | O |
| | | 4-yl | | |
| 1122 | C₂H₅ | 3-methyl-4,5-dihydroisoxazol- | Cl | O |
| | | 4-yl | | |
| 1123 | C₂H₅ | isoxazol-4-yl | Cl | O |
| 1124 | C₂H₅ | 3-methylisoxazol-4-yl | Cl | O |
| 1125 | C₂H₅ | phenyl | Cl | O |
| 1126 | C₂H₅ | benzyl | Cl | O |
| 1127 | C₂H₅ | benzoyl | Cl | O |
| 1128 | C₂H₅ | 2-pyridyl | Cl | O |
| 1129 | CH₃ | CH₃ | H | S |
| 1130 | CH₃ | H | H | S |
| 1131 | CH₃ | C₂H₅ | H | S |
| 1132 | CH₃ | n-C₃H₇ | H | S |
| 1133 | CH₃ | i-C₃H₇ | H | S |
| 1134 | CH₃ | n-C₄H₉ | H | S |
| 1135 | CH₃ | i-C₄H₉ | H | S |
| 1136 | CH₃ | s-C₄H₉ | H | S |
| 1137 | CH₃ | t-C₄H₉ | H | S |
| 1138 | CH₃ | CH₂OCH₃ | H | S |
| 1139 | CH₃ | CF₃ | H | S |
| 1140 | CH₃ | CF₂H | H | S |
| 1141 | CH₃ | CN | H | S |
| 1142 | CH₃ | OH | H | S |
| 1143 | CH₃ | OCH₃ | H | S |
| 1144 | CH₃ | NH₂ | H | S |
| 1145 | CH₃ | NHCH₃ | H | S |
| 1146 | CH₃ | N(CH₃)₂ | H | S |
| 1147 | CH₃ | CO₂CH₃ | H | S |
| 1148 | CH₃ | CO₂C₂H₅ | H | S |
| 1149 | CH₃ | C(O)CH₃ | H | S |
| 1150 | CH₃ | C(O)CF₃ | H | S |
| 1151 | CH₃ | C(═NOCH₃)CH₃ | H | S |
| 1152 | CH₃ | SO₂CH₃ | H | S |
| 1153 | CH₃ | SO₂CF₃ | H | S |
| 1154 | CH₃ | CH₂CO₂H | H | S |
| 1155 | CH₃ | CH₂COOCH₃ | H | S |
| 1156 | CH₃ | CH₂COOC₂H₅ | H | S |
| 1157 | CH₃ | prop-1-en-3-yl | H | S |
| 1158 | CH₃ | trans-but-2-en-1-yl | H | S |
| 1159 | CH₃ | cis-but-2-en-1-yl | H | S |
| 1160 | CH₃ | cis-3-methyl- | H | S |
| | | but-2-en-1-yl | | |
| 1161 | CH₃ | cyclopropyl | H | S |
| 1162 | CH₃ | cyclopentyl | H | S |
| 1163 | CH₃ | cyclohexyl | H | S |
| 1164 | CH₃ | 4,5-dihydroisoxazol- | H | S |
| | | 3-yl | | |
| 1165 | CH₃ | 4-methyl-4,5-dihydroisoxazol- | H | S |
| | | 3-yl | | |
| 1166 | CH₃ | isoxazol-3-yl | H | S |
| 1167 | CH₃ | 4-methylisoxazol-3-yl | H | S |
| 1168 | CH₃ | 4,5-dihydroisoxazol- | H | S |
| | | 4-y1 | | |
| 1169 | CH₃ | 3-methyl-4,5-dihydroisoxazol- | H | S |
| | | 4-yl | | |
| 1170 | CH₃ | isoxazol-4-yl | H | S |
| 1171 | CH₃ | 3-methylisoxazol-4-yl | H | S |
| 1172 | CH₃ | phenyl | H | S |
| 1173 | CH₃ | benzyl | H | S |
| 1174 | CH₃ | benzoyl | H | S |
| 1175 | CH₃ | 2-pyridyl | H | S |
| 1176 | CH₃ | H | CH₃ | S |
| 1177 | CH₃ | CH₃ | CH₃ | S |
| 1178 | CH₃ | C₂H₅ | CH₃ | S |
| 1179 | CH₃ | n-C₃H₇ | CH₃ | S |
| 1180 | CH₃ | i-C₃H₇ | CH₃ | S |
| 1181 | CH₃ | n-C₄H₉ | CH₃ | S |
| 1182 | CH₃ | i-C₄H₉ | CH₃ | S |
| 1183 | CH₃ | s-C₄H₉ | CH₃ | S |
| 1184 | CH₃ | t-C₄H₉ | CH₃ | S |
| 1185 | CH₃ | CH₂OCH₃ | CH₃ | S |
| 1186 | CH₃ | CF₃ | CH₃ | S |
| 1187 | CH₃ | CF₂H | CH₃ | S |
| 1188 | CH₃ | CN | CH₃ | S |
| 1189 | CH₃ | OH | CH₃ | S |
| 1190 | CH₃ | OCH₃ | CH₃ | S |
| 1191 | CH₃ | NH₂ | CH₃ | S |
| 1192 | CH₃ | NHCH₃ | CH₃ | S |
| 1193 | CH₃ | N(CH₃)₂ | CH₃ | S |
| 1194 | CH₃ | CO₂CH₃ | CH₃ | S |
| 1195 | CH₃ | CO₂C₂H₅ | CH₃ | S |
| 1196 | CH₃ | C(O)CH₃ | CH₃ | S |
| 1197 | CH₃ | C(O)CF₃ | CH₃ | S |
| 1198 | CH₃ | C(═NOCH₃)CH₃ | CH₃ | S |
| 1199 | CH₃ | SO₂CH₃ | CH₃ | S |
| 1200 | CH₃ | SO₂CF₃ | CH₃ | S |
| 1201 | CH₃ | CH₂CO₂H | CH₃ | S |
| 1202 | CH₃ | CH₂COOCH₃ | CH₃ | S |
| 1203 | CH₃ | CH₂COOC₂H₅ | CH₃ | S |
| 1204 | CH₃ | prop-1-en-3-yl | CH₃ | S |
| 1205 | CH₃ | trans-but-2-en-1-yl | CH₃ | S |
| 1206 | CH₃ | cis-but-2-en-1-yl | CH₃ | S |
| 1207 | CH₃ | cis-3-methyl- | CH₃ | S |
| | | but-2-en-1-yl | | |
| 1208 | CH₃ | cyclopropyl | CH₃ | S |
| 1209 | CH₃ | cyclopentyl | CH₃ | S |
| 1210 | CH₃ | cyclohexyl | CH₃ | S |
| 1211 | CH₃ | 4,5-dihydroisoxazol- | CH₃ | S |
| | | 3-yl | | |
| 1212 | CH₃ | 4-methyl-4,5-dihydroisoxazol- | CH₃ | S |
| | | 3-yl | | |
| 1213 | CH₃ | isoxazol-3-yl | CH₃ | S |
| 1214 | CH₃ | 4-methylisoxazol-3-yl | CH₃ | S |
| 1215 | CH₃ | 4,5-dihydroisoxazol- | CH₃ | S |
| | | 4-yl | | |
| 1216 | CH₃ | 3-methyl-4,5-dihydroisoxazol- | CH₃ | S |
| | | 4-yl | | |
| 1217 | CH₃ | isoxazol-4-yl | CH₃ | S |
| 1218 | CH₃ | 3-methylisoxazol-4-yl | CH₃ | S |
| 1219 | CH₃ | phenyl | CH₃ | S |
| 1220 | CH₃ | benzyl | CH₃ | S |
| 1221 | CH₃ | benzoyl | CH₃ | S |
| 1222 | CH₃ | 2-pyridyl | CH₃ | S |
| 1223 | CH₃ | H | Cl | S |
| 1224 | CH₃ | CH₃ | Cl | S |
| 1225 | CH₃ | C₂H₅ | Cl | S |
| 1226 | CH₃ | n-C₃H₇ | Cl | S |
| 1227 | CH₃ | i-C₃H₇ | Cl | S |
| 1228 | CH₃ | n-C₄H₉ | Cl | S |
| 1229 | CH₃ | i-C₄H₉ | Cl | S |
| 1230 | CH₃ | s-C₄H₉ | Cl | S |
| 1231 | CH₃ | t-C₄H₉ | Cl | S |
| 1232 | CH₃ | CH₂OCH₃ | Cl | S |
| 1233 | CH₃ | CF₃ | Cl | S |
| 1234 | CH₃ | CF₂H | Cl | S |
| 1235 | CH₃ | CN | Cl | S |
| 1236 | CH₃ | OH | Cl | S |
| 1237 | CH₃ | OCH₃ | Cl | S |
| 1238 | CH₃ | NH₂ | Cl | S |
| 1239 | CH₃ | NHCH₃ | Cl | S |
| 1240 | CH₃ | N(CH₃)₂ | Cl | S |
| 1241 | CH₃ | CO₂CH₃ | Cl | S |
| 1242 | CH₃ | CO₂C₂H₅ | Cl | S |
| 1243 | CH₃ | C(O)CH₃ | Cl | S |
| 1244 | CH₃ | C(O)CF₃ | Cl | S |
| 1245 | CH₃ | C(═NOCH₃)CH₃ | Cl | S |
| 1246 | CH₃ | SO₂CH₃ | Cl | S |
| 1247 | CH₃ | SO₂CF₃ | Cl | S |
| 1248 | CH₃ | CH₂CO₂H | Cl | S |
| 1249 | CH₃ | CH₂COOCH₃ | Cl | S |
| 1250 | CH₃ | CH₂COOC₂H₅ | Cl | S |
| 1251 | CH₃ | prop-1-en-3-yl | Cl | S |
| 1252 | CH₃ | trans-but-2-en-1-yl | Cl | S |
| 1253 | CH₃ | cis-but-2-en-1-yl | Cl | S |
| 1254 | CH₃ | cis-3-methyl- | Cl | S |
| | | but-2-en-1-yl | | |
| 1255 | CH₃ | cyclopropyl | Cl | S |
| 1256 | CH₃ | cyclopentyl | Cl | S |
| 1257 | CH₃ | cyclohexyl | Cl | S |
| 1258 | CH₃ | 4,5-dihydroisoxazol- | Cl | S |
| | | 3-yl | | |
| 1259 | CH₃ | 4-methyl-4,5-dihydroisoxazol- | Cl | S |
| | | 3-yl | | |
| 1260 | CH₃ | isoxazol-3-yl | Cl | S |
| 1261 | CH₃ | 4-methylisoxazol-3-yl | Cl | S |
| 1262 | CH₃ | 4,5-dihydroisoxazol- | Cl | S |
| | | 4-yl | | |
| 1263 | CH₃ | 3-methyl-4,5-dihydroisoxazol- | Cl | S |
| | | 4-yl | | |
| 1264 | CH₃ | isoxazol-4-yl | Cl | S |
| 1265 | CH₃ | 3-methylisoxazol-4-yl | Cl | S |
| 1266 | CH₃ | phenyl | Cl | S |
| 1267 | CH₃ | benzyl | Cl | S |
| 1268 | CH₃ | benzoyl | Cl | S |
| 1269 | CH₃ | 2-pyridyl | Cl | S |
| 1270 | Cl | H | H | S |
| 1271 | Cl | CH₃ | H | S |
| 1272 | Cl | C₂H₅ | H | S |
| 1273 | Cl | n-C₃H₇ | H | S |
| 1274 | Cl | i-C₃H₇ | H | S |
| 1275 | Cl | n-C₄H₉ | H | S |
| 1276 | Cl | i-C₄H₉ | H | S |
| 1277 | Cl | s-C₄H₉ | H | S |
| 1278 | Cl | t-C₄H₉ | H | S |
| 1279 | Cl | CH₂OCH₃ | H | S |
| 1280 | Cl | CF₃ | H | S |
| 1281 | Cl | CF₂H | H | S |
| 1282 | Cl | CN | H | S |
| 1283 | Cl | OH | H | S |
| 1284 | Cl | OCH₃ | H | S |
| 1285 | Cl | NH₂ | H | S |
| 1286 | Cl | NHCH₃ | H | S |
| 1287 | Cl | N(CH₃)₂ | H | S |
| 1288 | Cl | CO₂CH₃ | H | S |
| 1289 | Cl | CO₂C₂H₅ | H | S |
| 1290 | Cl | C(O)CH₃ | H | S |
| 1291 | Cl | C(O)CF₃ | H | S |
| 1292 | Cl | C(═NOCH₃)CH₃ | H | 5 |
| 1293 | Cl | SO₂CH₃ | H | S |
| 1294 | Cl | SO₂CF₃ | H | S |
| 1295 | Cl | CH₂CO₂H | H | S |
| 1296 | Cl | CH₂COOCH₃ | H | S |
| 1297 | Cl | CH₂COOC₂H₅ | H | S |
| 1298 | Cl | Prop-1-en-3-yl | H | S |
| 1299 | Cl | trans-but-2-en-1-yl | H | S |
| 1300 | Cl | cis-but-2-en-1-yl | H | S |
| 1301 | Cl | cis-3-methyl- | H | S |
| | | but-2-en-1-yl | | |
| 1302 | Cl | cyclopropyl | H | S |
| 1303 | Cl | cyclopentyl | H | S |
| 1304 | Cl | cyclohexyl | H | S |
| 1305 | Cl | 4,5-dihydroisoxazol- | H | S |
| | | 3-yl | | |
| 1306 | Cl | 4-methyl-4,5-dihydroisoxazol- | H | S |
| | | 3-yl | | |
| 1307 | Cl | isoxazol-3-yl | H | S |
| 1308 | Cl | 4-methylisoxazol-3-yl | H | S |
| 1309 | Cl | 4,5-dihydroisoxazol- | H | S |
| | | 4-yl | | |
| 1310 | Cl | 3-methyl-4,5-dihydroisoxazol- | H | S |
| | | 4-yl | | |
| 1311 | Cl | isoxazol-4-yl | H | S |
| 1312 | Cl | 3-methylisoxazol-4-yl | H | S |
| 1313 | Cl | phenyl | H | S |
| 1314 | Cl | benzyl | H | S |
| 1315 | Cl | benzoyl | H | S |
| 1316 | Cl | 2-pyridyl | H | S |
| 1317 | Cl | H | CH₃ | S |
| 1318 | Cl | CH₃ | CH₃ | S |
| 1319 | Cl | C₂H₅ | CH₃ | S |
| 1320 | Cl | n-C₃H₇ | CH₃ | S |
| 1321 | Cl | i-C₃H₇ | CH₃ | S |
| 1322 | Cl | n-C₄H₉ | CH₃ | S |
| 1323 | Cl | i-C₄H₉ | CH₃ | S |
| 1324 | Cl | s-C₄H₉ | CH₃ | S |
| 1325 | Cl | t-C₄H₉ | CH₃ | S |
| 1326 | Cl | CH₂OCH₃ | CH₃ | S |
| 1327 | Cl | CF₃ | CH₃ | S |
| 1328 | Cl | CF₂H | CH₃ | S |
| 1329 | Cl | CN | CH₃ | S |
| 1330 | Cl | OH | CH₃ | S |
| 1331 | Cl | OCH₃ | CH₃ | S |
| 1332 | Cl | NH₂ | CH₃ | S |
| 1333 | Cl | NHCH₃ | CH₃ | S |
| 1334 | Cl | N(CH₃)₂ | CH₃ | S |
| 1335 | Cl | CO₂CH₃ | CH₃ | S |
| 1336 | Cl | CO₂C₂H₅ | CH₃ | S |
| 1337 | Cl | C(O)CH₃ | CH₃ | S |
| 1338 | Cl | C(O)CF₃ | CH₃ | S |
| 1339 | Cl | C(═NOCH₃)CH₃ | CH₃ | S |
| 1340 | Cl | SO₂CH₃ | CH₃ | S |
| 1341 | Cl | SO₂CF₃ | CH₃ | S |
| 1342 | Cl | CH₂CO₂H | CH₃ | S |
| 1343 | Cl | CH₂COOCH₃ | CH₃ | S |
| 1344 | Cl | CH₂COOC₂H₅ | CH₃ | S |
| 1345 | Cl | prop-1-en-3-yl | CH₃ | S |
| 1346 | Cl | trans-but-2-en-1-yl | CH₃ | S |
| 1347 | Cl | cis-but-2-en-1-yl | CH₃ | S |
| 1348 | Cl | cis-3-methyl- | CH₃ | S |
| | | but-2-en-1-yl | | |
| 1349 | Cl | cyclopropyl | CH₃ | S |
| 1350 | Cl | cyclopentyl | CH₃ | S |
| 1351 | Cl | cyclohexyl | CH₃ | S |
| 1352 | Cl | 4,5-dihydroisoxazol- | CH₃ | S |
| | | 3-yl | | |
| 1353 | Cl | 4-methyl-4,5-dihydroisoxazol- | CH₃ | S |
| | | 3-yl | | |
| 1354 | Cl | isoxazol-3-yl | CH₃ | S |
| 1355 | Cl | 4-methylisoxazol-3-yl | CH₃ | S |
| 1356 | Cl | 4,5-dihydroisoxazol- | CH₃ | S |
| | | 4-yl | | |
| 1357 | Cl | 3-methyl-4,5-dihydroisoxazol- | CH₃ | S |
| | | 4-yl | | |
| 1358 | Cl | isoxazol-4-yl | CH₃ | S |
| 1359 | Cl | 3-methylisoxazol-4-yl | CH₃ | S |
| 1360 | Cl | phenyl | CH₃ | S |
| 1361 | Cl | benzyl | CH₃ | S |
| 1362 | Cl | benzoyl | CH₃ | S |
| 1363 | Cl | 2-pyridyl | CH₃ | S |
| 1364 | Cl | H | Cl | S |
| 1365 | Cl | CH₃ | Cl | S |
| 1366 | Cl | C₂H₅ | Cl | S |
| 1367 | Cl | n-C₃H₇ | Cl | S |
| 1368 | Cl | i-C₃H₇ | Cl | S |
| 1369 | Cl | n-C₄H₉ | Cl | S |
| 1370 | Cl | i-C₄H₉ | Cl | S |
| 1371 | Cl | s-C₄H₉ | Cl | S |
| 1372 | Cl | t-C₄H₉ | Cl | S |
| 1373 | Cl | CH₂OCH₃ | Cl | S |
| 1374 | Cl | CF₃ | Cl | S |
| 1375 | Cl | CF₂H | Cl | S |
| 1376 | Cl | CN | Cl | S |
| 1377 | Cl | OH | Cl | S |
| 1378 | Cl | OCH₃ | Cl | S |
| 1379 | Cl | NH₂ | Cl | S |
| 1380 | Cl | NHCH₃ | Cl | s |
| 1381 | Cl | N(CH₃)₂ | Cl | S |
| 1382 | Cl | CO₂CH₃ | Cl | S |
| 1383 | Cl | CO₂C₂H₅ | Cl | S |
| 1384 | Cl | C(O)CH₃ | Cl | S |
| 1385 | Cl | C(O)CF₃ | Cl | S |
| 1386 | Cl | C(═NOCH₃)CH₃ | Cl | S |
| 1387 | Cl | SO₂CH₃ | Cl | S |
| 1388 | Cl | SO₂CF₃ | Cl | S |
| 1389 | Cl | CH₂CO₂H | Cl | S |
| 1390 | Cl | CH₂COOCH₃ | Cl | S |
| 1391 | Cl | CH₂COOC₂H₅ | Cl | S |
| 1392 | Cl | prop-1-en-3-yl | Cl | S |
| 1393 | Cl | trans-but-2-en-1-yl | Cl | S |
| 1394 | Cl | cis-but-2-en-1-yl | Cl | S |
| 1395 | Cl | cis-3-methyl- | Cl | S |
| | | but-2-en-1-yl | | |
| 1396 | Cl | cyclopropyl | Cl | S |
| 1397 | Cl | cyclopentyl | Cl | S |
| 1398 | Cl | cyclohexyl | Cl | S |
| 1399 | Cl | 4,5-dihydroisoxazol- | Cl | S |
| | | 3-yl | | |
| 1400 | Cl | 4-methyl-4,5-dihydroisoxazol- | Cl | S |
| | | 3-yl | | |
| 1401 | Cl | isoxazol-3-yl | Cl | S |
| 1402 | Cl | 4-methylisoxazol-3-yl | Cl | S |
| 1403 | Cl | 4,5-dihydroisoxazol- | Cl | S |
| | | 4-yl | | |
| 1404 | Cl | 3-methyl-4,5-dihydroisoxazol- | Cl | S |
| | | 4-yl | | |
| 1405 | Cl | isoxazol-4-yl | Cl | S |
| 1406 | Cl | 3-methylisoxazol-4-yl | Cl | S |
| 1407 | Cl | phenyl | Cl | S |
| 1408 | Cl | benzyl | Cl | S |
| 1409 | Cl | benzoyl | Cl | S |
| 1410 | Cl | 2-pyridyl | Cl | S |
| 1411 | OCH₃ | H | H | S |
| 1412 | OCH₃ | CH₃ | H | S |
| 1413 | OCH₃ | C₂H₅ | H | S |
| 1414 | OCH₃ | n-C₃H₇ | H | S |
| 1415 | OCH₃ | i-C₃H₇ | H | S |
| 1416 | OCH₃ | n-C₄H₉ | H | S |
| 1417 | OCH₃ | i-C₄H₉ | H | S |
| 1418 | OCH₃ | s-C₄H₉ | H | S |
| 1419 | OCH₃ | t-C₄H₉ | H | S |
| 1420 | OCH₃ | CH₂OCH₃ | H | S |
| 1421 | OCH₃ | CF₃ | H | S |
| 1422 | OCH₃ | CF₂H | H | S |
| 1423 | OCH₃ | CN | H | S |
| 1424 | OCH₃ | OH | H | S |
| 1425 | OCH₃ | OCH₃ | H | S |
| 1426 | OCH₃ | NH₂ | H | S |
| 1427 | OCH₃ | NHCH₃ | H | S |
| 1428 | OCH₃ | N(CH₃)₂ | H | S |
| 1429 | OCH₃ | CO₂CH₃ | H | S |
| 1430 | OCH₃ | CO₂C₂H₅ | H | 5 |
| 1431 | OCH₃ | C(O)CH₃ | H | S |
| 1432 | OCH₃ | C(O)CF₃ | H | S |
| 1433 | OCH₃ | C(═NOCH₃)CH₃ | H | S |
| 1434 | OCH₃ | SO₂CH₃ | H | S |
| 1435 | OCH₃ | SO₂CF₃ | H | S |
| 1436 | OCH₃ | CH₂CO₂H | H | S |
| 1437 | OCH₃ | CH₂COOCH₃ | H | S |
| 1438 | OCH₃ | CH₂COOC₂H₅ | H | S |
| 1439 | OCH₃ | prop-1-en-3-yl | H | S |
| 1440 | OCH₃ | trans-but-2-en-1-yl | H | S |
| 1441 | OCH₃ | cis-but-2-en-1-yl | H | S |
| 1442 | OCH₃ | cis-3-methyl- | H | S |
| | | but-2-en-1-yl | | |
| 1443 | OCH₃ | cyclopropyl | H | S |
| 1444 | OCH₃ | cyclopentyl | H | S |
| 1445 | OCH₃ | cyclohexyl | H | S |
| 1446 | OCH₃ | 4,5-dihydroisoxazol- | H | S |
| | | 3-yl | | |
| 1447 | OCH₃ | 4-methyl-4,5-dihydroisoxazol- | H | S |
| | | 3-yl | | |
| 1448 | OCH₃ | isoxazol-3-yl | H | S |
| 1449 | OCH₃ | 4-methylisoxazol-3-yl | H | S |
| 1450 | OCH₃ | 4,5-dihydroisoxazol- | H | S |
| | | 4-yl | | |
| 1451 | OCH₃ | 3-methyl-4,5-dihydroisoxazol- | H | S |
| | | 4 -yl | | |
| 1452 | OCH₃ | isoxazol-4-yl | H | S |
| 1453 | OCH₃ | 3-methylisoxazol-4-yl | H | S |
| 1454 | OCH₃ | phenyl | H | S |
| 1455 | OCH₃ | benzyl | H | S |
| 1456 | OCH₃ | benzoyl | H | S |
| 1457 | OCH₃ | 2-pyridyl | H | S |
| 1458 | OCH₃ | H | CH₃ | S |
| 1459 | OCH₃ | CH₃ | CH₃ | S |
| 1460 | OCH₃ | C₂H₅ | CH₃ | S |
| 1461 | OCH₃ | n-C₃H₇ | CH₃ | S |
| 1462 | OCH₃ | i-C₃H₇ | CH₃ | S |
| 1463 | OCH₃ | n-C₄H₉ | CH₃ | S |
| 1464 | OCH₃ | i-C₄H₉ | CH₃ | S |
| 1465 | OCH₃ | s-C₄H₉ | CH₃ | S |
| 1466 | OCH₃ | t-C₄H₉ | CH₃ | S |
| 1467 | OCH₃ | CH₂OCH₃ | CH₃ | S |
| 1468 | OCH₃ | CF₃ | CH₃ | S |
| 1469 | OCH₃ | CF₂H | CH₃ | S |
| 1470 | OCH₃ | CN | CH₃ | S |
| 1471 | OCH₃ | OH | CH₃ | S |
| 1472 | OCH₃ | OCH₃ | CH₃ | S |
| 1473 | OCH₃ | NH₂ | CH₃ | S |
| 1474 | OCH₃ | NHCH₃ | CH₃ | S |
| 1475 | OCH₃ | N(CH₃)₂ | CH₃ | S |
| 1476 | OCH₃ | CO₂CH₃ | CH₃ | S |
| 1477 | OCH₃ | CO₂C₂H₅ | CH₃ | S |
| 1478 | OCH₃ | C(O)CH₃ | CH₃ | S |
| 1479 | OCH₃ | C(O)CF₃ | CH₃ | S |
| 1480 | OCH₃ | C(═NOCH₃)CH₃ | CH₃ | S |
| 1481 | OCH₃ | SO₂CH₃ | CH₃ | S |
| 1482 | OCH₃ | SO₂CF₃ | CH₃ | S |
| 1483 | OCH₃ | CH₂CO₂H | CH₃ | S |
| 1484 | OCH₃ | CH₂COOCH₃ | CH₃ | S |
| 1485 | OCH₃ | CH₂COOC₂H₅ | CH₃ | S |
| 1486 | OCH₃ | prop-1-en-3-yl | CH₃ | S |
| 1487 | OCH₃ | trans-but-2-en-1-yl | CH₃ | S |
| 1488 | OCH₃ | cis-but-2-en-1-yl | CH₃ | S |
| 1489 | OCH₃ | cis-3-methyl- | CH₃ | S |
| | | but-2-en-1-yl | | |
| 1490 | OCH₃ | cyclopropyl | CH₃ | S |
| 1491 | OCH₃ | cyclopentyl | CH₃ | S |
| 1492 | OCH₃ | cyclohexyl | CH₃ | S |
| 1493 | OCH₃ | 4,5-dihydroisoxazol- | CH₃ | S |
| | | 3-yl | | |
| 1494 | OCH₃ | 4-methyl-4,5-dihydroisoxazol- | CH₃ | S |
| | | 3-yl | | |
| 1495 | OCH₃ | isoxazol-3-yl | CH₃ | S |
| 1496 | OCH₃ | 4-methylisoxazol-3-yl | CH₃ | S |
| 1497 | OCH₃ | 4,5-dihydroisoxazol- CH₃ | S | |
| | | 4-yl | | |
| 1498 | OCH₃ | 3-methyl-4,5-dihydroisoxazol- | CH₃ | S |
| | | 4-yl | | |
| 1499 | OCH₃ | isoxazol-4-yl | CH₃ | S |
| 1500 | OCH₃ | 3-methylisoxazol-4-yl | CH₃ | S |
| 1501 | OCH₃ | phenyl | CH₃ | S |
| 1502 | OCH₃ | benzyl | CH₃ | S |
| 1503 | OCH₃ | benzoyl | CH₃ | S |
| 1504 | OCH₃ | 2-pyridyl | CH₃ | S |
| 1505 | OCH₃ | H | Cl | S |
| 1506 | OCH₃ | CH₃ | Cl | S |
| 1507 | OCH₃ | C₂H₅ | Cl | S |
| 1508 | OCH₃ | n-C₃H₇ | Cl | S |
| 1509 | OCH₃ | i-C₃H₇ | Cl | S |
| 1510 | OCH₃ | n-C₄H₉ | Cl | S |
| 1511 | OCH₃ | i-C₄H₉ | Cl | S |
| 1512 | OCH₃ | s-C₄H₉ | Cl | S |
| 1513 | OCH₃ | t-C₄H₉ | Cl | S |
| 1514 | OCH₃ | CH₂OCH₃ | Cl | S |
| 1515 | OCH₃ | CF₃ | Cl | S |
| 1516 | OCH₃ | CF₂H | Cl | S |
| 1517 | OCH₃ | CN | Cl | S |
| 1518 | OCH₃ | OH | Cl | S |
| 1519 | OCH₃ | OCH₃ | Cl | S |
| 1520 | OCH₃ | NH₂ | Cl | S |
| 1521 | OCH₃ | NHCH₃ | Cl | S |
| 1522 | OCH₃ | N(CH₃)₂ | Cl | S |
| 1523 | OCH₃ | CO₂CH₃ | Cl | S |
| 1524 | OCH₃ | CO₂C₂H₅ | Cl | S |
| 1525 | OCH₃ | C(O)CH₃ | Cl | S |
| 1526 | OCH₃ | C(O)CF₃ | Cl | S |
| 1527 | OCH₃ | C(═NOCH₃)CH₃ | Cl | S |
| 1528 | OCH₃ | SO₂CH₃ | Cl | S |
| 1529 | OCH₃ | SO₂CF₃ | Cl | S |
| 1530 | OCH₃ | CH₂CO₂H | Cl | S |
| 1531 | OCH₃ | CH₂COOCH₃ | Cl | S |
| 1532 | OCH₃ | CH₂COOC₂H₅ | Cl | S |
| 1533 | OCH₃ | prop-1-en-3-yl | Cl | S |
| 1534 | OCH₃ | trans-but-2-en-1-yl | Cl | S |
| 1535 | OCH₃ | cis-but-2-en-1-yl | Cl | S |
| 1536 | OCH₃ | cis-3-methyl- | Cl | S |
| | | but-2-en-1-yl | | |
| 1537 | OCH₃ | cyclopropyl | Cl | S |
| 1538 | OCH₃ | cyclopentyl | Cl | S |
| 1539 | OCH₃ | cyclohexyl | Cl | S |
| 1540 | OCH₃ | 4,5-dihydroisoxazol- | Cl | S |
| | | 3-yl | | |
| 1541 | OCH₃ | 4-methyl-4,5-dihydroisoxazol- | Cl | S |
| | | 3-yl | | |
| 1542 | OCH₃ | isoxazol-3-yl | Cl | S |
| 1543 | OCH₃ | 4-methylisoxazol-3-yl | Cl | S |
| 1544 | OCH₃ | 4,5-dihydroisoxazol- | Cl | S |
| | | 4-yl | | |
| 1545 | OCH₃ | 3-methyl-4,5-dihydroisoxazol- | Cl | S |
| | | 4-yl | | |
| 1546 | OCH₃ | isoxazol-4-yl | Cl | S |
| 1547 | OCH₃ | 3-methylisoxazol-4-yl | Cl | S |
| 1548 | OCH₃ | phenyl | Cl | S |
| 1549 | OCH₃ | benzyl | Cl | S |
| 1550 | OCH₃ | benzoyl | Cl | S |
| 1551 | OCH₃ | 2-pyridyl | Cl | S |
| 1552 | OCF₃ | H | H | S |
| 1553 | OCF₃ | CH₃ | H | S |
| 1554 | OCF₃ | C₂H₅ | H | S |
| 1555 | OCF₃ | n-C₃H₇ | H | S |
| 1556 | OCF₃ | i-C₃H₇ | H | S |
| 1557 | OCF₃ | n-C₄H₉ | H | S |
| 1558 | OCF₃ | i-C₄H₉ | H | S |
| 1559 | OCF₃ | s-C₄H₉ | H | S |
| 1560 | OCF₃ | t-C₄H₉ | H | S |
| 1561 | OCF₃ | CH₂OCH₃ | H | S |
| 1562 | OCF₃ | CF₃ | H | S |
| 1563 | OCF₃ | CF₂H | H | S |
| 1564 | OCF₃ | CN | H | S |
| 1565 | OCF₃ | OH | H | S |
| 1566 | OCF₃ | OCH₃ | H | S |
| 1567 | OCF₃ | NH₂ | H | S |
| 1568 | OCF₃ | NHCH₃ | H | S |
| 1569 | OCF₃ | N(CH₃)₂ | H | S |
| 1570 | OCF₃ | CO₂CH₃ | H | S |
| 1571 | OCF₃ | CO₂C₂H₅ | H | S |
| 1572 | OCF₃ | C(O)CH₃ | H | S |
| 1573 | OCF₃ | C(O)CF₃ | H | S |
| 1574 | OCF₃ | C(═NOCH₃)CH₃ | H | S |
| 1575 | OCF₃ | SO₂CH₃ | H | S |
| 1576 | OCF₃ | SO₂CF₃ | H | S |
| 1577 | OCF₃ | CH₂CO₂H | H | S |
| 1578 | OCF₃ | CH₂COOCH₃ | H | S |
| 1579 | OCF₃ | CH₂COOC₂H₅ | H | S |
| 1580 | OCF₃ | prop-1-en-3-yl | H | S |
| 1581 | OCF₃ | trans-but-2-en-1-yl | H | S |
| 1582 | OCF₃ | cis-but-2-en-1-yl | H | S |
| 1583 | OCF₃ | cis-3-methyl- | H | S |
| | | but-2-en-1-yl | | |
| 1584 | OCF₃ | cyclopropyl | H | S |
| 1585 | OCF₃ | cyclopentyl | H | S |
| 1586 | OCF₃ | cyclohexyl | H | S |
| 1587 | OCF₃ | 4,5-dihydroisoxazol- | H | S |
| | | 3-yl | | |
| 1588 | OCF₃ | 4-methyl-4,5-dihydroisoxazol- | H | S |
| | | 3-yl | | |
| 1589 | OCF₃ | isoxazol-3-yl | H | S |
| 1590 | OCF₃ | 4-methylisoxazol-3-yl | H | S |
| 1591 | OCF₃ | 4,5-dihydroisoxazol- | H | S |
| | | 4-yl | | |
| 1592 | OCF₃ | 3-methyl-4,5-dihydroisoxazol- | H | S |
| | | 4-yl | | |
| 1593 | OCF₃ | isoxazol-4-yl | H | S |
| 1594 | OCF₃ | 3-methylisoxazol-4-yl | H | S |
| 1595 | OCF₃ | phenyl | H | S |
| 1596 | OCF₃ | benzyl | H | S |
| 1597 | OCF₃ | benzoyl | H | S |
| 1598 | OCF₃ | 2-pyridyl | H | S |
| 1599 | OCF₃ | H | CH₃ | S |
| 1600 | OCF₃ | CH₃ | CH₃ | S |
| 1601 | OCF₃ | C₂H₅ | CH₃ | S |
| 1602 | OCF₃ | n-C₃H₇ | CH₃ | S |
| 1603 | OCF₃ | i-C₃H₇ | CH₃ | S |
| 1604 | OCF₃ | n-C₄H₉ | CH₃ | S |
| 1605 | OCF₃ | i-C₄H₉ | CH₃ | S |
| 1606 | OCF₃ | s-C₄H₉ | CH₃ | S |
| 1607 | OCF₃ | t-C₄H₉ | CH₃ | S |
| 1608 | OCF₃ | CH₂OCH₃ | CH₃ | S |
| 1609 | OCF₃ | CF₃ | CH₃ | S |
| 1610 | OCF₃ | CF₂H | CH₃ | S |
| 1611 | OCF₃ | CN | CH₃ | S |
| 1612 | OCF₃ | OH | CH₃ | S |
| 1613 | OCF₃ | OCH₃ | CH₃ | S |
| 1614 | OCF₃ | NH₂ | CH₃ | S |
| 1615 | OCF₃ | NHCH₃ | CH₃ | S |
| 1616 | OCF₃ | N(CH₃)2 | CH₃ | S |
| 1617 | OCF₃ | CO₂CH₃ | CH₃ | S |
| 1618 | OCF₃ | CO₂C₂H₅ | CH₃ | S |
| 1619 | OCF₃ | C(O)CH₃ | CH₃ | S |
| 1620 | OCF₃ | C(O)CF₃ | CH₃ | S |
| 1621 | OCF₃ | C(═NOCH₃)CH₃ | CH₃ | S |
| 1622 | OCF₃ | SO₂CH₃ | CH₃ | S |
| 1623 | OCF₃ | SO₂CF₃ | CH₃ | S |
| 1624 | OCF₃ | CH₂CO₂H | CH₃ | S |
| 1625 | OCF₃ | CH₂COOCH₃ | CH₃ | S |
| 1626 | OCF₃ | CH₂COOC₂H₅ | CH₃ | S |
| 1627 | OCF₃ | prop-1-en-3-yl | CH₃ | S |
| 1628 | OCF₃ | trans-but-2-en-1-yl | CH₃ | S |
| 1629 | OCF₃ | cis-but-2-en-1-yl | CH₃ | S |
| 1630 | OCF₃ | cis-3-methyl- | CH₃ | S |
| | | but-2-en-1-yl | | |
| 1631 | OCF₃ | cyclopropyl | CH₃ | S |
| 1632 | OCF₃ | cyclopentyl | CH₃ | S |
| 1633 | OCF₃ | cyclohexyl | CH₃ | S |
| 1634 | OCF₃ | 4,5-dihydroisoxazol- | CH₃ | S |
| | | 3-yl | | |
| 1635 | OCF₃ | 4-methyl-4,5-dihydroisoxazol- | CH₃ | S |
| | | 3-yl | | |
| 1636 | OCF₃ | isoxazol-3-yl | CH₃ | S |
| 1637 | OCF₃ | 4-methylisoxazol-3-yl | CH₃ | S |
| 1638 | OCF₃ | 4,5-dihydroisoxazol- | CH₃ | S |
| | | 4-yl | | |
| 1639 | OCF₃ | 3-methyl-4,5-dihydroisoxazol- | CH₃ | S |
| | | 4-yl | | |
| 1640 | OCF₃ | isoxazol-4-yl | CH₃ | S |
| 1641 | OCF₃ | 3-methylisoxazol-4-yl | CH₃ | S |
| 1642 | OCF₃ | phenyl | CH₃ | S |
| 1643 | OCF₃ | benzyl | CH₃ | S |
| 1644 | OCF₃ | benzoyl | CH₃ | S |
| 1645 | OCF₃ | 2-pyridyl | CH₃ | S |
| 1646 | OCF₃ | H | Cl | S |
| 1647 | OCF₃ | CH₃ | Cl | S |
| 1648 | OCF₃ | C₂H₅ | Cl | S |
| 1649 | OCF₃ | n-C₃H₇ | Cl | S |
| 1650 | OCF₃ | i-C₃H₇ | Cl | S |
| 1651 | OCF₃ | n-C₄H₉ | Cl | S |
| 1652 | OCF₃ | i-C₄H₉ | Cl | S |
| 1653 | OCF₃ | s-C₄H₉ | Cl | S |
| 1654 | OCF₃ | t-C₄H₉ | Cl | S |
| 1655 | OCF₃ | CH₂OCH₃ | Cl | S |
| 1656 | OCF₃ | CF₃ | Cl | S |
| 1657 | OCF₃ | CF₂H | Cl | S |
| 1658 | OCF₃ | CN | Cl | S |
| 1659 | OCF₃ | OH | Cl | S |
| 1660 | OCF₃ | OCH₃ | Cl | S |
| 1661 | OCF₃ | NH₂ | Cl | S |
| 1662 | OCF₃ | NHCH₃ | Cl | S |
| 1663 | OCF₃ | N(CH₃)₂ | Cl | S |
| 1664 | OCF₃ | CO₂CH₃ | Cl | S |
| 1665 | OCF₃ | CO₂C₂H₅ | Cl | S |
| 1666 | OCF₃ | C(O)CH₃ | Cl | S |
| 1667 | OCF₃ | C(O)CF₃ | Cl | S |
| 1668 | OCF₃ | C(═NOCH₃)CH₃ | Cl | S |
| 1669 | OCF₃ | SO₂CH₃ | Cl | S |
| 1670 | OCF₃ | SO₂CF₃ | Cl | S |
| 1671 | OCF₃ | CH₂CO₂H | Cl | S |
| 1672 | OCF₃ | CH₂COOCH₃ | Cl | S |
| 1673 | OCF₃ | CH₂COOC₂H₅ | Cl | S |
| 1674 | OCF₃ | prop-1-en-3-yl | Cl | S |
| 1675 | OCF₃ | trans-but-2-en-1-yl | Cl | S |
| 1676 | OCF₃ | cis-but-2-en-1-yl | Cl | S |
| 1677 | OCF₃ | cis-3-methyl- | Cl | S |
| | | but-2-en-1-yl | | |
| 1678 | OCF₃ | cyclopropyl | Cl | S |
| 1679 | OCF₃ | cyclopentyl | Cl | S |
| 1680 | OCF₃ | cyclohexyl | Cl | S |
| 1681 | OCF₃ | 4,5-dihydroisoxazol- | Cl | S |
| | | 3-yl | | |
| 1682 | OCF₃ | 4-methyl-4,5-dihydroisoxazol- | Cl | S |
| | | 3-yl | | |
| 1683 | OCF₃ | isoxazol-3-yl | Cl | S |
| 1684 | OCF₃ | 4-methylisoxazol-3-yl | Cl | S |
| 1685 | OCF₃ | 4,5-dihydroisoxazol- | Cl | S |
| | | 4-yl | | |
| 1686 | OCF₃ | 3-methyl-4,5-dihydroisoxazol- | Cl | S |
| | | 4-yl | | |
| 1687 | OCF₃ | isoxazol-4-yl | Cl | S |
| 1688 | OCF₃ | 3-methylisoxazol-4-yl | Cl | S |
| 1689 | OCF₃ | phenyl | Cl | S |
| 1690 | OCF₃ | benzyl | Cl | S |
| 1691 | OCF₃ | benzoyl | Cl | S |
| 1692 | OCF₃ | 2-pyridyl | Cl | S |
| 1693 | SCH₃ | H | H | S |
| 1694 | SCH₃ | CH₃ | H | S |
| 1695 | SCH₃ | C₂H₅ | H | S |
| 1696 | SCH₃ | n-C₃H₇ | H | S |
| 1697 | SCH₃ | i-C₃H₇ | H | S |
| 1698 | SCH₃ | n-C₄H₉ | H | S |
| 1699 | SCH₃ | i-C₄H₉ | H | S |
| 1700 | SCH₃ | s-C₄H₉ | H | S |
| 1701 | SCH₃ | t-C₄H₉ | H | S |
| 1702 | SCH₃ | CH₂OCH₃ | H | S |
| 1703 | SCH₃ | CF₃ | H | S |
| 1704 | SCH₃ | CF₂H | H | S |
| 1705 | SCH₃ | CN | H | S |
| 1706 | SCH₃ | OH | H | S |
| 1707 | SCH₃ | OCH₃ | H | S |
| 1708 | SCH₃ | NH₂ | H | S |
| 1709 | SCH₃ | NHCH₃ | H | S |
| 1710 | SCH₃ | N(CH₃)₂ | H | S |
| 1711 | SCH₃ | CO₂CH₃ | H | S |
| 1712 | SCH₃ | CO₂C₂H₅ | H | S |
| 1713 | SCH₃ | C(O)CH₃ | H | S |
| 1714 | SCH₃ | C(O)CF₃ | H | S |
| 1715 | SCH₃ | C(═NOCH₃)CH₃ | H | S |
| 1716 | SCH₃ | SO₂CH₃ | H | S |
| 1717 | SCH₃ | SO₂CF₃ | H | S |
| 1718 | SCH₃ | CH₂CO₂H | H | S |
| 1719 | SCH₃ | CH₂COOCH₃ | H | S |
| 1720 | SCH₃ | CH₂COOC₂H₅ | H | S |
| 1721 | SCH₃ | prop-1-en-3-yl | H | S |
| 1722 | SCH₃ | trans-but-2-en-1-yl | H | S |
| 1723 | SCH₃ | cis-but-2-en-1-yl | H | S |
| 1724 | SCH₃ | cis-3-methyl- | H | S |
| | | but-2-en-1-yl | | |
| 1725 | SCH₃ | cyclopropyl | H | S |
| 1726 | SCH₃ | cyclopentyl | H | S |
| 1727 | SCH₃ | cyclohexyl | H | S |
| 1728 | SCH₃ | 4,5-dihydroisoxazol- | H | S |
| | | 3-yl | | |
| 1729 | SCH₃ | 4-methyl-4,5-dihydroisoxazol- | H | S |
| | | 3-yl | | |
| 1730 | SCH₃ | isoxazol-3-yl | H | S |
| 1731 | SCH₃ | 4-methylisoxazol-3-yl | H | S |
| 1732 | SCH₃ | 4,5-dihydroisoxazol- | H | S |
| | | 4-yl | | |
| 1733 | SCH₃ | 3-methyl-4,5-dihydroisoxazol- | H | S |
| | | 4-yl | | |
| 1734 | SCH₃ | isoxazol-4-yl | H | S |
| 1735 | SCH₃ | 3-methylisoxazol-4-yl | H | S |
| 1736 | SCH₃ | phenyl | H | S |
| 1737 | SCH₃ | benzyl | H | S |
| 1738 | SCH₃ | benzoyl | H | S |
| 1739 | SCH₃ | 2-pyridyl | H | S |
| 1740 | SCH₃ | H | CH₃ | S |
| 1741 | SCH₃ | CH₃ | CH₃ | S |
| 1742 | SCH₃ | C₂H₅ | CH₃ | S |
| 1743 | SCH₃ | n-C₃H₇ | CH₃ | S |
| 1744 | SCH₃ | i-C₃H₇ | CH₃ | S |
| 1745 | SCH₃ | n-C₄H₉ | CH₃ | S |
| 1746 | SCH₃ | i-C₄H₉ | CH₃ | S |
| 1747 | SCH₃ | s-C₄H₉ | CH₃ | S |
| 1748 | SCH₃ | t-C₄H₉ | CH₃ | S |
| 1749 | SCH₃ | CH₂OCH₃ | CH₃ | S |
| 1750 | SCH₃ | CF₃ | CH₃ | S |
| 1751 | SCH₃ | CF₂H | CH₃ | S |
| 1752 | SCH₃ | CN | CH₃ | S |
| 1753 | SCH₃ | OH | CH₃ | S |
| 1754 | SCH₃ | OCH₃ | CH₃ | S |
| 1755 | SCH₃ | NH₂ | CH₃ | S |
| 1756 | SCH₃ | NHCH₃ | CH₃ | S |
| 1757 | SCH₃ | N(CH₃)₂ | CH₃ | S |
| 1758 | SCH₃ | CO₂CH₃ | CH₃ | S |
| 1759 | SCH₃ | CO₂C₂H₅ | CH₃ | S |
| 1760 | SCH₃ | C(O)CH₃ | CH₃ | S |
| 1761 | SCH₃ | C(O)CF₃ | CH₃ | S |
| 1762 | SCH₃ | C(═NOCH₃)CH₃ | CH₃ | S |
| 1763 | SCH₃ | SO₂CH₃ | CH₃ | S |
| 1764 | SCH₃ | SO₂CF₃ | CH₃ | S |
| 1765 | SCH₃ | CH₂CO₂H | CH₃ | S |
| 1766 | SCH₃ | CH₂COOCH₃ | CH₃ | S |
| 1767 | SCH₃ | CH₂COOC₂H₅ | CH₃ | S |
| 1768 | SCH₃ | prop-1-en-3-yl | CH₃ | S |
| 1769 | SCH₃ | trans-but-2-en-1-yl | CH₃ | S |
| 1770 | SCH₃ | cis-but-2-en-1-yl | CH₃ | S |
| 1771 | SCH₃ | cis-3-methyl- | CH₃ | S |
| | | but-2-en-1-yl | | |
| 1772 | SCH₃ | cyclopropyl | CH₃ | S |
| 1773 | SCH₃ | cyclopentyl | CH₃ | S |
| 1774 | SCH₃ | cyclohexyl | CH₃ | S |
| 1775 | SCH₃ | 4,5-dihydroisoxazol- | CH₃ | S |
| | | 3-yl | | |
| 1776 | SCH₃ | 4-methyl-4,5-dihydroisoxazol- | CH₃ | S |
| | | 3-yl | | |
| 1777 | SCH₃ | isoxazol-3-yl | CH₃ | S |
| 1778 | SCH₃ | 4-methylisoxazol-3-yl | CH₃ | S |
| 1779 | SCH₃ | 4,5-dihydroisoxazol- | CH₃ | S |
| | | 4-yl | | |
| 1780 | SCH₃ | 3-methyl-4,5-dihydroisoxazol- | CH₃ | S |
| | | 4-yl | | |
| 1781 | SCH₃ | isoxazol-4-yl | CH₃ | S |
| 1782 | SCH₃ | 3-methylisoxazol-4-yl | CH₃ | S |
| 1783 | SCH₃ | phenyl | CH₃ | S |
| 1784 | SCH₃ | benzyl | CH₃ | S |
| 1785 | SCH₃ | benzoyl | CH₃ | S |
| 1786 | SCH₃ | 2-pyridyl | CH₃ | S |
| 1787 | SCH₃ | H | Cl | S |
| 1788 | SCH₃ | CH₃ | Cl | S |
| 1789 | SCH₃ | C₂H₅ | Cl | S |
| 1790 | SCH₃ | n-C₃H₇ | Cl | S |
| 1791 | SCH₃ | i-C₃H₇ | Cl | S |
| 1792 | SCH₃ | n-C₄H₉ | Cl | S |
| 1793 | SCH₃ | i-C₄H₉ | Cl | S |
| 1794 | SCH₃ | s-C₄H₉ | Cl | S |
| 1795 | SCH₃ | t-C₄H₉ | Cl | S |
| 1796 | SCH₃ | CH₂OCH₃ | Cl | S |
| 1797 | SCH₃ | CF₃ | Cl | S |
| 1798 | SCH₃ | CF₂H | Cl | S |
| 1799 | SCH₃ | CN | Cl | S |
| 1800 | SCH₃ | OH | Cl | S |
| 1801 | SCH₃ | OCH₃ | Cl | S |
| 1802 | SCH₃ | NH₂ | Cl | S |
| 1803 | SCH₃ | NHCH₃ | Cl | S |
| 1804 | SCH₃ | N(CH₃)₂ | Cl | S |
| 1805 | SCH₃ | CO₂CH₃ | Cl | S |
| 1806 | SCH₃ | CO₂C₂H₅ | Cl | S |
| 1807 | SCH₃ | C(O)CH₃ | Cl | S |
| 1808 | SCH₃ | C(O)CF₃ | Cl | S |
| 1809 | SCH₃ | C(═NOCH₃)CH₃ | Cl | S |
| 1810 | SCH₃ | SO₂CH₃ | Cl | S |
| 1811 | SCH₃ | SO₂CF₃ | Cl | S |
| 1812 | SCH₃ | CH₂CO₂H | Cl | S |
| 1813 | SCH₃ | CH₂COOCH₃ | Cl | S |
| 1814 | SCH₃ | CH₂COOC₂H₅ | Cl | S |
| 1815 | SCH₃ | prop-1-en-3-yl | Cl | S |
| 1816 | SCH₃ | trans-but-2-en-1-yl | Cl | S |
| 1817 | SCH₃ | cis-but-2-en-1-yl | Cl | S |
| 1818 | SCH₃ | cis-3-methyl- | Cl | S |
| | | but-2-en-1-yl | | |
| 1819 | SCH₃ | cyclopropyl | Cl | S |
| 1820 | SCH₃ | cyclopentyl | Cl | S |
| 1821 | SCH₃ | cyclohexyl | Cl | S |
| 1822 | SCH₃ | 4,5-dihydroisoxazol- | Cl | S |
| | | 3-yl | | |
| 1823 | SCH₃ | 4-methyl-4,5-dihydroisoxazol- | Cl | S |
| | | 3-yl | | |
| 1824 | SCH₃ | isoxazol-3-yl | Cl | S |
| 1825 | SCH₃ | 4-methylisoxazol-3-yl | Cl | S |
| 1826 | SCH₃ | 4,5-dihydroisoxazol- | Cl | S |
| | | 4-yl | | |
| 1827 | SCH₃ | 3-methyl-4,5-dihydroisoxazol- | Cl | S |
| | | 4-yl | | |
| 1828 | SCH₃ | isoxazol-4-yl | Cl | S |
| 1829 | SCH₃ | 3-methylisoxazol-4-yl | Cl | S |
| 1830 | SCH₃ | phenyl | Cl | S |
| 1831 | SCH₃ | benzyl | Cl | S |
| 1832 | SCH₃ | benzoyl | Cl | S |
| 1833 | SCH₃ | 2-pyridyl | Cl | S |
| 1834 | SO₂CH₃ | H | H | S |
| 1835 | SO₂CH₃ | CH₃ | H | S |
| 1836 | SO₂CH₃ | C₂H₅ | H | S |
| 1837 | SO₂CH₃ | n-C₃H₇ | H | S |
| 1838 | SO₂CH₃ | i-C₃H₇ | H | S |
| 1839 | SO₂CH₃ | n-C₄H₉ | H | S |
| 1840 | SO₂CH₃ | i-C₄H₉ | H | S |
| 1841 | SO₂CH₃ | s-C₄H₉ | H | S |
| 1842 | SO₂CH₃ | t-C₄H₉ | H | S |
| 1843 | SO₂CH₃ | CH₂OCH₃ | H | S |
| 1844 | SO₂CH₃ | CF₃ | H | S |
| 1845 | SO₂CH₃ | CF₂H | H | S |
| 1846 | SO₂CH₃ | CN | H | S |
| 1847 | SO₂CH₃ | OH | H | S |
| 1848 | SO₂CH₃ | OCH₃ | H | S |
| 1849 | SO₂CH₃ | NH₂ | H | S |
| 1850 | SO₂CH₃ | NHCH₃ | H | S |
| 1851 | SO₂CH₃ | N(CH₃)₂ | H | S |
| 1852 | SO₂CH₃ | CO₂CH₃ | H | S |
| 1853 | SO₂CH₃ | CO₂C₂H₅ | H | S |
| 1854 | SO₂CH₃ | C(O)CH₃ | H | S |
| 1855 | SO₂CH₃ | C(O)CF₃ | H | S |
| 1856 | SO₂CH₃ | C(═NOCH₃)CH₃ | H | S |
| 1857 | SO₂CH₃ | SO₂CH₃ | H | S |
| 1858 | SO₂CH₃ | SO₂CF₃ | H | S |
| 1859 | SO₂CH₃ | CH₂CO₂H | H | S |
| 1860 | SO₂CH₃ | CH₂COOCH₃ | H | S |
| 1861 | SO₂CH₃ | CH₂COOC₂H₅ | H | S |
| 1862 | SO₂CH₃ | prop-1-en-3-yl | H | S |
| 1863 | SO₂CH₃ | trans-but-2-en-1-yl | H | S |
| 1864 | SO₂CH₃ | cis-but-2-en-1-yl | H | S |
| 1865 | SO₂CH₃ | cis-3-methyl- | H | S |
| | | but-2-en-1-yl | | |
| 1866 | SO₂CH₃ | cyclopropyl | H | S |
| 1867 | SO₂CH₃ | cyclopentyl | H | S |
| 1868 | SO₂CH₃ | cyclohexyl | H | S |
| 1869 | SO₂CH₃ | 4,5-dihydroisoxazol- | H | S |
| | | 3-yl | | |
| 1870 | SO₂CH₃ | 4-methyl-4,5-dihydroisoxazol- | H | S |
| | | 3-yl | | |
| 1871 | SO₂CH₃ | isoxazol-3-yl | H | S |
| 1872 | SO₂CH₃ | 4-methylisoxazol-3-yl | H | S |
| 1873 | SO₂CH₃ | 4,5-dihydroisoxazol- | H | S |
| | | 4-yl | | |
| 1874 | SO₂CH₃ | 3-methyl-4,5-dihydroisoxazol- | H | S |
| | | 4-yl | | |
| 1875 | SO₂CH₃ | isoxazol-4-yl | H | S |
| 1876 | SO₂CH₃ | 3-methylisoxazol-4-yl | H | S |
| 1877 | SO₂CH₃ | phenyl | H | S |
| 1878 | SO₂CH₃ | benzyl | H | S |
| 1879 | SO₂CH₃ | benzoyl | H | S |
| 1880 | SO₂CH₃ | 2-pyridyl | H | S |
| 1881 | SO₂CH₃ | H | CH₃ | S |
| 1882 | SO₂CH₃ | CH₃ | CH₃ | S |
| 1883 | SO₂CH₃ | C₂H₅ | CH₃ | S |
| 1884 | SO₂CH₃ | n-C₃H₇ | CH₃ | S |
| 1885 | SO₂CH₃ | i-C₃H₇ | CH₃ | S |
| 1886 | SO₂CH₃ | n-C₄H₉ | CH₃ | S |
| 1887 | SO₂CH₃ | i-C₄H₉ | CH₃ | S |
| 1888 | SO₂CH₃ | s-C₄H₉ | CH₃ | S |
| 1889 | SO₂CH₃ | t-C₄H₉ | CH₃ | S |
| 1890 | SO₂CH₃ | CH₂OCH₃ | CH₃ | S |
| 1891 | SO₂CH₃ | CF₃ | CH₃ | S |
| 1892 | SO₂CH₃ | CF₂H | CH₃ | S |
| 1893 | SO₂CH₃ | CN | CH₃ | S |
| 1894 | SO₂CH₃ | OH | CH₃ | S |
| 1895 | SO₂CH₃ | OCH₃ | CH₃ | S |
| 1896 | SO₂CH₃ | NH₂ | CH₃ | S |
| 1897 | SO₂CH₃ | NHCH₃ | CH₃ | S |
| 1898 | SO₂CH₃ | N(CH₃)₂ | CH₃ | S |
| 1899 | SO₂CH₃ | CO₂CH₃ | CH₃ | S |
| 1900 | SO₂CH₃ | CO₂C₂H₅ | CH₃ | S |
| 1901 | SO₂CH₃ | C(O)CH₃ | CH₃ | S |
| 1902 | SO₂CH₃ | C(O)CF₃ | CH₃ | S |
| 1903 | SO₂CH₃ | C(═NOCH₃)CH₃ | CH₃ | S |
| 1904 | SO₂CH₃ | SO₂CH₃ | CH₃ | S |
| 1905 | SO₂CH₃ | SO₂CF₃ | CH₃ | S |
| 1906 | SO₂CH₃ | CH₂CO₂H | CH₃ | S |
| 1907 | SO₂CH₃ | CH₂COOCH₃ | CH₃ | S |
| 1908 | SO₂CH₃ | CH₂COOC₂H₅ | CH₃ | S |
| 1909 | SO₂CH₃ | prop-1-en-3-yl | CH₃ | S |
| 1910 | SO₂CH₃ | trans-but-2-en-1-yl | CH₃ | S |
| 1911 | SO₂CH₃ | cis-but-2-en-1-yl | CH₃ | S |
| 1912 | SO₂CH₃ | cis-3-methyl- | CH₃ | S |
| | | but-2-en-1-yl | | |
| 1913 | SO₂CH₃ | cyclopropyl | CH₃ | S |
| 1914 | SO₂CH₃ | cyclopentyl | CH₃ | S |
| 1915 | SO₂CH₃ | cyclohexyl | CH₃ | S |
| 1916 | SO₂CH₃ | 4,5-dihydroisoxazol- | CH₃ | S |
| | | 3-yl | | |
| 1917 | SO₂CH₃ | 4-methyl-4,5-dihydroisoxazol- | CH₃ | S |
| | | 3-yl | | |
| 1918 | SO₂CH₃ | isoxazol-3-yl | CH₃ | S |
| 1919 | SO₂CH₃ | 4-methylisoxazol-3-yl | CH₃ | S |
| 1920 | SO₂CH₃ | 4,5-dihydroisoxazol- | CH₃ | S |
| | | 4-yl | | |
| 1921 | SO₂CH₃ | 3-methyl-4,5-dihydroisoxazol- | CH₃ | S |
| | | 4-yl | | |
| 1922 | SO₂CH₃ | isoxazol-4-yl | CH₃ | S |
| 1923 | SO₂CH₃ | 3-methylisoxazol-4-yl | CH₃ | S |
| 1924 | SO₂CH₃ | phenyl | CH₃ | S |
| 1925 | SO₂CH₃ | benzyl | CH₃ | S |
| 1926 | SO₂CH₃ | benzoyl | CH₃ | S |
| 1927 | SO₂CH₃ | 2-pyridyl | CH₃ | S |
| 1928 | SO₂CH₃ | H | Cl | S |
| 1929 | SO₂CH₃ | CH₃ | Cl | S |
| 1930 | SO₂CH₃ | C₂H₅ | Cl | S |
| 1931 | SO₂CH₃ | n-C₃H₇ | Cl | S |
| 1932 | SO₂CH₃ | i-C₃H₇ | Cl | S |
| 1933 | SO₂CH₃ | n-C₄H₉ | Cl | S |
| 1934 | SO₂CH₃ | i-C₄H₉ | Cl | S |
| 1935 | SO₂CH₃ | s-C₄H₉ | Cl | S |
| 1936 | SO₂CH₃ | t-C₄H₉ | Cl | S |
| 1937 | SO₂CH₃ | CH₂OCH₃ | Cl | S |
| 1938 | SO₂CH₃ | CF₃ | Cl | S |
| 1939 | SO₂CH₃ | CF₂H | Cl | S |
| 1940 | SO₂CH₃ | CN | Cl | S |
| 1941 | SO₂CH₃ | OH | Cl | S |
| 1942 | SO₂CH₃ | OCH₃ | Cl | S |
| 1943 | SO₂CH₃ | NH₂ | Cl | S |
| 1944 | SO₂CH₃ | NHCH₃ | Cl | S |
| 1945 | SO₂CH₃ | N(CH₃)₂ | Cl | S |
| 1946 | SO₂CH₃ | CO₂CH₃ | Cl | S |
| 1947 | SO₂CH₃ | CO₂C₂H₅ | Cl | S |
| 1948 | SO₂CH₃ | C(O)CH₃ | Cl | S |
| 1949 | SO₂CH₃ | C(O)CF₃ | Cl | S |
| 1950 | SO₂CH₃ | C(═NOCH₃)CH₃ | Cl | S |
| 1951 | SO₂CH₃ | SO₂CH₃ | Cl | S |
| 1952 | SO₂CH₃ | SO₂CF₃ | Cl | S |
| 1953 | SO₂CH₃ | CH₂CO₂H | Cl | S |
| 1954 | SO₂CH₃ | CH₂COOCH₃ | Cl | S |
| 1955 | SO₂CH₃ | CH₂COOC₂H₅ | Cl | S |
| 1956 | SO₂CH₃ | prop-1-en-3-yl | Cl | S |
| 1957 | SO₂CH₃ | trans-but-2-en-1-yl | Cl | S |
| 1958 | SO₂CH₃ | cis-but-2-en-1-yl | Cl | S |
| 1959 | SO₂CH₃ | cis-3-methyl- | Cl | S |
| | | but-2-en-1-yl | | |
| 1960 | SO₂CH₃ | cyclopropyl | Cl | S |
| 1961 | SO₂CH₃ | cyclopentyl | Cl | S |
| 1962 | SO₂CH₃ | cyclohexyl | Cl | S |
| 1963 | SO₂CH₃ | 4,5-dihydroisoxazol- | Cl | S |
| | | 3-yl | | |
| 1964 | SO₂CH₃ | 4-methyl-4,5-dihydroisoxazol- | Cl | S |
| | | 3-yl | | |
| 1965 | SO₂CH₃ | isoxazol-3-yl | Cl | S |
| 1966 | SO₂CH₃ | 4-methylisoxazol-3-yl | Cl | S |
| 1967 | SO₂CH₃ | 4,5-dihydroisoxazol- | Cl | S |
| | | 4-yl | | |
| 1968 | SO₂CH₃ | 3-methyl-4,5-dihydroisoxazol- | Cl | S |
| | | 4-yl | | |
| 1969 | SO₂CH₃ | isoxazol-4-yl | Cl | S |
| 1970 | SO₂CH₃ | 3-methylisoxazol-4-yl | Cl | S |
| 1971 | SO₂CH₃ | phenyl | Cl | S |
| 1972 | SO₂CH₃ | benzyl | Cl | S |
| 1973 | SO₂CH₃ | benzoyl | Cl | S |
| 1974 | SO₂CH₃ | 2-pyridyl | Cl | S |
| 1975 | CF₃ | H | H | S |
| 1976 | CF₃ | CH₃ | H | S |
| 1977 | CF₃ | C₂H₅ | H | S |
| 1978 | CF₃ | n-C₃H₇ | H | S |
| 1979 | CF₃ | i-C₃H₇ | H | S |
| 1980 | CF₃ | n-C₄H₉ | H | S |
| 1981 | CF₃ | i-C₄H₉ | H | S |
| 1982 | CF₃ | s-C₄H₉ | H | S |
| 1983 | CF₃ | t-C₄H₉ | H | S |
| 1984 | CF₃ | CH₂OCH₃ | H | S |
| 1985 | CF₃ | CF₃ | H | S |
| 1986 | CF₃ | CF₂H | H | S |
| 1987 | CF₃ | CN | H | S |
| 1988 | CF₃ | OH | H | S |
| 1989 | CF₃ | OCH₃ | H | S |
| 1990 | CF₃ | NH₂ | H | S |
| 1991 | CF₃ | NHCH₃ | H | S |
| 1992 | CF₃ | N(CH₃)₂ | H | S |
| 1993 | CF₃ | CO₂CH₃ | H | S |
| 1994 | CF₃ | CO₂C₂H₅ | H | S |
| 1995 | CF₃ | C(O)CH₃ | H | S |
| 1996 | CF₃ | C(O)CF₃ | H | S |
| 1997 | CF₃ | C(═NOCH₃)CH₃ | H | S |
| 1998 | CF₃ | SO₂CH₃ | H | S |
| 1999 | CF₃ | SO₂CF₃ | H | S |
| 2000 | CF₃ | CH₂CO₂H | H | S |
| 2001 | CF₃ | CH₂COOCH₃ | H | S |
| 2002 | CF₃ | CH₂COOC₂H₅ | H | S |
| 2003 | CF₃ | prop-1-en-3-yl | H | S |
| 2004 | CF₃ | trans-but-2-en-1-yl | H | S |
| 2005 | CF₃ | cis-but-2-en-1-yl | H | S |
| 2006 | CF₃ | cis-3-methyl- | H | S |
| | | but-2-en-1-yl | | |
| 2007 | CF₃ | cyclopropyl | H | S |
| 2008 | CF₃ | cyclopentyl | H | S |
| 2009 | CF₃ | cyclohexyl | H | S |
| 2010 | CF₃ | 4,5-dihydroisoxazol- | H | S |
| | | 3-yl | | |
| 2011 | CF₃ | 4-methyl-4,5-dihydroisoxazol- | H | S |
| | | 3-yl | | |
| 2012 | CF₃ | isoxazol-3-yl | H | S |
| 2013 | CF₃ | 4-methylisoxazol-3-yl | H | S |
| 2014 | CF₃ | 4,5-dihydroisoxazol- | H | S |
| | | 4-yl | | |
| 2015 | CF₃ | 3-methyl-4,5-dihydroisoxazol- | H | S |
| | | 4-yl | | |
| 2016 | CF₃ | isoxazol-4-yl | H | S |
| 2017 | CF₃ | 3-methylisoxazol-4-yl | H | S |
| 2018 | CF₃ | phenyl | H | S |
| 2019 | CF₃ | benzyl | H | S |
| 2020 | CF₃ | benzoyl | H | S |
| 2021 | CF₃ | 2-pyridyl | H | S |
| 2022 | CF₃ | H | CH₃ | S |
| 2023 | CF₃ | CH₃ | CH₃ | S |
| 2024 | CF₃ | C₂H₅ | CH₃ | S |
| 2025 | CF₃ | n-C₃H₇ | CH₃ | S |
| 2026 | CF₃ | i-C₃H₇ | CH₃ | S |
| 2027 | CF₃ | n-C₄H₉ | CH₃ | S |
| 2028 | CF₃ | i-C₄H₉ | CH₃ | S |
| 2029 | CF₃ | s-C₄H₉ | CH₃ | S |
| 2030 | CF₃ | t-C₄H₉ | CH₃ | S |
| 2031 | CF₃ | CH₂OCH₃ | CH₃ | S |
| 2032 | CF₃ | CF₃ | CH₃ | S |
| 2033 | CF₃ | CF₂H | CH₃ | S |
| 2034 | CF₃ | CN | CH₃ | S |
| 2035 | CF₃ | OH | CH₃ | S |
| 2036 | CF₃ | OCH₃ | CH₃ | S |
| 2037 | CF₃ | NH₂ | CH₃ | S |
| 2038 | CF₃ | NHCH₃ | CH₃ | S |
| 2039 | CF₃ | N(CH₃)₂ | CH₃ | S |
| 2040 | CF₃ | CO₂CH₃ | CH₃ | S |
| 2041 | CF₃ | CO₂C₂H₅ | CH₃ | S |
| 2042 | CF₃ | C(O)CH₃ | CH₃ | S |
| 2043 | CF₃ | C(O)CF₃ | CH₃ | S |
| 2044 | CF₃ | C(═NOCH₃)CH₃ | CH₃ | S |
| 2045 | CF₃ | SO₂CH₃ | CH₃ | S |
| 2046 | CF₃ | SO₂CF₃ | CH₃ | S |
| 2047 | CF₃ | CH₂CO₂H | CH₃ | S |
| 2048 | CF₃ | CH₂COOCH₃ | CH₃ | S |
| 2049 | CF₃ | CH₂COOC₂H₅ | CH₃ | S |
| 2050 | CF₃ | prop-1-en-3-yl | CH₃ | S |
| 2051 | CF₃ | trans-but-2-en-1-yl | CH₃ | S |
| 2052 | CF₃ | cis-but-2-en-1-yl | CH₃ | S |
| 2053 | CF₃ | cis-3-methyl- | CH₃ | S |
| | | but-2-en-1-yl | | |
| 2054 | CF₃ | cyclopropyl | CH₃ | S |
| 2055 | CF₃ | cyclopentyl | CH₃ | S |
| 2056 | CF₃ | cyclohexyl | CH₃ | S |
| 2057 | CF₃ | 4,5-dihydroisoxazol- | CH₃ | S |
| | | 3-yl | | |
| 2058 | CF₃ | 4-methyl-4,5-dihydroisoxazol- | CH₃ | S |
| | | 3-yl | | |
| 2059 | CF₃ | isoxazol-3-yl | CH₃ | S |
| 2060 | CF₃ | 4-methylisoxazol-3-yl | CH₃ | S |
| 2061 | CF₃ | 4,5-dihydroisoxazol- | CH₃ | S |
| | | 4-yl | | |
| 2062 | CF₃ | 3-methyl-4,5-dihydroisoxazol- | CH₃ | S |
| | | 4-yl | | |
| 2063 | CF₃ | isoxazol-4-yl | CH₃ | S |
| 2064 | CF₃ | 3-methylisoxazol-4-yl | CH₃ | S |
| 2065 | CF₃ | phenyl | CH₃ | S |
| 2066 | CF₃ | benzyl | CH₃ | S |
| 2067 | CF₃ | benzoyl | CH₃ | S |
| 2068 | CF₃ | 2-pyridyl | CH₃ | S |
| 2069 | CF₃ | H | Cl | S |
| 2070 | CF₃ | CH₃ | Cl | S |
| 2071 | CF₃ | C₂H₅ | Cl | S |
| 2072 | CF₃ | n-C₃H₇ | Cl | S |
| 2073 | CF₃ | i-C₃H₇ | Cl | S |
| 2074 | CF₃ | n-C₄H₉ | Cl | S |
| 2075 | CF₃ | i-C₄H₉ | Cl | S |
| 2076 | CF₃ | s-C₄H₉ | Cl | S |
| 2077 | CF₃ | t-C₄H₉ | Cl | S |
| 2078 | CF₃ | CH₂OCH₃ | Cl | S |
| 2079 | CF₃ | CF₃ | Cl | S |
| 2080 | CF₃ | CF₂H | Cl | S |
| 2081 | CF₃ | CN | Cl | S |
| 2082 | CF₃ | OH | Cl | S |
| 2083 | CF₃ | OCH₃ | Cl | S |
| 2084 | CF₃ | NH₂ | Cl | S |
| 2085 | CF₃ | NHCH₃ | Cl | S |
| 2086 | CF₃ | N(CH₃)₂ | Cl | S |
| 2087 | CF₃ | CO₂CH₃ | Cl | S |
| 2088 | CF₃ | CO₂C₂H₅ | Cl | S |
| 2089 | CF₃ | C(O)CH₃ | Cl | S |
| 2090 | CF₃ | C(O)CF₃ | Cl | S |
| 2091 | CF₃ | C(═NOCH₃)CH₃ | Cl | S |
| 2092 | CF₃ | SO₂CH₃ | Cl | S |
| 2093 | CF₃ | SO₂CF₃ | Cl | S |
| 2094 | CF₃ | CH₂CO₂H | Cl | S |
| 2095 | CF₃ | CH₂COOCH₃ | Cl | S |
| 2096 | CF₃ | CH₂COOC₂H₅ | Cl | S |
| 2097 | CF₃ | prop-1-en-3-yl | Cl | S |
| 2098 | CF₃ | trans-but-2-en-1-yl | Cl | S |
| 2099 | CF₃ | cis-but-2-en-1-yl | Cl | S |
| 2100 | CF₃ | cis-3-methyl- | Cl | S |
| | | but-2-en-1-yl | | |
| 2101 | CF₃ | cyclopropyl | Cl | S |
| 2102 | CF₃ | cyclopentyl | Cl | S |
| 2103 | CF₃ | cyclohexyl | Cl | S |
| 2104 | CF₃ | 4,5-dihydroisoxazol- | Cl | S |
| | | 3-yl | | |
| 2105 | CF₃ | 4-methyl-4,5-dihydroisoxazol- | Cl | S |
| | | 3-yl | | |
| 2106 | CF₃ | isoxazol-3-yl | Cl | S |
| 2107 | CF₃ | 4-methylisoxazol-3-yl | Cl | S |
| 2108 | CF₃ | 4,5-dihydroisoxazol- | Cl | S |
| | | 4-yl | | |
| 2109 | CF₃ | 3-methyl-4,5-dihydroisoxazol- | Cl | S |
| | | 4-yl | | |
| 2110 | CF₃ | isoxazol-4-yl | Cl | S |
| 2111 | CF₃ | 3-methylisoxazol-4-yl | Cl | S |
| 2112 | CF₃ | phenyl | Cl | S |
| 2113 | CF₃ | benzyl | Cl | S |
| 2114 | CF₃ | benzoyl | Cl | S |
| 2115 | CF₃ | 2-pyridyl | Cl | S |
| 2116 | C₂H₅ | H | H | S |
| 2117 | C₂H₅ | CH₃ | H | S |
| 2118 | C₂H₅ | C₂H₅ | H | S |
| 2119 | C₂H₅ | n-C₃H₇ | H | S |
| 2120 | C₂H₅ | i-C₃H₇ | H | S |
| 2121 | C₂H₅ | n-C₄H₉ | H | S |
| 2122 | C₂H₅ | i-C₄H₉ | H | S |
| 2123 | C₂H₅ | s-C₄H₉ | H | S |
| 2124 | C₂H₅ | t-C₄H₉ | H | S |
| 2125 | C₂H₅ | CH₂OCH₃ | H | S |
| 2126 | C₂H₅ | CF₃ | H | S |
| 2127 | C₂H₅ | CF₂H | H | S |
| 2128 | C₂H₅ | CN | H | S |
| 2129 | C₂H₅ | OH | H | S |
| 2130 | C₂H₅ | OCH₃ | H | S |
| 2131 | C₂H₅ | NH₂ | H | S |
| 2132 | C₂H₅ | NHCH₃ | H | S |
| 2133 | C₂H₅ | N(CH₃)₂ | H | S |
| 2134 | C₂H₅ | CO₂CH₃ | H | S |
| 2135 | C₂H₅ | CO₂C₂H₅ | H | S |
| 2136 | C₂H₅ | C(O)CH₃ | H | S |
| 2137 | C₂H₅ | C(O)CF₃ | H | S |
| 2138 | C₂H₅ | C(═NOCH₃)CH₃ | H | S |
| 2139 | C₂H₅ | SO₂CH₃ | H | S |
| 2140 | C₂H₅ | SO₂CF₃ | H | S |
| 2141 | C₂H₅ | CH₂CO₂H | H | S |
| 2142 | C₂H₅ | CH₂COOCH₃ | H | S |
| 2143 | C₂H₅ | CH₂COOC₂H₅ | H | S |
| 2144 | C₂H₅ | prop-1-en-3-yl | H | S |
| 2145 | C₂H₅ | trans-but-2-en-1-yl | H | S |
| 2146 | C₂H₅ | cis-but-2-en-1-yl | H | S |
| 2147 | C₂H₅ | cis-3-methyl- | H | S |
| | | but-2-en-1-yl | | |
| 2148 | C₂H₅ | cyclopropyl | H | S |
| 2149 | C₂H₅ | cyclopentyl | H | S |
| 2150 | C₂H₅ | cyclohexyl | H | S |
| 2151 | C₂H₅ | 4,5-dihydroisoxazol- | H | S |
| | | 3-yl | | |
| 2152 | C₂H₅ | 4-methyl-4,5-dihydroisoxazol- | H | S |
| | | 3-yl | | |
| 2153 | C₂H₅ | isoxazol-3-yl | H | S |
| 2154 | C₂H₅ | 4-methylisoxazol-3-yl | H | S |
| 2155 | C₂H₅ | 4,5-dihydroisoxazol- | H | S |
| | | 4-yl | | |
| 2156 | C₂H₅ | 3-methyl-4,5-dihydroisoxazol- | H | S |
| | | 4-yl | | |
| 2157 | C₂H₅ | isoxazol-4-yl | H | S |
| 2158 | C₂H₅ | 3-methylisoxazol-4-yl | H | S |
| 2159 | C₂H₅ | phenyl | H | S |
| 2160 | C₂H₅ | benzyl | H | S |
| 2161 | C₂H₅ | benzoyl | H | S |
| 2162 | C₂H₅ | 2-pyridyl | H | S |
| 2163 | C₂H₅ | H | CH₃ | S |
| 2164 | C₂H₅ | CH₃ | CH₃ | S |
| 2165 | C₂H₅ | C₂H₅ | CH₃ | S |
| 2166 | C₂H₅ | n-C₃H₇ | CH₃ | S |
| 2167 | C₂H₅ | i-C₃H₇ | CH₃ | S |
| 2168 | C₂H₅ | n-C₄H₉ | CH₃ | S |
| 2169 | C₂H₅ | i-C₄H₉ | CH₃ | S |
| 2170 | C₂H₅ | s-C₄H₉ | CH₃ | S |
| 2171 | C₂H₅ | t-C₄H₉ | CH₃ | S |
| 2172 | C₂H₅ | CH₂OCH₃ | CH₃ | S |
| 2173 | C₂H₅ | CF₃ | CH₃ | S |
| 2174 | C₂H₅ | CF₂H | CH₃ | S |
| 2175 | C₂H₅ | CN | CH₃ | S |
| 2176 | C₂H₅ | OH | CH₃ | S |
| 2177 | C₂H₅ | OCH₃ | CH₃ | S |
| 2178 | C₂H₅ | NH₂ | CH₃ | S |
| 2179 | C₂H₅ | NHCH₃ | CH₃ | S |
| 2180 | C₂H₅ | N(CH₃)₂ | CH₃ | S |
| 2181 | C₂H₅ | CO₂CH₃ | CH₃ | S |
| 2182 | C₂H₅ | CO₂C₂H₅ | CH₃ | S |
| 2183 | C₂H₅ | C(O)CH₃ | CH₃ | S |
| 2184 | C₂H₅ | C(O)CF₃ | CH₃ | S |
| 2185 | C₂H₅ | C(═NOCH₃)CH₃ | CH₃ | S |
| 2186 | C₂H₅ | SO₂CH₃ | CH₃ | S |
| 2187 | C₂H₅ | SO₂CF₃ | CH₃ | S |
| 2188 | C₂H₅ | CH₂CO₂H | CH₃ | S |
| 2189 | C₂H₅ | CH₂COOCH₃ | CH₃ | S |
| 2190 | C₂H₅ | CH₂COOC₂H₅ | CH₃ | S |
| 2191 | C₂H₅ | prop-1-en-3-yl | CH₃ | S |
| 2192 | C₂H₅ | trans-but-2-en-1-yl | CH₃ | S |
| 2193 | C₂H₅ | cis-but-2-en-1-yl | CH₃ | S |
| 2194 | C₂H₅ | cis-3-methyl- | CH₃ | S |
| | | but-2-en-1-yl | | |
| 2195 | C₂H₅ | cyclopropyl | CH₃ | S |
| 2196 | C₂H₅ | cyclopentyl | CH₃ | S |
| 2197 | C₂H₅ | cyclohexyl | CH₃ | S |
| 2198 | C₂H₅ | 4,5-dihydroisoxazol- | CH₃ | S |
| | | 3-yl | | |
| 2199 | C₂H₅ | 4-methyl-4,5-dihydroisoxazol- | CH₃ | S |
| | | 3-yl | | |
| 2200 | C₂H₅ | isoxazol-3-yl | CH₃ | S |
| 2201 | C₂H₅ | 4-methylisoxazol-3-yl | CH₃ | S |
| 2202 | C₂H₅ | 4,5-dihydroisoxazol- | CH₃ | S |
| | | 4-yl | | |
| 2203 | C₂H₅ | 3-methyl-4,5-dihydroisoxazol- | CH₃ | S |
| | | 4-yl | | |
| 2204 | C₂H₅ | isoxazol-4-yl | CH₃ | S |
| 2205 | C₂H₅ | 3-methylisoxazol-4-yl | CH₃ | S |
| 2206 | C₂H₅ | phenyl | CH₃ | S |
| 2207 | C₂H₅ | benzyl | CH₃ | S |
| 2208 | C₂H₅ | benzoyl | CH₃ | S |
| 2209 | C₂H₅ | 2-pyridyl | CH₃ | S |
| 2210 | C₂H₅ | H | Cl | S |
| 2211 | C₂H₅ | CH₃ | Cl | S |
| 2212 | C₂H₅ | C₂H₅ | Cl | S |
| 2213 | C₂H₅ | n-C₃H₇ | Cl | S |
| 2214 | C₂H₅ | i-C₃H₇ | Cl | S |
| 2215 | C₂H₅ | n-C₄H₉ | Cl | S |
| 2216 | C₂H₅ | i-C₄H₉ | Cl | S |
| 2217 | C₂H₅ | s-C₄H₉ | Cl | S |
| 2218 | C₂H₅ | t-C₄H₉ | Cl | S |
| 2219 | C₂H₅ | CH₂OCH₃ | Cl | S |
| 2220 | C₂H₅ | CF₃ | Cl | S |
| 2221 | C₂H₅ | CF₂H | Cl | S |
| 2222 | C₂H₅ | CN | Cl | S |
| 2223 | C₂H₅ | OH | Cl | S |
| 2224 | C₂H₅ | OCH₃ | Cl | S |
| 2225 | C₂H₅ | NH₂ | Cl | S |
| 2226 | C₂H₅ | NHCH₃ | Cl | S |
| 2227 | C₂H₅ | N(CH₃)₂ | Cl | S |
| 2228 | C₂H₅ | CO₂CH₃ | Cl | S |
| 2229 | C₂H₅ | CO₂C₂H₅ | Cl | S |
| 2230 | C₂H₅ | C(O)CH₃ | Cl | S |
| 2231 | C₂H₅ | C(O)CF₃ | Cl | S |
| 2232 | C₂H₅ | C(═NOCH₃)CH₃ | Cl | S |
| 2233 | C₂H₅ | SO₂CH₃ | Cl | S |
| 2234 | C₂H₅ | SO₂CF₃ | Cl | S |
| 2235 | C₂H₅ | CH₂CO₂H | Cl | S |
| 2236 | C₂H₅ | CH₂COOCH₃ | Cl | S |
| 2237 | C₂H₅ | CH₂COOC₂H₅ | Cl | S |
| 2238 | C₂H₅ | prop-1-en-3-yl | Cl | S |
| 2239 | C₂H₅ | trans-but-2-en-1-yl | Cl | S |
| 2240 | C₂H₅ | cis-but-2-en-1-yl | Cl | S |
| 2241 | C₂H₅ | cis-3-methyl- | Cl | S |
| | | but-2-en-1-yl | | |
| 2242 | C₂H₅ | cyclopropyl | Cl | S |
| 2243 | C₂H₅ | cyclopentyl | Cl | S |
| 2244 | C₂H₅ | cyclohexyl | Cl | S |
| 2245 | C₂H₅ | 4,5-dihydroisoxazol- | Cl | S |
| | | 3-yl | | |
| 2246 | C₂H₅ | 4-methyl-4,5-dihydroisoxazol- | Cl | S |
| | | 3-yl | | |
| 2247 | C₂H₅ | isoxazol-3-yl | Cl | S |
| 2248 | C₂H₅ | 4-methylisoxazol-3-yl | Cl | S |
| 2249 | C₂H₅ | 4,5-dihydroisoxazol- | Cl | S |
| | | 4-yl | | |
| 2250 | C₂H₅ | 3-methyl-4,5-dihydroisoxazol- | Cl | S |
| | | 4-yl | | |
| 2251 | C₂H₅ | isoxazol-4-yl | Cl | S |
| 2252 | C₂H₅ | 3-methylisoxazol-4-yl | Cl | S |
| 2253 | C₂H₅ | phenyl | Cl | S |
| 2254 | C₂H₅ | benzyl | Cl | S |
| 2255 | C₂H₅ | benzoyl | Cl | S |
| 2256 | C₂H₅ | 2-pyridyl | Cl | S |
| 2257 | CH₃ | H | H | NCH₃ |
| 2258 | CH₃ | CH₃ | H | NCH₃ |
| 2259 | CH₃ | C₂H₅ | H | NCH₃ |
| 2260 | CH₃ | n-C₃H₇ | H | NCH₃ |
| 2261 | CH₃ | i-C₃H₇ | H | NCH₃ |
| 2262 | CH₃ | n-C₄H₉ | H | NCH₃ |
| 2263 | CH₃ | i-C₄H₉ | H | NCH₃ |
| 2264 | CH₃ | s-C₄H₉ | H | NCH₃ |
| 2265 | CH₃ | t-C₄H₉ | H | NCH₃ |
| 2266 | CH₃ | CH₂OCH₃ | H | NCH₃ |
| 2267 | CH₃ | CF₃ | H | NCH₃ |
| 2268 | CH₃ | CF₂H | H | NCH₃ |
| 2269 | CH₃ | CN | H | NCH₃ |
| 2270 | CH₃ | OH | H | NCH₃ |
| 2271 | CH₃ | OCH₃ | H | NCH₃ |
| 2272 | CH₃ | NH₂ | H | NCH₃ |
| 2273 | CH₃ | NHCH₃ | H | NCH₃ |
| 2274 | CH₃ | N(CH₃)₂ | H | NCH₃ |
| 2275 | CH₃ | CO₂CH₃ | H | NCH₃ |
| 2276 | CH₃ | CO₂C₂H₅ | H | NCH₃ |
| 2277 | CH₃ | C(O)CH₃ | H | NCH₃ |
| 2278 | CH₃ | C(O)CF₃ | H | NCH₃ |
| 2279 | CH₃ | C(═NOCH₃)CH₃ | H | NCH₃ |
| 2280 | CH₃ | SO₂CH₃ | H | NCH₃ |
| 2281 | CH₃ | SO₂CF₃ | H | NCH₃ |
| 2282 | CH₃ | CH₂CO₂H | H | NCH₃ |
| 2283 | CH₃ | CH₂COOCH₃ | H | NCH₃ |
| 2284 | CH₃ | CH₂COOC₂H₅ | H | NCH₃ |
| 2285 | CH₃ | prop-1-en-3-yl | H | NCH₃ |
| 2286 | CH₃ | trans-but-2-en-1-yl | H | NCH₃ |
| 2287 | CH₃ | cis-but-2-en-1-yl | H | NCH₃ |
| 2288 | CH₃ | cis-3-methyl- | H | NCH₃ |
| | | but-2-en-1-yl | | |
| 2289 | CH₃ | cyclopropyl | H | NCH₃ |
| 2290 | CH₃ | cyclopentyl | H | NCH₃ |
| 2291 | CH₃ | cyclohexyl | H | NCH₃ |
| 2292 | CH₃ | 4,5-dihydroisoxazol- | H | NCH₃ |
| | | 3-yl | | |
| 2293 | CH₃ | 4-methyl-4,5-dihydroisoxazol- | H | NCH₃ |
| | | 3-yl | | |
| 2294 | CH₃ | isoxazol-3-yl | H | NCH₃ |
| 2295 | CH₃ | 4-methylisoxazol-3-yl | H | NCH₃ |
| 2296 | CH₃ | 4,5-dihydroisoxazol- | H | NCH₃ |
| | | 4-y1 | | |
| 2297 | CH₃ | 3-methyl-4,5-dihydroisoxazol- | H | NCH₃ |
| | | 4-yl | | |
| 2298 | CH₃ | isoxazol-4-yl | H | NCH₃ |
| 2299 | CH₃ | 3-methylisoxazol-4-yl | H | NCH₃ |
| 2300 | CH₃ | phenyl | H | NCH₃ |
| 2301 | CH₃ | benzyl | H | NCH₃ |
| 2302 | CH₃ | benzoyl | H | NCH₃ |
| 2303 | CH₃ | 2-pyridyl | H | NCH₃ |
| 2304 | CH₃ | H | CH₃ | NCH₃ |
| 2305 | CH₃ | CH₃ | CH₃ | NCH₃ |
| 2306 | CH₃ | C₂H₅ | CH₃ | NCH₃ |
| 2307 | CH₃ | n-C₃H₇ | CH₃ | NCH₃ |
| 2308 | CH₃ | i-C₃H₇ | CH₃ | NCH₃ |
| 2309 | CH₃ | n-C₄H₉ | CH₃ | NCH₃ |
| 2310 | CH₃ | i-C₄H₉ | CH₃ | NCH₃ |
| 2311 | CH₃ | s-C₄H₉ | CH₃ | NCH₃ |
| 2312 | CH₃ | t-C₄H₉ | CH₃ | NCH₃ |
| 2313 | CH₃ | CH₂OCH₃ | CH₃ | NCH₃ |
| 2314 | CH₃ | CF₃ | CH₃ | NCH₃ |
| 2315 | CH₃ | CF₂H | CH₃ | NCH₃ |
| 2316 | CH₃ | CN | CH₃ | NCH₃ |
| 2317 | CH₃ | OH | CH₃ | NCH₃ |
| 2318 | CH₃ | OCH₃ | CH₃ | NCH₃ |
| 2319 | CH₃ | NH₂ | CH₃ | NCH₃ |
| 2320 | CH₃ | NHCH₃ | CH₃ | NCH₃ |
| 2321 | CH₃ | N(CH₃)₂ | CH₃ | NCH₃ |
| 2322 | CH₃ | CO₂CH₃ | CH₃ | NCH₃ |
| 2323 | CH₃ | CO₂C₂H₅ | CH₃ | NCH₃ |
| 2324 | CH₃ | C(O)CH₃ | CH₃ | NCH₃ |
| 2325 | CH₃ | C(O)CF₃ | CH₃ | NCH₃ |
| 2326 | CH₃ | C(═NOCH₃)CH₃ | CH₃ | NCH₃ |
| 2327 | CH₃ | SO₂CH₃ | CH₃ | NCH₃ |
| 2328 | CH₃ | SO₂CF₃ | CH₃ | NCH₃ |
| 2329 | CH₃ | CH₂CO₂H | CH₃ | NCH₃ |
| 2330 | CH₃ | CH₂COOCH₃ | CH₃ | NCH₃ |
| 2331 | CH₃ | CH₂COOC₂H₅ | CH₃ | NCH₃ |
| 2332 | CH₃ | prop-1-en-3-yl | CH₃ | NCH₃ |
| 2333 | CH₃ | trans-but-2-en-1-yl | CH₃ | NCH₃ |
| 2334 | CH₃ | cis-but-2-en-1-yl | CH₃ | NCH₃ |
| 2335 | CH₃ | cis-3-methyl- | CH₃ | NCH₃ |
| | | but-2-en-1-yl | | |
| 2336 | CH₃ | cyclopropyl | CH₃ | NCH₃ |
| 2337 | CH₃ | cyclopentyl | CH₃ | NCH₃ |
| 2338 | CH₃ | cyclohexyl | CH₃ | NCH₃ |
| 2339 | CH₃ | 4,5-dihydroisoxazol- | CH₃ | NCH₃ |
| | | 3-yl | | |
| 2340 | CH₃ | 4-methyl-4,5-dihydroisoxazol- | CH₃ | NCH₃ |
| | | 3-yl | | |
| 2341 | CH₃ | isoxazol-3-yl | CH₃ | NCH₃ |
| 2342 | CH₃ | 4-methylisoxazol-3-yl | CH₃ | NCH₃ |
| 2343 | CH₃ | 4,5-dihydroisoxazol- | CH₃ | NCH₃ |
| | | 4-yl | | |
| 2344 | CH₃ | 3-methyl-4,5-dihydroisoxazol- | CH₃ | NCH₃ |
| | | 4-yl | | |
| 2345 | CH₃ | isoxazol-4-yl | CH₃ | NCH₃ |
| 2346 | CH₃ | 3-methylisoxazol-4-yl | CH₃ | NCH₃ |
| 2347 | CH₃ | phenyl | CH₃ | NCH₃ |
| 2348 | CH₃ | benzyl | CH₃ | NCH₃ |
| 2349 | CH₃ | benzoyl | CH₃ | NCH₃ |
| 2350 | CH₃ | 2-pyridyl | CH₃ | NCH₃ |
| 2351 | CH₃ | H | Cl | NCH₃ |
| 2352 | CH₃ | CH₃ | Cl | NCH₃ |
| 2353 | CH₃ | C₂H₅ | Cl | NCH₃ |
| 2354 | CH₃ | n-C₃H₇ | Cl | NCH₃ |
| 2355 | CH₃ | i-C₃H₇ | Cl | NCH₃ |
| 2356 | CH₃ | n-C₄H₉ | Cl | NCH₃ |
| 2357 | CH₃ | i-C₄H₉ | Cl | NCH₃ |
| 2358 | CH₃ | s-C₄H₉ | Cl | NCH₃ |
| 2359 | CH₃ | t-C₄H₉ | Cl | NCH₃ |
| 2360 | CH₃ | CH₂OCH₃ | Cl | NCH₃ |
| 2361 | CH₃ | CF₃ | Cl | NCH₃ |
| 2362 | CH₃ | CF₂H | Cl | NCH₃ |
| 2363 | CH₃ | CN | Cl | NCH₃ |
| 2364 | CH₃ | OH | Cl | NCH₃ |
| 2365 | CH₃ | OCH₃ | Cl | NCH₃ |
| 2366 | CH₃ | NH₂ | Cl | NCH₃ |
| 2367 | CH₃ | NHCH₃ | Cl | NCH₃ |
| 2368 | CH₃ | N(CH₃)₂ | Cl | NCH₃ |
| 2369 | CH₃ | CO₂CH₃ | Cl | NCH₃ |
| 2370 | CH₃ | CO₂C₂H₅ | Cl | NCH₃ |
| 2371 | CH₃ | C(O)CH₃ | Cl | NCH₃ |
| 2372 | CH₃ | C(O)CF₃ | Cl | NCH₃ |
| 2373 | CH₃ | C(═NOCH₃)CH₃ | Cl | NCH₃ |
| 2374 | CH₃ | SO₂CH₃ | Cl | NCH₃ |
| 2375 | CH₃ | SO₂CF₃ | Cl | NCH₃ |
| 2376 | CH₃ | CH₂CO₂H | Cl | NCH₃ |
| 2377 | CH₃ | CH₂COOCH₃ | Cl | NCH₃ |
| 2378 | CH₃ | CH₂COOC₂H₅ | Cl | NCH₃ |
| 2379 | CH₃ | prop-1-en-3-yl | Cl | NCH₃ |
| 2380 | CH₃ | trans-but-2-en-1-yl | Cl | NCH₃ |
| 2381 | CH₃ | cis-but-2-en-1-yl | Cl | NCH₃ |
| 2382 | CH₃ | cis-3-methyl- | Cl | NCH₃ |
| | | but-2-en-1-yl | | |
| 2383 | CH₃ | cyclopropyl | Cl | NCH₃ |
| 2384 | CH₃ | cyclopentyl | Cl | NCH₃ |
| 2385 | CH₃ | cyclohexyl | Cl | NCH₃ |
| 2386 | CH₃ | 4,5-dihydroisoxazol- | Cl | NCH₃ |
| | | 3-yl | | |
| 2387 | CH₃ | 4-methyl-4,5-dihydroisoxazol- | Cl | NCH₃ |
| | | 3-yl | | |
| 2388 | CH₃ | isoxazol-3-yl | Cl | NCH₃ |
| 2389 | CH₃ | 4-methylisoxazol-3-yl | Cl | NCH₃ |
| 2390 | CH₃ | 4,5-dihydroisoxazol- | Cl | NCH₃ |
| | | 4-yl | | |
| 2391 | CH₃ | 3-methyl-4,5-dihydroisoxazol- | Cl | NCH₃ |
| | | 4-yl | | |
| 2392 | CH₃ | isoxazol-4-yl | Cl | NCH₃ |
| 2393 | CH₃ | 3-methylisoxazol-4-yl | Cl | NCH₃ |
| 2394 | CH₃ | phenyl | Cl | NCH₃ |
| 2395 | CH₃ | benzyl | Cl | NCH₃ |
| 2396 | CH₃ | benzoyl | Cl | NCH₃ |
| 2397 | CH₃ | 2-pyridyl | Cl | NCH₃ |
| 2398 | Cl | H | H | NCH₃ |
| 2399 | Cl | CH₃ | H | NCH₃ |
| 2400 | Cl | C₂H₅ | H | NCH₃ |
| 2401 | Cl | n-C₃H₇ | H | NCH₃ |
| 2402 | Cl | i-C₃H₇ | H | NCH₃ |
| 2403 | Cl | n-C₄H₉ | H | NCH₃ |
| 2404 | Cl | i-C₄H₉ | H | NCH₃ |
| 2405 | Cl | s-C₄H₉ | H | NCH₃ |
| 2406 | Cl | t-C₄H₉ | H | NCH₃ |
| 2407 | Cl | CH₂OCH₃ | H | NCH₃ |
| 2408 | Cl | CF₃ | H | NCH₃ |
| 2409 | Cl | CF₂H | H | NCH₃ |
| 2410 | Cl | CN | H | NCH₃ |
| 2411 | Cl | OH | H | NCH₃ |
| 2412 | Cl | OCH₃ | H | NCH₃ |
| 2413 | Cl | NH₂ | H | NCH₃ |
| 2414 | Cl | NHCH₃ | H | NCH₃ |
| 2415 | Cl | N(CH₃)₂ | H | NCH₃ |
| 2416 | Cl | CO₂CH₃ | H | NCH₃ |
| 2417 | Cl | CO₂C₂H₅ | H | NCH₃ |
| 2418 | Cl | C(O)CH₃ | H | NCH₃ |
| 2419 | Cl | C(O)CF₃ | H | NCH₃ |
| 2420 | Cl | C(═NOCH₃)CH₃ | H | NCH₃ |
| 2421 | Cl | SO₂CH₃ | H | NCH₃ |
| 2422 | Cl | SO₂CF₃ | H | NCH₃ |
| 2423 | Cl | CH₂CO₂H | H | NCH₃ |
| 2424 | Cl | CH₂COOCH₃ | H | NCH₃ |
| 2425 | Cl | CH₂COOC₂H₅ | H | NCH₃ |
| 2426 | Cl | prop-1-en-3-yl | H | NCH₃ |
| 2427 | Cl | trans-but-2-en-1-yl | H | NCH₃ |
| 2428 | Cl | cis-but-2-en-1-yl | H | NCH₃ |
| 2429 | Cl | cis-3-methyl- | H | NCH₃ |
| | | but-2-en-1-yl | | |
| 2430 | Cl | cyclopropyl | H | NCH₃ |
| 2431 | Cl | cyclopentyl | H | NCH₃ |
| 2432 | Cl | cyclohexyl | H | NCH₃ |
| 2433 | Cl | 4,5-dihydroisoxazol- | H | NCH₃ |
| | | 3-yl | | |
| 2434 | Cl | 4-methyl-4,5-dihydroisoxazol- | H | NCH₃ |
| | | 3-yl | | |
| 2435 | Cl | isoxazol-3-yl | H | NCH₃ |
| 2436 | Cl | 4-methylisoxazol-3-yl | H | NCH₃ |
| 2437 | Cl | 4,5-dihydroisoxazol- | H | NCH₃ |
| | | 4-yl | | |
| 2438 | Cl | 3-methyl-4,5-dihydroisoxazol- | H | NCH₃ |
| | | 4-yl | | |
| 2439 | Cl | isoxazol-4-yl | H | NCH₃ |
| 2440 | Cl | 3-methylisoxazol-4-yl | H | NCH₃ |
| 2441 | Cl | phenyl | H | NCH₃ |
| 2442 | Cl | benzyl | H | NCH₃ |
| 2443 | Cl | benzoyl | H | NCH₃ |
| 2444 | Cl | 2-pyridyl | H | NCH₃ |
| 2445 | Cl | H | CH₃ | NCH₃ |
| 2446 | Cl | CH₃ | CH₃ | NCH₃ |
| 2447 | Cl | C₂H₅ | CH₃ | NCH₃ |
| 2448 | Cl | n-C₃H₇ | CH₃ | NCH₃ |
| 2449 | Cl | i-C₃H₇ | CH₃ | NCH₃ |
| 2450 | Cl | n-C₄H₉ | CH₃ | NCH₃ |
| 2451 | Cl | i-C₄H₉ | CH₃ | NCH₃ |
| 2452 | Cl | s-C₄H₉ | CH₃ | NCH₃ |
| 2453 | Cl | t-C₄H₉ | CH₃ | NCH₃ |
| 2454 | Cl | CH₂OCH₃ | CH₃ | NCH₃ |
| 2455 | Cl | CF₃ | CH₃ | NCH₃ |
| 2456 | Cl | CF₂H | CH₃ | NCH₃ |
| 2457 | Cl | CN | CH₃ | NCH₃ |
| 2458 | Cl | OH | CH₃ | NCH₃ |
| 2459 | Cl | OCH₃ | CH₃ | NCH₃ |
| 2460 | Cl | NH₂ | CH₃ | NCH₃ |
| 2461 | Cl | NHCH₃ | CH₃ | NCH₃ |
| 2462 | Cl | N(CH₃)₂ | CH₃ | NCH₃ |
| 2463 | Cl | CO₂CH₃ | CH₃ | NCH₃ |
| 2464 | Cl | CO₂C₂H₅ | CH₃ | NCH₃ |
| 2465 | Cl | C(O)CH₃ | CH₃ | NCH₃ |
| 2466 | Cl | C(O)CF₃ | CH₃ | NCH₃ |
| 2467 | Cl | C(═NOCH₃)CH₃ | CH₃ | NCH₃ |
| 2468 | Cl | SO₂CH₃ | CH₃ | NCH₃ |
| 2469 | Cl | SO₂CF₃ | CH₃ | NCH₃ |
| 2470 | Cl | CH₂CO₂H | CH₃ | NCH₃ |
| 2471 | Cl | CH₂COOCH₃ | CH₃ | NCH₃ |
| 2472 | Cl | CH₂COOC₂H₅ | CH₃ | NCH₃ |
| 2473 | Cl | prop-1-en-3-yl | CH₃ | NCH₃ |
| 2474 | Cl | trans-but-2-en-1-yl | CH₃ | NCH₃ |
| 2475 | Cl | cis-but-2-en-1-yl | CH₃ | NCH₃ |
| 2476 | Cl | cis-3-methyl- | CH₃ | NCH₃ |
| | | but-2-en-1-yl | | |
| 2477 | Cl | cyclopropyl | CH₃ | NCH₃ |
| 2478 | Cl | cyclopentyl | CH₃ | NCH₃ |
| 2479 | Cl | cyclohexyl | CH₃ | NCH₃ |
| 2480 | Cl | 4,5-dihydroisoxazol- | CH₃ | NCH₃ |
| | | 3-yl | | |
| 2481 | Cl | 4-methyl-4,5-dihydroisoxazol- | CH₃ | NCH₃ |
| | | 3-yl | | |
| 2482 | Cl | isoxazol-3-yl | CH₃ | NCH₃ |
| 2483 | Cl | 4-methylisoxazol-3-yl | CH₃ | NCH₃ |
| 2484 | Cl | 4,5-dihydroisoxazol- | CH₃ | NCH₃ |
| | | 4-yl | | |
| 2485 | Cl | 3-methyl-4,5-dihydroisoxazol- | CH₃ | NCH₃ |
| | | 4-yl | | |
| 2486 | Cl | isoxazol-4-yl | CH₃ | NCH₃ |
| 2487 | Cl | 3-methylisoxazol-4-yl | CH₃ | NCH₃ |
| 2488 | Cl | phenyl | CH₃ | NCH₃ |
| 2489 | Cl | benzyl | CH₃ | NCH₃ |
| 2490 | Cl | benzoyl | CH₃ | NCH₃ |
| 2491 | Cl | 2-pyridyl | CH₃ | NCH₃ |
| 2492 | Cl | H | Cl | NCH₃ |
| 2493 | Cl | CH₃ | Cl | NCH₃ |
| 2494 | Cl | C₂H₅ | Cl | NCH₃ |
| 2495 | Cl | n-C₃H₇ | Cl | NCH₃ |
| 2496 | Cl | i-C₃H₇ | Cl | NCH₃ |
| 2497 | Cl | n-C₄H₉ | Cl | NCH₃ |
| 2498 | Cl | i-C₄H₉ | Cl | NCH₃ |
| 2499 | Cl | s-C₄H₉ | Cl | NCH₃ |
| 2500 | Cl | t-C₄H₉ | Cl | NCH₃ |
| 2501 | Cl | CH₂OCH₃ | Cl | NCH₃ |
| 2502 | Cl | CF₃ | Cl | NCH₃ |
| 2503 | Cl | CF₂H | Cl | NCH₃ |
| 2504 | Cl | CN | Cl | NCH₃ |
| 2505 | Cl | OH | Cl | NCH₃ |
| 2506 | Cl | OCH₃ | Cl | NCH₃ |
| 2507 | Cl | NH₂ | Cl | NCH₃ |
| 2508 | Cl | NHCH₃ | Cl | NCH₃ |
| 2509 | Cl | N(CH₃)₂ | Cl | NCH₃ |
| 2510 | Cl | CO₂CH₃ | Cl | NCH₃ |
| 2511 | Cl | CO₂C₂H₅ | Cl | NCH₃ |
| 2512 | Cl | C(O)CH₃ | Cl | NCH₃ |
| 2513 | Cl | C(O)CF₃ | Cl | NCH₃ |
| 2514 | Cl | C(═NOCH₃)CH₃ | Cl | NCH₃ |
| 2515 | Cl | SO₂CH₃ | Cl | NCH₃ |
| 2516 | Cl | SO₂CF₃ | Cl | NCH₃ |
| 2517 | Cl | CH₂CO₂H | Cl | NCH₃ |
| 2518 | Cl | CH₂COOCH₃ | Cl | NCH₃ |
| 2519 | Cl | CH₂COOC₂H₅ | Cl | NCH₃ |
| 2520 | Cl | prop-1-en-3-yl | Cl | NCH₃ |
| 2521 | Cl | trans-but-2-en-1-yl | Cl | NCH₃ |
| 2522 | Cl | cis-but-2-en-1-yl | Cl | NCH₃ |
| 2523 | Cl | cis-3-methyl- | Cl | NCH₃ |
| | | but-2-en-1-yl | | |
| 2524 | Cl | cyclopropyl | Cl | NCH₃ |
| 2525 | Cl | cyclopentyl | Cl | NCH₃ |
| 2526 | Cl | cyclohexyl | Cl | NCH₃ |
| 2527 | Cl | 4,5-dihydroisoxazol- | Cl | NCH₃ |
| | | 3-yl | | |
| 2528 | Cl | 4-methyl-4,5-dihydroisoxazol- | Cl | NCH₃ |
| | | 3-yl | | |
| 2529 | Cl | isoxazol-3-yl | Cl | NCH₃ |
| 2530 | Cl | 4-methylisoxazol-3-yl | Cl | NCH₃ |
| 2531 | Cl | 4,5-dihydroisoxazol- | Cl | NCH₃ |
| | | 4-yl | | |
| 2532 | Cl | 3-methyl-4,5-dihydroisoxazol- | Cl | NCH₃ |
| | | 4-yl | | |
| 2533 | Cl | isoxazol-4-yl | Cl | NCH₃ |
| 2534 | Cl | 3-methylisoxazol-4-yl | Cl | NCH₃ |
| 2535 | Cl | phenyl | Cl | NCH₃ |
| 2536 | Cl | benzyl | Cl | NCH₃ |
| 2537 | Cl | benzoyl | Cl | NCH₃ |
| 2538 | Cl | 2-pyridyl | Cl | NCH₃ |
| 2539 | OCH₃ | H | H | NCH₃ |
| 2540 | OCH₃ | CH₃ | H | NCH₃ |
| 2541 | OCH₃ | C₂H₅ | H | NCH₃ |
| 2542 | OCH₃ | n-C₃H₇ | H | NCH₃ |
| 2543 | OCH₃ | i-C₃H₇ | H | NCH₃ |
| 2544 | OCH₃ | n-C₄H₉ | H | NCH₃ |
| 2545 | OCH₃ | i-C₄H₉ | H | NCH₃ |
| 2546 | OCH₃ | s-C₄H₉ | H | NCH₃ |
| 2547 | OCH₃ | t-C₄H₉ | H | NCH₃ |
| 2548 | OCH₃ | CH₂OCH₃ | H | NCH₃ |
| 2549 | OCH₃ | CF₃ | H | NCH₃ |
| 2550 | OCH₃ | CF₂H | H | NCH₃ |
| 2551 | OCH₃ | CN | H | NCH₃ |
| 2552 | OCH₃ | OH | H | NCH₃ |
| 2553 | OCH₃ | OCH₃ | H | NCH₃ |
| 2554 | OCH₃ | NH₂ | H | NCH₃ |
| 2555 | OCH₃ | NHCH₃ | H | NCH₃ |
| 2556 | OCH₃ | N(CH₃)₂ | H | NCH₃ |
| 2557 | OCH₃ | CO₂CH₃ | H | NCH₃ |
| 2558 | OCH₃ | CO₂C₂H₅ | H | NCH₃ |
| 2559 | OCH₃ | C(O)CH₃ | H | NCH₃ |
| 2560 | OCH₃ | C(O)CF₃ | H | NCH₃ |
| 2561 | OCH₃ | C(═NOCH₃)CH₃ | H | NCH₃ |
| 2562 | OCH₃ | SO₂CH₃ | H | NCH₃ |
| 2563 | OCH₃ | SO₂CF₃ | H | NCH₃ |
| 2564 | OCH₃ | CH₂CO₂H | H | NCH₃ |
| 2565 | OCH₃ | CH₂COOCH₃ | H | NCH₃ |
| 2566 | OCH₃ | CH₂COOC₂H₅ | H | NCH₃ |
| 2567 | OCH₃ | prop-1-en-3-yl | H | NCH₃ |
| 2568 | OCH₃ | trans-but-2-en-1-yl | H | NCH₃ |
| 2569 | OCH₃ | cis-but-2-en-1-yl | H | NCH₃ |
| 2570 | OCH₃ | cis-3-methyl- | H | NCH₃ |
| | | but-2-en-1-yl | | |
| 2571 | OCH₃ | cyclopropyl | H | NCH₃ |
| 2572 | OCH₃ | cyclopentyl | H | NCH₃ |
| 2573 | OCH₃ | cyclohexyl | H | NCH₃ |
| 2574 | OCH₃ | 4,5-dihydroisoxazol- | H | NCH₃ |
| | | 3-yl | | |
| 2575 | OCH₃ | 4-methyl-4,5-dihydroisoxazol- | H | NCH₃ |
| | | 3-yl | | |
| 2576 | OCH₃ | isoxazol-3-yl | H | NCH₃ |
| 2577 | OCH₃ | 4-methylisoxazol-3-yl | H | NCH₃ |
| 2578 | OCH₃ | 4,5-dihydroisoxazol- | H | NCH₃ |
| | | 4-yl | | |
| 2579 | OCH₃ | 3-methyl-4,5-dihydroisoxazol- | H | NCH₃ |
| | | 4-yl | | |
| 2580 | OCH₃ | isoxazol-4-yl | H | NCH₃ |
| 2581 | OCH₃ | 3-methylisoxazol-4-yl | H | NCH₃ |
| 2582 | OCH₃ | phenyl | H | NCH₃ |
| 2583 | OCH₃ | benzyl | H | NCH₃ |
| 2584 | OCH₃ | benzoyl | H | NCH₃ |
| 2585 | OCH₃ | 2-pyridyl | H | NCH₃ |
| 2586 | OCH₃ | H | CH₃ | NCH₃ |
| 2587 | OCH₃ | CH₃ | CH₃ | NCH₃ |
| 2588 | OCH₃ | C₂H₅ | CH₃ | NCH₃ |
| 2589 | OCH₃ | n-C₃H₇ | CH₃ | NCH₃ |
| 2590 | OCH₃ | i-C₃H₇ | CH₃ | NCH₃ |
| 2591 | OCH₃ | n-C₄H₉ | CH₃ | NCH₃ |
| 2592 | OCH₃ | i-C₄H₉ | CH₃ | NCH₃ |
| 2593 | OCH₃ | s-C₄H₉ | CH₃ | NCH₃ |
| 2594 | OCH₃ | t-C₄H₉ | CH₃ | NCH₃ |
| 2595 | OCH₃ | CH₂OCH₃ | CH₃ | NCH₃ |
| 2596 | OCH₃ | CF₃ | CH₃ | NCH₃ |
| 2597 | OCH₃ | CF₂H | CH₃ | NCH₃ |
| 2598 | OCH₃ | CN | CH₃ | NCH₃ |
| 2599 | OCH₃ | OH | CH₃ | NCH₃ |
| 2600 | OCH₃ | OCH₃ | CH₃ | NCH₃ |
| 2601 | OCH₃ | NH₂ | CH₃ | NCH₃ |
| 2602 | OCH₃ | NHCH₃ | CH₃ | NCH₃ |
| 2603 | OCH₃ | N(CH₃)₂ | CH₃ | NCH₃ |
| 2604 | OCH₃ | CO₂CH₃ | CH₃ | NCH₃ |
| 2605 | OCH₃ | CO₂C₂H₅ | CH₃ | NCH₃ |
| 2606 | OCH₃ | C(O)CH₃ | CH₃ | NCH₃ |
| 2607 | OCH₃ | C(O)CF₃ | CH₃ | NCH₃ |
| 2608 | OCH₃ | C(═NOCH₃)CH₃ | CH₃ | NCH₃ |
| 2609 | OCH₃ | SO₂CH₃ | CH₃ | NCH₃ |
| 2610 | OCH₃ | SO₂CF₃ | CH₃ | NCH₃ |
| 2611 | OCH₃ | CH₂CO₂H | CH₃ | NCH₃ |
| 2612 | OCH₃ | CH₂COOCH₃ | CH₃ | NCH₃ |
| 2613 | OCH₃ | CH₂COOC₂H₅ | CH₃ | NCH₃ |
| 2614 | OCH₃ | prop-1-en-3-yl | CH₃ | NCH₃ |
| 2615 | OCH₃ | trans-but-2-en-1-yl | CH₃ | NCH₃ |
| 2616 | OCH₃ | cis-but-2-en-1-yl | CH₃ | NCH₃ |
| 2617 | OCH₃ | cis-3-methyl- | CH₃ | NCH₃ |
| | | but-2-en-1-yl | | |
| 2618 | OCH₃ | cyclopropyl | CH₃ | NCH₃ |
| 2619 | OCH₃ | cyclopentyl | CH₃ | NCH₃ |
| 2620 | OCH₃ | cyclohexyl | CH₃ | NCH₃ |
| 2621 | OCH₃ | 4,5-dihydroisoxazol- | CH₃ | NCH₃ |
| | | 3-yl | | |
| 2622 | OCH₃ | 4-methyl-4,5-dihydroisoxazol- | CH₃ | NCH₃ |
| | | 3-yl | | |
| 2623 | OCH₃ | isoxazol-3-yl | CH₃ | NCH₃ |
| 2624 | OCH₃ | 4-methylisoxazol-3-yl | CH₃ | NCH₃ |
| 2625 | OCH₃ | 4,5-dihydroisoxazol- | CH₃ | NCH₃ |
| | | 4-yl | | |
| 2626 | OCH₃ | 3-methyl-4,5-dihydroisoxazol- | CH₃ | NCH₃ |
| | | 4-yl | | |
| 2627 | OCH₃ | isoxazol-4-yl | CH₃ | NCH₃ |
| 2628 | OCH₃ | 3-methylisoxazol-4-yl | CH₃ | NCH₃ |
| 2629 | OCH₃ | phenyl | CH₃ | NCH₃ |
| 2630 | OCH₃ | benzyl | CH₃ | NCH₃ |
| 2631 | OCH₃ | benzoyl | CH₃ | NCH₃ |
| 2632 | OCH₃ | 2-pyridyl | CH₃ | NCH₃ |
| 2633 | OCH₃ | H | Cl | NCH₃ |
| 2634 | OCH₃ | CH₃ | Cl | NCH₃ |
| 2635 | OCH₃ | C₂H₅ | Cl | NCH₃ |
| 2636 | OCH₃ | n-C₃H₇ | Cl | NCH₃ |
| 2637 | OCH₃ | i-C₃H₇ | Cl | NCH₃ |
| 2638 | OCH₃ | n-C₄H₉ | Cl | NCH₃ |
| 2639 | OCH₃ | i-C₄H₉ | Cl | NCH₃ |
| 2640 | OCH₃ | s-C₄H₉ | Cl | NCH₃ |
| 2641 | OCH₃ | t-C₄H₉ | Cl | NCH₃ |
| 2642 | OCH₃ | CH₂OCH₃ | Cl | NCH₃ |
| 2643 | OCH₃ | CF₃ | Cl | NCH₃ |
| 2644 | OCH₃ | CF₂H | Cl | NCH₃ |
| 2645 | OCH₃ | CN | Cl | NCH₃ |
| 2646 | OCH₃ | OH | Cl | NCH₃ |
| 2647 | OCH₃ | OCH₃ | Cl | NCH₃ |
| 2648 | OCH₃ | NH₂ | Cl | NCH₃ |
| 2649 | OCH₃ | NHCH₃ | Cl | NCH₃ |
| 2650 | OCH₃ | N(CH₃)₂ | Cl | NCH₃ |
| 2651 | OCH₃ | CO₂CH₃ | Cl | NCH₃ |
| 2652 | OCH₃ | CO₂C₂H₅ | Cl | NCH₃ |
| 2653 | OCH₃ | C(O)CH₃ | Cl | NCH₃ |
| 2654 | OCH₃ | C(O)CF₃ | Cl | NCH₃ |
| 2655 | OCH₃ | C(═NOCH₃)CH₃ | Cl | NCH₃ |
| 2656 | OCH₃ | SO₂CH₃ | Cl | NCH₃ |
| 2657 | OCH₃ | SO₂CF₃ | Cl | NCH₃ |
| 2658 | OCH₃ | CH₂CO₂H | Cl | NCH₃ |
| 2659 | OCH₃ | CH₂COOCH₃ | Cl | NCH₃ |
| 2660 | OCH₃ | CH₂COOC₂H₅ | Cl | NCH₃ |
| 2661 | OCH₃ | prop-1-en-3-yl | Cl | NCH₃ |
| 2662 | OCH₃ | trans-but-2-en-1-yl | Cl | NCH₃ |
| 2663 | OCH₃ | cis-but-2-en-1-yl | Cl | NCH₃ |
| 2664 | OCH₃ | cis-3-methyl- | Cl | NCH₃ |
| | | but-2-en-1-yl | | |
| 2665 | OCH₃ | cyclopropyl | Cl | NCH₃ |
| 2666 | OCH₃ | cyclopentyl | Cl | NCH₃ |
| 2667 | OCH₃ | cyclohexyl | Cl | NCH₃ |
| 2668 | OCH₃ | 4,5-dihydroisoxazol- | Cl | NCH₃ |
| | | 3-yl | | |
| 2669 | OCH₃ | 4-methyl-4,5-dihydroisoxazol- | Cl | NCH₃ |
| | | 3-yl | | |
| 2670 | OCH₃ | isoxazol-3-yl | Cl | NCH₃ |
| 2671 | OCH₃ | 4-methylisoxazol-3-yl | Cl | NCH₃ |
| 2672 | OCH₃ | 4,5-dihydroisoxazol- | Cl | NCH₃ |
| | | 4-yl | | |
| 2673 | OCH₃ | 3-methyl-4,5-dihydroisoxazol- | Cl | NCH₃ |
| | | 4-yl | | |
| 2674 | OCH₃ | isoxazol-4-yl | Cl | NCH₃ |
| 2675 | OCH₃ | 3-methylisoxazol-4-yl | Cl | NCH₃ |
| 2676 | OCH₃ | phenyl | Cl | NCH₃ |
| 2677 | OCH₃ | benzyl | Cl | NCH₃ |
| 2678 | OCH₃ | benzoyl | Cl | NCH₃ |
| 2679 | OCH₃ | 2-pyridyl | Cl | NCH₃ |
| 2680 | OCF₃ | H | H | NCH₃ |
| 2681 | OCF₃ | CH₃ | H | NCH₃ |
| 2682 | OCF₃ | C₂H₅ | H | NCH₃ |
| 2683 | OCF₃ | n-C₃H₇ | H | NCH₃ |
| 2684 | OCF₃ | i-C₃H₇ | H | NCH₃ |
| 2685 | OCF₃ | n-C₄H₉ | H | NCH₃ |
| 2686 | OCF₃ | i-C₄H₉ | H | NCH₃ |
| 2687 | OCF₃ | s-C₄H₉ | H | NCH₃ |
| 2688 | OCF₃ | t-C₄H₉ | H | NCH₃ |
| 2689 | OCF₃ | CH₂OCH₃ | H | NCH₃ |
| 2690 | OCF₃ | CF₃ | H | NCH₃ |
| 2691 | OCF₃ | CF₂H | H | NCH₃ |
| 2692 | OCF₃ | CN | H | NCH₃ |
| 2693 | OCF₃ | OH | H | NCH₃ |
| 2694 | OCF₃ | OCH₃ | H | NCH₃ |
| 2695 | OCF₃ | NH₂ | H | NCH₃ |
| 2696 | OCF₃ | NHCH₃ | H | NCH₃ |
| 2697 | OCF₃ | N(CH₃)₂ | H | NCH₃ |
| 2698 | OCF₃ | CO₂CH₃ | H | NCH₃ |
| 2699 | OCF₃ | CO₂C₂H₅ | H | NCH₃ |
| 2700 | OCF₃ | C(O)CH₃ | H | NCH₃ |
| 2701 | OCF₃ | C(O)CF₃ | H | NCH₃ |
| 2702 | OCF₃ | C(═NOCH₃)CH₃ | H | NCH₃ |
| 2703 | OCF₃ | SO₂CH₃ | H | NCH₃ |
| 2704 | OCF₃ | SO₂CF₃ | H | NCH₃ |
| 2705 | OCF₃ | CH₂CO₂H | H | NCH₃ |
| 2706 | OCF₃ | CH₂COOCH₃ | H | NCH₃ |
| 2707 | OCF₃ | CH₂COOC₂H₅ | H | NCH₃ |
| 2708 | OCF₃ | prop-1-en-3-yl | H | NCH₃ |
| 2709 | OCF₃ | trans-but-2-en-1-yl | H | NCH₃ |
| 2710 | OCF₃ | cis-but-2-en-1-yl | H | NCH₃ |
| 2711 | OCF₃ | cis-3-methyl- | H | NCH₃ |
| | | but-2-en-1-yl | | |
| 2712 | OCF₃ | cyclopropyl | H | NCH₃ |
| 2713 | OCF₃ | cyclopentyl | H | NCH₃ |
| 2714 | OCF₃ | cyclohexyl | H | NCH₃ |
| 2715 | OCF₃ | 4,5-dihydroisoxazol- | H | NCH₃ |
| | | 3-yl | | |
| 2716 | OCF₃ | 4-methyl-4,5-dihydroisoxazol- | H | NCH₃ |
| | | 3-yl | | |
| 2717 | OCF₃ | isoxazol-3-yl | H | NCH₃ |
| 2718 | OCF₃ | 4-methylisoxazol-3-yl | H | NCH₃ |
| 2719 | OCF₃ | 4,5-dihydroisoxazol- | H | NCH₃ |
| | | 4-yl | | |
| 2720 | OCF₃ | 3-methyl-4,5-dihydroisoxazol- | H | NCH₃ |
| | | 4-yl | | |
| 2721 | OCF₃ | isoxazol-4-yl | H | NCH₃ |
| 2722 | OCF₃ | 3-methylisoxazol-4-yl | H | NCH₃ |
| 2723 | OCF₃ | phenyl | H | NCH₃ |
| 2724 | OCF₃ | benzyl | H | NCH₃ |
| 2725 | OCF₃ | benzoyl | H | NCH₃ |
| 2726 | OCF₃ | 2-pyridyl | H | NCH₃ |
| 2727 | OCF₃ | H | CH₃ | NCH₃ |
| 2728 | OCF₃ | CH₃ | CH₃ | NCH₃ |
| 2729 | OCF₃ | C₂H₅ | CH₃ | NCH₃ |
| 2730 | OCF₃ | n-C₃H₇ | CH₃ | NCH₃ |
| 2731 | OCF₃ | i-C₃H₇ | CH₃ | NCH₃ |
| 2732 | OCF₃ | n-C₄H₉ | CH₃ | NCH₃ |
| 2733 | OCF₃ | i-C₄H₉ | CH₃ | NCH₃ |
| 2734 | OCF₃ | s-C₄H₉ | CH₃ | NCH₃ |
| 2735 | OCF₃ | t-C₄H₉ | CH₃ | NCH₃ |
| 2736 | OCF₃ | CH₂OCH₃ | CH₃ | NCH₃ |
| 2737 | OCF₃ | CF₃ | CH₃ | NCH₃ |
| 2738 | OCF₃ | CF₂H | CH₃ | NCH₃ |
| 2739 | OCF₃ | CN | CH₃ | NCH₃ |
| 2740 | OCF₃ | OH | CH₃ | NCH₃ |
| 2741 | OCF₃ | OCH₃ | CH₃ | NCH₃ |
| 2742 | OCF₃ | NH₂ | CH₃ | NCH₃ |
| 2743 | OCF₃ | NHCH₃ | CH₃ | NCH₃ |
| 2744 | OCF₃ | N(CH₃)₂ | CH₃ | NCH₃ |
| 2745 | OCF₃ | CO₂CH₃ | CH₃ | NCH₃ |
| 2746 | OCF₃ | CO₂C₂H₅ | CH₃ | NCH₃ |
| 2747 | OCF₃ | C(O)CH₃ | CH₃ | NCH₃ |
| 2748 | OCF₃ | C(O)CF₃ | CH₃ | NCH₃ |
| 2749 | OCF₃ | C(═NOCH₃)CH₃ | CH₃ | NCH₃ |
| 2750 | OCF₃ | SO₂CH₃ | CH₃ | NCH₃ |
| 2751 | OCF₃ | SO₂CF₃ | CH₃ | NCH₃ |
| 2752 | OCF₃ | CH₂CO₂H | CH₃ | NCH₃ |
| 2753 | OCF₃ | CH₂COOCH₃ | CH₃ | NCH₃ |
| 2754 | OCF₃ | CH₂COOC₂H₅ | CH₃ | NCH₃ |
| 2755 | OCF₃ | prop-1-en-3-yl | CH₃ | NCH₃ |
| 2756 | OCF₃ | trans-but-2-en-1-yl | CH₃ | NCH₃ |
| 2757 | OCF₃ | cis-but-2-en-1-yl | CH₃ | NCH₃ |
| 2758 | OCF₃ | cis-3-methyl- | CH₃ | NCH₃ |
| | | but-2-en-l-yl | | |
| 2759 | OCF₃ | cyclopropyl | CH₃ | NCH₃ |
| 2760 | OCF₃ | cyclopentyl | CH₃ | NCH₃ |
| 2761 | OCF₃ | cyclohexyl | CH₃ | NCH₃ |
| 2762 | OCF₃ | 4,5-dihydroisoxazol- | CH₃ | NCH₃ |
| | | 3-yl | | |
| 2763 | OCF₃ | 4-methyl-4,5-dihydroisoxazol- | CH₃ | NCH₃ |
| | | 3-yl | | |
| 2764 | OCF₃ | isoxazol-3-yl | CH₃ | NCH₃ |
| 2765 | OCF₃ | 4-methylisoxazol-3-yl | CH₃ | NCH₃ |
| 2766 | OCF₃ | 4,5-dihydroisoxazol- | CH₃ | NCH₃ |
| | | 4-yl | | |
| 2767 | OCF₃ | 3-methyl-4,5-dihydroisoxazol- | CH₃ | NCH₃ |
| | | 4-yl | | |
| 2768 | OCF₃ | isoxazol-4-yl | CH₃ | NCH₃ |
| 2769 | OCF₃ | 3-methylisoxazol-4-yl | CH₃ | NCH₃ |
| 2770 | OCF₃ | phenyl | CH₃ | NCH₃ |
| 2771 | OCF₃ | benzyl | CH₃ | NCH₃ |
| 2772 | OCF₃ | benzoyl | CH₃ | NCH₃ |
| 2773 | OCF₃ | 2-pyridyl | CH₃ | NCH₃ |
| 2774 | OCF₃ | H | Cl | NCH₃ |
| 2775 | OCF₃ | CH₃ | Cl | NCH₃ |
| 2776 | OCF₃ | C₂H₅ | Cl | NCH₃ |
| 2777 | OCF₃ | n-C₃H₇ | Cl | NCH₃ |
| 2778 | OCF₃ | i-C₃H₇ | Cl | NCH₃ |
| 2779 | OCF₃ | n-C₄H₉ | Cl | NCH₃ |
| 2780 | OCF₃ | i-C₄H₉ | Cl | NCH₃ |
| 2781 | OCF₃ | s-C₄H₉ | Cl | NCH₃ |
| 2782 | OCF₃ | t-C₄H₉ | Cl | NCH₃ |
| 2783 | OCF₃ | CH₂OCH₃ | Cl | NCH₃ |
| 2784 | OCF₃ | CF₃ | Cl | NCH₃ |
| 2785 | OCF₃ | CF₂H | Cl | NCH₃ |
| 2786 | OCF₃ | CN | Cl | NCH₃ |
| 2787 | OCF₃ | OH | Cl | NCH₃ |
| 2788 | OCF₃ | OCH₃ | Cl | NCH₃ |
| 2789 | OCF₃ | NH₂ | Cl | NCH₃ |
| 2790 | OCF₃ | NHCH₃ | Cl | NCH₃ |
| 2791 | OCF₃ | N(CH₃)₂ | Cl | NCH₃ |
| 2792 | OCF₃ | CO₂CH₃ | Cl | NCH₃ |
| 2793 | OCF₃ | CO₂C₂H₅ | Cl | NCH₃ |
| 2794 | OCF₃ | C(O)CH₃ | Cl | NCH₃ |
| 2795 | OCF₃ | C(O)CF₃ | Cl | NCH₃ |
| 2796 | OCF₃ | C(═NOCH₃)CH₃ | Cl | NCH₃ |
| 2797 | OCF₃ | SO₂CH₃ | Cl | NCH₃ |
| 2798 | OCF₃ | SO₂CF₃ | Cl | NCH₃ |
| 2799 | OCF₃ | CH₂CO₂H | Cl | NCH₃ |
| 2800 | OCF₃ | CH₂COOCH₃ | Cl | NCH₃ |
| 2801 | OCF₃ | CH₂COOC₂H₅ | Cl | NCH₃ |
| 2802 | OCF₃ | prop-1-en-3-yl | Cl | NCH₃ |
| 2803 | OCF₃ | trans-but-2-en-1-yl | Cl | NCH₃ |
| 2804 | OCF₃ | cis-but-2-en-1-yl | Cl | NCH₃ |
| 2805 | OCF₃ | cis-3-methyl- | Cl | NCH₃ |
| | | but-2-en-1-yl | | |
| 2806 | OCF₃ | cyclopropyl | Cl | NCH₃ |
| 2807 | OCF₃ | cyclopentyl | Cl | NCH₃ |
| 2808 | OCF₃ | cyclohexyl | Cl | NCH₃ |
| 2809 | OCF₃ | 4,5-dihydroisoxazol- | Cl | NCH₃ |
| | | 3-yl | | |
| 2810 | OCF₃ | 4-methyl-4,5-dihydroisoxazol- | Cl | NCH₃ |
| | | 3-yl | | |
| 2811 | OCF₃ | isoxazol-3-yl | Cl | NCH₃ |
| 2812 | OCF₃ | 4-methylisoxazol-3-yl | Cl | NCH₃ |
| 2813 | OCF₃ | 4,5-dihydroisoxazol- | Cl | NCH₃ |
| | | 4-yl | | |
| 2814 | OCF₃ | 3-methyl-4,5-dihydroisoxazol- | Cl | NCH₃ |
| | | 4-yl | | |
| 2815 | OCF₃ | isoxazol-4-yl | Cl | NCH₃ |
| 2816 | OCF₃ | 3-methylisoxazol-4-yl | Cl | NCH₃ |
| 2817 | OCF₃ | phenyl | Cl | NCH₃ |
| 2818 | OCF₃ | benzyl | Cl | NCH₃ |
| 2819 | OCF₃ | benzoyl | Cl | NCH₃ |
| 2820 | OCF₃ | 2-pyridyl | Cl | NCH₃ |
| 2821 | SCH₃ | H | H | NCH₃ |
| 2822 | SCH₃ | CH₃ | H | NCH₃ |
| 2823 | SCH₃ | C₂H₅ | H | NCH₃ |
| 2824 | SCH₃ | n-C₃H₇ | H | NCH₃ |
| 2825 | SCH₃ | i-C₃H₇ | H | NCH₃ |
| 2826 | SCH₃ | n-C₄H₉ | H | NCH₃ |
| 2827 | SCH₃ | i-C₄H₉ | H | NCH₃ |
| 2828 | SCH₃ | s-C₄H₉ | H | NCH₃ |
| 2829 | SCH₃ | t-C₄H₉ | H | NCH₃ |
| 2830 | SCH₃ | CH₂OCH₃ | H | NCH₃ |
| 2831 | SCH₃ | CF₃ | H | NCH₃ |
| 2832 | SCH₃ | CF₂H | H | NCH₃ |
| 2833 | SCH₃ | CN | H | NCH₃ |
| 2834 | SCH₃ | OH | H | NCH₃ |
| 2835 | SCH₃ | OCH₃ | H | NCH₃ |
| 2836 | SCH₃ | NH₂ | H | NCH₃ |
| 2837 | SCH₃ | NHCH₃ | H | NCH₃ |
| 2838 | SCH₃ | N(CH₃)₂ | H | NCH₃ |
| 2839 | SCH₃ | CO₂CH₃ | H | NCH₃ |
| 2840 | SCH₃ | CO₂C₂H₅ | H | NCH₃ |
| 2841 | SCH₃ | C(O)CH₃ | H | NCH₃ |
| 2842 | SCH₃ | C(O)CF₃ | H | NCH₃ |
| 2843 | SCH₃ | C(═NOCH₃)CH₃ | H | NCH₃ |
| 2844 | SCH₃ | SO₂CH₃ | H | NCH₃ |
| 2845 | SCH₃ | SO₂CF₃ | H | NCH₃ |
| 2846 | SCH₃ | CH₂CO₂H | H | NCH₃ |
| 2847 | SCH₃ | CH₂COOCH₃ | H | NCH₃ |
| 2848 | SCH₃ | CH₂COOC₂H₅ | H | NCH₃ |
| 2849 | SCH₃ | prop-1-en-3-yl | H | NCH₃ |
| 2850 | SCH₃ | trans-but-2-en-1-yl | H | NCH₃ |
| 2851 | SCH₃ | cis-but-2-en-1-yl | H | NCH₃ |
| 2852 | SCH₃ | cis-3-methyl- | H | NCH₃ |
| | | but-2-en-1-yl | | |
| 2853 | SCH₃ | cyclopropyl | H | NCH₃ |
| 2854 | SCH₃ | cyclopentyl | H | NCH₃ |
| 2855 | SCH₃ | cyclohexyl | H | NCH₃ |
| 2856 | SCH₃ | 4,5-dihydroisoxazol- | H | NCH₃ |
| | | 3-yl | | |
| 2857 | SCH₃ | 4-methyl-4,5-dihydroisoxazol- | H | NCH₃ |
| | | 3-yl | | |
| 2858 | SCH₃ | isoxazol-3-yl | H | NCH₃ |
| 2859 | SCH₃ | 4-methylisoxazol-3-yl | H | NCH₃ |
| 2860 | SCH₃ | 4,5-dihydroisoxazol- | H | NCH₃ |
| | | 4-yl | | |
| 2861 | SCH₃ | 3-methyl-4,5-dihydroisoxazol- | H | NCH₃ |
| | | 4-yl | | |
| 2862 | SCH₃ | isoxazol-4-yl | H | NCH₃ |
| 2863 | SCH₃ | 3-methylisoxazol-4-yl | H | NCH₃ |
| 2864 | SCH₃ | phenyl | H | NCH₃ |
| 2865 | SCH₃ | benzyl | H | NCH₃ |
| 2866 | SCH₃ | benzoyl | H | NCH₃ |
| 2867 | SCH₃ | 2-pyridyl | H | NCH₃ |
| 2868 | SCH₃ | H | CH₃ | NCH₃ |
| 2869 | SCH₃ | CH₃ | CH₃ | NCH₃ |
| 2870 | SCH₃ | C₂H₅ | CH₃ | NCH₃ |
| 2871 | SCH₃ | n-C₃H₇ | CH₃ | NCH₃ |
| 2872 | SCH₃ | i-C₃H₇ | CH₃ | NCH₃ |
| 2873 | SCH₃ | n-C₄H₉ | CH₃ | NCH₃ |
| 2874 | SCH₃ | i-C₄H₉ | CH₃ | NCH₃ |
| 2875 | SCH₃ | s-C₄H₉ | CH₃ | NCH₃ |
| 2876 | SCH₃ | t-C₄H₉ | CH₃ | NCH₃ |
| 2877 | SCH₃ | CH₂OCH₃ | CH₃ | NCH₃ |
| 2878 | SCH₃ | CF₃ | CH₃ | NCH₃ |
| 2879 | SCH₃ | CF₂H | CH₃ | NCH₃ |
| 2880 | SCH₃ | CN | CH₃ | NCH₃ |
| 2881 | SCH₃ | OH | CH₃ | NCH₃ |
| 2882 | SCH₃ | OCH₃ | CH₃ | NCH₃ |
| 2883 | SCH₃ | NH₂ | CH₃ | NCH₃ |
| 2884 | SCH₃ | NHCH₃ | CH₃ | NCH₃ |
| 2885 | SCH₃ | N(CH₃)₂ | CH₃ | NCH₃ |
| 2886 | SCH₃ | CO₂CH₃ | CH₃ | NCH₃ |
| 2887 | SCH₃ | CO₂C₂H₅ | CH₃ | NCH₃ |
| 2888 | SCH₃ | C(O)CH₃ | CH₃ | NCH₃ |
| 2889 | SCH₃ | C(O)CF₃ | CH₃ | NCH₃ |
| 2890 | SCH₃ | C(═NOCH₃)CH₃ | CH₃ | NCH₃ |
| 2891 | SCH₃ | SO₂CH₃ | CH₃ | NCH₃ |
| 2892 | SCH₃ | SO₂CF₃ | CH₃ | NCH₃ |
| 2893 | SCH₃ | CH₂CO₂H | CH₃ | NCH₃ |
| 2894 | SCH₃ | CH₂COOCH₃ | CH₃ | NCH₃ |
| 2895 | SCH₃ | CH₂COOC₂H₅ | CH₃ | NCH₃ |
| 2896 | SCH₃ | prop-1-en-3-yl | CH₃ | NCH₃ |
| 2897 | SCH₃ | trans-but-2-en-1-yl | CH₃ | NCH₃ |
| 2898 | SCH₃ | cis-but-2-en-1-yl | CH₃ | NCH₃ |
| 2899 | SCH₃ | cis-3-methyl- | CH₃ | NCH₃ |
| | | but-2-en-1-yl | | |
| 2900 | SCH₃ | cyclopropyl | CH₃ | NCH₃ |
| 2901 | SCH₃ | cyclopentyl | CH₃ | NCH₃ |
| 2902 | SCH₃ | cyclohexyl | CH₃ | NCH₃ |
| 2903 | SCH₃ | 4,5-dihydroisoxazol- | CH₃ | NCH₃ |
| | | 3-yl | | |
| 2904 | SCH₃ | 4-methyl-4,5-dihydroisoxazol- | CH₃ | NCH₃ |
| | | 3-yl | | |
| 2905 | SCH₃ | isoxazol-3-yl | CH₃ | NCH₃ |
| 2906 | SCH₃ | 4-methylisoxazol-3-yl | CH₃ | NCH₃ |
| 2907 | SCH₃ | 4,5-dihydroisoxazol- | CH₃ | NCH₃ |
| | | 4-yl | | |
| 2908 | SCH₃ | 3-methyl-4,5-dihydroisoxazol- | CH₃ | NCH₃ |
| | | 4-yl | | |
| 2909 | SCH₃ | isoxazol-4-yl | CH₃ | NCH₃ |
| 2910 | SCH₃ | 3-methylisoxazol-4-yl | CH₃ | NCH₃ |
| 2911 | SCH₃ | phenyl | CH₃ | NCH₃ |
| 2912 | SCH₃ | benzyl | CH₃ | NCH₃ |
| 2913 | SCH₃ | benzoyl | CH₃ | NCH₃ |
| 2914 | SCH₃ | 2-pyridyl | CH₃ | NCH₃ |
| 2915 | SCH₃ | H | Cl | NCH₃ |
| 2916 | SCH₃ | CH₃ | Cl | NCH₃ |
| 2917 | SCH₃ | C₂H₅ | Cl | NCH₃ |
| 2918 | SCH₃ | n-C₃H₇ | Cl | NCH₃ |
| 2919 | SCH₃ | i-C₃H₇ | Cl | NCH₃ |
| 2920 | SCH₃ | n-C₄H₉ | Cl | NCH₃ |
| 2921 | SCH₃ | i-C₄H₉ | Cl | NCH₃ |
| 2922 | SCH₃ | s-C₄H₉ | Cl | NCH₃ |
| 2923 | SCH₃ | t-C₄H₉ | Cl | NCH₃ |
| 2924 | SCH₃ | CH₂OCH₃ | Cl | NCH₃ |
| 2925 | SCH₃ | CF₃ | Cl | NCH₃ |
| 2926 | SCH₃ | CF₂H | Cl | NCH₃ |
| 2927 | SCH₃ | CN | Cl | NCH₃ |
| 2928 | SCH₃ | OH | Cl | NCH₃ |
| 2929 | SCH₃ | OCH₃ | Cl | NCH₃ |
| 2930 | SCH₃ | NH₂ | Cl | NCH₃ |
| 2931 | SCH₃ | NHCH₃ | Cl | NCH₃ |
| 2932 | SCH₃ | N(CH₃)₂ | Cl | NCH₃ |
| 2933 | SCH₃ | CO₂CH₃ | Cl | NCH₃ |
| 2934 | SCH₃ | CO₂C₂H₅ | Cl | NCH₃ |
| 2935 | SCH₃ | C(O)CH₃ | Cl | NCH₃ |
| 2936 | SCH₃ | C(O)CF₃ | Cl | NCH₃ |
| 2937 | SCH₃ | C(═NOCH₃) CH₃ | Cl | NCH₃ |
| 2938 | SCH₃ | SO₂CH₃ | Cl | NCH₃ |
| 2939 | SCH₃ | SO₂CF₃ | Cl | NCH₃ |
| 2940 | SCH₃ | CH₂CO₂H | Cl | NCH₃ |
| 2941 | SCH₃ | CH₂COOCH₃ | Cl | NCH₃ |
| 2942 | SCH₃ | CH₂COOC₂H₅ | Cl | NCH₃ |
| 2943 | SCH₃ | prop-1-en-3-yl | Cl | NCH₃ |
| 2944 | SCH₃ | trans-but-2-en-1-yl | Cl | NCH₃ |
| 2945 | SCH₃ | cis-but-2-en-1-yl | Cl | NCH₃ |
| 2946 | SCH₃ | cis-3-methyl- | Cl | NCH₃ |
| | | but-2-en-1-yl | | |
| 2947 | SCH₃ | cyclopropyl | Cl | NCH₃ |
| 2948 | SCH₃ | cyclopentyl | Cl | NCH₃ |
| 2949 | SCH₃ | cyclohexyl | Cl | NCH₃ |
| 2950 | SCH₃ | 4,5-dihydroisoxazol- | Cl | NCH₃ |
| | | 3-yl | | |
| 2951 | SCH₃ | 4-methyl-4,5-dihydroisoxazol- | Cl | NCH₃ |
| | | 3-yl | | |
| 2952 | SCH₃ | isoxazol-3-yl | Cl | NCH₃ |
| 2953 | SCH₃ | 4-methylisoxazol-3-yl | Cl | NCH₃ |
| 2954 | SCH₃ | 4,5-dihydroisoxazol- | Cl | NCH₃ |
| | | 4-yl | | |
| 2955 | SCH₃ | 3-methyl-4,5-dihydroisoxazol- | Cl | NCH₃ |
| | | 4-yl | | |
| 2956 | SCH₃ | isoxazol-4-yl | Cl | NCH₃ |
| 2957 | SCH₃ | 3-methylisoxazol-4-yl | Cl | NCH₃ |
| 2958 | SCH₃ | phenyl | Cl | NCH₃ |
| 2959 | SCH₃ | benzyl | Cl | NCH₃ |
| 2960 | SCH₃ | benzoyl | Cl | NCH₃ |
| 2961 | SCH₃ | 2-pyridyl | Cl | NCH₃ |
| 2962 | SO₂CH₃ | H | H | NCH₃ |
| 2963 | SO₂CH₃ | CH₃ | H | NCH₃ |
| 2964 | SO₂CH₃ | C₂H₅ | H | NCH₃ |
| 2965 | SO₂CH₃ | n-C₃H₇ | H | NCH₃ |
| 2966 | SO₂CH₃ | i-C₃H₇ | H | NCH₃ |
| 2967 | SO₂CH₃ | n-C₄H₉ | H | NCH₃ |
| 2968 | SO₂CH₃ | i-C₄H₉ | H | NCH₃ |
| 2969 | SO₂CH₃ | s-C₄H₉ | H | NCH₃ |
| 2970 | SO₂CH₃ | t-C₄H₉ | H | NCH₃ |
| 2971 | SO₂CH₃ | CH₂OCH₃ | H | NCH₃ |
| 2972 | SO₂CH₃ | CF₃ | H | NCH₃ |
| 2973 | SO₂CH₃ | CF₂H | H | NCH₃ |
| 2974 | SO₂CH₃ | CN | H | NCH₃ |
| 2975 | SO₂CH₃ | OH | H | NCH₃ |
| 2976 | SO₂CH₃ | OCH₃ | H | NCH₃ |
| 2977 | SO₂CH₃ | NH₂ | H | NCH₃ |
| 2978 | SO₂CH₃ | NHCH₃ | H | NCH₃ |
| 2979 | SO₂CH₃ | N(CH₃)₂ | H | NCH₃ |
| 2980 | SO₂CH₃ | CO₂CH₃ | H | NCH₃ |
| 2981 | SO₂CH₃ | CO₂C₂H₅ | H | NCH₃ |
| 2982 | SO₂CH₃ | C(O)CH₃ | H | NCH₃ |
| 2983 | SO₂CH₃ | C(O)CF₃ | H | NCH₃ |
| 2984 | SO₂CH₃ | C(═NOCH₃)CH₃ | H | NCH₃ |
| 2985 | SO₂CH₃ | SO₂CH₃ | H | NCH₃ |
| 2986 | SO₂CH₃ | SO₂CF₃ | H | NCH₃ |
| 2987 | SO₂CH₃ | CH₂CO₂H | H | NCH₃ |
| 2988 | SO₂CH₃ | CH₂COOCH₃ | H | NCH₃ |
| 2989 | SO₂CH₃ | CH₂COOC₂H₅ | H | NCH₃ |
| 2990 | SO₂CH₃ | prop-1-en-3-yl | H | NCH₃ |
| 2991 | SO₂CH₃ | trans-but-2-en-1-yl | H | NCH₃ |
| 2992 | SO₂CH₃ | cis-but-2-en-1-yl | H | NCH₃ |
| 2993 | SO₂CH₃ | cis-3-methyl- | H | NCH₃ |
| | | but-2-en-1-yl | | |
| 2994 | SO₂CH₃ | cyclopropyl | H | NCH₃ |
| 2995 | SO₂CH₃ | cyclopentyl | H | NCH₃ |
| 2996 | SO₂CH₃ | cyclohexyl | H | NCH₃ |
| 2997 | SO₂CH₃ | 4,5-dihydroisoxazol- | H | NCH₃ |
| | | 3-yl | | |
| 2998 | SO₂CH₃ | 4-methyl-4,5-dihydroisoxazol- | H | NCH₃ |
| | | 3-yl | | |
| 2999 | SO₂CH₃ | isoxazol-3-yl | H | NCH₃ |
| 3000 | SO₂CH₃ | 4-methylisoxazol-3-yl | H | NCH₃ |
| 3001 | SO₂CH₃ | 4,5-dihydroisoxazol- | H | NCH₃ |
| | | 4-yl | | |
| 3002 | SO₂CH₃ | 3-methyl-4,5-dihydroisoxazol- | H | NCH₃ |
| | | 4-yl | | |
| 3003 | SO₂CH₃ | isoxazol-4-yl | H | NCH₃ |
| 3004 | SO₂CH₃ | 3-methylisoxazol-4-yl | H | NCH₃ |
| 3005 | SO₂CH₃ | phenyl | H | NCH₃ |
| 3006 | SO₂CH₃ | benzyl | H | NCH₃ |
| 3007 | SO₂CH₃ | benzoyl | H | NCH₃ |
| 3008 | SO₂CH₃ | 2-pyridyl | H | NCH₃ |
| 3009 | SO₂CH₃ | H | CH₃ | NCH₃ |
| 3010 | SO₂CH₃ | CH₃ | CH₃ | NCH₃ |
| 3011 | SO₂CH₃ | C₂H₅ | CH₃ | NCH₃ |
| 3012 | SO₂CH₃ | n-C₃H₇ | CH₃ | NCH₃ |
| 3013 | SO₂CH₃ | i-C₃H₇ | CH₃ | NCH₃ |
| 3014 | SO₂CH₃ | n-C₄H₉ | CH₃ | NCH₃ |
| 3015 | SO₂CH₃ | i-C₄H₉ | CH₃ | NCH₃ |
| 3016 | SO₂CH₃ | s-C₄H₉ | CH₃ | NCH₃ |
| 3017 | SO₂CH₃ | t-C₄H₉ | CH₃ | NCH₃ |
| 3018 | SO₂CH₃ | CH₂OCH₃ | CH₃ | NCH₃ |
| 3019 | SO₂CH₃ | CF₃ | CH₃ | NCH₃ |
| 3020 | SO₂CH₃ | CF₂H | CH₃ | NCH₃ |
| 3021 | SO₂CH₃ | CN | CH₃ | NCH₃ |
| 3022 | SO₂CH₃ | OH | CH₃ | NCH₃ |
| 3023 | SO₂CH₃ | OCH₃ | CH₃ | NCH₃ |
| 3024 | SO₂CH₃ | NH₂ | CH₃ | NCH₃ |
| 3025 | SO₂CH₃ | NHCH₃ | CH₃ | NCH₃ |
| 3026 | SO₂CH₃ | N(CH₃)₂ | CH₃ | NCH₃ |
| 3027 | SO₂CH₃ | CO₂CH₃ | CH₃ | NCH₃ |
| 3028 | SO₂CH₃ | CO₂C₂H₅ | CH₃ | NCH₃ |
| 3029 | SO₂CH₃ | C(O)CH₃ | CH₃ | NCH₃ |
| 3030 | SO₂CH₃ | C(O)CF₃ | CH₃ | NCH₃ |
| 3031 | SO₂CH₃ | C(═NOCH₃)CH₃ | CH₃ | NCH₃ |
| 3032 | SO₂CH₃ | SO₂CH₃ | CH₃ | NCH₃ |
| 3033 | SO₂CH₃ | SO₂CF₃ | CH₃ | NCH₃ |
| 3034 | SO₂CH₃ | CH₂CO₂H | CH₃ | NCH₃ |
| 3035 | SO₂CH₃ | CH₂COOCH₃ | CH₃ | NCH₃ |
| 3036 | SO₂CH₃ | CH₂COOC₂H₅ | CH₃ | NCH₃ |
| 3037 | SO₂CH₃ | prop-1-en-3-yl | CH₃ | NCH₃ |
| 3038 | SO₂CH₃ | trans-but-2-en-1-yl | CH₃ | NCH₃ |
| 3039 | SO₂CH₃ | cis-but-2-en-1-yl | CH₃ | NCH₃ |
| 3040 | SO₂CH₃ | cis-3-methyl- | CH₃ | NCH₃ |
| | | but-2-en-1-yl | | |
| 3041 | SO₂CH₃ | cyclopropyl | CH₃ | NCH₃ |
| 3042 | SO₂CH₃ | cyclopentyl | CH₃ | NCH₃ |
| 3043 | SO₂CH₃ | cyclohexyl | CH₃ | NCH₃ |
| 3044 | SO₂CH₃ | 4,5-dihydroisoxazol- | CH₃ | NCH₃ |
| | | 3-yl | | |
| 3045 | SO₂CH₃ | 4-methyl-4,5-dihydroisoxazol- | CH₃ | NCH₃ |
| | | 3-yl | | |
| 3046 | SO₂CH₃ | isoxazol-3-yl | CH₃ | NCH₃ |
| 3047 | SO₂CH₃ | 4-methylisoxazol-3-yl | CH₃ | NCH₃ |
| 3048 | SO₂CH₃ | 4,5-dihydroisoxazol- | CH₃ | NCH₃ |
| | | 4-yl | | |
| 3049 | SO₂CH₃ | 3-methyl-4,5-dihydroisoxazol- | CH₃ | NCH₃ |
| | | 4-yl | | |
| 3050 | SO₂CH₃ | isoxazol-4-yl | CH₃ | NCH₃ |
| 3051 | SO₂CH₃ | 3-methylisoxazol-4-yl | CH₃ | NCH₃ |
| 3052 | SO₂CH₃ | phenyl | CH₃ | NCH₃ |
| 3053 | SO₂CH₃ | benzyl | CH₃ | NCH₃ |
| 3054 | SO₂CH₃ | benzoyl | CH₃ | NCH₃ |
| 3055 | SO₂CH₃ | 2-pyridyl | CH₃ | NCH₃ |
| 3056 | SO₂CH₃ | H | Cl | NCH₃ |
| 3057 | SO₂CH₃ | CH₃ | Cl | NCH₃ |
| 3058 | SO₂CH₃ | C₂H₅ | Cl | NCH₃ |
| 3059 | SO₂CH₃ | n-C₃H₇ | Cl | NCH₃ |
| 3060 | SO₂CH₃ | i-C₃H₇ | Cl | NCH₃ |
| 3061 | SO₂CH₃ | n-C₄H₉ | Cl | NCH₃ |
| 3062 | SO₂CH₃ | i-C₄H₉ | Cl | NCH₃ |
| 3063 | SO₂CH₃ | s-C₄H₉ | Cl | NCH₃ |
| 3064 | SO₂CH₃ | t-C₄H₉ | Cl | NCH₃ |
| 3065 | SO₂CH₃ | CH₂OCH₃ | Cl | NCH₃ |
| 3066 | SO₂CH₃ | CF₃ | Cl | NCH₃ |
| 3067 | SO₂CH₃ | CF₂H | Cl | NCH₃ |
| 3068 | SO₂CH₃ | CN | Cl | NCH₃ |
| 3069 | SO₂CH₃ | OH | Cl | NCH₃ |
| 3070 | SO₂CH₃ | OCH₃ | Cl | NCH₃ |
| 3071 | SO₂CH₃ | NH₂ | Cl | NCH₃ |
| 3072 | SO₂CH₃ | NHCH₃ | Cl | NCH₃ |
| 3073 | SO₂CH₃ | N(CH₃)₂ | Cl | NCH₃ |
| 3074 | SO₂CH₃ | CO₂CH₃ | Cl | NCH₃ |
| 3075 | SO₂CH₃ | CO₂C₂H₅ | Cl | NCH₃ |
| 3076 | SO₂CH₃ | C(O)CH₃ | Cl | NCH₃ |
| 3077 | SO₂CH₃ | C(O)CF₃ | Cl | NCH₃ |
| 3078 | SO₂CH₃ | C(═NOCH₃)CH₃ | Cl | NCH₃ |
| 3079 | SO₂CH₃ | SO₂CH₃ | Cl | NCH₃ |
| 3080 | SO₂CH₃ | SO₂CF₃ | Cl | NCH₃ |
| 3081 | SO₂CH₃ | CH₂CO₂H | Cl | NCH₃ |
| 3082 | SO₂CH₃ | CH₂COOCH₃ | Cl | NCH₃ |
| 3083 | SO₂CH₃ | CH₂COOC₂H₅ | Cl | NCH₃ |
| 3084 | SO₂CH₃ | prop-1-en-3-yl | Cl | NCH₃ |
| 3085 | SO₂CH₃ | trans-but-2-en-1-yl | Cl | NCH₃ |
| 3086 | SO₂CH₃ | cis-but-2-en-1-yl | Cl | NCH₃ |
| 3087 | SO₂CH₃ | cis-3-methyl- | Cl | NCH₃ |
| | | but-2-en-1-yl | | |
| 3088 | SO₂CH₃ | cyclopropyl | Cl | NCH₃ |
| 3089 | SO₂CH₃ | cyclopentyl | Cl | NCH₃ |
| 3090 | SO₂CH₃ | cyclohexyl | Cl | NCH₃ |
| 3091 | SO₂CH₃ | 4,5-dihydroisoxazol- | Cl | NCH₃ |
| | | 3-yl | | |
| 3092 | SO₂CH₃ | 4-methyl-4,5-dihydroisoxazol- | Cl | NCH₃ |
| | | 3-yl | | |
| 3093 | SO₂CH₃ | isoxazol-3-yl | Cl | NCH₃ |
| 3094 | SO₂CH₃ | 4-methylisoxazol-3-yl | Cl | NCH₃ |
| 3095 | SO₂CH₃ | 4,5-dihydroisoxazol- | Cl | NCH₃ |
| | | 4-yl | | |
| 3096 | SO₂CH₃ | 3-methyl-4,5-dihydroisoxazol- | Cl | NCH₃ |
| | | 4-yl | | |
| 3097 | SO₂CH₃ | isoxazol-4-yl | Cl | NCH₃ |
| 3098 | SO₂CH₃ | 3-methylisoxazol-4-yl | Cl | NCH₃ |
| 3099 | SO₂CH₃ | phenyl | Cl | NCH₃ |
| 3100 | SO₂CH₃ | benzyl | Cl | NCH₃ |
| 3101 | SO₂CH₃ | benzoyl | Cl | NCH₃ |
| 3102 | SO₂CH₃ | 2-pyridyl | Cl | NCH₃ |
| 3103 | CF₃ | H | H | NCH₃ |
| 3104 | CF₃ | CH₃ | H | NCH₃ |
| 3105 | CF₃ | C₂H₅ | H | NCH₃ |
| 3106 | CF₃ | n-C₃H₇ | H | NCH₃ |
| 3107 | CF₃ | i-C₃H₇ | H | NCH₃ |
| 3108 | CF₃ | n-C₄H₉ | H | NCH₃ |
| 3109 | CF₃ | i-C₄H₉ | H | NCH₃ |
| 3110 | CF₃ | s-C₄H₉ | H | NCH₃ |
| 3111 | CF₃ | t-C₄H₉ | H | NCH₃ |
| 3112 | CF₃ | CH₂OCH₃ | H | NCH₃ |
| 3113 | CF₃ | CF₃ | H | NCH₃ |
| 3114 | CF₃ | CF₂H | H | NCH₃ |
| 3115 | CF₃ | CN | H | NCH₃ |
| 3116 | CF₃ | OH | H | NCH₃ |
| 3117 | CF₃ | OCH₃ | H | NCH₃ |
| 3118 | CF₃ | NH₂ | H | NCH₃ |
| 3119 | CF₃ | NHCH₃ | H | NCH₃ |
| 3120 | CF₃ | N(CH₃)₂ | H | NCH₃ |
| 3121 | CF₃ | CO₂CH₃ | H | NCH₃ |
| 3122 | CF₃ | CO₂C₂H₅ | H | NCH₃ |
| 3123 | CF₃ | C(O)CH₃ | H | NCH₃ |
| 3124 | CF₃ | C(O)CF₃ | H | NCH₃ |
| 3125 | CF₃ | C(═NOCH₃)CH₃ | H | NCH₃ |
| 3126 | CF₃ | SO₂CH₃ | H | NCH₃ |
| 3127 | CF₃ | SO₂CF₃ | H | NCH₃ |
| 3128 | CF₃ | CH₂CO₂H | H | NCH₃ |
| 3129 | CF₃ | CH₂COOCH₃ | H | NCH₃ |
| 3130 | CF₃ | CH₂COOC₂H₅ | H | NCH₃ |
| 3131 | CF₃ | prop-1-en-3-yl | H | NCH₃ |
| 3132 | CF₃ | trans-but-2-en-1-yl | H | NCH₃ |
| 3133 | CF₃ | cis-but-2-en-1-yl | H | NCH₃ |
| 3134 | CF₃ | cis-3-methyl- | H | NCH₃ |
| | | but-2-en-1-yl | | |
| 3135 | CF₃ | cyclopropyl | H | NCH₃ |
| 3136 | CF₃ | cyclopentyl | H | NCH₃ |
| 3137 | CF₃ | cyclohexyl | H | NCH₃ |
| 3138 | CF₃ | 4,5-dihydroisoxazol- | H | NCH₃ |
| | | 3-yl | | |
| 3139 | CF₃ | 4-methyl-4,5-dihydroisoxazol- | H | NCH₃ |
| | | 3-yl | | |
| 3140 | CF₃ | isoxazol-3-yl | H | NCH₃ |
| 3141 | CF₃ | 4-methylisoxazol-3-yl | H | NCH₃ |
| 3142 | CF₃ | 4,5-dihydroisoxazol- | H | NCH₃ |
| | | 4-yl | | |
| 3143 | CF₃ | 3-methyl-4,5-dihydroisoxazol- | H | NCH₃ |
| | | 4-yl | | |
| 3144 | CF₃ | isoxazol-4-yl | H | NCH₃ |
| 3145 | CF₃ | 3-methylisoxazol-4-yl | H | NCH₃ |
| 3146 | CF₃ | phenyl | H | NCH₃ |
| 3147 | CF₃ | benzyl | H | NCH₃ |
| 3148 | CF₃ | benzoyl | H | NCH₃ |
| 3149 | CF₃ | 2-pyridyl | H | NCH₃ |
| 3150 | CF₃ | H | CH₃ | NCH₃ |
| 3151 | CF₃ | CH₃ | CH₃ | NCH₃ |
| 3152 | CF₃ | C₂H₅ | CH₃ | NCH₃ |
| 3153 | CF₃ | n-C₃H₇ | CH₃ | NCH₃ |
| 3154 | CF₃ | i-C₃H₇ | CH₃ | NCH₃ |
| 3155 | CF₃ | n-C₄H₉ | CH₃ | NCH₃ |
| 3156 | CF₃ | i-C₄H₉ | CH₃ | NCH₃ |
| 3157 | CF₃ | s-C₄H₉ | CH₃ | NCH₃ |
| 3158 | CF₃ | t-C₄H₉ | CH₃ | NCH₃ |
| 3159 | CF₃ | CH₂OCH₃ | CH₃ | NCH₃ |
| 3160 | CF₃ | CF₃ | CH₃ | NCH₃ |
| 3161 | CF₃ | CF₂H | CH₃ | NCH₃ |
| 3162 | CF₃ | CN | CH₃ | NCH₃ |
| 3163 | CF₃ | OH | CH₃ | NCH₃ |
| 3164 | CF₃ | OCH₃ | CH₃ | NCH₃ |
| 3165 | CF₃ | NH₂ | CH₃ | NCH₃ |
| 3166 | CF₃ | NHCH₃ | CH₃ | NCH₃ |
| 3167 | CF₃ | N(CH₃)₂ | CH₃ | NCH₃ |
| 3168 | CF₃ | CO₂CH₃ | CH₃ | NCH₃ |
| 3169 | CF₃ | CO₂C₂H₅ | CH₃ | NCH₃ |
| 3170 | CF₃ | C(O)CH₃ | CH₃ | NCH₃ |
| 3171 | CF₃ | C(O)CF₃ | CH₃ | NCH₃ |
| 3172 | CF₃ | C(═NOCH₃)CH₃ | CH₃ | NCH₃ |
| 3173 | CF₃ | SO₂CH₃ | CH₃ | NCH₃ |
| 3174 | CF₃ | SO₂CF₃ | CH₃ | NCH₃ |
| 3175 | CF₃ | CH₂CO₂H | CH₃ | NCH₃ |
| 3176 | CF₃ | CH₂COOCH₃ | CH₃ | NCH₃ |
| 3177 | CF₃ | CH₂COOC₂H₅ | CH₃ | NCH₃ |
| 3178 | CF₃ | prop-1-en-3-yl | CH₃ | NCH₃ |
| 3179 | CF₃ | trans-but-2-en-1-yl | CH₃ | NCH₃ |
| 3180 | CF₃ | cis-but-2-en-1-yl | CH₃ | NCH₃ |
| 3181 | CF₃ | cis-3-methyl- | CH₃ | NCH₃ |
| | | but-2-en-1-yl | | |
| 3182 | CF₃ | cyclopropyl | CH₃ | NCH₃ |
| 3183 | CF₃ | cyclopentyl | CH₃ | NCH₃ |
| 3184 | CF₃ | cyclohexyl | CH₃ | NCH₃ |
| 3185 | CF₃ | 4,5-dihydroisoxazol- | CH₃ | NCH₃ |
| | | 3-yl | | |
| 3186 | CF₃ | 4-methyl-4,5-dihydroisoxazol- | CH₃ | NCH₃ |
| | | 3-yl | | |
| 3187 | CF₃ | isoxazol-3-yl | CH₃ | NCH₃ |
| 3188 | CF₃ | 4-methylisoxazol-3-yl | CH₃ | NCH₃ |
| 3189 | CF₃ | 4,5-dihydroisoxazol- | CH₃ | NCH₃ |
| | | 4-yl | | |
| 3190 | CF₃ | 3-methyl-4,5-dihydroisoxazol- | CH₃ | NCH₃ |
| | | 4-yl | | |
| 3191 | CF₃ | isoxazol-4-yl | CH₃ | NCH₃ |
| 3192 | CF₃ | 3-methylisoxazol-4-yl | CH₃ | NCH₃ |
| 3193 | CF₃ | phenyl | CH₃ | NCH₃ |
| 3194 | CF₃ | benzyl | CH₃ | NCH₃ |
| 3195 | CF₃ | benzoyl | CH₃ | NCH₃ |
| 3196 | CF₃ | 2-pyridyl | CH₃ | NCH₃ |
| 3197 | CF₃ | H | Cl | NCH₃ |
| 3198 | CF₃ | CH₃ | Cl | NCH₃ |
| 3199 | CF₃ | C₂H₅ | Cl | NCH₃ |
| 3200 | CF₃ | n-C₃H₇ | Cl | NCH₃ |
| 3201 | CF₃ | i-C₃H₇ | Cl | NCH₃ |
| 3202 | CF₃ | n-C₄H₉ | Cl | NCH₃ |
| 3203 | CF₃ | i-C₄H₉ | Cl | NCH₃ |
| 3204 | CF₃ | s-C₄H₉ | Cl | NCH₃ |
| 3205 | CF₃ | t-C₄H₉ | Cl | NCH₃ |
| 3206 | CF₃ | CH₂OCH₃ | Cl | NCH₃ |
| 3207 | CF₃ | CF₃ | Cl | NCH₃ |
| 3208 | CF₃ | CF₂H | Cl | NCH₃ |
| 3209 | CF₃ | CN | Cl | NCH₃ |
| 3210 | CF₃ | OH | Cl | NCH₃ |
| 3211 | CF₃ | OCH₃ | Cl | NCH₃ |
| 3212 | CF₃ | NH₂ | Cl | NCH₃ |
| 3213 | CF₃ | NHCH₃ | Cl | NCH₃ |
| 3214 | CF₃ | N(CH₃)₂ | Cl | NCH₃ |
| 3215 | CF₃ | CO₂CH₃ | Cl | NCH₃ |
| 3216 | CF₃ | CO₂C₂H₅ | Cl | NCH₃ |
| 3217 | CF₃ | C(O)CH₃ | Cl | NCH₃ |
| 3218 | CF₃ | C(O)CF₃ | Cl | NCH₃ |
| 3219 | CF₃ | C(═NOCH₃)CH₃ | Cl | NCH₃ |
| 3220 | CF₃ | SO₂CH₃ | Cl | NCH₃ |
| 3221 | CF₃ | SO₂CF₃ | Cl | NCH₃ |
| 3222 | CF₃ | CH₂CO₂H | Cl | NCH₃ |
| 3223 | CF₃ | CH₂COOCH₃ | Cl | NCH₃ |
| 3224 | CF₃ | CH₂COOC₂H₅ | Cl | NCH₃ |
| 3225 | CF₃ | prop-1-en-3-yl | Cl | NCH₃ |
| 3226 | CF₃ | trans-but-2-en-1-yl | Cl | NCH₃ |
| 3227 | CF₃ | cis-but-2-en-1-yl | Cl | NCH₃ |
| 3228 | CF₃ | cis-3-methyl- | Cl | NCH₃ |
| | | but-2-en-1-yl | | |
| 3229 | CF₃ | cyclopropyl | Cl | NCH₃ |
| 3230 | CF₃ | cyclopentyl | Cl | NCH₃ |
| 3231 | CF₃ | cyclohexyl | Cl | NCH₃ |
| 3232 | CF₃ | 4,5-dihydroisoxazol- | Cl | NCH₃ |
| | | 3-yl | | |
| 3233 | CF₃ | 4-methyl-4,5-dihydroisoxazol- | Cl | NCH₃ |
| | | 3-yl | | |
| 3234 | CF₃ | isoxazol-3-yl | Cl | NCH₃ |
| 3235 | CF₃ | 4-methylisoxazol-3-yl | Cl | NCH₃ |
| 3236 | CF₃ | 4,5-dihydroisoxazol- | Cl | NCH₃ |
| | | 4-yl | | |
| 3237 | CF₃ | 3-methyl-4,5-dihydroisoxazol- | Cl | NCH₃ |
| | | 4-yl | | |
| 3238 | CF₃ | isoxazol-4-yl | Cl | NCH₃ |
| 3239 | CF₃ | 3-methylisoxazol-4-yl | Cl | NCH₃ |
| 3240 | CF₃ | phenyl | Cl | NCH₃ |
| 3241 | CF₃ | benzyl | Cl | NCH₃ |
| 3242 | CF₃ | benzoyl | Cl | NCH₃ |
| 3243 | CF₃ | 2-pyridyl | Cl | NCH₃ |
| 3244 | C₂H₅ | H | H | NCH₃ |
| 3245 | C₂H₅ | CH₃ | H | NCH₃ |
| 3246 | C₂H₅ | C₂H₅ | H | NCH₃ |
| 3247 | C₂H₅ | n-C₃H₇ | H | NCH₃ |
| 3248 | C₂H₅ | i-C₃H₇ | H | NCH₃ |
| 3249 | C₂H₅ | n-C₄H₉ | H | NCH₃ |
| 3250 | C₂H₅ | i-C₄H₉ | H | NCH₃ |
| 3251 | C₂H₅ | s-C₄H₉ | H | NCH₃ |
| 3252 | C₂H₅ | t-C₄H₉ | H | NCH₃ |
| 3253 | C₂H₅ | CH₂OCH₃ | H | NCH₃ |
| 3254 | C₂H₅ | CF₃ | H | NCH₃ |
| 3255 | C₂H₅ | CF₂H | H | NCH₃ |
| 3256 | C₂H₅ | CN | H | NCH₃ |
| 3257 | C₂H₅ | OH | H | NCH₃ |
| 3258 | C₂H₅ | OCH₃ | H | NCH₃ |
| 3259 | C₂H₅ | NH₂ | H | NCH₃ |
| 3260 | C₂H₅ | NHCH₃ | H | NCH₃ |
| 3261 | C₂H₅ | N(CH₃)₂ | H | NCH₃ |
| 3262 | C₂H₅ | CO₂CH₃ | H | NCH₃ |
| 3263 | C₂H₅ | CO₂C₂H₅ | H | NCH₃ |
| 3264 | C₂H₅ | C(O)CH₃ | H | NCH₃ |
| 3265 | C₂H₅ | C(O)CF₃ | H | NCH₃ |
| 3266 | C₂H₅ | C(═NOCH₃)CH₃ | H | NCH₃ |
| 3267 | C₂H₅ | SO₂CH₃ | H | NCH₃ |
| 3268 | C₂H₅ | SO₂CF₃ | H | NCH₃ |
| 3269 | C₂H₅ | CH₂CO₂H | H | NCH₃ |
| 3270 | C₂H₅ | CH₂COOCH₃ | H | NCH₃ |
| 3271 | C₂H₅ | CH₂COOC₂H₅ | H | NCH₃ |
| 3272 | C₂H₅ | prop-1-en-3-yl | H | NCH₃ |
| 3273 | C₂H₅ | trans-but-2-en-1-yl | H | NCH₃ |
| 3274 | C₂H₅ | cis-but-2-en-1-yl | H | NCH₃ |
| 3275 | C₂H₅ | cis-3-methyl- | H | NCH₃ |
| | | but-2-en-1-yl | | |
| 3276 | C₂H₅ | cyclopropyl | H | NCH₃ |
| 3277 | C₂H₅ | cyclopentyl | H | NCH₃ |
| 3278 | C₂H₅ | cyclohexyl | H | NCH₃ |
| 3279 | C₂H₅ | 4,5-dihydroisoxazol- | H | NCH₃ |
| | | 3-yl | | |
| 3280 | C₂H₅ | 4-methyl-4,5-dihydroisoxazol- | H | NCH₃ |
| | | 3-yl | | |
| 3281 | C₂H₅ | isoxazol-3-yl | H | NCH₃ |
| 3282 | C₂H₅ | 4-methylisoxazol-3-yl | H | NCH₃ |
| 3283 | C₂H₅ | 4,5-dihydroisoxazol- | H | NCH₃ |
| | | 4-yl | | |
| 3284 | C₂H₅ | 3-methyl-4,5-dihydroisoxazol- | H | NCH₃ |
| | | 4-yl | | |
| 3285 | C₂H₅ | isoxazol-4-yl | H | NCH₃ |
| 3286 | C₂H₅ | 3-methylisoxazol-4-yl | H | NCH₃ |
| 3287 | C₂H₅ | phenyl | H | NCH₃ |
| 3288 | C₂H₅ | benzyl | H | NCH₃ |
| 3289 | C₂H₅ | benzoyl | H | NCH₃ |
| 3290 | C₂H₅ | 2-pyridyl | H | NCH₃ |
| 3291 | C₂H₅ | H | CH₃ | NCH₃ |
| 3292 | C₂H₅ | CH₃ | CH₃ | NCH₃ |
| 3293 | C₂H₅ | C₂H₅ | CH₃ | NCH₃ |
| 3294 | C₂H₅ | n-C₃H₇ | CH₃ | NCH₃ |
| 3295 | C₂H₅ | i-C₃H₇ | CH₃ | NCH₃ |
| 3296 | C₂H₅ | n-C₄H₉ | CH₃ | NCH₃ |
| 3297 | C₂H₅ | i-C₄H₉ | CH₃ | NCH₃ |
| 3298 | C₂H₅ | s-C₄H₉ | CH₃ | NCH₃ |
| 3299 | C₂H₅ | t-C₄H₉ | CH₃ | NCH₃ |
| 3300 | C₂H₅ | CH₂OCH₃ | CH₃ | NCH₃ |
| 3301 | C₂H₅ | CF₃ | CH₃ | NCH₃ |
| 3302 | C₂H₅ | CF₂H | CH₃ | NCH₃ |
| 3303 | C₂H₅ | CN | CH₃ | NCH₃ |
| 3304 | C₂H₅ | OH | CH₃ | NCH₃ |
| 3305 | C₂H₅ | OCH₃ | CH₃ | NCH₃ |
| 3306 | C₂H₅ | NH₂ | CH₃ | NCH₃ |
| 3307 | C₂H₅ | NHCH₃ | CH₃ | NCH₃ |
| 3308 | C₂H₅ | N(CH₃)₂ | CH₃ | NCH₃ |
| 3309 | C₂H₅ | CO₂CH₃ | CH₃ | NCH₃ |
| 3310 | C₂H₅ | CO₂C₂H₅ | CH₃ | NCH₃ |
| 3311 | C₂H₅ | C(O)CH₃ | CH₃ | NCH₃ |
| 3312 | C₂H₅ | C(O)CF₃ | CH₃ | NCH₃ |
| 3313 | C₂H₅ | C(═NOCH₃)CH₃ | CH₃ | NCH₃ |
| 3314 | C₂H₅ | SO₂CH₃ | CH₃ | NCH₃ |
| 3315 | C₂H₅ | SO₂CF₃ | CH₃ | NCH₃ |
| 3316 | C₂H₅ | CH₂CO₂H | CH₃ | NCH₃ |
| 3317 | C₂H₅ | CH₂COOCH₃ | CH₃ | NCH₃ |
| 3318 | C₂H₅ | CH₂COOC₂H₅ | CH₃ | NCH₃ |
| 3319 | C₂H₅ | prop-1-en-3-yl | CH₃ | NCH₃ |
| 3320 | C₂H₅ | trans-but-2-en-1-yl | CH₃ | NCH₃ |
| 3321 | C₂H₅ | cis-but-2-en-1-yl | CH₃ | NCH₃ |
| 3322 | C₂H₅ | cis-3-methyl- | CH₃ | NCH₃ |
| | | but-2-en-1-yl | | |
| 3323 | C₂H₅ | cyclopropyl | CH₃ | NCH₃ |
| 3324 | C₂H₅ | cyclopentyl | CH₃ | NCH₃ |
| 3325 | C₂H₅ | cyclohexyl | CH₃ | NCH₃ |
| 3326 | C₂H₅ | 4,5-dihydroisoxazol- | CH₃ | NCH₃ |
| | | 3-yl | | |
| 3327 | C₂H₅ | 4-methyl-4,5-dihydroisoxazol- | CH₃ | NCH₃ |
| | | 3-yl | | |
| 3328 | C₂H₅ | isoxazol-3-yl | CH₃ | NCH₃ |
| 3329 | C₂H₅ | 4-methylisoxazol-3-yl | CH₃ | NCH₃ |
| 3330 | C₂H₅ | 4,5-dihydroisoxazol- | CH₃ | NCH₃ |
| | | 4-yl | | |
| 3331 | C₂H₅ | 3-methyl-4,5-dihydroisoxazol- | CH₃ | NCH₃ |
| | | 4-yl | | |
| 3332 | C₂H₅ | isoxazol-4-yl | CH₃ | NCH₃ |
| 3333 | C₂H₅ | 3-methylisoxazol-4-yl | CH₃ | NCH₃ |
| 3334 | C₂H₅ | phenyl | CH₃ | NCH₃ |
| 3335 | C₂H₅ | benzyl | CH₃ | NCH₃ |
| 3336 | C₂H₅ | benzoyl | CH₃ | NCH₃ |
| 3337 | C₂H₅ | 2-pyridyl | CH₃ | NCH₃ |
| 3338 | C₂H₅ | H | Cl | NCH₃ |
| 3339 | C₂H₅ | CH₃ | Cl | NCH₃ |
| 3340 | C₂H₅ | C₂H₅ | Cl | NCH₃ |
| 3341 | C₂H₅ | n-C₃H₇ | Cl | NCH₃ |
| 3342 | C₂H₅ | i-C₃H₇ | Cl | NCH₃ |
| 3343 | C₂H₅ | n-C₄H₉ | Cl | NCH₃ |
| 3344 | C₂H₅ | i-C₄H₉ | Cl | NCH₃ |
| 3345 | C₂H₅ | s-C₄H₉ | Cl | NCH₃ |
| 3346 | C₂H₅ | t-C₄H₉ | Cl | NCH₃ |
| 3347 | C₂H₅ | CH₂OCH₃ | Cl | NCH₃ |
| 3348 | C₂H₅ | CF₃ | Cl | NCH₃ |
| 3349 | C₂H₅ | CF₂H | Cl | NCH₃ |
| 3350 | C₂H₅ | CN | Cl | NCH₃ |
| 3351 | C₂H₅ | OH | Cl | NCH₃ |
| 3352 | C₂H₅ | OCH₃ | Cl | NCH₃ |
| 3353 | C₂H₅ | NH₂ | Cl | NCH₃ |
| 3354 | C₂H₅ | NHCH₃ | Cl | NCH₃ |
| 3355 | C₂H₅ | N(CH₃)₂ | Cl | NCH₃ |
| 3356 | C₂H₅ | CO₂CH₃ | Cl | NCH₃ |
| 3357 | C₂H₅ | CO₂C₂H₅ | Cl | NCH₃ |
| 3358 | C₂H₅ | C(O)CH₃ | Cl | NCH₃ |
| 3359 | C₂H₅ | C(O)CF₃ | Cl | NCH₃ |
| 3360 | C₂H₅ | C(═NOCH₃)CH₃ | Cl | NCH₃ |
| 3361 | C₂H₅ | SO₂CH₃ | Cl | NCH₃ |
| 3362 | C₂H₅ | SO₂CF₃ | Cl | NCH₃ |
| 3363 | C₂H₅ | CH₂CO₂H | Cl | NCH₃ |
| 3364 | C₂H₅ | CH₂COOCH₃ | Cl | NCH₃ |
| 3365 | C₂H₅ | CH₂COOC₂H₅ | Cl | NCH₃ |
| 3366 | C₂H₅ | prop-1-en-3-yl | Cl | NCH₃ |
| 3367 | C₂H₅ | trans-but-2-en-1-yl | Cl | NCH₃ |
| 3368 | C₂H₅ | cis-but-2-en-1-yl | Cl | NCH₃ |
| 3369 | C₂H₅ | cis-3-methyl- | Cl | NCH₃ |
| | | but-2-en-1-yl | | |
| 3370 | C₂H₅ | cyclopropyl | Cl | NCH₃ |
| 3371 | C₂H₅ | cyclopentyl | Cl | NCH₃ |
| 3372 | C₂H₅ | cyclohexyl | Cl | NCH₃ |
| 3373 | C₂H₅ | 4,5-dihydroisoxazol- | Cl | NCH₃ |
| | | 3-yl | | |
| 3374 | C₂H₅ | 4-methyl-4,5-dihydroisoxazol- | Cl | NCH₃ |
| | | 3-yl | | |
| 3375 | C₂H₅ | isoxazol-3-yl | Cl | NCH₃ |
| 3376 | C₂H₅ | 4-methylisoxazol-3-yl | Cl | NCH₃ |
| 3377 | C₂H₅ | 4,5-dihydroisoxazol- | Cl | NCH₃ |
| | | 4-yl | | |
| 3378 | C₂H₅ | 3-methyl-4,5-dihydroisoxazol- | Cl | NCH₃ |
| | | 4-yl | | |
| 3379 | C₂H₅ | isoxazol-4-yl | Cl | NCH₃ |
| 3380 | C₂H₅ | 3-methylisoxazol-4-yl | Cl | NCH₃ |
| 3381 | C₂H₅ | phenyl | Cl | NCH₃ |
| 3382 | C₂H₅ | benzyl | Cl | NCH₃ |
| 3383 | C₂H₅ | benzoyl | Cl | NCH₃ |
| 3384 | C₂H₅ | 2-pyridyl | Cl | NCH₃ |
| 3385 | CH₃ | n-Pentyl | H | O |
| 3386 | CH₃ | CH₂—C≡C—CH₂—CH₃ | H | O |
| 3387 | CH₃ | CH₂—CH₂—CH═CH₂ | H | O |
| 3388 | CH₃ | CH₂—CH₂—CH₂—CH═CH₂ | H | O |
| 3389 | CH₃ | CH₂—[(3-OCH₃)C₆H₄] | H | O |
| 3390 | CH₃ | CH₂—C≡C—CH₃ | H | O |
| 3391 | CH₃ | CH₂—CH₂-(1,3-dioxolan- | H | O |
| | | 2-yl) | | |
| 3392 | CH₃ | CH₂-(1,3-dioxolan- | H | O |
| | | 2-yl) | | |
| 3393 | CH₃ | n-Pentyl | CH₃ | O |
| 3394 | CH₃ | CH₂—C≡C—CH₂—CH₃ | CH₃ | O |
| 3395 | CH₃ | CH₂—CH₂—CH═CH₂ | CH₃ | O |
| 3396 | CH₃ | CH₂—CH₂—CH₂—CH═CH₂ | CH₃ | O |
| 3397 | CH₃ | CH₂—[(3-OCH₃)C₆H₄] | CH₃ | O |
| 3398 | CH₃ | CH₂—C≡C—CH₃ | CH₃ | O |
| 3399 | CH₃ | CH₂—CH₂-(1,3-dioxolan- | CH₃ | O |
| | | 2-yl) | | |
| 3400 | CH₃ | CH₂-(1,3-dioxolan- | CH₃ | O |
| | | 2-yl) | | |
| 3401 | CH₃ | n-Pentyl | Cl | O |
| 3402 | CH₃ | CH₂—C≡C—CH₂—CH₃ | Cl | O |
| 3403 | CH₃ | CH₂—CH₂—CH═CH₂ | Cl | O |
| 3404 | CH₃ | CH₂—CH₂—CH₂—CH═CH₂ | Cl | O |
| 3405 | CH₃ | CH₂—[(3-OCH₃)C₆H₄] | Cl | O |
| 3406 | CH₃ | CH₂—C≡C—CH₃ | Cl | O |
| 3407 | CH₃ | CH₂—CH₂-(1,3-dioxolan- | Cl | O |
| | | 2-yl) | | |
| 3408 | CH₃ | CH₂-(1,3-dioxolan- | Cl | O |
| | | 2-yl) | | |
| 3409 | Cl | n-Pentyl | H | O |
| 3410 | Cl | CH₂—C≡C—CH₂—CH₃ | H | O |
| 3411 | Cl | CH₂—CH₂—CH═CH₂ | H | O |
| 3412 | Cl | CH₂—CH₂—CH₂—CH═CH₂ | H | O |
| 3413 | Cl | CH₂—[(3-OCH₃)C₆H₄] | H | O |
| 3414 | Cl | CH₂—C≡C—CH₃ | H | O |
| 3415 | Cl | CH₂—CH₂-(1,3-dioxolan- | H | O |
| | | 2-yl) | | |
| 3416 | Cl | CH₂-(1,3-dioxolan- | H | O |
| | | 2-yl) | | |
| 3417 | Cl | n-Pentyl | CH₃ | O |
| 3418 | Cl | CH₂—C≡C—CH₂—CH₃ | CH₃ | O |
| 3419 | Cl | CH₂—CH₂—CH═CH₂ | CH₃ | O |
| 3420 | Cl | CH₂—CH₂—CH₂—CH═CH₂ | CH₃ | O |
| 3421 | Cl | CH₂—[(3-OCH₃)C₆H₄] | CH₃ | O |
| 3422 | Cl | CH₂—C≡C—CH₃ | CH₃ | O |
| 3423 | Cl | CH₂—CH₂-(1,3-dioxolan- | CH₃ | O |
| | | 2-yl) | | |
| 3424 | Cl | CH₂-(1,3-dioxolan- | CH₃ | O |
| | | 2-yl) | | |
| 3425 | Cl | n-Pentyl | Cl | O |
| 3426 | Cl | CH₂—C≡C-CH₂—CH₃ | Cl | O |
| 3427 | Cl | CH₂—CH₂—CH═CH₂ | Cl | O |
| 3428 | Cl | CH₂—CH₂—CH₂—CH═CH₂ | Cl | O |
| 3429 | Cl | CH₂—[(3-OCH₃)C₆H₄] | Cl | O |
| 3430 | Cl | CH₂—C≡C—CH₃ | Cl | O |
| 3431 | Cl | CH₂—CH₂-(1,3-dioxolan- | Cl | O |
| | | 2-yl) | | |
| 3432 | Cl | CH₂-(1,3-dioxolan- | Cl | O |
| | | 2-yl) | | |
| 3433 | OCH₃ | n-Pentyl | H | O |
| 3434 | OCH₃ | CH₂—C≡C—CH₂—CH₃ | H | O |
| 3435 | OCH₃ | CH₂—CH₂—CH═CH₂ | H | O |
| 3436 | OCH₃ | CH₂—CH₂—CH₂—CH═CH₂ | H | O |
| 3437 | OCH₃ | CH₂—[(3-OCH₃)C₆H₄] | H | O |
| 3438 | OCH₃ | CH₂—C≡C—CH₃ | H | O |
| 3439 | OCH₃ | CH₂—CH₂-(1,3-dioxolan- | H | O |
| | | 2-yl) | | |
| 3440 | OCH₃ | CH₂-(1,3-dioxolan- | H | O |
| | | 2-yl) | | |
| 3441 | OCH₃ | n-Pentyl | CH₃ | O |
| 3442 | OCH₃ | CH₂—C≡C—CH₂—CH₃ | CH₃ | O |
| 3443 | OCH₃ | CH₂—CH₂—CH═CH₂ | CH₃ | O |
| 3444 | OCH₃ | CH₂—CH₂—CH₂—CH═CH₂ | CH₃ | O |
| 3445 | OCH₃ | CH₂—[(3-OCH₃)C₆H₄] | CH₃ | O |
| 3446 | OCH₃ | CH₂—C≡C—CH₃ | CH₃ | O |
| 3447 | OCH₃ | CH₂—CH₂-(1,3-dioxolan- | CH₃ | O |
| | | 2-yl) | | |
| 3448 | OCH₃ | CH₂-(1,3-dioxolan- | CH₃ | O |
| | | 2-yl) | | |
| 3449 | OCH₃ | n-Pentyl | Cl | O |
| 3450 | OCH₃ | CH₂—C≡C—CH₂—CH₃ | Cl | O |
| 3451 | OCH₃ | CH₂—CH₂—CH═CH₂ | Cl | O |
| 3452 | OCH₃ | CH₂—CH₂—CH₂—CH═CH₂ | Cl | O |
| 3453 | OCH₃ | CH₂—[(3-OCH₃)C₆H₄] | Cl | O |
| 3454 | OCH₃ | CH₂—C≡C—CH₃ | Cl | O |
| 3455 | OCH₃ | CH₂—CH₂-(1,3-dioxolan- | Cl | O |
| | | 2-yl) | | |
| 3456 | OCH₃ | CH₂-(1,3-dioxolan- | Cl | O |
| | | 2-yl) | | |
| 3457 | OCF₃ | n-Pentyl | H | O |
| 3458 | OCF₃ | CH₂—C≡C—CH₂—CH₃ | H | O |
| 3459 | OCF₃ | CH₂—CH₂—CH═CH₂ | H | O |
| 3460 | OCF₃ | CH₂—CH₂—CH₂—CH═CH₂ | H | O |
| 3461 | OCF₃ | CH₂—[(3-OCH₃)C₆H₄] | H | O |
| 3462 | OCF₃ | CH₂—C≡C—CH₃ | H | O |
| 3463 | OCF₃ | CH₂—CH₂-(1,3-dioxolan- | H | O |
| | | 2-yl) | | |
| 3464 | OCF₃ | CH₂-(1,3-dioxolan- | H | O |
| | | 2-yl) | | |
| 3465 | OCF₃ | n-Pentyl | CH₃ | O |
| 3466 | OCF₃ | CH₂—C≡C—CH₂—CH₃ | CH₃ | O |
| 3467 | OCF₃ | CH₂—CH₂—CH═CH₂ | CH₃ | O |
| 3468 | OCF₃ | CH₂—CH₂—CH₂—CH═CH₂ | CH₃ | O |
| 3469 | OCF₃ | CH₂—[(3-OCH₃)C₆H₄] | CH₃ | O |
| 3470 | OCF₃ | CH₂—C≡C—CH₃ | CH₃ | O |
| 3471 | OCF₃ | CH₂—CH₂-(1,3-dioxolan- | CH₃ | O |
| | | 2-yl) | | |
| 3472 | OCF₃ | CH₂-(1,3-dioxolan- | CH₃ | O |
| | | 2-yl) | | |
| 3473 | OCF₃ | n-Pentyl | Cl | O |
| 3474 | OCF₃ | CH₂—C≡C—CH₂—CH₃ | Cl | O |
| 3475 | OCF₃ | CH₂—CH₂—CH═CH₂ | Cl | O |
| 3476 | OCF₃ | CH₂—CH₂—CH₂—CH═CH₂ | Cl | O |
| 3477 | OCF₃ | CH₂—[(3-OCH₃)C₆H₄] | Cl | O |
| 3478 | OCF₃ | CH₂—C≡C—CH₃ | Cl | O |
| 3479 | OCF₃ | CH₂—CH₂-(1,3-dioxolan- | Cl | O |
| | | 2-yl) | | |
| 3480 | OCF₃ | CH₂-(1,3-dioxolan- | Cl | O |
| | | 2-yl) | | |
| 3481 | SCH₃ | n-Pentyl | H | O |
| 3482 | SCH₃ | CH₂—C≡C—CH₂—CH₃ | H | O |
| 3483 | SCH₃ | CH₂—CH₂—CH═CH₂ | H | O |
| 3484 | SCH₃ | CH₂—CH₂—CH₂—CH═CH₂ | H | O |
| 3485 | SCH₃ | CH₂—[(3-OCH₃)C₆H₄] | H | O |
| 3486 | SCH₃ | CH₂—C≡C—CH₃ | H | O |
| 3487 | SCH₃ | CH₂—CH₂-(1,3-dioxolan- | H | O |
| | | 2-yl) | | |
| 3488 | SCH₃ | CH₂-(1,3-dioxolan- | H | O |
| | | 2-yl) | | |
| 3489 | SCH₃ | n-Pentyl | CH₃ | O |
| 3490 | SCH₃ | CH₂—C≡C—CH₂—CH₃ | CH₃ | O |
| 3491 | SCH₃ | CH₂—CH₂—CH═CH₂ | CH₃ | O |
| 3492 | SCH₃ | CH₂—CH₂—CH₂—CH═CH₂ | CH₃ | O |
| 3493 | SCH₃ | CH₂—[(3-OCH₃)C₆H₄] | CH₃ | O |
| 3494 | SCH₃ | CH₂—C≡C—CH₃ | CH₃ | O |
| 3495 | SCH₃ | CH₂—CH₂-(1,3-dioxolan- | CH₃ | O |
| | | 2-yl) | | |
| 3496 | SCH₃ | CH₂-(1,3-dioxolan- | CH₃ | O |
| | | 2-yl) | | |
| 3497 | SCH₃ | n-Pentyl | Cl | O |
| 3498 | SCH₃ | CH₂—C≡C—CH₂—CH₃ | Cl | O |
| 3499 | SCH₃ | CH₂—CH₂—CH═CH₂ | Cl | O |
| 3500 | SCH₃ | CH₂—CH₂—CH₂—CH═CH₂ | Cl | O |
| 3501 | SCH₃ | CH₂—[(3-OCH₃)C₆H₄] | Cl | O |
| 3502 | SCH₃ | CH₂—C≡C—CH₃ | Cl | O |
| 3503 | SCH₃ | CH₂—CH₂-(1,3-dioxolan- | Cl | O |
| | | 2-yl) | | |
| 3504 | SCH₃ | CH₂-(1,3-dioxolan- | Cl | O |
| | | 2-yl) | | |
| 3505 | SO₂CH₃ | n-Pentyl | H | O |
| 3506 | SO₂CH₃ | CH₂—C≡C—CH₂—CH₃ | H | O |
| 3507 | SO₂CH₃ | CH₂—CH₂—CH═CH₂ | H | O |
| 3508 | SO₂CH₃ | CH₂—CH₂—CH₂—CH═CH₂ | H | O |
| 3509 | SO₂CH₃ | CH₂—[(3-OCH₃)C₆H₄] | H | O |
| 3510 | SO₂CH₃ | CH₂—C≡C—CH₃ | H | O |
| 3511 | SO₂CH₃ | CH₂—CH₂-(1,3-dioxolan- | H | O |
| | | 2-yl) | | |
| 3512 | SO₂CH₃ | CH₂-(1,3-dioxolan- | H | O |
| | | 2-yl) | | |
| 3513 | SO₂CH₃ | n-Pentyl | CH₃ | O |
| 3514 | SO₂CH₃ | CH₂—C≡C—CH₂—CH₃ | CH₃ | O |
| 3515 | SO₂CH₃ | CH₂—CH₂—CH═CH₂ | CH₃ | O |
| 3516 | SO₂CH₃ | CH₂—CH₂—CH₂—CH═CH₂ | CH₃ | O |
| 3517 | SO₂CH₃ | CH₂—[(3-OCH₃)C₆H₄] | CH₃ | O |
| 3518 | SO₂CH₃ | CH₂—C≡C—CH₃ | CH₃ | O |
| 3519 | SO₂CH₃ | CH₂—CH₂-(1,3-dioxolan- | CH₃ | O |
| | | 2-yl) | | |
| 3520 | SO₂CH₃ | CH₂-(1,3-dioxolan- | CH₃ | O |
| | | 2-yl) | | |
| 3521 | SO₂CH₃ | n-Pentyl | Cl | O |
| 3522 | SO₂CH₃ | CH₂—C≡C—CH₂—CH₃ | Cl | O |
| 3523 | SO₂CH₃ | CH₂—CH₂—CH═CH₂ | Cl | O |
| 3524 | SO₂CH₃ | CH₂—CH₂—CH₂—CH═CH₂ | Cl | O |
| 3525 | SO₂CH₃ | CH₂—[(3-OCH₃)C₆H₄] | Cl | O |
| 3526 | SO₂CH₃ | CH₂—C≡C—CH₃ | Cl | O |
| 3527 | SO₂CH₃ | CH₂—CH₂-(1,3-dioxolan- | Cl | O |
| | | 2-yl) | | |
| 3528 | SO₂CH₃ | CH₂-(1,3-dioxolan- | Cl | O |
| | | 2-yl) | | |
| 3529 | CF₃ | n-Pentyl | H | O |
| 3530 | CF₃ | CH₂—C≡C—CH₂—CH₃ | H | O |
| 3531 | CF₃ | CH₂—CH₂—CH═CH₂ | H | O |
| 3532 | CF₃ | CH₂—CH₂—CH₂—CH═CH₂ | H | O |
| 3533 | CF₃ | CH₂—[(3-OCH₃)C₆H₄] | H | O |
| 3534 | CF₃ | CH₂—C≡C—CH₃ | H | O |
| 3535 | CF₃ | CH₂—CH₂-(1,3-dioxolan- | H | O |
| | | 2-yl) | | |
| 3536 | CF₃ | CH₂-(1,3-dioxolan- | H | O |
| | | 2-yl) | | |
| 3537 | CF₃ | n-Pentyl | CH₃ | O |
| 3538 | CF₃ | CH₂—C≡C—CH₂—CH₃ | CH₃ | O |
| 3539 | CF₃ | CH₂—CH₂—CH═CH₂ | CH₃ | O |
| 3540 | CF₃ | CH₂—CH₂—CH₂—CH═CH₂ | CH₃ | O |
| 3541 | CF₃ | CH₂—[(3-OCH₃)C₆H₄] | CH₃ | O |
| 3542 | CF₃ | CH₂—C≡C—CH₃ | CH₃ | O |
| 3543 | CF₃ | CH₂—CH₂-(1,3-dioxolan- | CH₃ | O |
| | | 2-yl) | | |
| 3544 | CF₃ | CH₂-(1,3-dioxolan- | CH₃ | O |
| | | 2-yl) | | |
| 3545 | CF₃ | n-Pentyl | Cl | O |
| 3546 | CF₃ | CH₂—C≡C—CH₂—CH₃ | Cl | O |
| 3547 | CF₃ | CH₂—CH₂—CH═CH₂ | Cl | O |
| 3548 | CF₃ | CH₂—CH₂—CH₂—CH═CH₂ | Cl | O |
| 3549 | CF₃ | CH₂—[(3-OCH₃)C₆H₄] | Cl | O |
| 3550 | CF₃ | CH₂—C≡C—CH₃ | Cl | O |
| 3551 | CF₃ | CH₂—CH₂-(1,3-dioxolan- | Cl | O |
| | | 2-yl) | | |
| 3552 | CF₃ | CH₂-(1,3-dioxolan- | Cl | O |
| | | 2-yl) | | |
| 3553 | C₂H₅ | n-Pentyl | H | O |
| 3554 | C₂H₅ | CH₂—C≡C—CH₂—CH₃ | H | O |
| 3555 | C₂H₅ | CH₂—CH₂—CH═CH₂ | H | O |
| 3556 | C₂H₅ | CH₂—CH₂—CH₂—CH═CH₂ | H | O |
| 3557 | C₂H₅ | CH₂—[(3-OCH₃)C₆H₄] | H | O |
| 3558 | C₂H₅ | CH₂—C≡C—CH₃ | H | O |
| 3559 | C₂H₅ | CH₂—CH₂-(1,3-dioxolan- | H | O |
| | | 2-yl) | | |
| 3560 | C₂H₅ | CH₂-(1,3-dioxolan- | H | O |
| | | 2-yl) | | |
| 3561 | C₂H₅ | n-Pentyl | CH₃ | O |
| 3562 | C₂H₅ | CH₂—C≡C—CH₂—CH₃ | CH₃ | O |
| 3563 | C₂H₅ | CH₂—CH₂—CH═CH₂ | CH₃ | O |
| 3564 | C₂H₅ | CH₂—CH₂—CH₂—CH═CH₂ | CH₃ | O |
| 3565 | C₂H₅ | CH₂—[(3-OCH₃)C₆H₄] | CH₃ | O |
| 3566 | C₂H₅ | CH₂C≡C—CH₃ | CH₃ | O |
| 3567 | C₂H₅ | CH₂—CH₂-(1,3-dioxolan- | CH₃ | O |
| | | 2-yl) | | |
| 3568 | C₂H₅ | CH₂-(1,3-dioxolan- | CH₃ | O |
| | | 2-yl) | | |
| 3569 | C₂H₅ | n-Pentyl | Cl | O |
| 3570 | C₂H₅ | CH₂—C≡C—CH₂—CH₃ | Cl | O |
| 3571 | C₂H₅ | CH₂—CH₂—CH═CH₂ | Cl | O |
| 3572 | C₂H₅ | CH₂—CH₂—CH₂—CH═CH₂ | Cl | O |
| 3573 | C₂H₅ | CH₂—[(3-OCH₃)C₆H₄] | Cl | O |
| 3574 | C₂H₅ | CH₂—C≡C—CH₃ | Cl | O |
| 3575 | C₂H₅ | CH₂—CH₂-(1,3-dioxolan- | Cl | O |
| | | 2-yl) | | |
| 3576 | C₂H₅ | CH₂-(1,3-dioxolan- | Cl | O |
| | | 2-yl) | | |
| 3577 | CH₃ | n-Pentyl | H | S |
| 3578 | CH₃ | CH₂—C≡C—CH₂—CH₃ | H | S |
| 3579 | CH₃ | CH₂—CH₂—CH═CH₂ | H | S |
| 3580 | CH₃ | CH₂—CH₂—CH₂—CH═CH₂ | H | S |
| 3581 | CH₃ | CH₂—[(3-OCH₃)C₆H₄] | H | S |
| 3582 | CH₃ | CH₂—C≡C—CH₃ | H | S |
| 3583 | CH₃ | CH₂—CH₂-(1,3-dioxolan- | H | S |
| | | 2-yl) | | |
| 3584 | CH₃ | CH₂-(1,3-dioxolan- | H | S |
| | | 2-yl) | | |
| 3585 | CH₃ | n-Pentyl | CH₃ | S |
| 3586 | CH₃ | CH₂—C≡C—CH₂—CH₃ | CH₃ | S |
| 3587 | CH₃ | CH₂—CH₂—CH═CH₂ | CH₃ | S |
| 3588 | CH₃ | CH₂—CH₂—CH₂—CH═CH₂ | CH₃ | S |
| 3589 | CH₃ | CH₂—[(3-OCH₃)C₆H₄] | CH₃ | S |
| 3590 | CH₃ | CH₂—C≡C—CH₃ | CH₃ | S |
| 3591 | CH₃ | CH₂—CH₂-(1,3-dioxolan- | CH₃ | S |
| | | 2-yl) | | |
| 3592 | CH₃ | CH₂-(1,3-dioxolan- | CH₃ | S |
| | | 2-yl) | | |
| 3593 | CH₃ | n-Pentyl | Cl | S |
| 3594 | CH₃ | CH₂—C≡C—CH₂—CH₃ | Cl | S |
| 3595 | CH₃ | CH₂—CH₂—CH═CH₂ | Cl | S |
| 3596 | CH₃ | CH₂—CH₂—CH₂—CH═CH₂ | Cl | S |
| 3597 | CH₃ | CH₂—[(3-OCH₃)C₆H₄] | Cl | S |
| 3598 | CH₃ | CH₂—C≡C—CH₃ | Cl | S |
| 3599 | CH₃ | CH₂—CH₂-(1,3-dioxolan- | Cl | S |
| | | 2-yl) | | |
| 3600 | CH₃ | CH₂-(1,3-dioxolan- | Cl | S |
| | | 2-yl) | | |
| 3601 | Cl | n-Pentyl | H | S |
| 3602 | Cl | CH₂—C≡C—CH₂—CH₃ | H | S |
| 3603 | Cl | CH₂—CH₂—CH═CH₂ | H | S |
| 3604 | Cl | CH₂—CH₂—CH₂—CH═CH₂ | H | S |
| 3605 | Cl | CH₂—[(3-OCH₃)C₆H₄] | H | S |
| 3606 | Cl | CH₂—C≡C—CH₃ | H | S |
| 3607 | Cl | CH₂—CH₂-(1,3-dioxolan- | H | S |
| | | 2-yl) | | |
| 3608 | Cl | CH₂-(1,3-dioxolan- | H | S |
| | | 2-yl) | | |
| 3609 | Cl | n-Pentyl | CH₃ | S |
| 3610 | Cl | CH₂—C≡C—CH₂—CH₃ | CH₃ | S |
| 3611 | Cl | CH₂—CH₂—CH═CH₂ | CH₃ | S |
| 3612 | Cl | CH₂—CH₂—CH₂—CH═CH₂ | CH₃ | S |
| 3613 | Cl | CH₂—[(3-OCH₃)C₆H₄] | CH₃ | S |
| 3614 | Cl | CH₂—C≡C—CH₃ | CH₃ | S |
| 3615 | Cl | CH₂—CH₂-(1,3-dioxolan- | CH₃ | S |
| | | 2-yl) | | |
| 3616 | Cl | CH₂-(1,3-dioxolan- | CH₃ | S |
| | | 2-yl) | | |
| 3617 | Cl | n-Pentyl | Cl | S |
| 3618 | Cl | CH₂—C≡C—CH₂—CH₃ | Cl | S |
| 3619 | Cl | CH₂—CH₂—CH═CH₂ | Cl | S |
| 3620 | Cl | CH₂—CH₂—CH₂—CH═CH₂ | Cl | S |
| 3621 | Cl | CH₂—[(3-OCH₃)C₆H₄] | Cl | S |
| 3622 | Cl | CH₂—C≡C—CH₃ | Cl | S |
| 3623 | Cl | CH₂—CH₂-(1,3-dioxolan- | Cl | S |
| | | 2-yl) | | |
| 3624 | Cl | CH₂-(1,3-dioxolan- | Cl | S |
| | | 2-yl) | | |
| 3625 | OCH₃ | n-Pentyl | H | S |
| 3626 | OCH₃ | CH₂—C≡C—CH₂—CH₃ | H | S |
| 3627 | OCH₃ | CH₂—CH₂—CH═CH₂ | H | S |
| 3628 | OCH₃ | CH₂—CH₂—CH₂—CH═CH₂ | H | S |
| 3629 | OCH₃ | CH₂—[(3-OCH₃)C₆H₄] | H | S |
| 3630 | OCH₃ | CH₂—C≡C—CH₃ | H | S |
| 3631 | OCH₃ | CH₂—CH₂-(1,3-dioxolan- | H | S |
| | | 2-yl) | | |
| 3632 | OCH₃ | CH₂-(1,3-dioxolan- | H | S |
| | | 2-yl) | | |
| 3633 | OCH₃ | n-Pentyl | CH₃ | S |
| 3634 | OCH₃ | CH₂—C≡C—CH₂—CH₃ | CH₃ | S |
| 3635 | OCH₃ | CH₂—CH₂—CH═CH₂ | CH₃ | S |
| 3636 | OCH₃ | CH₂—CH₂—CH₂—CH═CH₂ | CH₃ | S |
| 3637 | OCH₃ | CH₂—[(3-OCH₃)C₆H₄] | CH₃ | S |
| 3638 | OCH₃ | CH₂—C≡C—CH₃ | CH₃ | S |
| 3639 | OCH₃ | CH₂—CH₂-(1,3-dioxolan- | CH₃ | S |
| | | 2-yl) | | |
| 3640 | OCH₃ | CH₂-(1,3-dioxolan- | CH₃ | S |
| | | 2-yl) | | |
| 3641 | OCH₃ | n-Pentyl | Cl | S |
| 3642 | OCH₃ | CH₂—C≡C—CH₂—CH₃ | Cl | S |
| 3643 | OCH₃ | CH₂—CH₂—CH═CH₂ | Cl | S |
| 3644 | OCH₃ | CH₂—CH₂—CH₂—CH═CH₂ | Cl | S |
| 3645 | OCH₃ | CH₂—[(3-OCH₃)C₆H₄] | Cl | S |
| 3646 | OCH₃ | CH₂—C≡C—CH₃ | Cl | S |
| 3647 | OCH₃ | CH₂—CH₂-(1,3-dioxolan- | Cl | S |
| | | 2-yl) | | |
| 3648 | OCH₃ | CH₂-(1,3-dioxolan- | Cl | S |
| | | 2-yl) | | |
| 3649 | OCF₃ | n-Pentyl | H | S |
| 3650 | OCF₃ | CH₂—C≡C—CH₂—CH₃ | H | S |
| 3651 | OCF₃ | CH₂—CH₂—CH═CH₂ | H | S |
| 3652 | OCF₃ | CH₂—CH₂—CH₂—CH═CH₂ | H | S |
| 3653 | OCF₃ | CH₂—[(3-OCH₃)C₆H₄] | H | S |
| 3654 | OCF₃ | CH₂—C≡C—CH₃ | H | S |
| 3655 | OCF₃ | CH₂—CH₂-(1,3-dioxolan- | H | S |
| | | 2-yl) | | |
| 3656 | OCF₃ | CH₂-(1,3-dioxolan- | H | S |
| | | 2-yl) | | |
| 3657 | OCF₃ | n-Pentyl | CH₃ | S |
| 3658 | OCF₃ | CH₂—C≡C—CH₂—CH₃ | CH₃ | S |
| 3659 | OCF₃ | CH₂—CH₂—CH═CH₂ | CH₃ | S |
| 3660 | OCF₃ | CH₂—CH₂—CH₂—CH═CH₂ | CH₃ | S |
| 3661 | OCF₃ | CH₂—[(3-OCH₃)C₆H₄] | CH₃ | S |
| 3662 | OCF₃ | CH₂—C≡C—CH₃ | CH₃ | S |
| 3663 | OCF₃ | CH₂—CH₂-(1,3-dioxolan- | CH₃ | S |
| | | 2-yl) | | |
| 3664 | OCF₃ | CH₂-(1,3-dioxolan- | CH₃ | S |
| | | 2-yl) | | |
| 3665 | OCF₃ | n-Pentyl | Cl | S |
| 3666 | OCF₃ | CH₂—C≡C—CH₂—CH₃ | Cl | S |
| 3667 | OCF₃ | CH₂—CH₂—CH═CH₂ | Cl | S |
| 3668 | OCF₃ | CH₂—CH₂—CH₂—CH═CH₂ | Cl | S |
| 3669 | OCF₃ | CH₂—[(3-OCH₃)C₆H₄] | Cl | S |
| 3670 | OCF₃ | CH₂—C≡C—CH₃ | Cl | S |
| 3671 | OCF₃ | CH₂—CH₂-(1,3-dioxolan- | Cl | S |
| | | 2-yl) | | |
| 3672 | OCF₃ | CH₂-(1,3-dioxolan- | Cl | S |
| | | 2-yl) | | |
| 3673 | SCH₃ | n-Pentyl | H | S |
| 3674 | SCH₃ | CH₂—C≡C—CH₂—CH₃ | H | S |
| 3675 | SCH₃ | CH₂—CH₂—CH═CH₂ | H | S |
| 3676 | SCH₃ | CH₂—CH₂—CH₂—CH═CH₂ | H | S |
| 3677 | SCH₃ | CH₂—[(3-OCH₃)C₆H₄] | H | S |
| 3678 | SCH₃ | CH₂—C≡C—CH₃ | H | S |
| 3679 | SCH₃ | CH₂—CH₂-(1,3-dioxolan- | H | S |
| | | 2-yl) | | |
| 3680 | SCH₃ | CH₂-(1,3-dioxolan- | H | S |
| | | 2-yl) | | |
| 3681 | SCH₃ | n-Pentyl | CH₃ | S |
| 3682 | SCH₃ | CH₂—C≡C—CH₂—CH₃ | CH₃ | S |
| 3683 | SCH₃ | CH₂—CH₂—CH═CH₂ | CH₃ | S |
| 3684 | SCH₃ | CH₂—CH₂—CH₂—CH═CH₂ | CH₃ | S |
| 3685 | SCH₃ | CH₂—[(3-OCH₃)C₆H₄] | CH₃ | S |
| 3686 | SCH₃ | CH₂—C≡C—CH₃ | CH₃ | S |
| 3687 | SCH₃ | CH₂—CH₂-(1,3-dioxolan- | CH₃ | S |
| | | 2-yl) | | |
| 3688 | SCH₃ | CH₂-(1,3-dioxolan- | CH₃ | S |
| | | 2-yl) | | |
| 3689 | SCH₃ | n-Pentyl | Cl | S |
| 3690 | SCH₃ | CH₂—C≡C—CH₂—CH₃ | Cl | S |
| 3691 | SCH₃ | CH₂—CH₂—CH═CH₂ | Cl | S |
| 3692 | SCH₃ | CH₂—CH₂—CH₂—CH═CH₂ | Cl | S |
| 3693 | SCH₃ | CH₂—[(3-OCH₃)C₆H₄] | Cl | S |
| 3694 | SCH₃ | CH₂—C≡C—CH₃ | Cl | S |
| 3695 | SCH₃ | CH₂—CH₂-(1,3-dioxolan- | Cl | S |
| | | 2-yl) | | |
| 3696 | SCH₃ | CH₂-(1,3-dioxolan- | Cl | S |
| | | 2-yl) | | |
| 3697 | SO₂CH₃ | n-Pentyl | H | S |
| 3698 | SO₂CH₃ | CH₂—C≡C—CH₂—CH₃ | H | S |
| 3699 | SO₂CH₃ | CH₂—CH₂—CH═CH₂ | H | S |
| 3700 | SO₂CH₃ | CH₂—CH₂—CH₂—CH═CH₂ | H | S |
| 3701 | SO₂CH₃ | CH₂—[(3-OCH₃)C₆H₄] | H | S |
| 3702 | SO₂CH₃ | CH₂—C≡C—CH₃ | H | S |
| 3703 | SO₂CH₃ | CH₂—CH₂-(1,3-dioxolan- | H | S |
| | | 2-yl) | | |
| 3704 | SO₂CH₃ | CH₂-(1,3-dioxolan- | H | S |
| | | 2-yl) | | |
| 3705 | SO₂CH₃ | n-Pentyl | CH₃ | S |
| 3706 | SO₂CH₃ | CH₂—C≡C—CH₂—CH₃ | CH₃ | S |
| 3707 | SO₂CH₃ | CH₂—CH₂—CH═CH₂ | CH₃ | S |
| 3708 | SO₂CH₃ | CH₂—CH₂—CH₂—CH═CH₂ | CH₃ | S |
| 3709 | SO₂CH₃ | CH₂—[(3-OCH₃)C₆H₄] | CH₃ | S |
| 3710 | SO₂CH₃ | CH₂—C≡C—CH₃ | CH₃ | S |
| 3711 | SO₂CH₃ | CH₂—CH₂-(1,3-dioxolan- | CH₃ | S |
| | | 2-yl) | | |
| 3712 | SO₂CH₃ | CH₂-(1,3-dioxolan- | CH₃ | S |
| | | 2-yl) | | |
| 3713 | SO₂CH₃ | n-Pentyl | Cl | S |
| 3714 | SO₂CH₃ | CH₂—C≡C—CH₂—CH₃ | Cl | S |
| 3715 | SO₂CH₃ | CH₂—CH₂—CH═CH₂ | Cl | S |
| 3716 | SO₂CH₃ | CH₂—CH₂—CH₂—CH═CH₂ | Cl | S |
| 3717 | SO₂CH₃ | CH₂—[(3-OCH₃)C₆H₄] | Cl | S |
| 3718 | SO₂CH₃ | CH₂—C≡C—CH₃ | Cl | S |
| 3719 | SO₂CH₃ | CH₂—CH₂-(1,3-dioxolan- | Cl | S |
| | | 2-yl) | | |
| 3720 | SO₂CH₃ | CH₂-(1,3-dioxolan- | Cl | S |
| | | 2-yl) | | |
| 3721 | CF₃ | n-Pentyl | H | S |
| 3722 | CF₃ | CH₂—C≡C—CH₂—CH₃ | H | S |
| 3723 | CF₃ | CH₂—CH₂—CH═CH₂ | H | S |
| 3724 | CF₃ | CH₂—CH₂—CH₂—CH═CH₂ | H | S |
| 3725 | CF₃ | CH₂—[(3-OCH₃)C₆H₄] | H | S |
| 3726 | CF₃ | CH₂—C≡C—CH₃ | H | S |
| 3727 | CF₃ | CH₂—CH₂-(1,3-dioxolan- | H | S |
| | | 2-yl) | | |
| 3728 | CF₃ | CH₂-(1,3-dioxolan- | H | S |
| | | 2-yl) | | |
| 3729 | CF₃ | n-Pentyl | CH₃ | S |
| 3730 | CF₃ | CH₂—C≡C—CH₂—CH₃ | CH₃ | S |
| 3731 | CF₃ | CH₂—CH₂—CH═CH₂ | CH₃ | S |
| 3732 | CF₃ | CH₂—CH₂—CH₂—CH═CH₂ | CH₃ | S |
| 3733 | CF₃ | CH₂—[(3-OCH₃)C₆H₄] | CH₃ | S |
| 3734 | CF₃ | CH₂—C≡C—CH₃ | CH₃ | S |
| 3735 | CF₃ | CH₂—CH₂-(1,3-dioxolan- | CH₃ | S |
| | | 2-yl) | | |
| 3736 | CF₃ | CH₂-(1,3-dioxolan- | CH₃ | S |
| | | 2-yl) | | |
| 3737 | CF₃ | n-Pentyl | Cl | S |
| 3738 | CF₃ | CH₂—C≡C—CH₂—CH₃ | Cl | S |
| 3739 | CF₃ | CH₂—CH₂—CH═CH₂ | Cl | S |
| 3740 | CF₃ | CH₂—CH₂—CH₂—CH═CH₂ | Cl | S |
| 3741 | CF₃ | CH₂—[(3-OCH₃)C₆H₄] | Cl | S |
| 3742 | CF₃ | CH₂—C≡C—CH₃ | Cl | S |
| 3743 | CF₃ | CH₂—CH₂-(1,3-dioxolan- | Cl | S |
| | | 2-yl) | | |
| 3744 | CF₃ | CH₂-(1,3-dioxolan- | Cl | S |
| | | 2-yl) | | |
| 3745 | C₂H₅ | n-Pentyl | H | S |
| 3746 | C₂H₅ | CH₂—C≡C—CH₂—CH₃ | H | S |
| 3747 | C₂H₅ | CH₂—CH₂—CH═CH₂ | H | S |
| 3748 | C₂H₅ | CH₂—CH₂—CH₂—CH═CH₂ | H | S |
| 3749 | C₂H₅ | CH₂—[(3-OCH₃)C₆H₄] | H | S |
| 3750 | C₂H₅ | CH₂—C≡C—CH₃ | H | S |
| 3751 | C₂H₅ | CH₂—CH₂-(1,3-dioxolan- | H | S |
| | | 2-yl) | | |
| 3752 | C₂H₅ | CH₂-(1,3-dioxolan- | H | S |
| | | 2-yl) | | |
| 3753 | C₂H₅ | n-Pentyl | CH₃ | S |
| 3754 | C₂H₅ | CH₂—C≡C—CH₂—CH₃ | CH₃ | S |
| 3755 | C₂H₅ | CH₂—CH₂—CH═CH₂ | CH₃ | S |
| 3756 | C₂H₅ | CH₂—CH₂—CH₂—CH═CH₂ | CH₃ | S |
| 3757 | C₂H₅ | CH₂—[(3-OCH₃)C₆H₄] | CH₃ | S |
| 3758 | C₂H₅ | CH₂—C≡C—CH₃ | CH₃ | S |
| 3759 | C₂H₅ | CH₂—CH₂-(1,3-dioxolan- | CH₃ | S |
| | | 2-yl) | | |
| 3760 | C₂H₅ | CH₂-(1,3-dioxolan- | CH₃ | S |
| | | 2-yl) | | |
| 3761 | C₂H₅ | n-Pentyl | Cl | S |
| 3762 | C₂H₅ | CH₂—C≡C—CH₂—CH₃ | Cl | S |
| 3763 | C₂H₅ | CH₂—CH₂—CH═CH₂ | Cl | S |
| 3764 | C₂H₅ | CH₂—CH₂—CH₂—CH═CH₂ | Cl | S |
| 3765 | C₂H₅ | CH₂—[(3-OCH₃)C₆H₄] | Cl | S |
| 3766 | C₂H₅ | CH₂—C≡C—CH₃ | Cl | S |
| 3767 | C₂H₅ | CH₂—CH₂-(1,3-dioxolan- | Cl | S |
| | | 2-yl) | | |
| 3768 | C₂H₅ | CH₂-(1,3-dioxolan- | Cl | S |
| | | 2-yl) | | |
| 3769 | CH₃ | n-Pentyl | H | NCH₃ |
| 3770 | CH₃ | CH₂—C≡C—CH₂—CH₃ | H | NCH₃ |
| 3771 | CH₃ | CH₂—CH₂—CH═CH₂ | H | NCH₃ |
| 3772 | CH₃ | CH₂—CH₂—CH₂—CHC═CH₂ | H | NCH₃ |
| 3773 | CH₃ | CH₂—[(3-OCH₃)C₆H₄] | H | NCH₃ |
| 3774 | CH₃ | CH₂—C≡C—CH₃ | H | NCH₃ |
| 3775 | CH₃ | CH₂—CH₂-(1,3-dioxolan- | H | NCH₃ |
| | | 2-yl) | | |
| 3776 | CH₃ | CH₂-(1,3-dioxolan- | H | NCH₃ |
| | | 2-yl) | | |
| 3777 | CH₃ | n-Pentyl | CH₃ | NCH₃ |
| 3778 | CH₃ | CH₂—C≡C—CH₂—CH₃ | CH₃ | NCH₃ |
| 3779 | CH₃ | CH₂—CH₂—CH═CH₂ | CH₃ | NCH₃ |
| 3780 | CH₃ | CH₂—CH₂—CH₂—CH═CH₂ | CH₃ | NCH₃ |
| 3781 | CH₃ | CH₂—[(3-OCH₃)C₆H₄] | CH₃ | NCH₃ |
| 3782 | CH₃ | CH₂—C≡C—CH₃ | CH₃ | NCH₃ |
| 3783 | CH₃ | CH₂—CH₂-(1,3-dioxolan- | CH₃ | NCH₃ |
| | | 2-yl) | | |
| 3784 | CH₃ | CH₂-(1,3-dioxolan- | CH₃ | NCH₃ |
| | | 2-yl) | | |
| 3785 | CH₃ | n-Pentyl | Cl | NCH₃ |
| 3786 | CH₃ | CH₂—C≡C—CH₂—CH₃ | Cl | NCH₃ |
| 3787 | CH₃ | CH₂—CH₂—CH═CH₂ | Cl | NCH₃ |
| 3788 | CH₃ | CH₂—CH₂—CH₂—CH═CH₂ | Cl | NCH₃ |
| 3789 | CH₃ | CH₂—[(3-OCH₃)C₆H₄] | Cl | NCH₃ |
| 3790 | CH₃ | CH₂—C≡C—CH₃ | Cl | NCH₃ |
| 3791 | CH₃ | CH₂—CH₂-(1,3-dioxolan- | Cl | NCH₃ |
| | | 2-yl) | | |
| 3792 | CH₃ | CH₂-(1,3-dioxolan- | Cl | NCH₃ |
| | | 2-yl) | | |
| 3793 | Cl | n-Pentyl | H | NCH₃ |
| 3794 | Cl | CH₂—C≡C—CH₂—CH₃ | H | NCH₃ |
| 3795 | Cl | CH₂—CH₂—CH═CH₂ | H | NCH₃ |
| 3796 | Cl | CH₂—CH₂—CH₂—CH═CH₂ | H | NCH₃ |
| 3797 | Cl | CH₂—[(3-OCH₃)C₆H₄] | H | NCH₃ |
| 3798 | Cl | CH₂—C≡C—CH₃ | H | NCH₃ |
| 3799 | Cl | CH₂—CH₂-(1,3-dioxolan- | H | NCH₃ |
| | | 2-yl) | | |
| 3800 | Cl | CH₂-(1,3-dioxolan- | H | NCH₃ |
| | | 2-yl) | | |
| 3801 | Cl | n-Pentyl | CH₃ | NCH₃ |
| 3802 | Cl | CH₂—C≡C—CH₂—CH₃ | CH₃ | NCH₃ |
| 3803 | Cl | CH₂—CH₂—CH═CH₂ | CH₃ | NCH₃ |
| 3804 | Cl | CH₂—CH₂—CH₂—CH═CH₂ | CH₃ | NCH₃ |
| 3805 | Cl | CH₂—[(3-OCH₃)C₆H₄] | CH₃ | NCH₃ |
| 3806 | Cl | CH₂—C≡C—CH₃ | CH₃ | NCH₃ |
| 3807 | Cl | CH₂—CH₂-(1,3-dioxolan- | CH₃ | NCH₃ |
| | | 2-yl) | | |
| 3808 | Cl | CH₂(1,3-dioxolan- | CH₃ | NCH₃ |
| | | 2-yl) | | |
| 3809 | Cl | n-Pentyl | Cl | NCH₃ |
| 3810 | Cl | CH₂—C≡C—CH₂—CH₃ | Cl | NCH₃ |
| 3811 | Cl | CH₂—CH₂—CH═CH₂ | Cl | NCH₃ |
| 3812 | Cl | CH₂—CH₂—CH₂—CH═CH₂ | Cl | NCH₃ |
| 3813 | Cl | CH₂—[(3-OCH₃)C₆H₄] | Cl | NCH₃ |
| 3814 | Cl | CH₂—C≡C—CH₃ | Cl | NCH₃ |
| 3815 | Cl | CH₂—CH₂-(1,3-dioxolan- | Cl | NCH₃ |
| | | 2-yl) | | |
| 3816 | Cl | CH₂-(1,3-dioxolan- | Cl | NCH₃ |
| | | 2-yl) | | |
| 3817 | OCH₃ | n-Pentyl | H | NCH₃ |
| 3818 | OCH₃ | CH₂—C≡C—CH₂—CH₃ | H | NCH₃ |
| 3819 | OCH₃ | CH₂—CH₂—CH═CH₂ | H | NCH₃ |
| 3820 | OCH₃ | CH₂—CH₂—CH₂—CH═CH₂ | H | NCH₃ |
| 3821 | OCH₃ | CH₂—[(3-OCH₃)C₆H₄] | H | NCH₃ |
| 3822 | OCH₃ | CH₂—C≡C—CH₃ | H | NCH₃ |
| 3823 | OCH₃ | CH₂—CH₂-(1,3-dioxolan- | H | NCH₃ |
| | | 2-yl) | | |
| 3824 | OCH₃ | CH₂-(1,3-dioxolan- | H | NCH₃ |
| | | 2-yl) | | |
| 3825 | OCH₃ | n-Pentyl | CH₃ | NCH₃ |
| 3826 | OCH₃ | CH₂—C≡C—CH₂—CH₃ | CH₃ | NCH₃ |
| 3827 | OCH₃ | CH₂—CH₂—CH═CH₂ | CH₃ | NCH₃ |
| 3828 | OCH₃ | CH₂—CH₂—CH₂—CH═CH₂ | CH₃ | NCH₃ |
| 3829 | OCH₃ | CH₂—[(3-OCH₃)C₆H₄] | CH₃ | NCH₃ |
| 3830 | OCH₃ | CH₂—C≡C—CH₃ | CH₃ | NCH₃ |
| 3831 | OCH₃ | CH₂—CH₂-(1,3-dioxolan- | CH₃ | NCH₃ |
| | | 2-yl) | | |
| 3832 | OCH₃ | CH₂-(1,3-dioxolan- | CH₃ | NCH₃ |
| | | 2-yl) | | |
| 3833 | OCH₃ | n-Pentyl | Cl | NCH₃ |
| 3834 | OCH₃ | CH₂—C≡C—CH₂—CH₃ | Cl | NCH₃ |
| 3835 | OCH₃ | CH₂—CH₂—CH═CH₂ | Cl | NCH₃ |
| 3836 | OCH₃ | CH₂—CH₂—CH₂—CH═CH₂ | Cl | NCH₃ |
| 3837 | OCH₃ | CH₂—[(3-OCH₃)C₆H₄] | Cl | NCH₃ |
| 3838 | OCH₃ | CH₂—C≡C—CH₃ | Cl | NCH₃ |
| 3839 | OCH₃ | CH₂—CH₂-(1,3-dioxolan- | Cl | NCH₃ |
| | | 2-yl) | | |
| 3840 | OCH₃ | CH₂-(1,3-dioxolan- | Cl | NCH₃ |
| | | 2-yl) | | |
| 3841 | OCF₃ | n-Pentyl | H | NCH₃ |
| 3842 | OCF₃ | CH₂—C≡C—CH₂—CH₃ | H | NCH₃ |
| 3843 | OCF₃ | CH₂—CH₂—CH═CH₂ | H | NCH₃ |
| 3844 | OCF₃ | CH₂—CH₂—CH₂—CH═CH₂ | H | NCH₃ |
| 3845 | OCF₃ | CH₂—[(3-OCH₃)C₆H₄] | H | NCH₃ |
| 3846 | OCF₃ | CH₂—C≡C—CH₃ | H | NCH₃ |
| 3847 | OCF₃ | CH₂—CH₂-(1,3-dioxolan- | H | NCH₃ |
| | | 2-yl) | | |
| 3848 | OCF₃ | CH₂-(1,3-dioxolan- | H | NCH₃ |
| | | 2-yl) | | |
| 3849 | OCF₃ | n-Pentyl | CH₃ | NCH₃ |
| 3850 | OCF₃ | CH₂—C≡C—CH₂—CH₃ | CH₃ | NCH₃ |
| 3851 | OCF₃ | CH₂—CH₂—CH═CH₂ | CH₃ | NCH₃ |
| 3852 | OCF₃ | CH₂—CH₂—CH₂—CH═CH₂ | CH₃ | NCH₃ |
| 3853 | OCF₃ | CH₂—[(3-OCH₃)C₆H₄] | CH₃ | NCH₃ |
| 3854 | OCF₃ | CH₂—C≡C—CH₃ | CH₃ | NCH₃ |
| 3855 | OCF₃ | CH₂—CH₂-(1,3-dioxolan- | CH₃ | NCH₃ |
| | | 2-yl) | | |
| 3856 | OCF₃ | CH₂-(1,3-dioxolan- | CH₃ | NCH₃ |
| | | 2-yl) | | |
| 3857 | OCF₃ | n-Pentyl | Cl | NCH₃ |
| 3858 | OCF₃ | CH₂—C≡C—CH₂—CH₃ | Cl | NCH₃ |
| 3859 | OCF₃ | CH₂—CH₂—CH═CH₂ | Cl | NCH₃ |
| 3860 | OCF₃ | CH₂—CH₂—CH₂—CH═CH₂ | Cl | NCH₃ |
| 3861 | OCF₃ | CH₂—[(3-OCH₃)C₆H₄] | Cl | NCH₃ |
| 3862 | OCF₃ | CH₂—C≡C—CH₃ | Cl | NCH₃ |
| 3863 | OCF₃ | CH₂—CH₂-(1,3-dioxolan- | Cl | NCH₃ |
| | | 2-yl) | | |
| 3864 | OCF₃ | CH₂-(1,3-dioxolan- | Cl | NCH₃ |
| | | 2-yl) | | |
| 3865 | SCH₃ | n-Pentyl | H | NCH₃ |
| 3866 | SCH₃ | CH₂—C≡C—CH₂—CH₃ | H | NCH₃ |
| 3867 | SCH₃ | CH₂—CH₂—CH═CH₂ | H | NCH₃ |
| 3868 | SCH₃ | CH₂—CH₂—CH₂—CH═CH₂ | H | NCH₃ |
| 3869 | SCH₃ | CH₂—[(3-OCH₃)C₆H₄] | H | NCH₃ |
| 3870 | SCH₃ | CH₂—C≡C—CH₃ | H | NCH₃ |
| 3871 | SCH₃ | CH₂—CH₂-(1,3-dioxolan- | H | NCH₃ |
| | | 2-yl) | | |
| 3872 | SCH₃ | CH₂-(1,3-dioxolan- | H | NCH₃ |
| | | 2-yl) | | |
| 3873 | SCH₃ | n-Pentyl | CH₃ | NCH₃ |
| 3874 | SCH₃ | CH₂—C≡C—CH₂—CH₃ | CH₃ | NCH₃ |
| 3875 | SCH₃ | CH₂—CH₂—CH═CH₂ | CH₃ | NCH₃ |
| 3876 | SCH₃ | CH₂—CH₂—CH₂—CH═CH₂ | CH₃ | NCH₃ |
| 3877 | SCH₃ | CH₂—[(3-OCH₃)C₆H₄] | CH₃ | NCH₃ |
| 3878 | SCH₃ | CH₂—C≡C—CH₃ | CH₃ | NCH₃ |
| 3879 | SCH₃ | CH₂—CH₂-(1,3-dioxolan- | CH₃ | NCH₃ |
| | | 2-yl) | | |
| 3880 | SCH₃ | CH₂-(1,3-dioxolan- | CH₃ | NCH₃ |
| | | 2-yl) | | |
| 3881 | SCH₃ | n-Pentyl | Cl | NCH₃ |
| 3882 | SCH₃ | CH₂—C≡C—CH₂—CH₃ | Cl | NCH₃ |
| 3883 | SCH₃ | CH₂—CH₂—CH═CH₂ | Cl | NCH₃ |
| 3884 | SCH₃ | CH₂—CH₂—CH₂—CH═CH₂ | Cl | NCH₃ |
| 3885 | SCH₃ | CH₂—[(3-OCH₃)C₆H₄] | Cl | NCH₃ |
| 3886 | SCH₃ | CH₂—C≡C—CH₃ | Cl | NCH₃ |
| 3887 | SCH₃ | CH₂—CH₂-(1,3-dioxolan- | Cl | NCH₃ |
| | | 2-yl) | | |
| 3888 | SCH₃ | CH₂-(1,3-dioxolan- | Cl | NCH₃ |
| | | 2-yl) | | |
| 3889 | SO₂CH₃ | n-Pentyl | H | NCH₃ |
| 3890 | SO₂CH₃ | CH₂—C≡C—CH₂—CH₃ | H | NCH₃ |
| 3891 | SO₂CH₃ | CH₂—CH₂—CH═CH₂ | H | NCH₃ |
| 3892 | SO₂CH₃ | CH₂—CH₂—CH₂—CH═CH₂ | H | NCH₃ |
| 3893 | SO₂CH₃ | CH₂—[(3-OCH₃)C₆H₄] | H | NCH₃ |
| 3894 | SO₂CH₃ | CH₂—C≡C—CH₃ | H | NCH₃ |
| 3895 | SO₂CH₃ | CH₂—CH₂-(1,3-dioxolan- | H | NCH₃ |
| | | 2-yl) | | |
| 3896 | SO₂CH₃ | CH₂-(1,3-dioxolan- | H | NCH₃ |
| | | 2-yl) | | |
| 3897 | SO₂CH₃ | n-Pentyl | CH₃ | NCH₃ |
| 3898 | SO₂CH₃ | CH₂—C≡C—CH₂—CH₃ | CH₃ | NCH₃ |
| 3899 | SO₂CH₃ | CH₂—CH₂—CH═CH₂ | CH₃ | NCH₃ |
| 3900 | SO₂CH₃ | CH₂—CH₂—CH₂—CH═CH₂ | CH₃ | NCH₃ |
| 3901 | SO₂CH₃ | CH₂—[(3-OCH₃)C₆H₄] | CH₃ | NCH₃ |
| 3902 | SO₂CH₃ | CH₂—C≡C—CH₃ | CH₃ | NCH₃ |
| 3903 | SO₂CH₃ | CH₂—CH₂-(1,3-dioxolan- | CH₃ | NCH₃ |
| | | 2-yl) | | |
| 3904 | SO₂CH₃ | CH₂-(1,3-dioxolan- | CH₃ | NCH₃ |
| | | 2-yl) | | |
| 3905 | SO₂CH₃ | n-Pentyl | Cl | NCH₃ |
| 3906 | SO₂CH₃ | CH₂—C≡C—CH₂—CH₃ | Cl | NCH₃ |
| 3907 | SO₂CH₃ | CH₂—CH₂—CH═CH₂ | Cl | NCH₃ |
| 3908 | SO₂CH₃ | CH₂—CH₂—CH₂—CH═CH₂ | Cl | NCH₃ |
| 3909 | SO₂CH₃ | CH₂—[(3-OCH₃)C₆H₄] | Cl | NCH₃ |
| 3910 | SO₂CH₃ | CH₂—C≡C—CH₃ | Cl | NCH₃ |
| 3911 | SO₂CH₃ | CH₂—CH₂-(1,3-dioxolan- | Cl | NCH₃ |
| | | 2-yl) | | |
| 3912 | SO₂CH₃ | CH₂-(1,3-dioxolan- | Cl | NCH₃ |
| | | 2-yl) | | |
| 3913 | CF₃ | n-Pentyl | H | NCH₃ |
| 3914 | CF₃ | CH₂—C≡C—CH₂—CH₃ | H | NCH₃ |
| 3915 | CF₃ | CH₂—CH₂—CH═CH₂ | H | NCH₃ |
| 3916 | CF₃ | CH₂—CH₂—CH₂—CH═CH₂ | H | NCH₃ |
| 3917 | CF₃ | CH₂—[(3-OCH₃)C₆H₄] | H | NCH₃ |
| 3918 | CF₃ | CH₂—C≡C—CH₃ | H | NCH₃ |
| 3919 | CF₃ | CH₂—CH₂-(1,3-dioxolan- | H | NCH₃ |
| | | 2-yl) | | |
| 3920 | CF₃ | CH₂-(1,3-dioxolan- | H | NCH₃ |
| | | 2-yl) | | |
| 3921 | CF₃ | n-Pentyl | CH₃ | NCH₃ |
| 3922 | CF₃ | CH₂—C≡C—CH₂—CH₃ | CH₃ | NCH₃ |
| 3923 | CF₃ | CH₂—CH₂—CH═CH₂ | CH₃ | NCH₃ |
| 3924 | CF₃ | CH₂—CH₂—CH₂—CH═CH₂ | CH₃ | NCH₃ |
| 3925 | CF₃ | CH₂—[(3-OCH₃)C₆H₄] | CH₃ | NCH₃ |
| 3926 | CF₃ | CH₂—C≡C—CH₃ | CH₃ | NCH₃ |
| 3927 | CF₃ | CH₂—CH₂-(1,3-dioxolan- | CH₃ | NCH₃ |
| | | 2-yl) | | |
| 3928 | CF₃ | CH₂-(1,3-dioxolan- | CH₃ | NCH₃ |
| | | 2-yl) | | |
| 3929 | CF₃ | n-Pentyl | Cl | NCH₃ |
| 3930 | CF₃ | CH₂—C≡C—CH₂—CH₃ | Cl | NCH₃ |
| 3931 | CF₃ | CH₂—CH₂—CH═CH₂ | Cl | NCH₃ |
| 3932 | CF₃ | CH₂—CH₂—CH₂—CH═CH₂ | Cl | NCH₃ |
| 3933 | CF₃ | CH₂—[(3-OCH₃)C₆H₄] | Cl | NCH₃ |
| 3934 | CF₃ | CH₂—C≡C—CH₃ | Cl | NCH₃ |
| 3935 | CF₃ | CH₂—CH₂-(1,3-dioxolan- | Cl | NCH₃ |
| | | 2-yl) | | |
| 3936 | CF₃ | CH₂-(1,3-dioxolan- | Cl | NCH₃ |
| | | 2-yl) | | |
| 3937 | C₂H₅ | n-Pentyl | H | NCH₃ |
| 3938 | C₂H₅ | CH₂—C≡C—CH₂—CH₃ | H | NCH₃ |
| 3939 | C₂H₅ | CH₂—CH₂—CH═CH₂ | H | NCH₃ |
| 3940 | C₂H₅ | CH₂—CH₂—CH₂—CH═CH₂ | H | NCH₃ |
| 3941 | C₂H₅ | CH₂—[(3-OCH₃)C₆H₄] | H | NCH₃ |
| 3942 | C₂H₅ | CH₂—C≡C—CH₃ | H | NCH₃ |
| 3943 | C₂H₅ | CH₂—CH₂-(1,3-dioxolan- | H | NCH₃ |
| | | 2-yl) | | |
| 3944 | C₂H₅ | CH₂-(1,3-dioxolan- | H | NCH₃ |
| | | 2-yl) | | |
| 3945 | C₂H₅ | n-Pentyl | CH₃ | NCH₃ |
| 3946 | C₂H₅ | CH₂—C≡C—CH₂—CH₃ | CH₃ | NCH₃ |
| 3947 | C₂H₅ | CH₂—CH₂—CH═CH₂ | CH₃ | NCH₃ |
| 3948 | C₂H₅ | CH₂—CH₂—CH₂—CH═CH₂ | CH₃ | NCH₃ |
| 3949 | C₂H₅ | CH₂—[(3-OCH₃)C₆H₄] | CH₃ | NCH₃ |
| 3950 | C₂H₅ | CH₂—C≡C—CH₃ | CH₃ | NCH₃ |
| 3951 | C₂H₅ | CH₂—CH₂-(1,3-dioxolan- | CH₃ | NCH₃ |
| | | 2-yl) | | |
| 3952 | C₂H₅ | CH₂-(1,3-dioxolan- | CH₃ | NCH₃ |
| | | 2-yl) | | |
| 3953 | C₂H₅ | n-Pentyl | Cl | NCH₃ |
| 3954 | C₂H₅ | CH₂—C≡C—CH₂—CH₃ | Cl | NCH₃ |
| 3955 | C₂H₅ | CH₂—CH₂—CH═CH₂ | Cl | NCH₃ |
| 3956 | C₂H₅ | CH₂—CH₂—CH₂—CH═CH₂ | Cl | NCH₃ |
| 3957 | C₂H₅ | CH₂—[(3-OCH₃)C₆H₄] | Cl | NCH₃ |
| 3958 | C₂H₅ | CH₂—C≡C—CH₃ | Cl | NCH₃ |
| 3959 | C₂H₅ | CH₂—CH₂-(1,3-dioxolan- | Cl | NCH₃ |
| | | 2-yl) | | |
| 3960 | C₂H₅ | CH₂-(1,3-dioxolan- | Cl | NCH₃ |
| | | 2-yl) | | |

Compounds of the formula I where R⁷ is hydroxyl are prepared by reacting an activated carboxylic acid IVb or a carboxylic acid IVa, which is preferably activated in situ, with 5-hydroxypyrazole of the formula III to give the acylation product, followed by rearrangement.

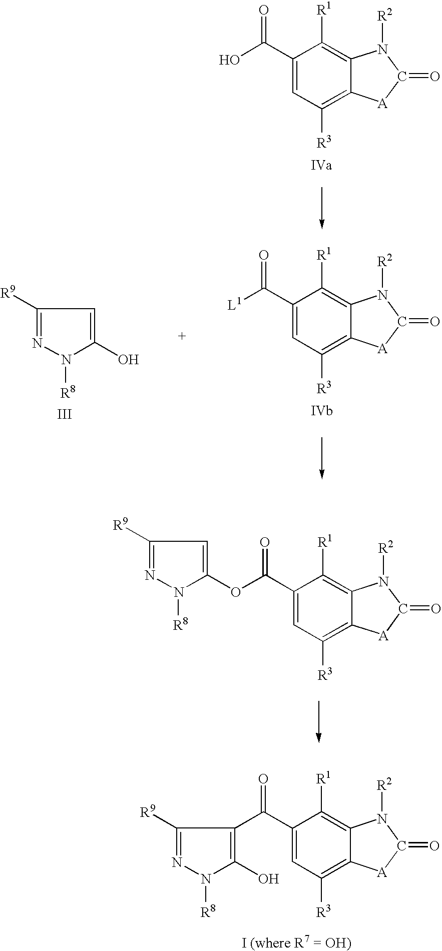

L¹ is a nucleophilically replaceable leaving group, such as halogen, for example bromine or chlorine, hetaryl, for example imidazolyl or pyridyl, carboxylate, for example acetate or trifluoroacetate, etc.

The activated carboxylic acid IVb can be employed directly, such as in the case of the benzoyl halides, or be generated in situ, for example using a carbodiimide, such as ethyl-(3′-dimethylaminopropyl)carbodiimide, dicyclohexylcarbodiimide, triphenylphosphine/azodicarboxylic ester, 2-pyridine disulfide/triphenylphosphine, carbonyldiimidazole, etc.

If appropriate, it may be advantageous to carry out the acylation reaction in the presence of a base. Here, the reactants and the auxiliary base are advantageously employed in equimolar amounts. In some cases, it may be advantageous to employ a slight excess of the auxiliary base, for example from 1.2 to 1.5 molar equivalents, based on IVa or IVb.

Suitable auxiliary bases are tertiary alkylamines, pyridine, 4-dimethylaminopyridine or alkali metal carbonates. Suitable solvents are, for example, chlorinated hydrocarbons, such as methylene chloride or 1,2-dichloroethane, aromatic hydrocarbons, such as toluene, xylene or chlorobenzene, ethers, such as diethyl ether, methyl tert-butyl ether, tetrahydrofuran or dioxane, polar aprotic solvents, such as acetonitrile, dimethylformamide or dimethyl sulfoxide, or esters, such as ethyl acetate, or mixtures of these.

If the activated carboxylic acid component used is a halide, it may be advantageous to cool the reaction mixture to 0-10° C. when adding this reactant. The mixture is subsequently stirred at 20-100° C., preferably at 25-50° C., until the reaction has gone to completion. Work-up is carried out in a customary manner, for example by pouring the reaction mixture into water and extracting the product of value. Solvents which are suitable for this purpose are, in particular, methylene chloride, diethyl ether and ethyl acetate. After the organic phase has been dried and the solvent has been removed, the crude ester can be employed for the rearrangement without further purification.

The rearrangement of the esters to give the compounds of the formula I is advantageously carried out at 20-100° C. in a solvent and in the presence of a base and, if appropriate, using a cyano compound as catalyst.

Suitable solvents are, for example, acetonitrile, methylene chloride, 1,2-dichloroethane, dioxane, ethyl acetate, toluene or mixtures of these. Preferred solvents are acetonitrile and dioxane.

Suitable bases are tertiary amines, such as triethylamine, aromatic amines, such as pyridine, or alkali metal carbonates, such as sodium carbonate or potassium carbonate, which are preferably employed in an equimolar amount or an up to 4-fold excess, based on the ester. Preference is given to using triethylamine or alkali metal carbonate, preferably in twice the equimolar amount, based on the ester.

Suitable cyano compounds are inorganic cyanides, such as sodium cyanide or potassium cyanide, and organic cyano compounds, such as acetonecyanohydrin or trimethylsilyl cyanide. They are employed in an amount of 1-50 mol percent, based on the ester. Preference is given to using acetonecyanohydrin or trimethylsilyl cyanide, for example in an amount of 5-15, preferably about 10, mol percent, based on the ester.

Work-up can be carried out in a manner known per se. The reaction mixture is, for example, acidified with dilute mineral acid, such as 5% strength hydrochloric acid or sulfuric acid, and extracted with an organic solvent, for example methylene chloride or ethyl acetate. The organic extract can be extracted with 5-10% strength alkali metal carbonate solution, for example sodium carbonate or potassium carbonate solution. The aqueous phase is acidified and the precipitate that is formed is filtered off with suction and/or extracted with methylene chloride or ethyl acetate, dried and concentrated.

B. Preparation of compounds of the formula I where R⁷=halogen is carried out by reacting pyrazole derivatives of the formula I (where R⁷=hydroxyl) with halogenating agents:

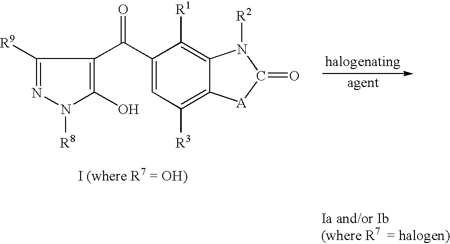

Here and below, “compound Ia” is a compound of the formula I where Pz is a pyrazolyl radical of the formula IIa and, correspondingly, compound Ib is a compound of the formula I where Pz is a radical IIb.

Suitable halogenating agents are, for example, phosgene, diphosgene, triphosgene, thionyl chloride, oxalyl chloride, phosphorus oxychloride, phosphorus pentachloride, mesyl chloride, chloromethylene-N,N-dimethylammonium chloride, oxalyl bromide, phosphorus oxybromide, etc.

C. Preparation of compounds of the formula I where R7=OR¹⁰, OSO₂R¹¹, OPOR¹²R¹³ or OPSR¹²R¹³ by reacting pyrazole derivatives of the formula I (where R⁷=hydroxyl) with alkylating, sulfonylating or phosphonylating agents Vα, Vβ, Vγ and Vδ, respectively.

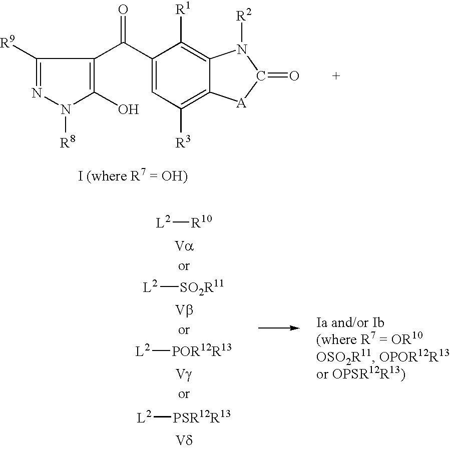

L² is a nucleophilically replaceable leaving group, such as halogen, for example chlorine or bromine, hetaryl, for example imidazolyl, carboxylate, for example acetate, or sulfonate, for example mesylate or triflate, etc.

When preparing compounds of the formula I where R⁷═OR¹⁰ from compounds of the formula I where R⁷═OH, the reaction is preferably carried out in the presence of a base.

The reactants and the base are expediently employed in equimolar amounts. A slight excess of base, for example 1.1-1.5 molar equivalents, based on I, may be advantageous in certain cases.

Suitable bases are tertiary amines, pyridines, alkali metal carbonates or alkali metal hydrides. Suitable solvents are, for example, chlorinated hydrocarbons, such as methylene chloride or 1,2-dichloroethane, aromatic hydrocarbons, such as toluene, xylene or chlorobenzene, ethers, such as diethyl ether, methyl tert-butyl ether, tetrahydrofuran, dioxane or dimethoxyethane, polar aprotic solvents, such as acetonitrile, dimethylformamide or dimethyl sulfoxide, or esters, such as ethyl acetate, and mixtures of these.

If, in place of the alcohol I (R⁷═OH) halides (R⁷=halogen) or activated alcohols, such as mesylates or tosylates (R⁷═OSO₂CH₃ or OSO₂-tolyl) are used for the derivatization, it may be expedient to cool the reaction mixture to 0° C.-10° C. when adding the reaction partner. The mixture is then stirred at 20° C.-100° C., preferably at 20° C.-75° C., until the reaction has gone to completion.

Work-up is carried out in a customary manner; for example, the reaction mixture is poured into water and the product of value is extracted. Solvents which are suitable for this purpose are, in particular, solvents such as methylene chloride, ethyl acetate, methyl tert-butyl ether or diethyl ether. The organic phase is dried and the solvent is removed and the crude product can then, if required, be purified by silica gel column chromatography. Suitable mobile phases are solvents such as methylene chloride, ethyl acetate, cyclohexane, petroleum ether, methanol, acetone or chloroform, and mixtures of these.

Compounds of the formula Vα, Vβ, Vγ or Vδ can be employed directly, such as in the case of the carbonyl halides, or be generated in situ, for example activated carboxylic acids (using carboxylic acid and dicyclohexylcarbodiimide, etc.).

D. Compounds of the formula I where R7=OR¹⁰, SR¹⁰, POR¹²R¹³, NR¹⁴R¹⁵, ONR¹⁴R¹⁵ or N-bonded heterocyclyl are prepared by reacting compounds of the formula I where R⁷=halogen, OSO₂R¹¹ with compounds of the formula VIα, VIβ, VIγ, VIδ, VIε or VIη, if appropriate in the presence of a base or with prior formation of salt.

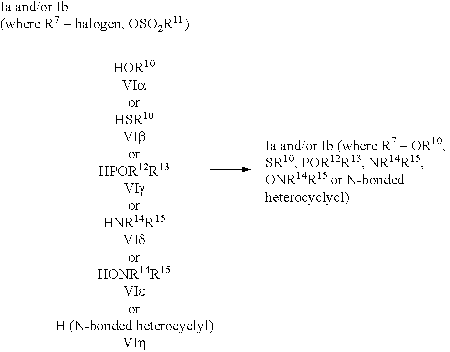

E. Compounds of the formula I where R⁷═SOR¹¹, SO₂R¹¹ are prepared, for example, by reacting compounds of the formula I where R⁷═SR¹¹ with an oxidizing agent.

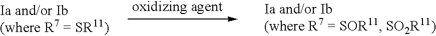

Suitable oxidizing agents are, for example, m-chloro-perbenzoic acid, peroxyacetic acid, trifluoroperoxyacetic acid, hydrogen peroxide, if appropriate in the presence of a catalyst, such as tungstate.

For the reactions mentioned under points B to E, the following conditions apply:

The starting materials are generally employed in equimolar amounts. However, it may also be advantageous to employ an excess of one or the other component.

If appropriate, it may be advantageous to carry out the reactions in the presence of a base. Reactants and base are advantageously employed in equimolar amounts.

With respect to the processes C and D, it may, in certain cases, be advantageous to employ an excess of base, for example 1.5 to 3 molar equivalents, in each case based on the starting material.

Suitable bases are tertiary alkylamines, such as triethylamine, aromatic amines, such as pyridine, alkali metal carbonates, for example sodium carbonate or potassium carbonate, alkali metal bicarbonates, such as sodium bicarbonate and potassium bicarbonate, alkali metal alkoxides, such as sodium methoxide, sodium ethoxide, potassium tert-butoxide, or alkali metal hydrides, for example sodium hydride. Preference is given to using triethylamine or pyridine.

Suitable solvents are, for example, chlorinated hydrocarbons, such as methylene chloride or 1,2-dichloroethane, aromatic hydrocarbons, for example toluene, xylene or chlorobenzene, ethers, such as diethyl ether, methyl tert-butyl ether, tetrahydrofuran or dioxane, polar aprotic solvents, such as acetonitrile, dimethylformamide or dimethyl sulfoxide, or esters, such as ethyl acetate, or mixtures of these.

In general, the reaction temperature is in the range from 0° C. to the boiling point of the reaction mixture.

Work-up can be carried out in a manner known per se to give the product.

Depending on the reaction conditions, in the processes B to D the compounds Ia, Ib, or mixtures of these can be formed. The latter can be separated by classic separation methods, for example crystallization, chromatography, etc.

F. The preparation of compounds of the formula I where Pz is a group of the formula IIa can also be carried out by reacting a metallated pyrazole derivative of the formula VII with a carboxylic acid derivative of the formula IVb:

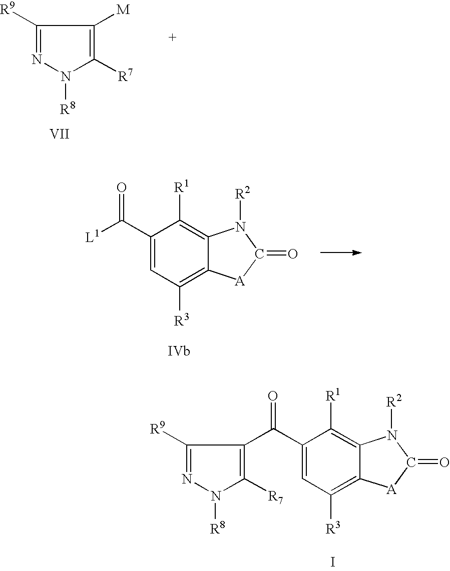

Here, M is a metal, in particular an alkali metal, such as lithium or sodium, an alkaline earth metal, such as magnesium, or a transition metal, such as palladium, nickel, etc., and L¹ is a nucleophilically replaceable leaving group, such as halogen, for example chlorine or bromine, alkylsulfonate, such as mesylate, haloalkylsulfonate, such as triflate or cyanide. Preferably, R⁷ does not have any acidic hydrogen atoms.

The reaction is generally carried out at temperatures from −100° C. to the reflux temperature of the reaction mixture. Suitable solvents are inert aprotic solvents, such as ethers, for example diethyl ether, tetrahydrofuran. The compounds of the formula IVb are generally employed in excess; however, it may also be advantageous to employ them in equimolar amounts or in substoichiometric amounts. Work-up is carried out to afford the product.

The metallated pyrazole derivatives of the formula VII can be formed in a manner known per se by reacting pyrazoles which are halogenated in the 4 position with metals such as lithium, sodium, magnesium, etc., or with organometallic compounds, for example butyllithium. However, it is also possible to metallate pyrazoles which are linked in the 4 position to hydrogen directly, for example using the abovementioned metals or organometallic compounds. The reactions are generally carried out in an inert aprotic solvent, preferably in ethers, such as diethyl ether, tetrahydrofuran, etc. The reaction temperature is in the range from −100° C. to the boiling point of the reaction mixture. The compounds of the formula VII are preferably generated in situ and reacted directly.

The 5-hydroxypyrazoles of the formula III used as starting materials are known or can be prepared by processes known per se as described, for example, in EP-A 240 001, in J. Chem. Soc. 315, (1997), p. 383, J. Prakt. Chem. 315, (1973), p. 382 (see also the reviews in Advances Heterocycle. Chem. 48, (1990), pp. 223-299 and Katritzky, Rees (Eds.), Comprehensive Heterocyclic Chem. Vol. 5, Pergamon Press 1984, Oxford, pp. 167-343 and literature cited therein). Furthermore, 1,3-dimethyl-5-hydroxypyrazole is a compound which is commercially available.

The alkylating agents Vα, sulfonylating agents Vβ, phosphonylating agents Vγ and Vδ, and the compounds VIα, VIβ, VIγ, VIδ and VIε are likewise known, or they can be prepared by known processes.

The carboxylic acids of the formula IVa and their activated derivatives IVb are novel and also form part of the subject-matter of the present invention.

Scheme 1 shows a general route to compounds of the formula IVa in which A is oxygen or NR⁶.

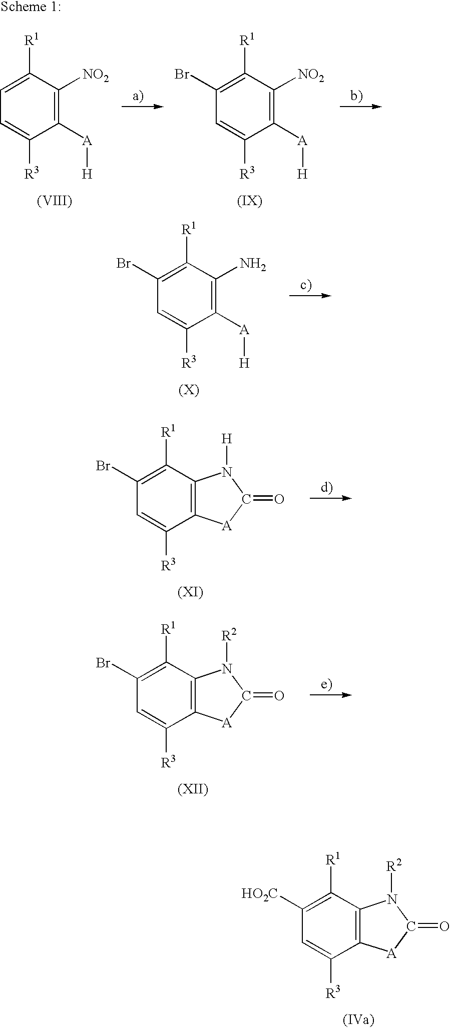

According to scheme 1, benzazolonecarboxylic acids of the formula IVa (A=O or NR⁶) can be prepared from 2-nitroanilines or 2-nitrophenols of the formula VIII, which are substituted in position 3. In step a), the nitro compounds VIII are initially brominated in the position meta to the nitro group. Brominating agents which are customary for this purpose are bromine, N-bromosuccinimide, N-bromohydantoin or pyridinium perbromide which, if appropriate, are employed together with a Lewis acid such as FeBr₃. The bromination is usually carried out in an inert solvent. Suitable solvents are aliphatic or cycloaliphatic hydrocarbons, for example n-hexane or cyclohexane, halogenated hydrocarbons, for example dichloromethane, trichloromethane, carbon tetrachloride, trichloroethane, trichloroethylene, heteroaromatic compounds, such as pyridine, or anhydrous inorganic or organic acids, such as acetic acid. Customary reaction temperatures are in the range from −15° C. to 150° C., preferably in the range from −15° C. to 100° C. Methods for brominating nitro compounds are known, for example from Organikum, 16th ed., 1986, p. 315.

Subsequently, in step b), the nitro group of the compound IX is reduced to the amino group. Suitable reducing agents are, for example, hydrazines, metal hydrides, such as aluminum hydride, and complex hydrides derived therefrom, such as lithium aluminum hydride, diisobutyl aluminum hydride, or boranes, and also nascent hydrogen, for example iron, zinc or tin the presence of acids, such as hydrochloric acid or carboxylic acids, such as acetic acid. A further suitable reducing agent is hydrogen in the presence of catalytic amounts of transition metals such as nickel, palladium, platinum, ruthenium or rhodium. The transition metals can be used as such or in supported form, for example on activated carbon, in the form of activated metals, for example Raney nickel, or in the form of soluble complex compounds. The reaction is preferably carried out in a solvent. Suitable solvents for the reduction are, depending on the solubility of the substrate to be hydrogenated and the chosen reducing agent, for example C₁-C₄-alcohols, such as methanol, ethanol, n-propanol, isopropanol or n-butanol, halogenated C₁-C₆-hydrocarbons, such as dichloromethane, trichloromethane, trichloroethane, trichloroethylene, aromatic hydrocarbons, such as benzene, toluene, xylenes, chlorobenzene, aqueous solutions of inorganic acids, such as aqueous hydrochloric acid, or organic acids, and mixtures thereof with water. The reduction is usually carried out at temperatures in the range from −15° C. to +100° C., preferably in the range from 0° C. to 40° C. The reduction with hydrogen is usually carried out at a hydrogen pressure in the range from 1 to 50 bar. Catalytic hydrogenations with hydrogen are preferably carried out in the range from 1 to 10 bar. For the catalytic hydrogenation of aromatic nitro groups, see, for example, Rylander in “Catalytic Hydrogenation over Platinum Metals”, Academic Press, New York, 1967, 168-202; Furst et al., Chem. Rev. 65 (1965), 52; Tepko et al., J. Org. Chem. 45 (1980), 4992.

The 3-bromoaniline X is then, in step c), condensed to the heterocycle by reacting the compound X with a carbonic acid equivalent, such as methyl chloroformate, phosgene or its synthesis equivalents, such as diphosgene or triphosgene, under conditions which are customary for phosgenation. In general, the cyclization is carried out under neutral to acidic reaction conditions at temperatures in the range from 0° C. to 150° C. and preferably in the range from 20° C. to 120° C. The phosgenation is usually carried out in a solvent. Suitable solvents are, in particular, aliphatic or cycloaliphatic hydrocarbons, such as n-hexane or cyclohexane, halogenated hydrocarbons, such as dichloromethane, chloroform, trichloroethane, trichloroethylene, aromatic hydrocarbons, such as benzene, aliphatic ethers, such as diethyl ether, methyl tert-butyl ether, or cyclic ethers, such as tetrahydrofuran or dioxane. Phosgenation methods are known, see, for example, Justus Liebigs Ann. Chem., (2), 1978 193-213; J. Med. Chem., 30 (N 7) (1987), 1166-1176, J. Heterocycl. Chem. 28 (8) (1991), 1937-1939; J. Nat. Prod. 58 (3) (1995), 456-458.

In step d), the substituent R² is introduced, for example, by reacting the 5-bromobenzazol-2-one XI obtained in step c) with R²-L or its precursor, L being a nucleophilically displaceable leaving group. Suitable leaving groups are, for example, halogen, such as chlorine, bromine or iodine, carboxylate, such as acetate or trifluoroacetate, or sulfonates, such as tosylate, mesylate or triflate. The reaction is preferably carried out in the presence of an auxiliary base, for example alkali metal carbonates or alkaline earth metal carbonates, such as sodium carbonate, potassium carbonate, magnesium carbonate or calcium carbonate, alkali metal hydrides or alkaline earth metal hydrides, for example sodium hydride, tertiary alkylamines, for example triethylamine, aromatic amines, for example pyridine, DMPU. The reaction is generally carried out at temperatures in the range from −15° C. to 150° C. and preferably at from 0° C. to 100° C. The reaction is usually carried out in a solvent. Suitable solvents are, for example, the abovementioned inert hydrocarbons, the abovementioned halogenated hydrocarbons, aromatic hydrocarbons, such as benzene, toluene, xylene or chlorobenzene, the abovementioned acyclic or cyclic ethers, furthermore polar aprotic solvents, such as dimethylformamide, acetonitrile or dimethyl sulfoxide. Methods for introducing a substituent at a heterocylic amide nitrogen atom are known, see also Eur. J. Med. Chem. 30 (9) (1995), 715-719; Tetrahedron 54 (9) (1998), 1763-1772.

Successive reaction of XII with magnesium or alkylmagnesium halides to the corresponding Grignard reagent and subsequent reaction of the Grignard reagent with carbon dioxide gives the carboxylic acid IVa (step e)). Customary reaction temperatures are in the range from −15° C. to 150° C., preferably in the range from −15° C. to 100° C. Suitable solvents are anhydrous solvents, in particular the abovementioned inert cyclic or acyclic hydrocarbons, the abovementioned aromatic hydrocarbons or the abovementioned acyclic or cyclic ethers. The benzazolone-5-carboxylic acid IVa is obtained by introducing dry carbon dioxide into the resulting solution of the Grignard reagent corresponding to XII and subsequent aqueous work-up. The carbon dioxide pressure is usually from 1 to 6 bar.

Alternatively, XII can be converted into carboxylic acid IVa by halogen-metal exchange using an alkali metal alkyl, for example a lithium alkyl, such as methyllithium, n-butyllithium or tert-butyllithium, and subsequent reaction of the lithiated product with CO₂. Customary reaction temperatures are in the range from −100° C. to 0° C., preferably in the range from −78° C. to −50° C. Suitable solvents are anhydrous solvents, in particular the abovementioned inert hydrocarbons, the abovementioned aromatic hydrocarbons or the abovementioned acyclic or cyclic ethers. Introduction of dry carbon dioxide into the solution of the lithiated product of XII gives the benzazolonecarboxylic acid IVa. The carbon dioxide pressure is usually from 1 to 6 bar.

Reaction step e) in scheme 1 can also be realized by reacting XII with carbon monoxide, a base and water, under elevated pressure in the presence of a palladium, nickel, cobalt or rhodium catalyst.

The catalysts nickel, cobalt, rhodium and in particular palladium can be present in metallic form or in the form of customary salts, such as in the form of halogen compounds, for example palladium(II) chloride, rhodium(III) chloride hydrate, acetates, for example palladium(II) acetate, cyanides, etc., in the known valence states. Metal complexes with tertiary phosphines, metal alkyl carbonyls, metal carbonyls, for example CO₂(CO)₈, Ni(CO)₄, metal carbonyl complexes with tertiary phosphines, for example (PPh₃)₂Ni(CO)₂, or transition metal salts complexed with tertiary phosphines can also be employed. The lastmentioned embodiment is preferred, in particular when the catalyst used is palladium. Here, the type of phosphine ligands is of minor importance. Suitable ligands are, for example, those of the formula:

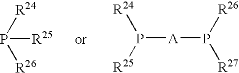

where the radicals R²⁴ to R²⁶ are low-molecular-weight alkyl, for example C₁-C₆-alkyl, aryl, C₁-C₄-alkylaryl, for example benzyl, phenethyl, or aryloxy. Aryl is, for example naphthyl, anthryl and preferably unsubstituted or substituted phenyl, where, with respect to the substituents, attention has to be paid only to their inertness to the carboxylation reaction, otherwise they can be varied widely and include all inert organocarbon radicals, such as C₁-C₆-alkyl radicals, for example methyl, carboxyl radicals, such as COOH, COOM (M is, for example, an alkali metal, alkaline earth metal or ammonium salt), or organocarbon radicals attached via oxygen, such as C₁-C₆-alkoxy radicals. A is a divalent organic radical, for example C₁-C₄-alkylene, 1,2-cycloalkylene, α,α′-ferrocenediyl, α,α-biphenyl or similar bifunctional groups.

The phosphine complexes can be prepared in a manner known per se, for example as described in the documents mentioned at the outset. For example, customary commercially available metal salts such as palladium(II) chloride or palladium(II) acetate are used as starting materials and the phosphine, for example P(C₆H₅)₃, P(n-C₄H₉)₃, PCH₃(C₆H₅)₂, 1,2-bis(diphenylphosphino)ethane, is added.

The amount of phosphine, based on the transition metal, is usually from 0 to 20, in particular from 0.1 to 10, molar equivalents, particularly preferably from 1 to 5 molar equivalents.

The amount of transition metal is not critical. Of course, for reasons of cost, preference is given to using a relatively small amount, for example from 0.1 to 10 mol %, in particular from 1 to 5 mol %, based on the starting material IVa.

For preparing the benzazolonecarboxylic acid IVa, the reaction is carried out with carbon monoxide and at least equimolar amounts of water, based on the bromide obtained in step d). The reaction component water can simultaneously also serve as solvent, i.e. the maximum amount is not critical.

However, depending on the nature of the starting materials and the catalysts used, it may also be advantageous for the solvent used to be, instead of the reaction component, another inert solvent or the base which is used for the carboxylation.

Suitable inert solvents for carboxylation reactions are customary solvents such as hydrocarbons, for example toluene, xylene, hexane, pentane, cyclohexane, ethers, for example methyl tert-butyl ether, tetrahydrofuran, dioxane, dimethoxyethane, substituted amides, such as dimethylformamide, persubstituted ureas, such as tetra-C₁-C₄-alkylureas, or nitrites, such as benzonitrile or acetonitrile.

In a preferred embodiment of the process, one of the reaction components, in particular the base, is used in an excess, so that no additional solvent is necessary.

Bases which are suitable for the process are all inert bases which are able to bind hydrogen iodide or hydrogen bromide liberated during the reaction. Examples which may be mentioned here are tertiary amines, such as tert-alkylamines, trialkylamines, such as triethylamine, cyclic amines, such as N-methylpiperidine or N,N′-dimethylpiperazine, pyridine, alkali metal carbonates or bicarbonates, or tetraalkyl-substituted urea derivatives, such as tetra-C₁-C₄-alkylurea, for example tetramethylurea.

The amount of base is not critical: customarily from 1 to 10, in particular from 1 to 5, mol are used. When the base is simultaneously used as solvent, the amount is generally such that the reaction components are dissolved, unnecessarily high excesses being avoided for reasons of practicability in order to save costs, to be able to employ small reaction vessels and to ensure that the reaction components have maximum contact.

During the reaction, the carbon monoxide pressure is adjusted such that an excess of CO, based on the bromide, is always present. At room temperature, the carbon monoxide pressure is preferably from 1 to 250 bar, in particular from 5 to 150 bar, of CO.

The carbonylation is generally carried out continuously or batchwise at from 20 to 250° C., in particular from 30 to 150° C. In the case of batchwise operation, carbon monoxide is advantageously continuously injected onto the reaction mixture to maintain a constant pressure.

It is, of course, also possible to carry out reaction step e) first and then reaction step d).

The 2-nitroanilines or 2-nitrophenols of the formula VIII, which are substituted in the 3-position, used as starting materials for the synthesis of the benzazolonecarboxylic acids IVa are known and can be prepared by processes known per se. Alternatively, the compounds IX in which A is oxygen can be prepared in the manner shown below in scheme 7.

A further general route to the benzazolonecarboxylic acids of the formula IVa is shown in scheme 2.

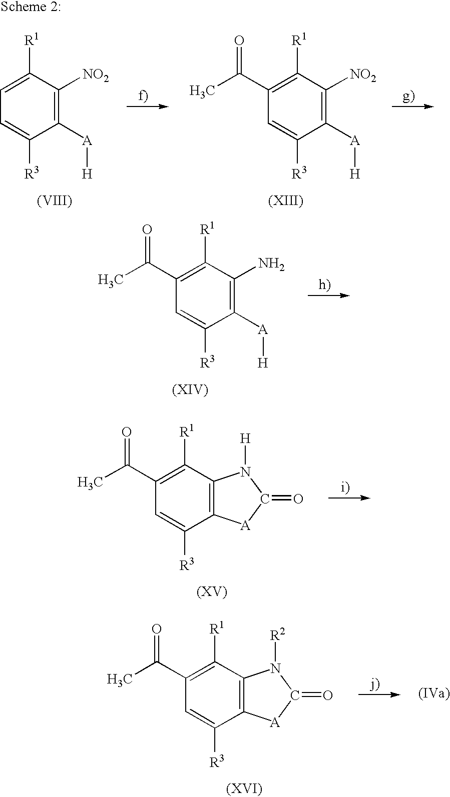

Starting with the 2-nitroanilines or 2-nitrophenols of the formula VIII, which are substituted in the 3-position, the substituted acetophenone XIII can be prepared by Friedel-Crafts acylation in step f). The acetyl group can be introduced in a known manner by reacting the compound VIII with acetic acid or activated acetic acid, such as acetic anhydride or acetyl chloride, in the presence of a Lewis acid such as aluminum trichloride, boron trifluoride or trifluoroacetic acid, under anhydrous conditions. Usually, more than 1 mol of Lewis acid is required per mole of ketone formed, since the ketone formed binds the Lewis acid as a complex. After the reaction has ended, this complex is cleaved hydrolytically. Friedel-Crafts acylations are usually carried out in a solvent. Suitable solvents are the abovementioned cyclic and acyclic hydrocarbons, the abovementioned halogenated hydrocarbons, aromatic hydrocarbons, such as nitrobenzene, or the abovementioned ethers. The reaction temperatures are generally in the range from 0° C. to 150° C. and preferably in the range from 20° C. to 120° C. Methods for introducing acyl groups are known, see, for example, Organikum, 16th ed. 1986, p. 325.

In step g), the substituted acetophenone XIII is then reduced to the amino compound XIV. The reduction is carried out in the manner described in step b) in scheme 1. In step h), the aniline derivative XIV is then phosgenated in the manner described in step c) in scheme 1. The substituent R² can be introduced similarly to step d) in scheme 1 (step i) in scheme 2).

The compound XVI obtained in step i) in scheme 2 is converted into the benzazolonecarboxylic acid IVa with the aid of the haloform reaction. To this end, a halogenating agent, such as hypohalite, for example hypochlorite, or chlorine in alkaline solution is allowed to act on the compound XVI. Initially, a trihalomethylcarbonyl derivative is formed, which, under the alkaline reaction conditions, is cleaved hydrolytically with formation of the desired benzazolonecarboxylic acid IVa. Suitable bases are, in particular, alkali metal hydroxides, such as sodium hydroxide or potassium hydroxide. The reaction is usually carried out in solution. Suitable solvents are in particular water, mixtures of water and organic solvents, such as C₁-C₄-alcohols, for example methanol, ethanol, propanol, butanol, or the abovementioned ethers. Customary reaction temperatures are in the range from 0° C. to 150° C., preferably in the range from 20° C. to 120° C. For the haloform reaction, see, for example, Organikum, 16th ed. 1986, p. 375.

If A in formula IVa is sulfur, the benzazolonecarboxylic acids of the general formula IVa can also be prepared in the manner shown in scheme 3.

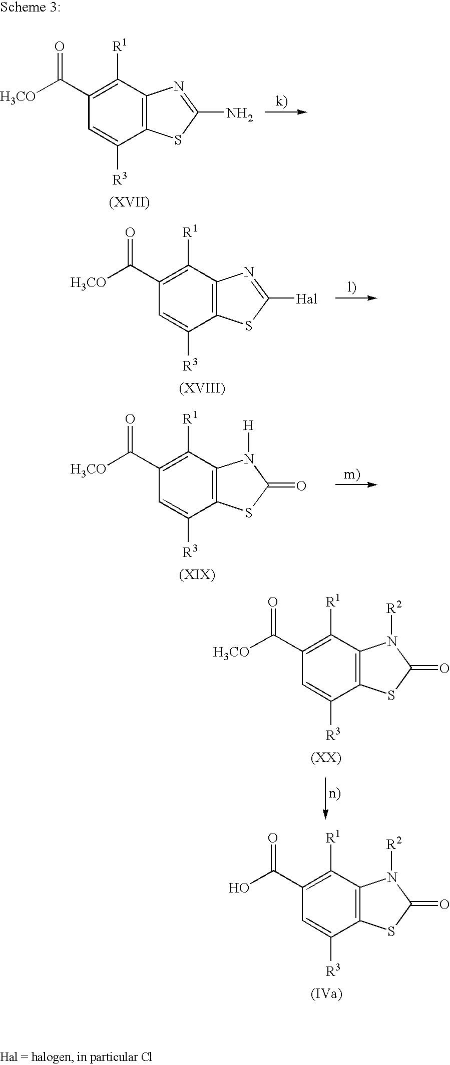

According to scheme 3, the benzazolonecarboxylic acids of the formula IVa where A=sulfur can be prepared from the aminobenzothiazoles XVII. The 2-aminobenzothiazole XVII is converted into the 2-halobenzothiazole compound XVIII in a manner known per se under Sandmeyer conditions (step k)). In this manner, further functionalities can be introduced in the 2-position of the benzothiazole ring.

To this end, the 2-aminobenzothiazole XVII is initially reacted with inorganic or organic nitrite, such as sodium nitrite in the presence of acid, such as hydrochloric acid, or with tert-butyl nitrite. The resulting diazonium salt is then reacted with an inorganic halide, such as sodium chloride, with addition of copper or a Cu(I) halide, such as Cu(I) chloride. The reaction is generally carried out at temperatures in the range from 0° C. to 150° C. and preferably in the range from 20° C. to 100° C. Suitable solvents are in particular water or mixtures of water with organic solvents, such as the abovementioned alcohols or ethers. For preparing aromatic halides, in particular chlorides, according to Sandmeyer, see also Organikum, 16th ed. 1986, p. 545.

In step 1), the 2-halobenzothiazole compound XVIII can then be hydrolyzed under acidic or alkaline conditions to give the benzothiazolone. To this end, the compound XVIII is treated with a base, such as alkali metal hydroxide or alkaline earth metal hydroxide, for example sodium hydroxide, potassium hydroxide or magnesium hydroxide, or alkali metal alkoxide, such as sodium methoxide or potassium methoxide, or with an acid, such as hydrochloric acid. The hydrolysis is usually carried out in a solvent. Suitable solvents are, depending on the base used, polar aprotic solvents, such as dimethylformamide, dimethyl sulfoxide, N-methylpyrrolidone or acetonitrile, ethers, such as tetrahydrofuran or dioxane, water and mixtures of water with the abovementioned alcohols, ethers or polar aprotic solvents. The hydrolysis is generally carried out at from 0° C. to 150° C. and preferably at from 20° C. to 120° C. For the hydrolysis of haloheteroaromatic compounds to keto compounds see also J. Med. Chem. 20 (No. 6) (1977), 791-796.

In step m), the substituent R² is introduced into the compound XIX as described in step d) in scheme 1. For the hydrolysis in step n), for example, the benzazolone methyl ester XX obtained in step m) is reacted with alkali metal hydroxide, for example lithium hydroxide, sodium hydroxide or potassium hydroxide, with alkaline earth metal hydroxide, such as magnesium hydroxide, or with alkali metal iodides, such as sodium iodide, in a suitable solvent, preferably in the absence of oxygen. Usual reaction temperatures are in the range from 0° C. to 200° C. and in particular in the range from 20° C. to 180° C. Suitable solvents are the abovementioned aliphatic or cycloaliphatic hydrocarbons, the halogenated hydrocarbons, the aromatic hydrocarbons, the abovementioned ethers and alcohols, aqueous monophasic systems, and also pyridine. For hydrolysis, see, for example, Organikum, 16th ed. 1986, p. 415, McMurry, Org. React. 24 (1976), 187; Taschner et al., Rocz. Chem. 30 (1956), 323; Houben-Weyl: “Methoden der organischen Chemie” [Methods of Organic Chemistry], volume E 8 b 1994; p. 1010 f.; J.Chem. Soc. Perkin Trans. 1, No. 12 (1976), 1291-1296; in particular A. R. Katritzky et al., J. Heterocycl. Chem., 30 (1) (1993) 135-139. The synthesis of the starting material XVII is described in PCT/EP 00/04042 and PCT/EP 00/04040.

A further route to the compounds of the formula IVa is shown in scheme 4.

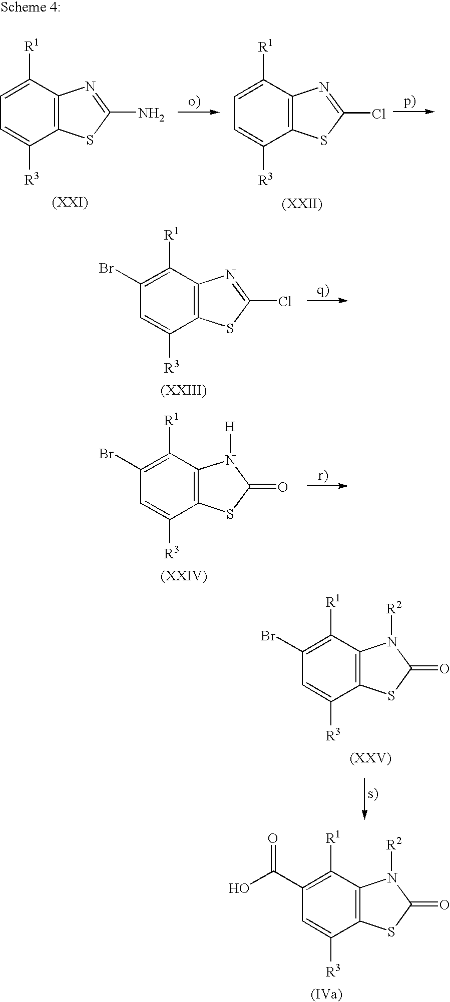

In step o), the 2-chlorobenzothiazole compounds XXII can be prepared in a Sandmeyer reaction from the 2-aminobenzothiazoles of the formula XXI, which are known per se. The reaction conditions required correspond to those for step k) in scheme 3. The 2-chlorobenzothiazole XXII can be brominated in a manner similar to that of step a) in scheme 1, the bromine substituent being introduced selectively in the position ortho to R¹ (step p)). The compound XXIII is then, under the conditions given for step 1) in scheme 3, subjected to basic hydrolysis (step q)). In step r), the substituent R² can be introduced into XXIV under the conditions described for step d) in scheme 1. The carboxyl group is introduced (step s)) according to the reaction conditions described in step e) in scheme 1.

A variant for preparing the benzothiazolonecarboxylic acid IVa (A=S) is shown in scheme 5.

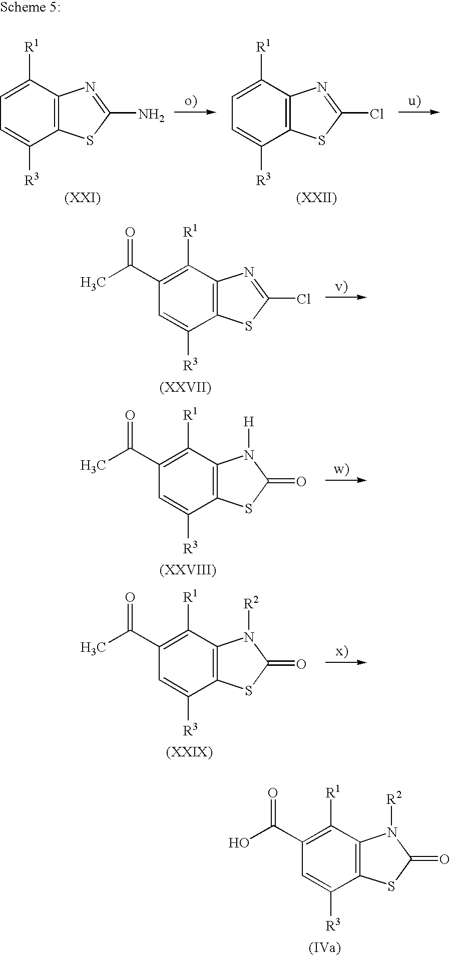

Again, the initial starting materials are substituted 2-aminobenzothiazoles XXI which are converted in the manner described above into the 2-chlorobenzothiazoles XXII (step o), see scheme 3). In step u), the 2-chlorobenzothiazoles XXII are then subjected to a Friedel-Crafts acylation under the conditions given in step f) in scheme 2, giving the compound XXVII. XXVII is hydrolyzed in a manner similar to that described for reaction step q) in scheme 4. In step w), the substituent R² is introduced into XXVIII in a manner known per se, for example as described in step d) in scheme 1. The substituted acetophenone XXIX is then, in the concluding haloform reaction in step x), under the conditions given in step j) in scheme 2, converted into the desired benzazolonecarboxylic acid IVa, with loss of a carbon.

A further route to benzazolonecarboxylic acids of the formula IVa (A=sulfur) is shown in scheme 6.

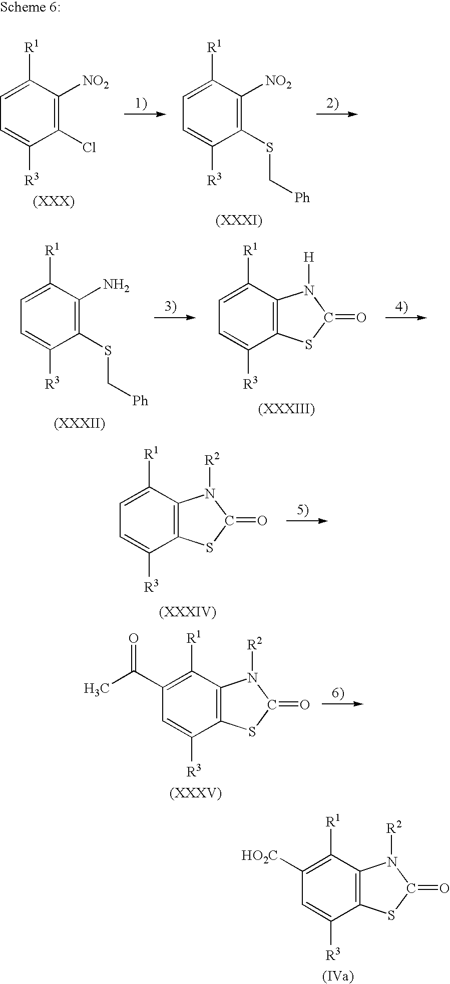

The o-chloronitrobenzenes of the formula XXX, which are known per se, are initially converted with alkali metal salts of benzyl mercaptan into the corresponding thioethers XXXI (step 1)). The substitution is usually carried out in one of the abovementioned aliphatic or cycloaliphatic hydrocarbons, halogenated hydrocarbons, aromatic hydrocarbons, ethers, in dimethyl-formamide, NMP, sulfolane or dimethyl sulfoxide. Customary reaction temperatures are in the range from 0° C. to 250° C. and preferably in the range from 50° C. to 175° C. Methods for nucleophilic substitution are known, see also A. Bagno et al., J. Chem. Soc. Perkin Trans. II, 1991 (5), 651-655; J. R. Beck et al., J. Org. Chem. 43 (10), (1978), 2048-2052.

In step 2), the compound XXXI is then reduced to amino compound XXXII. The required reaction conditions correspond to those for step b) in scheme 1. The amino compound XXXII is then cyclized under the reaction conditions described in step c) in scheme 1 using carbonic acid equivalents, to give the benzothiazolone XXXIII (step 3)). The substituent R² is subsequently introduced under the reaction conditions described in step d) in scheme 1 (step 4)). The acetyl group is introduced in the position ortho to substituent R¹ by Friedel-Crafts acylation of the compound XXXIV (step 5)). The required reaction conditions correspond to those of step f) in scheme 2. The desired benzazolonecarboxylic acid IVa can be obtained from compound XXXV by haloform reaction (step 6)). The required reaction conditions correspond to those in step j) in scheme 2.

In a similar manner as in scheme 1, compounds of the formula IVa where A=sulfur can be obtained in a variant of this process starting with o-chloronitrobenzenes XXX by initially brominating the thioether XXXI obtained in step 1). The required reaction conditions correspond to those of step a) in scheme 1. The subsequent reduction of the nitro group to the amino group is carried out under the conditions mentioned in step b) in scheme 1. Condensation with carbonic acid equivalents gives the benzothiazolones. The required reaction conditions correspond to those of step c) in scheme 1. The substituent R² is introduced in the customary manner, analogously to step d) in scheme 1. The carboxyl group is introduced by the procedure described in step e) in scheme 1.

A further route to benzazolonecarboxylic acids where A=oxygen is shown in scheme 7.

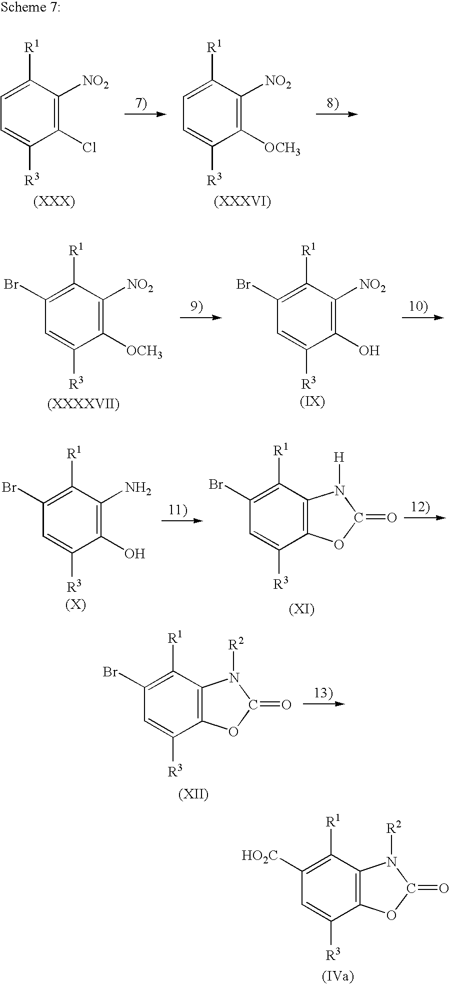

According to scheme 7, for example, o-chloronitrobenzenes of the formula XXX can be converted with alkali metal salts of alkoxides into the corresponding o-nitroethers XXXVI (step 7)). This nucleophilic substitution on the aromatic ring is generally carried out with exclusion of water, usually in a solvent. Suitable solvents are, in particular, the abovementioned aliphatic or cycloaliphatic hydrocarbons, halogenated hydrocarbons, aromatic hydrocarbons, ethers, DMF, NMP, sulfolane or dimethyl sulfoxide. The required reaction temperatures are generally in the range from 0° C. to 250° C. and preferably from 50° C. to 175° C. Methods for preparing aromatic ethers from o-nitrochloro compounds are known, see also A. Bagno et al., J.Chem. Soc. Perkin Trans. II, 1991 (5), 651-655; J. R. Beck et al., J. Org. Chem. 43 (10) (1978), 2048-2052.

The resulting o-nitroanisole XXXVI is brominated under the reaction conditions given in step a) in scheme 1, the bromine atom being introduced selectively in position para to the methoxy group (step 8)).

In step 9), the hydroxyl group is then exposed by ether cleavage under acidic reaction conditions in the presence of a Lewis acid, such as aluminum trichloride, aluminum tribromide or hydrohalic acids, such as hydriodic acid or hydrobromic acid, giving 4-bromo-2-nitrophenols of the formula IX. The ether cleavage is usually carried out in a solvent. Suitable solvents are the abovementioned acyclic and cyclic hydrocarbons, halogenated hydrocarbons, aromatic hydrocarbons or acids, such as acetic acid. The ether cleavage is generally carried out at temperatures in the range from −15° C. to 150° C., preferably in the range from 0° C. to 100° C. For the cleavage of phenol ethers, see also Organikum, 16th ed. 1986, p. 192.

The further reaction steps 10) to 13) in scheme 7 correspond to reaction steps b) to e) in scheme 1.

The examples below serve to illustrate the invention.

### EXAMPLE 1

Preparation of 3,4-dimethyl-5-(5′-hydroxy-1′-methyl-pyrazol-4-yl)carbonyl benzothiazol-2-one (compound I-1a.1129)

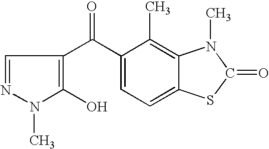

1.1 Methyl 2-chloro-4-methylbenzothiazole-5-carboxylate

A solution of 5 g (22.5 mmol) of methyl 2-amino-4-methylbenzothiazole-5-carboxylate in 2 1 of acetonitrile was admixed with 10 ml of water, 4.5 g (44.8 mmol) of copper(I) chloride, 6.6 g of sodium chloride (110 mmol) and 2 ml of 15-crown-5. A solution of 3 g (29 mmol) of tert-butyl nitrite was then added dropwise with stirring, the solution was heated at reflux for 15 h, the resulting precipitate was filtered off and the solution was concentrated under reduced pressure. The residue was then extracted three times with in each case 500 ml of ethyl acetate. To this end, the solvent was heated to boiling point and the solution was filtered whilst hot. The extracts were concentrated under reduced pressure. The residue was purified by trituration with n-hexane/diethyl ether. This gave 4.2 g (17.4 mmol, 77% yield) of methyl 2-chloro-4-methylbenzothiazole-5-carboxylate of m.p. 112° C.

¹H-NMR (CDCl₃): δ (ppm)=2.98 (s, 3H), 3.94 (s, 3H), 7.64 (d, 1H), 7.95 (d, 1H).

1.2 Methyl 4-methylbenzothiazol-2-one-5-carboxylate

A solution of 22.5 g (93 mmol) of methyl 2-chloro-4-methylbenzothiazole-5-carboxylate in 360 ml of N-methylpyrrolidone was admixed with 13.6 g (186 mmol) of potassium methoxide and heated at 100° C. for 5 hours. After cooling, the resulting precipitate was filtered off with suction and the filtrate was admixed with water. The pH of the reaction solution was then adjusted to pH 1, the aqueous solution was extracted three times with ethyl acetate and the combined organic phases were washed and dried. The solvent was removed under reduced pressure and the residue was purified by trituration with methylene chloride/n-hexane. This gave, in a yield of 55%, 11.38 g (51 mmol) of methyl 4-methylbenzothiazol-2-one-5-carboxylate of m.p. 262° C.-266° C.

¹H-NMR (CDCl₃): δ (ppm)=2.64 (s, 3H), 3.91 (s, 3H), 7.28 (d, 1H), 7.74 (d, 1H), 9.94 (br s, 1 H, NH).

1.3 Methyl 3,4-dimethylbenzothiazol-2-one-5-carboxylate

A solution of 11.38 g (51 mmol) of methyl 4-methylbenzothiazol-2-one-5-carboxylate in 400 ml of acetone was admixed with 14.18 g of potassium carbonate. 5.1 ml (54 mmol) of dimethyl sulfate were then added dropwise with stirring, and the mixture was stirred at 23° C. for 78 hours. The precipitated solid was filtered off and the solvent was removed under reduced pressure. Recrystallization from ether gave, in a yield of 84%, 10.15 g (43 mmol) of methyl 3,4-dimethylbenzothiazol-2-one-5-carboxylate of m.p. 97° C.-100° C.

¹H-NMR (CDCl₃): δ (ppm)=2.78 (s, 3H), 3.77 (s, 3H), 3.92 (s, 3H), 7.28 (d, 1H), 7.36 (d, 1H).

1.4 Methyl 3,4-dimethylbenzothiazol-2-one-5-carboxylic acid

A solution of 10.15 g (43 mmol) of methyl 3,4-dimethylbenzothiazol-2-one-5-carboxylate in 100 ml of tetrahydrofuran and 100 ml of water was admixed with 2.06 g (86 mmol) of lithium hydroxide. The solution was then heated at reflux for 2 hours. After cooling, the tetrahydrofuran was removed under reduced pressure, the remaining aqueous solution was acidified and the precipitated solid was filtered off with suction and dried. More product was obtained by extracting the mother liquor with ethyl acetate. This gave a total of 8 g (36 mmol, 83% yield) of 3,4-dimethylbenzothiazol-2-one5-carboxylic acid of m.p. 235° C.-239° C.

¹H-NMR (DMSO-D₆): δ (ppm)=2.77 (s, 3H), 3.66 (s, 3H), 7.42 (d, 1H), 7.56 (d, 1H).

1.5 1-Methylpyrazol-5-yl 3,4-dimethylbenzothiazol-2-one5-carboxylate 0.94 g (4 mmol) of 3,4-dimethylbenzothiazol-2-one5-carboxylic acid, 0.43 g of 5-hydroxy-1-methylpyrazole and 0.81 g of ethyl(3′-dimethylaminopropyl)carbodiimide were dissolved in 40 ml of acetonitrile, and the solution was stirred at 23° C. for 10 hours. After the reaction had ended, the precipitate was filtered off and the solution was concentrated under reduced pressure. The residue was taken up in water and extracted with methylene chloride. The organic phase was washed and dried and the solvent was then removed. This gave 0.72 g (2.4 mmol, 56% yield) of 1-methyl-pyrazol-5-yl 3,4-dimethylbenzothiazol-2-one-5-carboxylate of m.p. 168° C.-174° C.

¹H-NMR (CDCl₃): δ (ppm)=2.88 (s, 3H), 3.80 (s, 3H), 3.82 (s, 3H), 6.23 (s, 1H), 7.39 (d, 1H), 7.47 (s, 1H), 7.82 (d, 1H).

1.6 3,4-Dimethyl-5-(5′-hydroxy-1′-methylpyrazol-4-yl)carbonylbenzothiazol-2-one

With stirring, 1.41 g of potassium carbonate were added to a solution of 0.61 g (2 mmol) of 1-methylpyrazol-5-yl 3,4-dimethylbenzothiazol-2-one-5-carboxylate in 40 ml of dimethoxyethane. The reaction mixture was heated at reflux for 72 hours. The solvent was removed under reduced pressure and the residue was then taken up in water. The aqueous phase was extracted with methylene chloride, initially at pH 10.8 and then 7.0. The product could to be obtained after acidification to pH 1 by extraction with methylene chloride. Removal of the solvent gave 0.52 g (1.7 mmol, 87% yield) of the title compound of m.p. 192° C.-195° C.

¹H-NMR (CDCl₃): δ (ppm)=2.66 (s, 3H), 3.73 (s, 3H), 3.79 (s, 3H), 4.60 (m, 1H), 7.26 (d, 1H), 7.36 (d, 1H), 7.38 (s, 1H).

### EXAMPLE 2

Preparation of 3,4-dimethyl-5-(5′-hydroxy-1′-ethylpyrazol-4-yl)carbonylbenzothiazol-2-one (compound I-1b.1129)

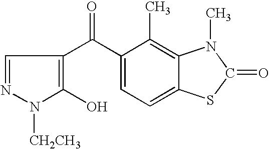

2.1 1-Ethylpyrazol-5-yl 3,4-dimethylbenzothiazol-2-one-5-carboxylate

The reaction was carried out analogously to the procedure described in Example 1.5, but using 1.1 g (5 mmol) of 3,4-dimethylbenzothiazol-2-one-5-carboxylic acid, 0.58 g of hydroxy-1-ethylpyrazole and 0.94 g of ethyl-(3′-dimethylaminopropyl)carbodiimide.

This gave 0.55 g (1.7 mmol, 34% yield) of 1-ethylpyrazol-5-yl 3,4-dimethylbenzothiazol-2-one-5-carboxylate of m.p. 122° C.-124° C.

¹H-NMR (CDCl₃): δ (ppm)=1.42 (t, 3H), 2.88 (s, 3H), 3.90 (s, 3H), 4.12 (q, 2H), 6.23 (s, 1H), 7.39 (d, 1H), 7.50 (s, 1H), 7.79 (d, 1H).

2.2 3,4-Dimethyl-5-(5′-hydroxy-1′-ethylpyrazol-4-yl)carbonyl-benzothiazol-2-one

The reaction was carried out analogously to the procedure described in Example 1.6, but using, in place of 0.62 g (2 mmol) of 1-methylpyrazol-5-yl 3,4-dimethylbenzothiazol-2-one-5-carboxylate, 0.53 g (1.7 mmol) of 1-ethylpyrazol-5-yl 3,4-dimethylbenzothiazol-2-one-5-carboxylate.

The title compound was purified by triturating the resulting crude product with ether. This gave 0.17 g (0.5 mmol, 32% yield) of product of m.p. 147° C.-149° C.

¹H-NMR (CDCl₃): δ (ppm)=1.44 (t, 3H), 2.66 (s, 3H), 3.79 (s, 3H), 4.09 (q, 2H), 7.26 (d, 1H), 7.36 (d, 1H), 7.38 (s, 1H).

### EXAMPLE 3

Preparation of 3,4-dimethyl-5-(5′-hydroxy-1′-isopropylpyrazol-4-yl)carbonylbenzothiazol-2-one (compound I-1c.1129)

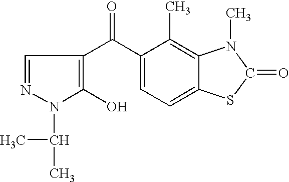

3.1 1-Isopropylpyrazol-5-yl 3,4-dimethylbenzothiazol-2-one-5-carboxylate

The reaction was carried out analogously to the procedure described in Example 1.5.

Starting with 1.1 g (5 mmol) of 3,4-dimethylbenzothiazol-2-one-5-carboxylic acid, 0.65 g of 5-hydroxy-1-isopropyl-pyrazole and 0.94 g of ethyl-(3′-dimethylaminopropyl)carbodiimide, 0.65 g (2 mmol, 40% yield) of 1-isopropyl-pyrazol-5-yl 3,4-dimethylbenzothiazol-2-one-5-carboxylate of m.p. 137° C.-140° C. were isolated.

¹H-NMR (CDCl₃): δ (ppm)=1.48 (d, 6H), 2.88 (s, 3H), 3.90 (s, 3H), 4.52 (m, 1H), 6.21 (s, 1H), 7.40 (d, 1H), 7.51 (s, 1H), 7.80 (d, 1H).

3.2 3,4-Dimethyl-5-(5′-hydroxy-1′-isopropylpyrazol-4-yl)-carbonylbenzothiazol-2-one

The reaction was carried out analogously to the procedure in Example 1.6, but using, in place of 1-methylpyrazol-5-yl 3,4-dimethylbenzothiazol-2-one-5-carboxylate, 0.63 g (1.9 mmol) of 1-isopropylpyrazol-5-yl 3,4-dimethylbenzo-thiazol-2-one-5-carboxylate.

This gave 0.39 g (1.2 mmol, 65% yield) of the title compound of m.p. 175° C.-177° C.

¹H-NMR (CDCl₃): δ (ppm)=1.68 (d, 6H), 2.66 (s, 3H), 3.79 (s, 3H), 4.60 (m, 1H), 7.26 (d, 1H), 7.36 (d, 1H), 7.38 (s, 1H).

The compounds I of Examples 4 to 47 were obtained in a similar manner by reacting the respective carboxylic acid IVa with the 5-hydroxypyrazole III and optionally followed by derivatization of the thus obtained compound I.

| | | m.p. or ¹³C-NMR or ¹H-NMR |
|---|---|---|
| Ex. | Structure/Compound No. | (CDCl₃) |
| 1 | 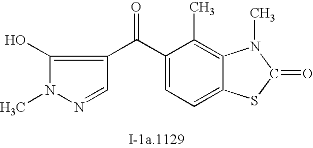 | m.p. 192° C. to 195° C. |
| 2 | 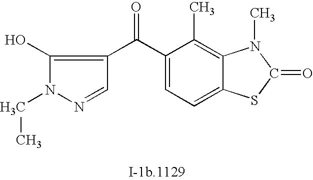 | m.p. 147° C. to 149° C. |
| 3 | 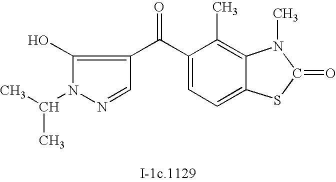 | m.p. 175° C. to 177° C. |
| 4 | 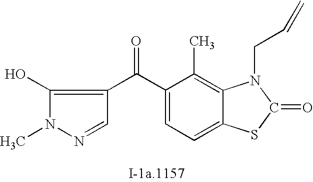 | m.p. 155° C. to 158° C. |
| 5 | 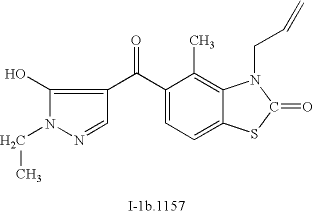 | δ (ppm) = 193.08 (C═O), 170.49 (C═O), 16.14 (CH₃) |
| 6 | 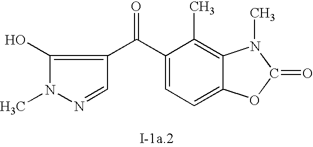 | m.p. 200° C. to 203° C. |
| 7 | 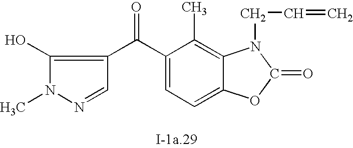 | m.p. 127° C. to 129° C. |
| 8 | 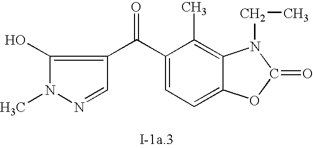 | m.p. 156° C. to 157° C. |
| 9 | 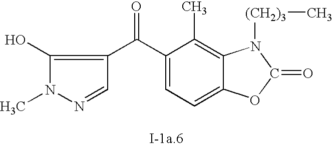 | m.p. 165° C. to 167° C. |
| 10 | 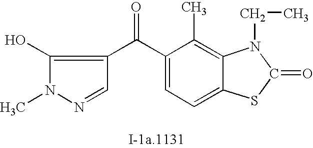 | m.p. 181° C. to 182° C. |
| 11 | 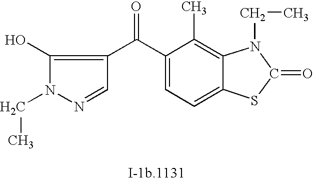 | m.p. 122° C. to 123° C. |
| 12 | 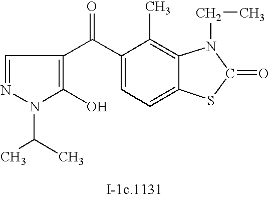 | m.p. 108° C. to 110° C. |
| 13 | 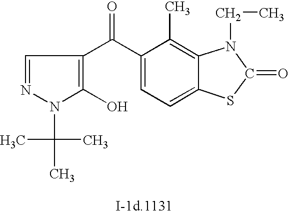 | m.p. 144° C. to 147° C. |
| 14 | 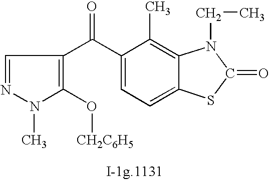 | δ (ppm) = 1.35 (t, 3H), 2.55 (s, 3H), 3.55 (s, 3H), 4.30 (m, 2H), 5.55 (s, 2H), 7.10 (d, 1H), 7.30-7.40 (m, 7H) |
| 15 | 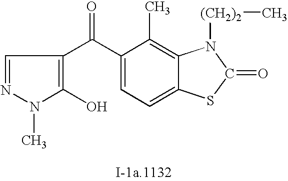 | m.p. 135° C. to 137° C. |
| 16 | 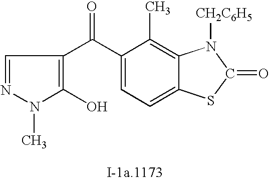 | m.p. 65° C. to 71° C. |
| 17 | 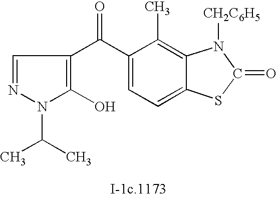 | m.p. 142° C. to 144° C. |
| 18 | 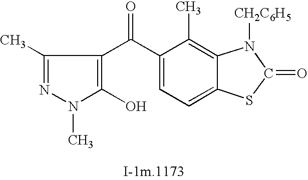 | m.p. 153° C. to 156° C. |
| 19 | 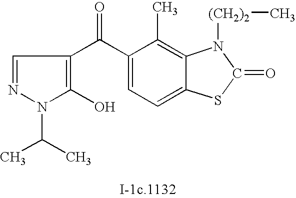 | δ (ppm) = 0.95 (t, 3H), 1.50 (d, 6H), 1.75 (m, 2H), 2.65 (s, 3H), 4.20 (t, 2H), 4.60 (m, 1H), 7.20-7.35 (m, 3H), 8.6 (s, 1H) |
| 20 | 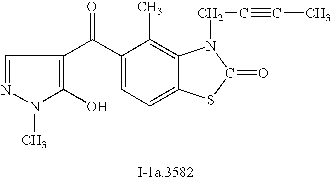 | m.p. 140° C. to 147° C. |
| 21 | 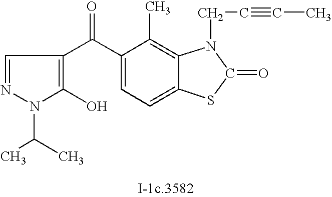 | m.p. 54° C. to 60° C. |
| 22 | 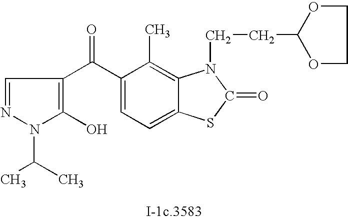 | δ (ppm) = 1.50 (d, 6H), 2.15 (m, 2H), 2.70 (s, 3H), 3.80 (m, 2H), 3.90 (m, 2H), 4.40 (m, 2H), 4.60 (m, 1H), 4.95 (m, 1H), 7.20-7.25 (m, 3H), 7.40 (d, 1H) |
| 23 | 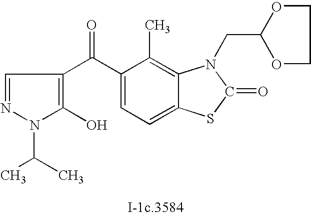 | m.p. 54° C. to 58° C. |
| 24 | 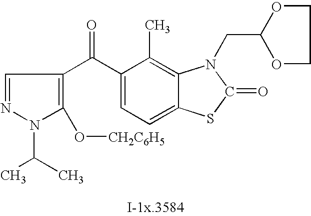 | m.p. 133° C. to 134° C. |
| 25 | 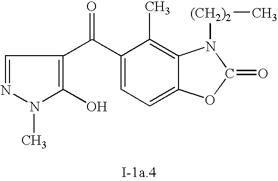 | m.p. 117° C. to 121° C. |
| 26 | 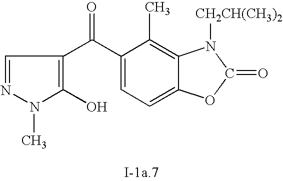 | m.p. 150° C. to 151° C. |
| 27 | 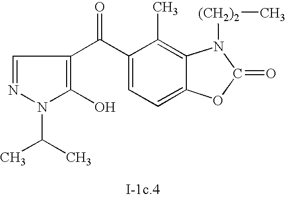 | m.p. 104° C. to 105° C. |
| 28 | 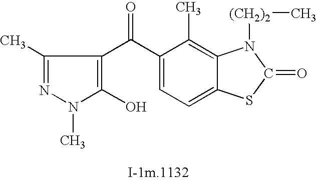 | m.p. 56° C. to 61° C. |
| 29 | 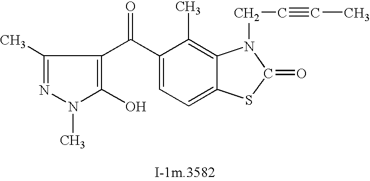 | δ (ppm) = 1.70 (s, 3H), 1.75 (s, 3H), 2.70 (s, 3H), 3.65 (s, 3H), 4.90 (s, 2H), 7.00 (d, 1H), 7.35 (d, 1H) |
| 30 | 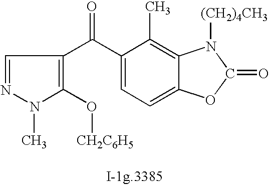 | δ (ppm) = 0.95 (t, 3H), 1.40 (m, 4H), 1.75, (m, 2H), 2.55 (s, 3H), 3.55 (s, 3H), 4.05 (m, 2H), 5.55 (s, 2H), 7.10 (d, 1H), 7.15 (d, 1H), 7.35 (m, 6H) |
| 31 | 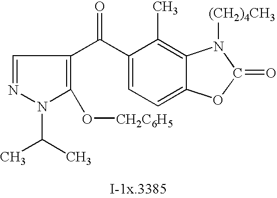 | δ (ppm) = 0.95 (t, 3H), 1.25 (d, 6H), 1.40 (m, 4H), 1.80 (m, 2H), 2.55 (s, 3H), 3.55 (s, 3H), 4.05 (m, 2H), 5.55 (s, 2H), 7.10 (d, 1H), 7.15 (d, 1H), 7.35 (m, 6H) |
| 32 | 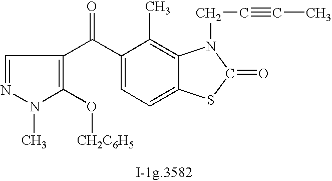 | δ (ppm) = 1.75 (s, 3H), 2.75 (s, 3H), 3.55 (s, 3H), 4.90 (s, 3H), 5.05 (s, 2H), 7.10 (d, 1H), 7.30-7.40 (m, 7H) |
| 33 | 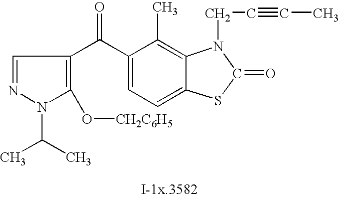 | δ (ppm) = 1.25 (d, 6H), 1.80 (s, 3H), 2.75 (s, 3H), 4.50 (m, 1H), 4.90 (s, 2H), 5.05 (s, 2H), 7.10 (d, 1H), 7.30-7.40 (m, 7H) |
| 34 | 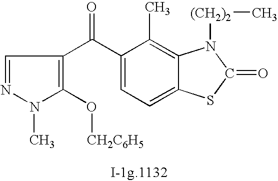 | δ (ppm) = 0.95 (t, 3H), 1.75 (m, 2H), 2.55 (s, 3H), 3.60 (s, 3H), 4.20 (m, 2H), 5.50 (s, 2H), 7.10 (d, 1H), 7.25-7.40 (m, 7H) |
| 35 | 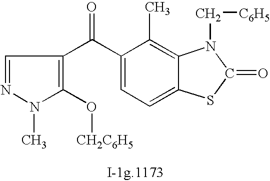 | m.p. 150° C. to 151° C. |
| 36 | 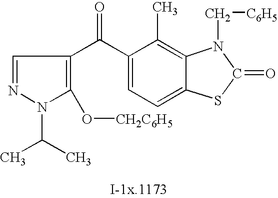 | δ (ppm) = 1.25 (d, 6H), 2.35 (s, 3H), 4.45 (m, 1H), 5.45 (m, 4H), 7.10-7.35 (m, 11H) |
| 37 | 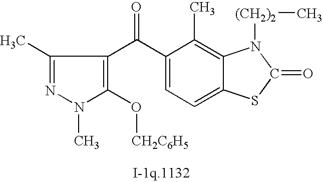 | δ (ppm) = 0.95 (t, 3H), 1.65 (m, 2H), 2.05 (s, 3H), 2.55 (s, 3H), 3.50 (s, 3H), 4.15 (m, 2H), 4.95 (s, 2H), 7.05-7.35 (m, 7H) |
| 38 | 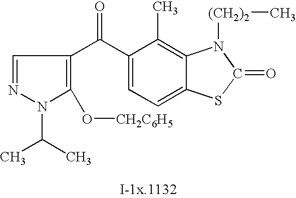 | δ (ppm) = 0.95 (t, 3H), 1.25 (d, 6H), 1.75 (m, 2H), 2.60 (s, 3H), 4.20 (m, 2H), 4.50 (m, 1H), 5.55 (s, 2H), 7.15 (d, 1H), 7.30-7.40 (m, 7H) |
| 39 | 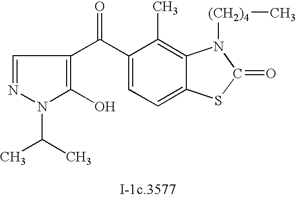 | m.p. 105° C. to 107° C. |
| 40 | 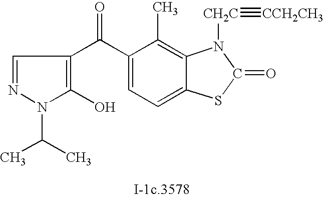 | δ (ppm) = 1.10 (t, 3H), 1.50 (d, 6H), 2.20 (m, 2H), 2.80 (s, 3H), 4.60 (m, 1H), 4.95 (s, 2H), 7.25-7.45 (m, 3H) |
| 41 | 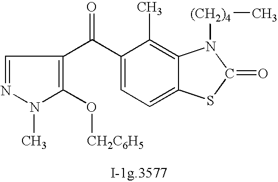 | δ (ppm) = 0.90 (t, 3H), 1.35 (m, 4H), 1.75 (m, 2H), 2.55 (s, 3H), 3.55 (s, 3H), 4.20 (m, 2H), 5.55 (s, 2H), 7.10 (d, 1H), 7.30-7.40 (m, 7H) |
| 42 | 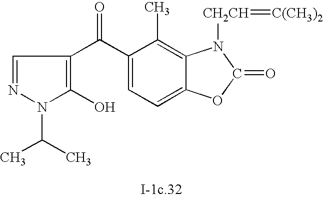 | δ (ppm) = 1.50 (d, 6H), 1.75 (s, 3H), 1.80 (s, 3H), 2.60 (s, 3H), 4.60 (m, 1H), 4.70 (m, 2H), 5.25 (m, 1H), 7.15 (d, 1H), 7.30 (d, 1H), 7.40 (d, 1H), 9.5 (s, 1H) |
| 43 | 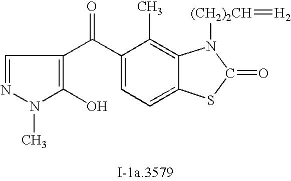 | δ (ppm) = 2.50 (m, 2H), 2.65 (s, 3H), 3.75 (s, 3H), 4.30 (m, 2H), 5.05 (m, 2H), 5.80 (m, 1H), 7.25 (d, 1H), 7.40 (d, 1H), 8.9 (s, 1H) |
| 44 | 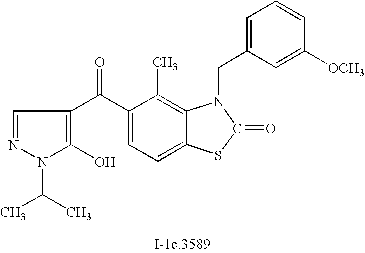 | m.p. 71° C. to 74° C. |
| 45 | 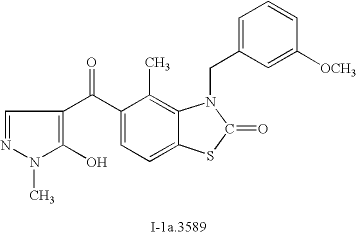 | m.p. 79° C. to 89° C. |
| 46 | 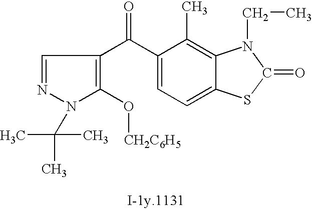 | δ (ppm) = 1.35 (t, 3H), 1.65 (s, 9H) 2.60 (s, 3H), 4.30 (q, 2H), 5.55 (s, 2H), 7.10-7.55 (m, 8H) |
| 47 | 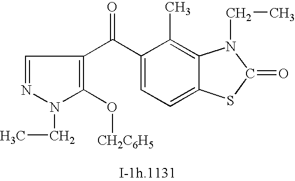 | δ (ppm) = 1.25 (t, 3H), 1.40 (t, 3H), 2.60 (s, 3H), 3.95 (q, 2H), 4.30 (q, 2H), 5.55 (s, 2H), 7.10 (d, 1H), 7.25-7.40 (m, 7H) |

The compounds I and their agriculturally useful salts are suitable, both as isomer mixtures and in the form of the pure isomers, for use as herbicides. The herbicidal compositions comprising compounds I effect very good control of vegetation on non-crop areas, especially at high application rates. In crops such as wheat, rice, maize, soybeans and cotton, they act against broad-leaved weeds and grass weeds without causing any significant damage to the crop plants. This effect is observed in particular at low application rates.

Depending on the application method in question, the compounds I or the herbicidal compositions comprising them can additionally be employed in a further number of crop plants for eliminating undesirable plants. Suitable crops are, for example, the following:

Allium cepa, Ananas comosus, Arachis hypogaea, Asparagus officinalis, Beta vulgaris spec. altissima, Beta vulgaris spec. rapa, Brassica napus var. napus, Brassica napus var. napobrassica, Brassica rapa var. silvestris, Camellia sinensis, Carthamus tinctorius, Carya illinoinensis, Citrus limon, Citrus sinensis, Coffea arabica (Coffea canephora, Coffea liberica), Cucumis sativus, Cynodon dactylon, Daucus carota, Elaeis guineensis, Fragaria vesca, Glycine max, Gossypium hirsutum, (Gossypium arboreum, Gossypium herbaceum, Gossypium vitifolium), Helianthus annuus, Hevea brasiliensis, Hordeum vulgare, Humulus lupulus, Ipomoea batatas, Juglans regia, Lens culinaris, Linum usitatissimum, Lycopersicon lycopersicum, Malus spec., Manihot esculenta, Medicago sativa, Musa spec., Nicotiana tabacum (N.rustica), Olea europaea, Oryza sativa, Phaseolus lunatus, Phaseolus vulgaris, Picea abies, Pinus spec., Pisum sativum, Prunus avium, Prunus persica, Pyrus communis, Ribes sylvestre, Ricinus communis, Saccharum officinarum, Secale cereale, Solanum tuberosum, Sorghum bicolor (s. vulgare), Theobroma cacao, Trifolium pratense, Triticum aestivum, Triticum durum, Vicia faba, Vitis vinifera and Zea mays.

In addition, the compounds I can also be used in crops which tolerate the action of herbicides due to breeding, including genetic engineering methods.

The compounds I, or the compositions comprising them, can be applied, for example, in the form of directly sprayable aqueous solutions, powders, suspensions, including highly-concentrated aqueous, oily or other suspensions or dispersions, emulsions, oil ispersions, pastes, dusts, materials for broadcasting or granules, by means of spraying, atomizing, dusting, broadcasting, pouring or seed dressing or mixing with the seed. The use forms depend on the intended purposes; in each case, they should ensure the finest possible distribution of the active compounds according to the invention. The herbicidal compositions comprise a herbicidally effective amount of at least one compound of the formula I or an agriculturally useful salt of I and auxiliaries which are customarily used for formulating crop protection agents.

Suitable inert additives are essentially:

Mineral oil fractions of medium to high boiling point, such as kerosene and diesel oil, furthermore coal tar oils and oils of vegetable or animal origin, aliphatic, cyclic and aromatic hydrocarbons, for example paraffin, tetrahydro-naphthalene, alkylated naphthalenes and their derivatives, alkylated benzenes and their derivatives, alcohols such as methanol, ethanol, propanol, butanol and cyclohexanol, ketones such as cyclohexanone, strongly polar solvents, for example amines such as N-methylpyrrolidone, and water.

Aqueous use forms can be prepared from emulsion concentrates, suspensions, pastes, wettable powders or water-dispersible granules by adding water. To prepare emulsions, pastes or oil dispersions, the compounds of the formula I, as such or dissolved in an oil or solvent, can be homogenized in water by means of wetting agent, tackifier, dispersant or emulsifier. Alternatively, it is possible to prepare concentrates from active substance, wetting agent, tackifier, dispersant or emulsifier and, if desired, solvent or oil, and these concentrates are suitable for dilution with water.

Suitable surfactants are the alkali metal salts, alkaline earth metal salts and ammonium salts of aromatic sulfonic acids, for example ligno-, phenol-, naphthalene- and dibutylnaphthalene-sulfonic acid, and of fatty acids, of alkyl- and alkylaryl-sulfonates, of alkyl sulfates, lauryl ether sulfates and fatty alcohol sulfates, and the salts of sulfated hexa-, hepta- and octadecanols and of fatty alcohol glycol ethers, condensates of sulfonated naphthalene and its derivatives with formaldehyde, condensates of naphthalene or of the naphthalenesulfonic acids with phenol and formaldehyde, polyoxyethylene octylphenol ether, ethoxylated isooctyl-, octyl- or nonylphenol, alkylphenyl polyglycol ethers, tributylphenyl polyglycol ether, alkylaryl polyether alcohols, isotridecyl alcohol, fatty alcohol/ethylene oxide condensates,-ethoxylated castor oil, polyoxyethylene alkyl ethers or polyoxypropylene alkyl ethers, lauryl alcohol polyglycol ether acetate, sorbitol esters, lignin-sulfite waste liquors or methylcellulose.

Powders, materials for spreading and dusts can be prepared by mixing or concomitant grinding of the active substances with a solid carrier.

Granules, e.g. coated granules, impregnated granules and homogeneous granules, can be prepared by binding the active compounds to solid carriers. Solid carriers are mineral earths such as silicas, silica gels, silicates, talc, kaolin, limestone, lime, chalk, bole, loess, clay, dolomite, diatomaceous earth, calcium sulfate, magnesium sulfate, magnesium oxide, ground synthetic materials, fertilizers such as ammonium sulfate, ammonium phosphate, ammonium nitrate, ureas, and products of vegetable origin such as cereal meal, tree bark meal, wood meal and nutshell meal, cellulose powders, or other solid carriers.

The concentrations of the active compounds I in the ready-to-use products can be varied within wide ranges. In general, the formulations comprise from 0.001 to 98% by weight, preferably 0.01 to 95% by weight, of at least one active compound. The active compounds are employed in a purity of from 90% to 100%, preferably 95% to 100% (according to NMR spectrum).

The compounds I according to the invention can be formulated, for example, as follows:

I. 20 parts by weight of the compound of the formula I are dissolved in a mixture composed of 80 parts by weight of alkylated benzene, 10 parts by weight of the adduct of 8 to 10 mol of ethylene oxide to 1 mol of oleic acid N-monoethanolamide, 5 parts by weight of calcium dodecylbenzenesulfonate and 5 parts by weight of the adduct of 40 mol of ethylene oxide and 1 mol of castor oil. Pouring the solution into 100,000 parts by weight of water and finely distributing it therein gives an aqueous dispersion which comprises 0.02% by weight of the active compound.

II. 20 parts by weight of the compound of the formula I are dissolved in a mixture composed of 40 parts by weight of cyclohexanone, 30 parts by weight of isobutanol, 20 parts by weight of the adduct of 7 mol of ethylene oxide to 1 mol of isooctylphenol and 10 parts by weight of the adduct of 40 mol of ethylene oxide to 1 mol of castor oil. Pouring the solution into 100,000 parts by weight of water and finely distributing it therein gives an aqueous dispersion which comprises 0.02% by weight of the active compound.

III. 20 parts by weight of the active compound of the formula I are dissolved in a mixture composed of 25 parts by weight of cyclohexanone, 65 parts by weight of a mineral oil fraction of boiling point 210 to 280° C. and 10 parts by weight of the adduct of 40 mol of ethylene oxide and 1 mol of castor oil. Pouring the solution into 100,000 parts by weight of water and finely distributing it therein gives an aqueous dispersion which comprises 0.02% by weight of the active compound.

IV. 20 parts by weight of the active compound of the formula I are mixed thoroughly with 3 parts by weight of sodium diisobutylnaphthalenesulfonate, 17 parts by weight of the sodium salt of a lignosulfonic acid from a sulfite waste liquor and 60 parts by weight of pulverulent silica gel, and the mixture is ground in a hammer mill. Finely distributing the mixture in 20,000 parts by weight of water gives a spray mixture which comprises 0.1% by weight of the active compound.

V. 3 parts by weight of the active compound of the formula I are mixed with 97 parts by weight of finely divided kaolin. This gives a dust which comprises 3% by weight of the active compound.

VI. 20 parts by weight of the active compound of the formula I are mixed intimately with 2 parts by weight of calcium dodecylbenzenesulfonate, 8 parts by weight of fatty alcohol polyglycol ether, 2 parts by weight of the sodium salt of a phenol/urea/formaldehyde condensate and 68 parts by weight of a paraffinic mineral oil. This gives a stable oily dispersion.

VII. 1 part by weight of the compound of the formula I is dissolved in a mixture composed of 70 parts by weight of cyclohexanone, 20 parts by weight of ethoxylated isooctylphenol and 10 parts by weight of ethoxylated castor oil. This gives a stable emulsion concentrate.

VIII. 1 part by weight of the compound of the formula I is dissolved in a mixture composed of 80 parts by weight of cyclohexanone and 20 parts by weight of Wettol® EM 31 (=non-ionic emulsifier based on ethoxylated castor oil). This gives a stable emulsion concentrate.

The herbicidal compositions or the active compounds can be applied pre- or post-emergence or together in the seed of a crop plant. It is also possible to apply the herbicidal compositions or active compounds by applying crop plant seed pretreated with the herbicidal compositions or active compounds. If the active compounds are less-well tolerated by certain crop plants, it is possible to use application techniques in which the herbicidal compositions are sprayed, with the aid of the spraying equipment, in such a way that they come into as little contact as possible, if any, with the leaves of the sensitive crop plants while the active compounds reach the leaves of undesirable plants which grow underneath, or the bare soil surface (post-directed, lay-by).

Depending on the intended aim, the season, the target plants and the growth stage, the rates of application of the active compound I are from 0.001 to 3.0, preferably 0.01 to 1.0, kg of active substance (a.s.)/ha.

To widen the spectrum of action and to achieve synergistic effects, the compounds I may be mixed, and applied jointly, with a large number of representatives of other groups of herbicidally or growth-regulating active compounds. Suitable examples of components in mixtures are 1,2,4-thiadiazoles, 1,3,4-thiadiazoles, amides, aminophosphoric acid and its derivatives, aminotriazoles, anilides, (het)aryloxyalkanoic acids and their derivatives, benzoic acid and its derivatives, benzothiadiazinones, 2-aroyl-1,3-cyclohexanediones, 2-hetaroyl-1,3-cyclohexanedione, hetaryl aryl ketones, benzylisoxazolidinones, meta-CF₃-phenyl derivatives, carbamates, quinolinecarboxylic acid and its derivatives, chloroacetanilides, cyclohexenone oxime ether derivatives, diazines, dichloropropionic acid and its derivatives, dihydrobenzofurans, dihydrofuran-3-ones, dinitroanilines, dinitrophenols, diphenyl ethers, dipyridyls, halocarboxylic acids and their derivatives, ureas, 3-phenyluracils, imidazoles, imidazolinones, N-phenyl-3,4,5,6-tetrahydrophthalimides, oxadiazoles, oxiranes, phenols, aryloxy- and hetaryloxyphenoxypropionic esters, phenylacetic acid and its derivatives, phenylpropionic acid and its derivatives, pyrazoles, phenylpyrazoles, pyridazines, pyridinecarboxylic acid and its derivatives, pyrimidyl ethers, sulfonamides, sulfonylureas, triazines, triazinones, triazolinones, triazolecarboxamides and uracils.

Moreover, it may be advantageous to apply the compounds I alone or in combination with other herbicides, even in the form of a mixture together with further crop protection agents, for example with pesticides or agents for controlling phytopathogenic fungi or bacteria. Also of interest is the miscibility with mineral salt solutions which are employed for treating nutritional and trace element deficiencies. Nonphytotoxic oils and oil concentrates may also be added.

Use Examples

The herbicidal activity of the benzazolones of the formula I was demonstrated by the following greenhouse experiments:

The culture containers used were plastic pots containing loamy sand with approximately 3.0% of humus as substrate. The seeds of the test plants were sown separately for each species.

For the pre-emergence treatment, the active compounds, suspended or emulsified in water, were applied directly after sowing by means of finely distributing nozzles. The containers were irrigated gently to promote germination and growth and subsequently covered with translucent plastic hoods until the plants had rooted. This cover caused uniform germination of the test plants unless this was adversely affected by the active compounds.

For the post-emergence treatment, the test plants were first grown to a plant height of from 3 to 15 cm, depending on the plant habit, and only then treated with the active compounds which had been suspended or emulsified in water. To this end, the test plants were either sown directly and grown in the same containers, or they were first grown separately as seedlings and transplanted into the test containers a few days prior to treatment. The rate of application for the post-emergence treatment was 31.3, 62.5, 125 and/or 250 g of a.s. (active substance) /ha.

Depending on the species, the plants were kept at from 10 to 25° C., or 20-35° C., respectively. The test period extended over 2 to 4 weeks. During this time, the plants were tended, and their response to the individual treatments was evaluated.

Evaluation was carried out using a scale of from 0 to 100. 100 means no emergence of the plants, or complete destruction of at least the aerial parts, and 0 means no damage, or normal course of growth. A damage of at least 95% corresponds to very good herbicidal action.

The plants used in the greenhouse experiments were of the following species:

| Bayercode | Common Name |
|---|---|
| AMARE | redroot pigweed |
| BIDPI | hairy beggarticks |
| BRAPL | marmelade grass |
| CHEAL | lambsquarters (goo- |
| | sefoot) |
| ECHCG | barnyardgrass |
| LAMAM | henbit |
| PAPRH | cornpoppy |
| PHBPU | morningglory, com- |
| | mon |
| POLPE | ladysthumb |
| SETFA | giant foxtail |
| STEME | chickweed |
| THLAR | pennycress |

The following results were obtained by the post-emergence method.

At application rates of 31.3 or 62.5 g/ha (a.s.), the compound I-1a.1129 from Example 1, used by the post-emergence method, showed very good herbicidal action against CHEAL, SETFA, STEME and THLAR.

At application rates of 31.3 or 62.5 g/ha (a.s.), the compound I-1b.1129 from Example 2, used by the post-emergence method, showed very good herbicidal action against CHEAL, ECHCG, PARPH, STEME and THLAR.

At application rates of 31.3 or 62.5 g/ha (a.s.), the compound I-1c.1129 from Example 3, used by the post-emergence method, showed very good herbicidal action against AMARE, CHEAL, ECHCG and POLPE.

At application rates of 125 or 250 g/ha (a.s.), the compound I-1a.1131 from Example 10, used by the post-emergence method, showed very good herbicidal action against BRAPL. AMARE, CHEAL, ECHCG and SETFA.

At application rates of 125 or 250 g/ha (a.s.), the compound I-1b.1131 from Example 11, used by the post-emergence method, showed very good herbicidal action against BRAPL. AMARE, CHEAL, ECHCG and SETFA.

At application rates of 125 or 250 g/ha (a.s.), the compound I-1c.1131 from Example 12, used by the post-emergence method, showed very good herbicidal action against BRAPL. AMARE, CHEAL, ECHCG and SETFA.

At application rates of 125 or 250 g/ha (a.s.), the compound I-1d.1131 from Example 13, used by the post-emergence method, showed very good herbicidal action against BRAPL. AMARE, CHEAL, ECHCG and SETFA.

At application rates of 125 or 250 g/ha (a.s.), the compound I-1h.1131 from Example 47, used by the post-emergence method, showed very good herbicidal action against BRAPL. AMARE, CHEAL, ECHCG and SETFA.

At application rates of 125 or 250 g/ha (a.s.), the compound I-1y.1131 from Example 46, used by the post-emergence method, showed very good herbicidal action against BRAPL. PHBPU, CHEAL, ECHCG and SETFA.

At application rates of 125 or 250 g/ha (a.s.), the compound I-1g.1131 from Example 14, used by the post-emergence method, showed very good-herbicidal action against BRAPL. AMARE, CHEAL, ECHCG and SETFA.

At application rates of 125 or 62.5 g/ha (a.s.), the compound I-1a.4 from Example 25, used by the post-emergence method, showed very good herbicidal action against BRAPL. AMARE, CHEAL, ECHCG and SETFA.

At application rates of 125 or 250 g/ha (a.s.), the compound I-1a.6 from Example 9, used by the post-emergence method, showed very good herbicidal action against BIDPI, CHEAL, POLPE and SETFA.

We claim:

1. A pyrazolylbenzazolone of the formula I 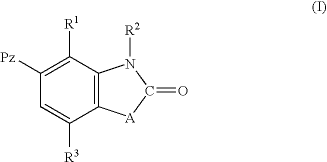
in which A, R¹, R², R³ and Pz are as defined below:
A is O, S, SO, SO₂ or NR⁶;
R¹ is halogen, C₁-C₄-alkyl, C₁-C₄-haloalkyl, C₁-C₄-hydroxy-alkyl, C₁-C₄-alkoxy-C₁-C₄-alkyl, C₁-C₄-haloalkoxy-C₁-C₄-alkyl, C₁-C₄-haloalkylthio-C₁-C₄-alkyl, C₁-C₄-alkylthio-C₁-C₄-alkyl, C₁-C₄-alkylsulfonyl-C₁-C₄-alkyl,
C₁-C₄-haloalkylsulfonyl-C₁-C₄-alkyl, C₁-C₄-alkoxy,
C₁-C₄-hydroxyalkoxy, C₁-C₄-haloalkoxy, C₁-C₄-alkoxy-C₁-C₄-alkoxy, C₁-C₄-haloalkoxy-C₁-C₄-alkoxy, C₁-C₄-alkyl-thio, C₁-C₄-haloalkylthio, C₁-C₄-alkylsulfonyl,
C₁-C₄-haloalkylsulfonyl;
R² is hydrogen, hydroxyl, nitro, amino, C₁-C₆-alkylamino,
di(C₁-C₆-alkyl)amino, cyano, CHO, C₁-C₆-alkoxy,
C₁-C₆-alkyl, C₁-C₆-hydroxyalkyl, C₁-C₆-haloalkyl,
C₁-C₆-alkoxy-C₁-C₆-alkyl, C₁-C₆-haloalkoxy-C₁-C₆-alkyl,
C₂-C₆-alkenyl, C₂-C₆-haloalkenyl, C₁-C₆-haloalkoxy-C₂-C₆-alkenyl, C₁-C₆-alkoxy-C₂-C₆-alkenyl, C₂-C₆-alkynyl,
C₂-C₆-haloalkynyl, C₁-C₆-haloalkoxy-C₂-C₆-alkynyl,
C₁-C₆-alkoxy-C₂-C₆-alkynyl, C₁-C₆-alkylsulfonyl,
C₁-C₆-haloalkylsulfonyl, (C₁-C₆-alkyl)carbonyl,
C₁-C₆-haloalkylcarbonyl, hydroxycarbonyl-C₁-C₄-alkyl,
C₁-C₆-alkoxycarbonyl-C₁-C₆-alkyl,
a radical of the formula C(O)OR⁴, CON(R⁵)₂ or
C(═NOR^{4a})R^{4b}, aryl, aryl-C₁-C₄-alkyl, arylsulfonyl,
arylcarbonyl, C₃-C₆-cycloalkyl, C₃-C₆-cycloalkenyl,
3-, 4-, 5-, 6- or 7-membered heterocyclyl,
3-, 4-, 5-, 6- or 7-membered heterocyclyl-C₁-C₆-alkyl,
where each aryl, cycloalkyl, cycloalkenyl and each heterocyclyl radical may be unsubstituted or may carry one, two, three or four substituents, in each case selected from the group consisting of halogen,
C₁-C₄-haloalkyl, C₁-C₄-alkoxy and C₁-C₄-haloalkoxy;
R³ is hydrogen, C₁-C₄-alkyl, C₁-C₄-haloalkyl, C₁-C₄-alkoxy-C₁-C₄-alkyl, C₁-C₄-haloalkoxy-C₁-C₄-alkyl or halogen;
in which
R⁴ is C₁-C₆-alkyl, C₁-C₆-haloalkyl, C₁-C₆-alkoxy-C₁-C₆-alkyl, C₁-C₆-haloalkoxy-C₁-C₆-alkyl,
C₂-C₆-alkenyl, C₂-C₆-haloalkenyl, C₁-C₆-haloalkoxy-C₂-C₆-alkenyl, C₁-C₆-alkoxy-C₂-C₆-alkenyl,
C₂-C₆-alkynyl, C₂-C₆-haloalkynyl, C₁-C₆-haloalkoxy-C₂-C₆-alkynyl, C₁-C₆-alkoxy-C₂-C₆-alkynyl;
R^{4a}, R^{4b} independently of one another may have the meanings mentioned for R⁴, and R^{4b} may be hydrogen;
R⁵ independently of one another are hydrogen,
C₁-C₆-alkyl, C₁-C₆-haloalkyl, C₁-C₆-alkoxy-C₁-C₆-alkyl, (C₁-C₆-haloalkoxy)-C₁-C₆-alkyl,
C₂-C₆-alkenyl, C₂-C₆-haloalkenyl, C₁-C₆-haloalkyl-C₂-C₆-alkenyl, C₁-C₆-haloalkoxy-C₂-C₆-alkenyl,
C₁-C₆-alkoxy-C₂-C₆-alkenyl, C₂-C₆-alkynyl,
C₂-C₆-haloalkynyl, C₁-C₆-haloalkyl-C₂-C₆-alkynyl,
C₁-C₆-haloalkoxy-C₂-C₆-alkynyl, C₁-C₆-alkoxy-C₂-C₆-alkynyl, or together form a 3- to 7-membered heterocycle which may be partially or fully halogenated and/or may carry one, two or three substituents selected from the group consisting of
C₁-C₆-alkyl, C₁-C₆-haloalkyl, C₁-C₆-alkoxy,
C₁-C₆-haloalkoxy;
R⁶ is hydrogen, C₁-C₄-alkyl, C₁-C₄-haloalkyl, C₁-C₄-halo-alkoxy-C₁-C₄-alkyl, C₁-C₄-alkoxy-C₁-C₄-alkyl; and
Pz is a radical of the formula IIa or IIb, 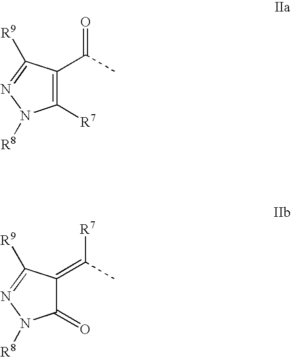
in which the variables R⁷, R⁸ and R⁹ are as defined below:
R⁷ is hydroxyl, mercapto, halogen, OR¹⁰, SR¹⁰, SOR¹¹, SO₂R¹¹, OSO₂R¹¹, P(O)R¹²R¹³, OP(O)R¹²R¹³, P(S)R¹²R¹³, OP(S)R¹²R¹³, NR¹⁴R¹⁵, ONR¹⁴R¹⁵ or N-bonded heterocyclyl which may be partially or fully halogenated and/or may carry one, two or three of the following radicals: nitro, cyano, C₁-C₄-alkyl, C₁-C₄-haloalkyl,
C₁-C₄-alkoxy or C₁-C₄-haloalkoxy;
R⁸ is hydrogen, C₁-C₆-alkyl, C₁-C₆-haloalkyl,
C₃-C₆-cycloalkyl, hydroxyl, C₁-C₆-alkoxy or
C₁-C₆-haloalkoxy;
R⁹ is hydrogen, halogen, C₁-C₆-alkyl, C₁-C₆-haloalkyl,
hydroxyl, C₁-C₆-alkoxy, C₁-C₆-haloalkoxy,
C₁-C₆-alkylthio or C₁-C₆-haloalkylthio;
where
R¹⁰ is C₁-C₆-alkyl, C₃-C₆-alkenyl, C₃-C₆-haloalkenyl,
C₃-C₆-alkynyl, C₃-C₆-haloalkynyl, C₃-C₆-cycloalkyl,
C₁-C₆-alkylcarbonyl, C₂-C₆-alkenylcarbonyl,
C₂-C₆-alkynylcarbonyl, C₃-C₆-cycloalkylcarbonyl,
C₁-C₆-alkoxycarbonyl, C₃-C₆-alkenyloxycarbonyl,
C₃-C₆-alkynyloxycarbonyl, C₁-C₆-alkylthiocarbonyl, C₁-C₆-alkylaminocarbonyl, C₃-C₆-alkenylaminocarbonyl, C₃-C₆-alkynylaminocarbonyl, N,N-di(C₁-C₆-alkyl)amino-carbonyl, N—(C₃-C₆-alkenyl)-N—(C₁-C₆-alkyl)amino-carbonyl, N—(C₃-C₆-alkynyl)-N—(C₁-C₆-alkyl)amino-carbonyl, N—(C₁-C₆-alkoxy)-N—(C₁-C₆-alkyl)amino-carbonyl, N—(C₃-C₆-alkenyl)-N—(C₁-C₆-alkoxy)amino-carbonyl, N—(C₃-C₆-alkynyl)-N—(C₁-C₆-alkoxy)amino-carbonyl, di(C₁-C6-alkyl)aminothiocarbonyl or
C₁-C₆-alkoxyimino-C₁-C₆-alkyl, where the alkyl, cycloalkyl and alkoxy radicals mentioned may be partially or fully halogenated and/or may carry one to three of the following groups: cyano,
C₁-C₄-alkoxy, C₁-C₄-alkylthio, di(C₁-C₄-alkyl)amino,
C₁-C₄-alkylcarbonyl, C₁-C₄-alkoxycarbonyl,
C₁-C₄-alkoxy-C₁-C₄-alkoxycarbonyl,
C₁-C₄-alkylaminocarbonyl,
di(C₁-C₄-alkyl)aminocarbonyl, aminocarbonyl,
C₁-C₄-alkylcarbonyloxy or C₃-C₆-cycloalkyl;
is phenyl, phenyl-C₁-C₆-alkyl, phenylcarbonyl-C₁-C₆-alkyl, phenylcarbonyl, phenoxycarbonyl,
phenyloxythiocarbonyl, phenylaminocarbonyl,
N—(C₁-C₆-alkyl)-N-(phenyl)aminocarbonyl, phenyl-C₂-C₆-alkenylcarbonyl, heterocyclyl, heterocyclyl-C₁-C₆-alkyl, heterocyclylcarbonyl-C₁-C₆-alkyl,
heterocyclylcarbonyl, heterocyclyloxycarbonyl,
heterocyclyloxythiocarbonyl, heterocyclylaminocarbonyl,
N—(C₁-C₆-alkyl)-N-(heterocyclyl)-aminocarbonyl, or heterocyclyl-C₂-C₆-alkenylcarbonyl,
where the phenyl and the heterocyclyl radical of the 18 lastmentioned substituents may be partially or fully halogenated and/or may carry one, two or three of the following radicals: nitro, cyano, C₁-C₄-alkyl,
C₁-C₄-haloalkyl, C₁-C₄-alkoxy or C₁-C₄-haloalkoxy;
R¹¹ is C₁-C₆-alkyl, C₃-C₆-alkenyl, C₃-C₆-alkynyl or C₃-C₆-cycloalkyl, where the four radicals mentioned may be partially or fully halogenated and/or may carry one, two or three of the following groups:
cyano, C₁-C₄-alkoxy, C₁-C₄-haloalkoxy,
C₁-C₄-alkylthio, C₁-C₄-haloalkylthio,
C₁-C₄-alkylcarbonyl, C₁-C₄-alkoxycarbonyl or C₁-C₄-haloalkoxycarbonyl;
is phenyl, phenyl-C₁-C₆-alkyl, heterocyclyl or heterocyclyl-C₁-C₆-alkyl, where the phenyl and the heterocyclyl radical of the lastmentioned substituents may be partially or fully halogenated and/or may carry one, two or three of the following radicals: nitro, cyano, C₁-C₄-alkyl, C₁-C₄-haloalkyl,
C₁-C₄-alkoxy, C₁-C₄-haloalkoxy or
C₁-C₄-alkoxycarbonyl;
R¹², R¹³ independently of one another are hydrogen, hydroxyl,
C₁-C₆-alkyl, C₁-C₆-alkoxy, C₁-C₆-alkylthio, phenyl,
phenyl-C₁-C₄-alkyl or phenoxy, where the three lastmentioned substituents may be partially or fully halogenated and/or may carry one, two or three of the following radicals: nitro, cyano, C₁-C₄-alkyl,
C₁-C₄-haloalkyl, C₁-C₄-alkoxy, C₁-C₄-haloalkoxy or
C₁-C₄-alkoxycarbonyl;
R¹⁴ is hydrogen, C₁-C₆-alkyl, C₃-C₆-alkenyl,
C₃-C₆-haloalkenyl, C₃-C₆-alkynyl, C₃-C₆-haloalkynyl,
C₃-C₆-cycloalkyl, C₁-C₆-alkylcarbonyl, hydroxyl,
C₁-C₆-alkoxy, C₃-C₆-alkenyloxy, C₃-C₆-alkynyloxy,
amino, C₁-C₆-alkylamino, di(C₁-C₆-alkyl)amino or
C₁-C₆-alkylcarbonylamino, where the alkyl, cycloalkyl and alkoxy radicals mentioned may be partially or fully halogenated and/or may carry one, two or three of the following radicals: cyano, C₁-C₄-alkoxy-carbonyl, C₁-C₄-alkylaminocarbonyl, di(C₁-C₄-alkyl)-aminocarbonyl or C₃-C₆-cycloalkyl;
is phenyl, phenyl-C₁-C₄-alkyl, phenylcarbonyl,
heterocyclyl, heterocyclyl-C₁-C₄-alkyl or
heterocyclylcarbonyl, where the phenyl or
heterocyclyl radical of the six lastmentioned substituents may be partially or fully halogenated and/or may carry one, two or three of the following radicals: nitro, cyano, C₁-C₄-alkyl, C₁-C₄-haloalkyl,
C₁-C₄-alkoxy or C₁-C₄-haloalkoxy; and
R¹⁵ is hydrogen, C₁-C₆-alkyl or C₃-C₆-alkenyl,
C₃-C₆-alkynyl;
and its agriculturally useful salts.

2. A benzazolone as claimed in claim 1 where A in the formula I is oxygen or NR⁶.

3. A benzazolone as claimed in claim 1 where A in the formula I is sulfur or SO₂.

4. A benzazolone as claimed in any of the preceding claims where R¹ in the formula I is selected from the group consisting of C₁-C₄-alkyl, halogen and C₁-C₄-alkoxy.

5. A benzazolone as claimed in any of the preceding claims where R² is different from hydrogen.

6. A benzazolone as claimed in any of the preceding claims where R² in the formula I is a heterocycle selected from the group consisting of 4,5-dihydroisoxazol-3-yl, 4,5-dihydroisoxazol-4-yl, isoxazol-3-yl, isoxazol-4-yl, 1,3-dioxolan-2-yl, 1,3-dithiolan-2-yl, 1,3-dioxan-2-yl, 1,3-dithian-2-yl, oxazolin-2-yl and oxazolidin-2-yl, where the abovementioned heterocycles may be mono-, di- or trisubstituted by C₁-C₄-alkyl.

7. A benzazolone as claimed in any of claims 1 to 5, where R² in the formula I is cyano, C₁-C₄-alkyl, C₃-C₆-alkenyl,
C₁-C₄-(halo)alkylcarbonyl, C₁-C₄-alkoxycarbonyl-C₁-C₄-alkyl or
C₁-C₄-alkoxycarbonyl.

8. A benzazolone as claimed in any of the preceding claims where R³ in the formula I is hydrogen, C₁-C₄-alkyl or halogen.

9. A benzazolone as claimed in any of the preceding claims where Pz in the formula I is a radical of the formula IIa where R⁷ is selected from the group consisting of hydroxyl, OR¹⁰ and OSO₂R¹¹, where R¹⁰ and R¹¹ are as defined in claim 1, R⁸ and R⁹ being as defined in claim 1.

10. A benzazolone as claimed in claim 9 where in the formula IIa
R⁷ is hydroxyl, C₁-C₄-alkyloxy, acetoxy, O—CH₂-phenyl,
phenylcarbonyloxy, 2-, 3- or 4-fluorophenyl-carbonyloxy, cyclopropylcarbonyloxy, C₁-C₄-sulfonyloxy,
phenylsulfonyloxy or 2-, 3- or 4-methylphenylsulfonyloxy;.
R⁸ is C₁-C₄-alkyl or cyclopropyl and
R⁹ is hydrogen or C₁-C₄-alkyl.

11. A benzazolonecarboxylic acid of the formula IVa 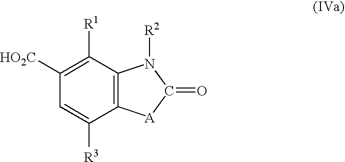
where
A, R¹, R² and R³ are as defined in claim 1.

12. A composition, comprising at least one pyrazole derivative of the formula I or an agriculturally useful salt of I as claimed in any of claims 1 to 10, and customary auxiliaries.

13. A method for controlling undesirable vegetation, which comprises allowing a herbicidally effective amount of at least one pyrazole derivative of-the formula I or an agriculturally useful salt of I as claimed in any of claims 1 to 10 to act on plants, their habitat and/or on seed.

14. The use of pyrazole derivatives of the formula I or their agriculturally useful salts as claimed in any of claims 1 to 10 as herbicides.
